(19) United States
(12) Patent Application Publication
(10) Pub. No.: US 2025/0060782 A1
(43) Pub. Date: Feb. 20, 2025

(54) WEARABLE DEVICES WITH WIRELESS TRANSMITTER-RECEIVER PAIRS FOR ACOUSTIC SENSING OF USER CHARACTERISTICS

(71) Applicant: Cornell University, Ithaca, NY (US)

(72) Inventors: Saif Mahmud, Ithaca, NY (US); Vineet Arjav Parikh, Ithaca, NY (US); Ruidong Zhang, Ithaca, NY (US); Francois Guimbretiere, Ithaca, NY (US); Cheng Zhang, Ithaca, NY (US)

(21) Appl. No.: 18/925,803

(22) Filed: Oct. 24, 2024

Related U.S. Application Data
(63) Continuation-in-part of application No. 18/597,419, filed on Mar. 6, 2024.
Application No. 18/597,419 is a continuation-in-part of application No. 17/986,102, filed on Nov. 14, 2022.
(60) Provisional application No. 63/450,344, filed on Mar. 6, 2023.
(60) Provisional application No. 63/343,023, filed on May 17, 2022.
(60) Provisional application No. 63/592,781, filed on Oct. 24, 2023.

(51) Int. Cl. G06F 1/16; H01Q 1/27

(52) U.S. Cl. CPC G06F 1/163; H01Q 1/273

(57) ABSTRACT

An apparatus in one embodiment comprises at least one wearable device, with the at least one wearable device comprising at least one of a transmitter and a receiver of a wireless transmitter-receiver pair. The transmitter of the wireless transmitter-receiver pair transmits an acoustic signal, and the receiver of the wireless transmitter-receiver pair receives the acoustic signal. The received acoustic signal is processed utilizing a machine learning system to detect at least one characteristic of a user of the at least one wearable device. In some embodiments, a given wearable device comprises at least first and second wireless transmitter-receiver pairs, with the transmitter of each of the first and second wireless transmitter-receiver pairs transmitting an acoustic signal having a different carrier frequency. In such embodiments, a multi-channel echo profile may be generated using the multiple acoustic signals and classified by the machine learning system to detect the at least one characteristic.

### CROSS-REFERENCE TO RELATED APPLICATIONS

This application is a continuation-in-part of U.S. patent application Ser. No. 18/597,419, filed Mar. 6, 2024 and entitled “Wearable Devices To Determine Facial Outputs Using Acoustic Sensing,” which claims the benefit of U.S. Provisional Patent Application Ser. No. 63/450,344, filed Mar. 6, 2023 and entitled “Wearable Devices to Determine Facial Outputs Using Acoustic Sensing” and is a continuation-in-part of U.S. patent application Ser. No. 17/986,102, filed Nov. 14, 2022 and entitled “Wearable Facial Movement Tracking Devices,” which claims the benefit of U.S. Provisional Patent Application Ser. No. 63/343,023, filed May 17, 2022 and entitled “Wearable Facial Movement Tracking Devices” and is a continuation-in-part of PCT Patent Application No. PCT/US2021/032511, filed May 14, 2021 and entitled “Wearable Devices For Facial Expression Recognition,” which claims the benefit of U.S. Provisional Patent Application Ser. No. 63/025,979, filed May 15, 2020 and entitled “C-Face: Continuously Reconstructing Facial Expressions by Deep Learning Contours of the Face with Ear-Mounted Miniature Cameras.” The present application also claims the benefit of U.S. Provisional Patent Application Ser. No. 63/592,781, filed Oct. 24, 2023 and entitled “Wearable Devices with Wireless Transmitter-Receiver Pairs for Acoustic Sensing of User Characteristics.” The entire contents of the above-identified priority applications are hereby fully incorporated herein by reference.

### STATEMENT OF GOVERNMENT SUPPORT

This invention was made with U.S. government support under Grant No. 2239569 of the National Science Foundation (NSF). The U.S. government has certain rights in the invention.

### TECHNICAL FIELD

The field relates generally to wearable devices and associated signal processing and machine learning techniques for detection of user activities and/or other user characteristics in diverse applications.

### BACKGROUND

A broad array of different types and configurations of wearable devices have been developed. Some of these wearable devices are configured to track or otherwise detect various types of user characteristics. For example, user activity detection is of particular importance in a wide variety of different contexts. Conventional approaches to user activity detection are often based on unduly complex sensor arrangements, such as inertial measurement units (IMUs), and as a result can be unduly costly and resource-intensive, requiring substantial processing and memory resources. Such deficiencies in these and other conventional approaches have created a need for improvements in wearable device functionality for user activity detection and numerous other diverse applications.

### SUMMARY

Illustrative embodiments disclosed herein provide wearable devices with wireless transmitter-receiver pairs for acoustic sensing of user activities and/or other user characteristics. For example, in some embodiments, one or more wearable devices are each configured with one or more wireless transmitter-receiver pairs for transmitting and receiving acoustic signals for acoustic sensing of user activities.

As another example, other embodiments disclosed herein configure such wireless transmitter-receiver pairs to detect facial expressions, hand poses and/or hand-object interaction, in addition to or in place of other user characteristics.

In still other illustrative embodiments disclosed herein, one or more wireless transmitter-receiver pairs of at least one wearable device are configured to provide a silent speech interface, for detecting user characteristics that include silent commands generated by a user of the wearable device.

These and numerous other embodiments disclosed herein can be configured for use in a wide variety of different applications utilizing one or more multiple distinct wearable device form factors such as, for example, smart glasses, wristbands, headphones and/or rings. A wide variety of other form factors can be used, in any combination.

Also, although some embodiments utilize acoustic signals, other embodiments can utilize other types of signals, such as millimeter wave signals and/or other radio frequency signals, in addition to or in place of acoustic signals.

In one embodiment, an apparatus comprises at least one wearable device, with the at least one wearable device comprising at least one of a transmitter and a receiver of a wireless transmitter-receiver pair. The transmitter of the wireless transmitter-receiver pair transmits an acoustic signal, and the receiver of the wireless transmitter-receiver pair receives the acoustic signal. The received acoustic signal is processed utilizing a machine learning system to detect at least one characteristic of a user of the at least one wearable device.

In some embodiments, a given wearable device comprises at least first and second wireless transmitter-receiver pairs, with the transmitter of each of the first and second wireless transmitter-receiver pairs transmitting an acoustic signal having a different carrier frequency, such as first and second frequency modulated continuous wave (FMCW) acoustic signals having respective different base carrier frequencies. Other modulation arrangements can be used in addition to or in place of FMCW in other embodiments.

A multi-channel echo profile may be generated using the multiple transmitted acoustic signals as received by the receivers of the first and second wireless transmitter-receiver pairs, with the multi-channel echo profile being classified by the machine learning system to detect the at least one characteristic of the user of the wearable device.

It is to be appreciated that the foregoing arrangements are only examples, including examples of applications of the disclosed techniques, and numerous alternative arrangements are possible.

These and other illustrative embodiments include but are not limited to systems, methods, apparatus, processing devices, integrated circuits, and computer program products comprising processor-readable storage media having software program code embodied therein.

### BRIEF DESCRIPTION OF THE DRAWINGS

FIG. 1 is a block diagram depicting a facial expression reconstruction system.

FIGS. 2A and 2B are perspective views of head-mounted wearable devices for facial expression reconstruction.

FIGS. 3A, 3B, and 3C are illustrations depicting examples of head-mounted wearable devices on a user.

FIG. 4 is a block diagram depicting a deep-learning model process.

FIG. 5 is a block diagram depicting a classifier process.

FIG. 6 is a diagram depicting the correlation between frontal view camera images, landmark training data, predicted facial expression landmarks, and right and left facial contour images.

FIG. 7 is a diagram depicting the correlation between frontal view camera images, two-dimensional training data, predicted two-dimensional facial expressions, and right and left facial contour images.

FIG. 8 is a block flow diagram depicting a method to reconstruct facial expressions.

FIG. 9 is a block flow diagram depicting a method to create a data training set using frontal view digital images.

FIG. 10 is a block flow diagram depicting a method to reconstruct facial expressions using one or more facial digital image(s).

FIG. 11 is a block flow diagram depicting a method to pre-process each pair of synchronized facial digital images.

FIGS. 12A, 12B, and 12C are perspective views of neck-mounted wearable devices for facial expression reconstruction.

FIGS. 13A and 13B are illustrations depicting examples of neck-mounted wearable devices on a user.

FIG. 14 is a block diagram depicting an alternate embodiment of a deep-learning model process.

FIG. 15A is a diagram depicting the correlation between frontal view camera images, three-dimensional training data, predicted three-dimensional face expressions, and infrared facial images.

FIG. 15B is a diagram depicting the correlation between frontal view camera images, three-dimensional training data, predicted three-dimensional face expressions, and infrared facial images.

FIG. 16 is a block flow diagram depicting an alternative method to create a data training set using frontal view images.

FIG. 17 is a block flow diagram depicting an alternative method to reconstruct facial expressions using one or more facial digital image(s).

FIG. 18 is a block flow diagram depicting an alternative method to pre-process the one or more digital facial image(s).

FIG. 19 is a block diagram depicting an acoustic sensor system based facial expression reconstruction system.

FIG. 20A is a block diagram depicting a first embodiment of an acoustic sensor system.

FIG. 20B is a block diagram depicting a second embodiment of an acoustic sensor system. FIG. 20C is a block diagram depicting a third embodiment of an acoustic sensor system.

FIG. 21 is a block diagram depicting a data processing module.

FIG. 22A depicts a first embodiment of a head-mounted acoustic sensor system wearable device. FIG. 22B is an illustration depicting the first embodiment of the head-mounted acoustic sensor system wearable device on a user.

FIG. 23A depicts a second embodiment of a head-mounted acoustic sensor system wearable device. FIG. 23B is an illustration depicting the second embodiment of the head-mounted acoustic sensor system wearable device on a user.

FIG. 24A depicts a third embodiment of a head-mounted acoustic sensor system wearable device. FIG. 24B is an illustration depicting the third embodiment of the head-mounted acoustic sensor system wearable device on a user.

FIG. 25 is a block flow diagram depicting a method to reconstruct facial expressions based on acoustic signals.

FIG. 26 is a diagram depicting an acoustic sensor system based facial expression reconstruction process.

FIG. 27 is a diagram depicting an acoustic sensor system based facial expression reconstruction output process.

FIG. 28 is a diagram depicting the correlation between frontal view camera images, predicted facial expressions, and left and right differential echo profiles.

FIG. 29 is a diagram depicting the correlation between frontal view camera images, training data, predicted facial expressions, and left and right differential echo profiles.

FIG. 30A is a diagram depicting the correlation between frontal view camera images of an open mouth, a left view image, a left and right echo profile, and a right view image. FIG. 30B is a diagram depicting the correlation between frontal view camera images of a right sneer, a left view image, a left and right echo profile, and a right view image.

FIG. 31 is a block diagram depicting a computing machine and a module.

FIG. 32 illustrates an example wearable device configured for acoustic-based eye tracking in an illustrative embodiment.

FIG. 33 illustrates example signal processing operations for acoustic-based eye tracking in an illustrative embodiment.

FIG. 34 shows aspects of additional illustrative embodiments of wearable devices configured for acoustic-based eye tracking.

FIG. 35 is a plot comparing eye tracking performance of an example wearable device in an illustrative embodiment with that of a conventional eye tracking system, across multiple study participants.

FIG. 36 illustrates an example wearable device configured for acoustic-based silent speech recognition in an illustrative embodiment.

FIG. 37 shows additional examples of wearable devices configured for acoustic-based silent speech recognition in illustrative embodiments.

FIG. 38 shows aspects of additional illustrative embodiments of wearable devices configured for acoustic-based silent speech recognition.

FIG. 39 shows plots of silent speech recognition performance in illustrative embodiments, across multiple study participants.

FIG. 40 shows plots of silent speech recognition performance in illustrative embodiments, for different signal paths and sensor configurations.

FIG. 41 is a block diagram of an information processing system comprising an acoustic interface system that includes a processing platform configured to implement machine learning based acoustic signal processing in an illustrative embodiment.

FIG. 42 shows an information processing system comprising one or more wearable devices configured for acoustic sensing of user activities and/or other characteristics in an illustrative embodiment.

FIG. 43 shows example acoustic signal processing operations in an illustrative embodiment.

FIGS. 44 and 45 show respective examples of machine learning systems utilized in acoustic sensing of user activities and/or other characteristics in illustrative embodiments.

FIG. 46 shows example sequences of video frames, echo frames and echo profiles in an illustrative embodiment.

FIG. 47 shows an example wearable device configured for acoustic-based activity tracking in an illustrative embodiment.

FIG. 48 shows an example wearable device configured for acoustic-based upper body pose detection in an illustrative embodiment.

FIG. 49 shows examples of upper body poses that are detectable by the example wearable device of FIG. 48 in an illustrative embodiment.

FIG. 50 shows an example of a machine learning system utilized in acoustic-based upper body pose detection in an illustrative embodiment.

FIG. 51 shows an example wearable device configured for acoustic-based facial expression tracking in an illustrative embodiment.

FIG. 52 shows additional details of different aspects of the example wearable device of FIG. 51 in an illustrative embodiment.

FIG. 53 shows the operation of acoustics signal processing and machine learning for the example wearable device of FIG. 51 in an illustrative embodiment.

FIG. 54 shows an example wearable device configured for acoustic-based hand pose tracking and hand-object interaction recognition in an illustrative embodiment.

FIG. 55 shows example hand joints and associated vectors utilized in hand pose tracking in the example wearable device of FIG. 54 in an illustrative embodiment.

FIG. 56 shows example hand gestures that are detectable using the example wearable device of FIG. 54 in an illustrative embodiment.

FIG. 57 shows an example of a machine learning system utilized in acoustic-based hand pose tracking and hand-object interaction recognition in an illustrative embodiment.

FIG. 58 shows an example wearable device configured for acoustic-based silent speech recognition in an illustrative embodiment.

FIG. 59 shows the operation of an example wearable device configured for acoustic-based hand pose tracking in an illustrative embodiment.

FIG. 60 shows hardware configurations of the example wearable device of FIG. 59 in an illustrative embodiment.

FIG. 61 shows example acoustic signal processing operations for the example wearable device of FIG. 59 in an illustrative embodiment.

FIG. 62 shows an example of a machine learning system for acoustic-based hand pose tracking using the example wearable device of FIG. 59 in an illustrative embodiment.

### DETAILED DESCRIPTION

The present technology in some embodiments allows reconstruction of facial expressions and tracking of facial movements using non-obtrusive, wearable devices that capture optical or acoustical images of facial contours, chin profiles, or skin deformation of a user's face. The wearable devices include head-mounted technology that continuously reconstruct full facial expressions by capturing the positions and shapes of the mouth, eyes, and eyebrows. Miniature cameras capture contours of the sides of the face, which are used to train a deep-learning model to predict facial expressions. An alternate embodiment of this technology includes a neck-mounted technology to continuously reconstruct facial expressions. Infrared cameras capture chin and face shapes underneath the neck, which are used to train a deep-learning model to predict facial expressions.

Additional embodiments include various camera types or acoustic imaging systems for the wearable devices. The acoustic imaging systems may comprise microphones and speakers. For example, the wearable devices may use the microphones and speakers to transmit and receive acoustical signals to determine skin deformation of a user. Full facial movements and expressions can be reconstructed from subtle skin deformations. The wearable devices may comprise ear mounted devices, eye mounted devices, or neck mounted devices.

The systems of this technology include wearable devices configured with miniature cameras or acoustical imaging systems in communication with computing devices to transmit images or acoustical signals from the cameras or acoustical imaging systems to a remote server, data acquisition system, or data processing device for facial expression reconstruction or to track facial movement. The wearable devices include headphone, earbud, necklace, neckband, glasses, virtual reality (“VR”) headsets, augmented reality (“AR”) headsets, and other form factors. Each of the form factors include miniature cameras or acoustical imaging systems and micro computing devices, such as Raspberry Pi™.

The exemplary headphone device includes two cameras and may include functionality with Bluetooth or Wi-Fi connectivity and speakers embedded within the earpieces of the headphone. The cameras are attached to the earpieces of the headphone device and are connected to a computing device to transmit acquired images to a remote server. The headphone device is configured to acquire images of the contours of a user's face by directing the cameras at adjustable angles and positions.

The exemplary earbud devices are constructed for wearing as a left-side earbud and a right-side earbud. Both the left and right earbud devices include a camera to acquire images of the contours of a user's face. Each camera is connected to a computing device to transmit acquired images to a remote server.

The exemplary necklace device includes an infrared (“IR”) camera with an IR LED and an IR bandpass filter. The necklace device is configured to acquire images of a user's chin profile by directing the camera at the profile of a user's chin. The IR LED projects IR light onto a user's chin to enhance the quality of the image captured by the camera. The IR bandpass filter filters visible light such that the camera captures infrared light reflected by a user's skin. The camera is connected to a computing device to transmit acquired images to a remote server.

The exemplary neckband device includes two cameras fashioned to be positioned on the left and right sides of a user's neck. The neckband device includes IR LEDs and IR bandpass filters configured in proximity to each camera, similar to the necklace device. Each camera is connected to a computing device to transmit acquired images to a remote server.

Using one of the wearable devices, facial expressions can be reconstructed from images acquired from the cameras within the devices. A data training set is created using frontal view images of a user in a machine learning algorithm. Multiple frontal view images of a user are acquired with a variety of facial expressions. The frontal view images are transmitted to a data processing system to create the data training set.

The wearable device captures one or more facial digital image(s) and transmits the digital images to data acquisition computing devices connected to each of the cameras of the wearable device. The data acquisition computing devices subsequently transmit the images to a remote server or data processing system. The data processing system reconstructs facial expressions using the images. The data processing system pre-processes the images by reducing the image size, removing noise from the image, extracting skin color from the background of the image, and binarizing each the image. In some embodiments, a wearable imaging system comprises one or more imaging sensor(s), wherein the one or more imaging sensor(s) are positioned to capture one or more image(s) with incomplete side contours of a face (for example, from ear(s) and/or from neck), a processor, and a non-transitory machine-readable storage medium comprising machine-readable instructions executed by the processor to extract a plurality of features (for example, landmarks or parameters) from the one or more image(s), compare the extracted features and/or changes of the extracted features with features from a ground truth, and output one or more recognition or prediction result(s), wherein the results comprise a word or a phrase spoken by a user, an emoji of a facial expression of a user, and/or a real-time avatar of a facial expression of a user.

The data processing system applies a deep-learning model to the pre-processed images for facial expression reconstruction. The reconstructed facial expressions may be used in applications such as silent speech and emoji recognition.

In an alternate embodiment, acoustic sensing technology can be used to reconstruct facial expressions using an array of microphones and speakers and deep-learning models. Acoustic sensing technology is small, lightweight and, therefore, suitable to mount to a variety of wearable devices. Facial movements may be tracked by detecting skin deformations observed from different positions on a user's head. When a user performs facial movements, the skin on the face deforms with unique patterns. Using acoustic sensing technology, skin deformations may be captured without capturing images of the entire face. The acoustic technology comprises a wearable device such as headphones, earbuds, necklaces, neckbands, and any other suitable form factors such that the microphones and speakers can be mounted or attached to the wearable device. The positions of the microphones and speakers may be adjustable to optimize the recording of reflected signals.

The acoustic wearable device actively sends signals from the speakers towards a user's face. The signals are reflected by the user's face and captured by the microphones on the acoustic wearable device. The signals are reflected differently back towards the microphones based on different facial expressions or movements. The acoustic wearable device sends the transmitted and reflected signals to a computing device for further processing. An echo profile is calculated based on the transmitted and reflected acoustic signals. The echo profile is calculated by calculating a cross-correlation between the received acoustic signals and the transmitted acoustic signals, which can display the deformations of the skin in temporal and spatial domains. The echo profile is input into a deep learning module to reconstruct the facial expressions of the user.

While acoustic sensing technology may be used to determine facial expressions by detecting skin deformations, acoustic sensing technology may also be used to directly determine other outputs associated with skin deformation without the need to first determine facial expressions. For example, the acoustic sensing technology may track blinking patterns and eyeball movements of a user. Blinking patterns and eyeball movements can be applied to the diagnosis and treatment processes of eye diseases. The acoustic sensing technology may detect movements of various parts of the face associated with speech, whether silent or voiced. While speaking, different words and/or phrases lead to subtle, yet distinct, skin deformations. The acoustic sensing technology can capture the skin deformation to recognize silent speech or to vocalize sound. The acoustic sensing technology may also be used to recognize and track physical activities. For example, while eating, a user opens the mouth, chews, and swallows. During each of those movements, the user's skin deforms in a certain way such that opening the mouth is distinguishable from chewing and from swallowing. The detected skin deformations may be used to determine the type and quantity of food consumed by a user. Similar to eating, a type and quantity of a consumed drink may be determined by skin deformation. The acoustic sensing technology may also be used to determine an emotional status of a user. An emotional status may be related to skin deformations. By detecting skin deformations, an emotional status can be determined and reported to corresponding applications.

These and other aspects, objects, features, and advantages of the disclosed technology will become apparent to those having ordinary skill in the art upon consideration of the following detailed description of illustrated examples.

### Example System Architecture

Turning now to the drawings, in which like numerals indicate like (but not necessarily identical) elements throughout the figures, examples of the technology are described in detail.

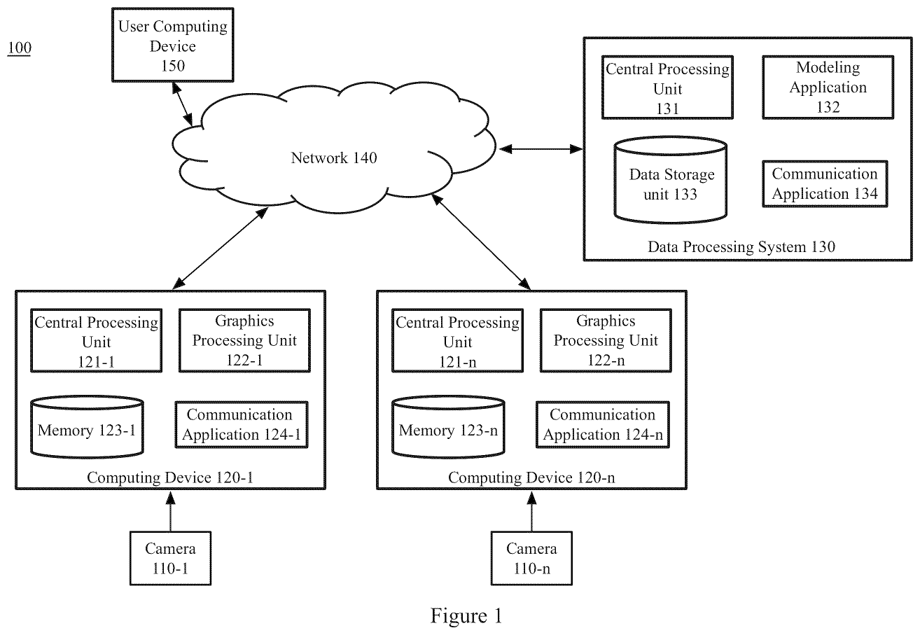

FIG. 1 is a block diagram depicting a facial expression reconstruction system 100, in accordance with certain examples. As depicted in FIG. 1, the facial expression reconstruction system 100 comprises cameras 110-1 through 110-n, computing devices 120-1 through 120-n, data processing system 130, and user computing device 150. Computing devices 120, data processing system 130, and user computing device 150 are configured to communicate via a network 140.

In example embodiments, network 140 includes one or more wired or wireless telecommunications system(s) by which network devices may exchange data. For example, the network 140 may include one or more of a local area network (LAN), a wide area network (WAN), an intranet, an Internet, a storage area network (SAN), a personal area network (PAN), a metropolitan area network (MAN), a wireless local area network (WLAN), a virtual private network (VPN), a cellular or other mobile communication network, a BLUETOOTH® wireless technology connection, a near field communication (NFC) connection, any combination thereof, and any other appropriate architecture or system that facilitates the communication of signals, data, and/or messages.

Facial expression reconstruction system 100 comprises cameras 110 that may be any suitable sensors for capturing images. For example, cameras 110 may include depth cameras, red-green-blue (“RGB”) cameras, infrared (“IR”) sensors, acoustic cameras or sensors, speakers, microphones, thermal imaging sensors, charge-coupled devices (“CCDs”), complementary metal oxide semiconductor (“CMOS”) devices, active-pixel sensors, radar imaging sensors, fiber optics, and any other suitable image device technology.

The image frame resolution of the camera 110 may be defined by the number of pixels in a frame. The image frame resolution of the camera 110 may comprise any suitable resolution, including of the following resolutions, without limitation: 32×24 pixels; 32×48 pixels; 48×64 pixels; 160×120 pixels, 249×250 pixels, 250×250 pixels, 320×240 pixels, 420×352 pixels, 480×320 pixels, 640×480 pixels, 720×480 pixels, 1280×720 pixels, 1440×1080 pixels, 1920×1080 pixels, 2048×1080 pixels, 3840×2160 pixels, 4096×2160 pixels, 7680×4320 pixels, or 15360×8640 pixels. The image frame resolution of the camera 110 may comprise a resolution within a range defined by any two of the preceding pixel resolutions, for example, within a range from 32×24 pixels to 250×250 pixels (for example, 249×250 pixels). In some embodiments, at least one dimension (the height and/or the width) of the image frame resolution of the camera 110 can be any of the following, including but not limited to 8 pixels, 16 pixels, 24 pixels, 32 pixels, 48 pixels, 72 pixels, 96 pixels, 108 pixels, 128 pixels, 256 pixels, 360 pixels, 480 pixels, 720 pixels, 1080 pixels, 1280 pixels, 1536 pixels, or 2048 pixels. The camera 110 may have a pixel size smaller than 1 micron, 2 microns, 3 microns, 5 microns, 10 microns, 20 microns, and the like. The camera 110 may have a footprint (for example, a dimension in a plane parallel to a lens) on the order of 10 mm×10 mm, 8 mm×8 mm, 5 mm×5 mm, 4 mm×4 mm, 2 mm×2 mm, or 1 mm×1 mm, 0.8 mm×0.8 mm, or smaller.

Each camera 110 is in communication with a computing device 120. Each camera 110 is configured to transmit images or data to a computing device 120. Each camera 110 may be communicatively coupled to a computing device 120. In an alternate example, each camera 110 may communicate wirelessly with a computing device 120, such as via near field communication (“NFC”) or other wireless communication technology, such as Bluetooth, Wi-Fi, infrared, or any other suitable technology.

Computing devices 120 comprise a central processing unit 121, a graphics processing unit 122, a memory 123, and a communication application 124. In an example, computing devices 120 may be small, single-board computing devices, such as a Raspberry Pi™ device. Computing devices 120 function to receive images or data from cameras 110 and to transmit the images via network 140 to a data processing system 130.

Computing device 120 comprises a central processing unit 121 configured to execute code or instructions to perform the operations and functionality described herein, manage request flow and address mappings, and perform calculations and generate commands. Central processing unit 121 may be configured to monitor and control the operation of the components in the computing device 120. Central processing unit 121 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. Central processing unit 121 may be a single processing unit, multiple processing units, a single processing core, multiple processing cores, special purpose processing cores, co-processors, or any combination thereof. Central processing unit 121 along with other components of the computing device 120 may be a virtualized computing machine executing within one or more other computing machine(s).

Computing device 120 comprises a graphics processing unit 122 that serves to accelerate rendering of graphics and images in two- and three-dimensional spaces. Graphics processing unit 122 can process multiple images, or data, simultaneously for use in machine learning and high-performance computing.

Computing device 120 comprises a memory 123. Memory 123 may include non-volatile memories, such as read-only memory (“ROM”), programmable read-only memory (“PROM”), erasable programmable read-only memory (“EPROM”), flash memory, or any other device capable of storing program instructions or data with or without applied power. Memory 123 may also include volatile memories, such as random access memory (“RAM”), static random access memory (“SRAM”), dynamic random access memory (“DRAM”), and synchronous dynamic random access memory (“SDRAM”). Other types of RAM also may be used to implement memory 123. Memory 123 may be implemented using a single memory module or multiple memory modules. While memory 123 is depicted as being part of the computing device 120, memory 123 may be separate from the computing device 120 without departing from the scope of the subject technology.

Computing device 120 comprises a communication application 124. Communication application 124 interacts with web servers or other computing devices or systems connected via network 140, including data processing system 130.

Facial expression reconstruction system 100 comprises a data processing system 130. Data processing system 130 serves to receive images or data from cameras 110 via computing devices 120 and network 140. Data processing system 130 comprises a central processing unit 131, a modeling application 132, a data storage unit 133, and a communication application 134.

Data processing system 130 comprises central processing unit 131 configured to execute code or instructions to perform the operations and functionality described herein, manage request flow and address mappings, and perform calculations and generate commands. Central processing unit 131 may be configured to monitor and control the operation of the components in the data processing system 130. Central processing unit 131 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. Central processing unit 131 may be a single processing unit, multiple processing units, a single processing core, multiple processing cores, special purpose processing cores, co-processors, or any combination thereof. Central processing unit 131 along with other components of the data processing system 130 may be a virtualized computing machine executing within one or more other computing machine(s).

Data processing system 130 comprises a modeling application 132. The modeling application 132 employs a variety of tools, applications, and devices for machine learning applications. The modeling application 132 may receive a continuous or periodic feed of images or data from one or more of the computing device(s) 120, the central processing unit 131, or the data storage unit 133. Collecting the data allows the modeling application 132 to leverage a rich dataset to use in the development of a training set of data or ground truth for further use in facial expression reconstructions. The modeling application 132 may use one or more machine learning algorithm(s) to develop facial expression reconstructions, such as a convolution neural network (“CNN”), Naïve Bayes Classifier, K Means Clustering, Support Vector Machine, Apriori, linear regression, logistic regression, decision trees, random forest, or any other suitable machine learning algorithm.

Data processing system 130 comprises a data storage unit 133. Data storage unit 133 may be accessible by the modeling application 132 and the communication application 134. The example data storage unit 133 can include one or more tangible computer-readable storage device(s). The data storage unit 133 can be within the data processing system 130 or can be logically coupled to the data processing system 130. For example, the data storage unit 133 can include on-board flash memory and/or one or more removable memory device(s) or removable flash memory. In certain embodiments, the data storage unit 133 may reside in a cloud-based computing system.

Data processing system 130 comprises a communication application 134. Communication application 134 interacts with web servers or other computing devices or systems connected via network 140, including the computing devices 120 and user computing device 150.

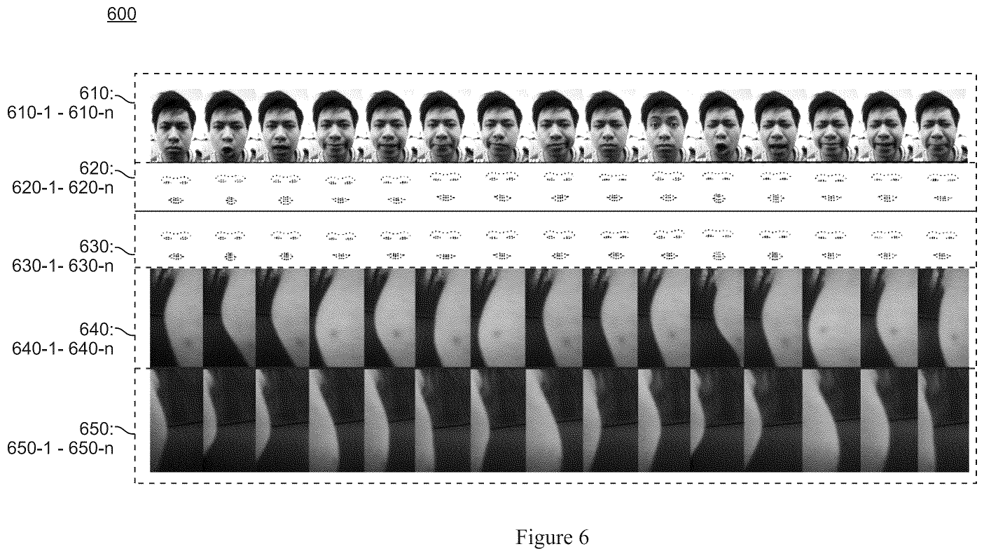

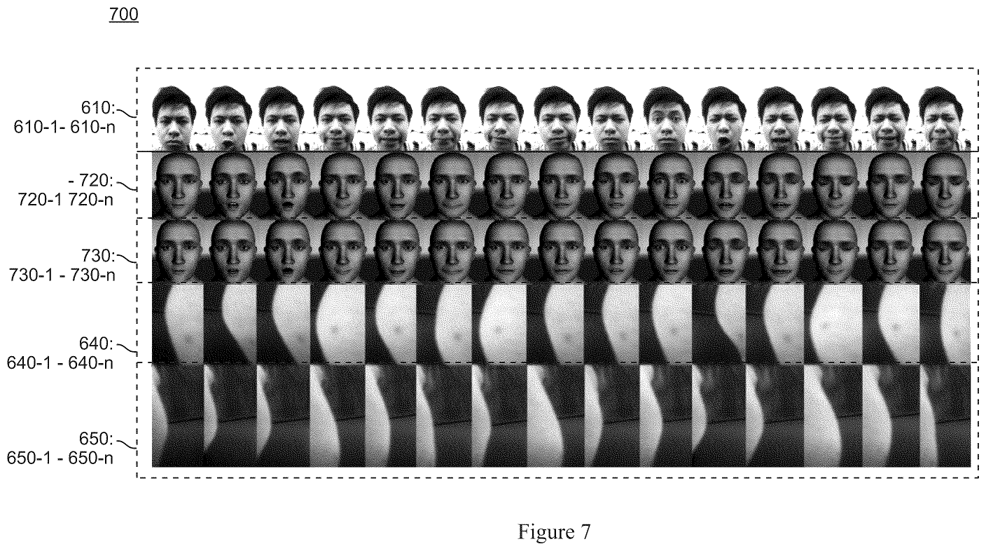

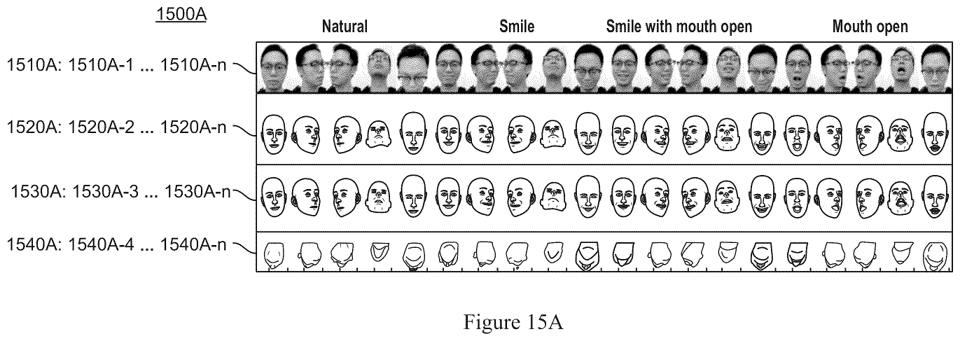

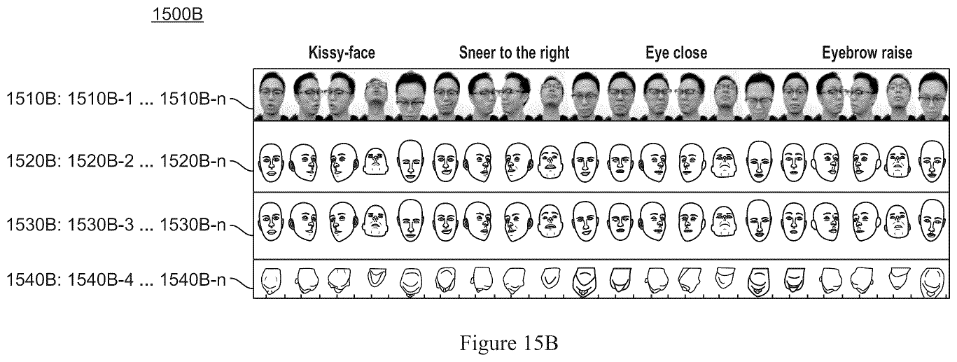

User computing device 150 is a computing device configured to receive and communicate results of facial expression reconstruction or facial movement. The results of the facial expression reconstruction may be displayed as a graphical representation of a facial expression, such as 630 of FIG. 6, a predicted facial expression with three-dimensional visualization, such as 730 of FIG. 7, a three-dimensional facial expression, such as 1530A of FIG. 15A, an emoji, text or audio representing silent speech recognition, or any other suitable display of facial expression reconstruction results. The user computing device 150 also may comprise a speaker to audibly communicate the facial expression reconstruction results directed to silent speech recognition. In an alternate embodiment by tracking facial movement, user computing device 150 may determine skin deformation or stretching and, subsequently, directly determine one or more of facial expression(s), eyeball movement, or eye-related disease. By tracking facial movement, user computing device 150 may recognize, or make audible, silent speech, and recognize and track human activities involving facial movements such as eating or drinking. By tracking facial movement, user computing device 150 may synthesize a user's voice or determine a user's emotional status.

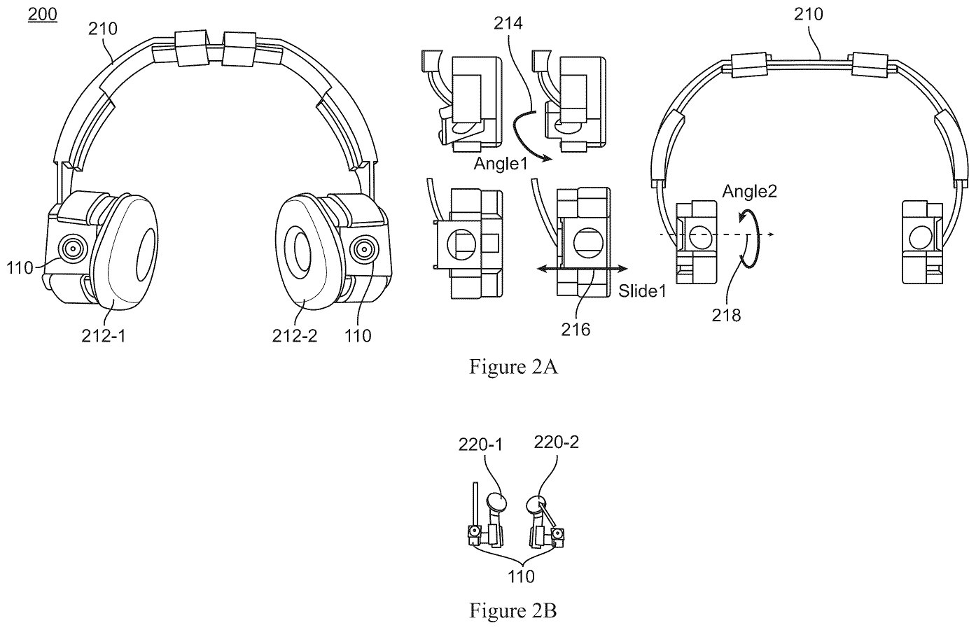

FIGS. 2A and 2B are perspective views 200 of head-mounted wearable devices 210, 220, respectively, for facial expression reconstruction, in accordance with certain examples.

FIG. 2A depicts a headphone-style wearable device 210 (herein referred to as headphone device 210 or headphone 210) as a form factor to acquire images or data for use in facial expression reconstruction, in accordance with certain examples. Headphone device 210 comprises two cameras 110-1 and 110-2 to acquire images of a left and a right contour, respectively. Cameras 110 were previously described herein with reference to FIG. 1. In an example, headphone device 210 is a device constructed of a band suitable to wear across the top of a user's head with a left-side earpiece 212-1 and a right-side earpiece 212-2. In an example, headphone device 210 may be over-the-ear headphones or outside-the-ear headphones. In an example, headphone device 210 may include functionality with Bluetooth or Wi-Fi connectivity and speakers embedded within the earpieces 212. Camera 110-1 is connected to left-side earpiece 212-1, and camera 110-2 is connected to right-side earpiece 212-2. In an alternate example, two cameras 110 are connected to each of the left-side earpiece 212-1 and right-side earpiece 212-2. Any suitable number of cameras may be connected to each of the earpieces 212. Each camera 110 is in communication with a computing device 120, as previously described with respect to FIG. 1. In an example, computing device 120 may be connected to each camera 110 and be embedded within the headphone device 210. In an alternate example, each camera 110 may communicate with a computing device 120 via a wireless technology, such as Bluetooth or Wi-Fi.

Headphone device 210 is configured to acquire images of a left and a right contour of a user's face by directing cameras 110-1 and 110-2 at adjustable angles and positions. Each of the cameras 110 are independently adjustable by a first angle 214, a slide 216, and second angle 218. First angle 214 adjusts a tilt of the position of the camera 110 relative to a plane parallel to an exterior surface of a user's ear. The first angle 214 may be adjusted so that the camera 110/earpiece 212 assembly is tilted closer to a user's ear, or the first angle 214 may be adjusted so that the camera 110 via the earpiece 212 is tilted farther away or offset from a user's ear. In an example, first angle 214 may be 0° indicating that the camera 110/earpiece 212 assembly is in a vertical position relative to a plane parallel to the exterior surface of a user's ear. First angle 214 may be adjusted by −10°, −20°, −30°, −40°, or any suitable angle measure relative to the plane parallel to the exterior surface of a user's ear, such that each camera 110 may be aligned with the left and right contours of a user's face.

Slide 216 adjusts a position of the camera 110 relative to the earpiece 212 in a direction that is perpendicular to a plane parallel to the exterior surface of a user's ear, in other words, the position of the camera 110 may change along the slide 216 while the position of the earpiece 212 is fixed. The position of the camera 110 via the slide 216 may be adjusted such that the earpiece 212 is in close contact with an exterior surface of a user's ear. The position of the camera 110 via the slide 216 may be adjusted such that the camera 110 is extended a distance away from the plane parallel to the exterior surface of a user's ear. In an example, the extended distance may be 1 cm, 2 cm, 3 cm, or any suitable distance away from the plane parallel to the exterior surface of a user's ear. The slide 216 positions the cameras 110 in a manner similar to positioning the earpieces 212 of the headphone device 210. In some embodiments, the position of an imaging sensor or a camera (for example, the optical center of the lens in the camera) is less than 5 cm, less than 4 cm, less than 3 cm, less than 2 cm, less than 1 cm, or less than 0.5 cm away from the surface plane of a user's ear. In some embodiments, the position of an imaging sensor or a camera projected to the closest skin surface is within the region of a user's ear or less than 5 cm, less than 4 cm, less than 3 cm, less than 2 cm, or less than 1 cm away from the nearest contour edge of a user's ear. In some embodiments, the system comprises at least one, at least two, or at least three imaging sensors (for example, cameras) located in different positions as described above. In some embodiments, an imaging sensor, such as a camera, is positioned below a chin of a user and less than 25 cm, less than 20 cm, less than 15 cm, less than 10 cm, or less than 5 cm away from the chin of a user, or 2-30 cm below and away from the chin of the user.

Second angle 218 adjusts a rotational position of the camera 110 along a horizontal axis through earpieces 212-1 and 212-2. In an example, second angle 218 adjusts an angular position of the camera 110 relative to the horizontal axis while the position of the earpiece 212 remains unchanged. In an alternate example, second angle 218 adjusts an angular position of the camera 110/earpiece 212 assembly. Relative to a left or right contour of a user's face, second angle 218 may be 0° indicating that the camera 110 is in a horizontal position. A second angle 218 of 10° indicates that the camera 110 is directed 10° upwards. A second angle 218 of −10° indicates that the camera 110 is directed 100 downwards. Any suitable measure of second angle 218 may be used to align the cameras 110 with the contour of a user's face.

Each of the cameras 110 are independently adjustable by the first angle 214 and the second angle 218, by any suitable mechanism, for example, by mounting the cameras 110 to the headphone device 210 via rotational positioning devices allowing incremental changes of the direction of the cameras 110.

FIG. 2B depicts earbud-style wearable devices 220-1 and 220-2 (herein referred to as earbud devices 220 or earbuds 220) as a form factor to acquire images or data for use in facial expression reconstruction, in accordance with certain examples. Earbud device 220-1 is constructed for wear as a left-side earbud, and earbud device 220-2 is constructed for wear as a right-side earbud. In an example, earbud device 220 may be ear pods, earphones, or in-the-ear (“ITE”) headphones. Earbud device 220-1 comprises a camera 110-1, and earbud device 220-2 comprises a camera 110-2 to acquire images of a left and a right contour, respectively, of a user's face by directing cameras 110-1 and 110-2 at the left and right contours of a user's face. Cameras 110-1 and 110-2 were previously described in reference to FIG. 1. In an example, earbud devices 220 may include functionality with Bluetooth or Wi-Fi connectivity and speakers embedded within the earbuds 220. Each camera 110 is in communication with a computing device 120, as previously described with respect to FIG. 1. In an example, a computing device 120 may be connected to each camera 110 and be embedded within each earbud device 220. In an alternate example, each camera 110 may communicate with a computing device 120 via a wireless technology, such as Bluetooth or Wi-Fi.

The camera 110 position for each earbud device 220 may be controlled by twisting and/or rotating the earbud device 220 in the user's ear. The earbud device 220 may be rotated such that the camera 110 is angled closer to the contour of a user's face. In an alternate example, the camera 110 may be attached to the earbud device 220 such that the camera 110 may be positioned independently of the earbud device 220. The camera 110 may be attached to the earbud device 220 with a ball and socket joint or any other suitable attachment method such that the position of the camera 110 may be adjusted independently of the earbud device 220.

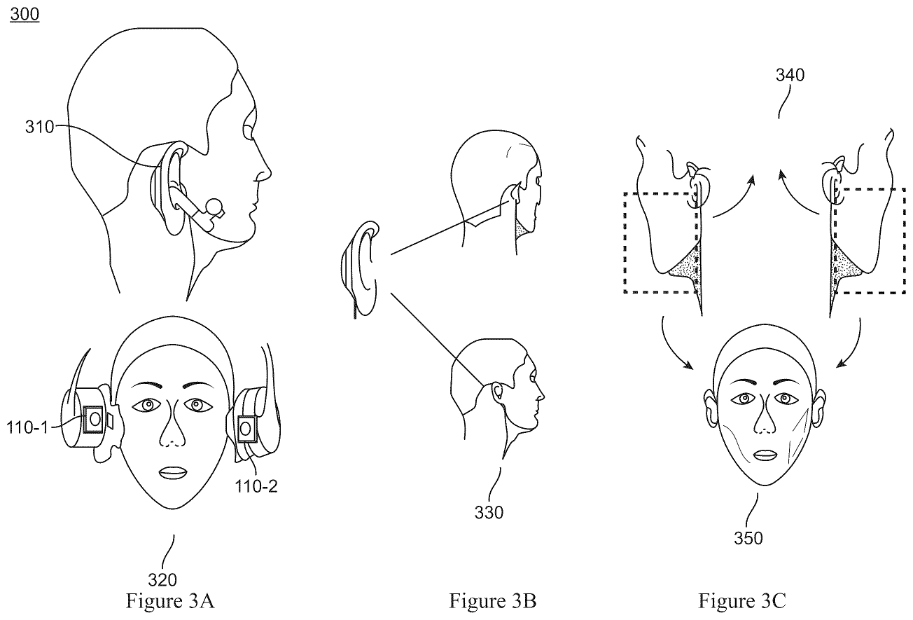

FIGS. 3A, 3B, and 3C are illustrations 300 depicting examples 310-350 of head-mounted, wearable devices 210, 220 on a user, camera views 330, captured facial contours 340, and corresponding facial expressions 350, in accordance with certain examples. In FIG. 3A, earbuds 220 are illustrated in a closeup view of the back of a user's ear. Camera 110 of the earbuds 220 is illustrated in this example as being positioned in a forward direction towards a right contour of a user's face. Although not depicted in FIG. 3A, a second earbud 220 is worn by the user in the opposite, left ear, having a camera 110 positioned in a forward direction towards a left contour of the user's face.

Also, in FIG. 3A, alternative headphone 210 is illustrated in a closeup view from a front perspective of the user. Cameras 110-1 and 110-2 of the headphone 210 are illustrated in this example as being positioned in a forward direction towards left and right contours of a user's face.

FIG. 3B depicts a back and side view of a user to illustrate the contour of the user's face from the point of view of a camera 110 in either the earbud device 220 or headphone device 210 depicted in FIG. 3A.

FIG. 3C depicts the left and right contours of a user's face as captured by cameras 110 through the use of the headphone 210 or the earbuds 220. FIG. 3B also depicts the facial expression of a user a reconstructed through the images captured by cameras 110 through the use of the headphone 210 or the earbuds 220.

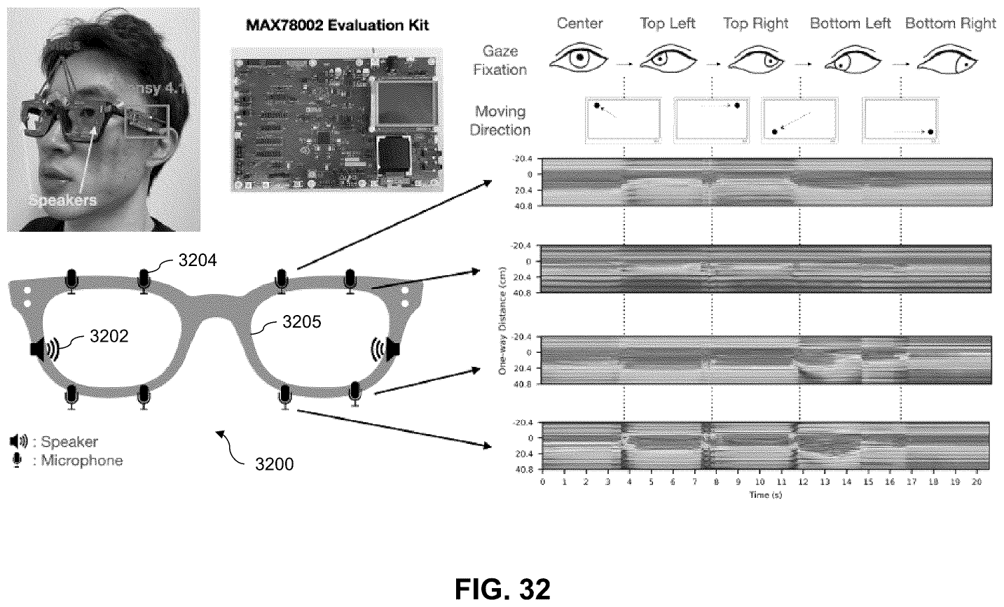

The computing devices 120, data processing system 130, and user computing device 150 and any other network computing devices other computing machines associated with the technology presented herein may be any type of computing machine, such as, but not limited to, those discussed in more detail with respect to FIG. 31. For example, each device can include any suitable processor-driven device.

Furthermore, any functions, applications, or components associated with any of these computing machines, such as those described herein or others (for example, scripts, web content, software, firmware, hardware, or modules) associated with the technology presented herein may be any of the components discussed in more detail with respect to FIG. 31.

The network connections illustrated are examples and other means of establishing a communications link between the computers and devices can be used. The computing machines discussed herein may communicate with one another, as well as with other computing machines or communication systems over one or more network(s). Each network may include various types of data or communications networks, including any of the network technology discussed with respect to FIG. 31.

Additionally, those having ordinary skill in the art having the benefit of the present disclosure will appreciate that the devices illustrated in the figures may have any of several other suitable computer system configurations.

### Example Processes

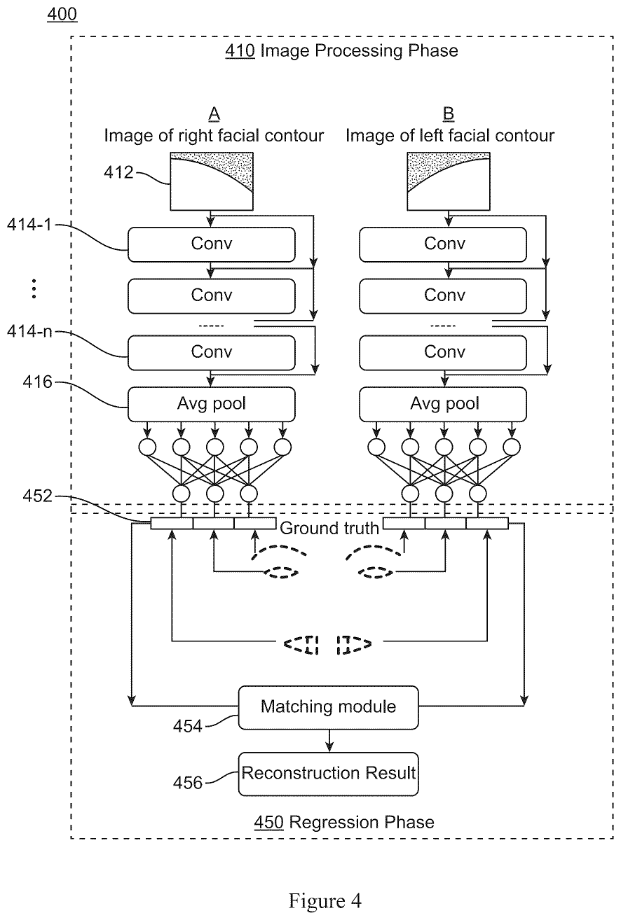

The methods illustrated in FIGS. 4 through 11 are described hereinafter with respect to the components of facial expression reconstruction system 100, headphone device 210 of FIG. 2A, and earbud devices 220 of FIG. 2B. The methods of FIGS. 4 through 11 may also be performed with other systems and in other environments. The operations described with respect to FIGS. 4 through 11 can be implemented as executable code stored on a computer- or machine-readable, non-transitory, tangible storage medium (for example, floppy disk, hard disk, ROM, EEPROM, nonvolatile RAM, CD-ROM, etc.) that are completed based on execution of the code by a processor circuit implemented using one or more integrated circuit(s); the operations described herein also can be implemented as executable logic that is encoded in one or more non-transitory, tangible media for execution (for example, programmable logic arrays or devices, field programmable gate arrays, programmable array logic, application specific integrated circuits, etc.).

FIG. 4 is a block diagram depicting a deep-learning model process 400, in accordance with certain examples. The deep-learning model process 400 may be performed by the modeling application 132 of the data processing system 130, previously described herein in reference to FIG. 1. In an example where the machine learning algorithm is a convolution neural network (“CNN”), the deep-learning model process 400 receives images as an input and assigns importance (learnable weights and biases) to various aspects/objects in the images. The CNN reduces the images into a form that is easier to process without losing the features of the images that are used to get a good prediction. In the current example, the prediction is a reconstructed facial expression based on the received right and left contour facial images.

The deep-learning model process 400 comprises an image processing phase 410 and a regression phase 450. In the image processing phase 410, image processing is divided into two parallel paths. Path A is directed to processing an image of a right facial contour, and path B is directed to processing an image of a left facial contour. The right facial contour images and left facial contour images are processed independently of each other and combined in a matching module 454 of the deep-learning model process 400.

In block 412, the data processing system 130 receives an input of an image of a right facial contour and an input of an image of a left facial contour. Example right facial contour images are depicted in row 640 of FIGS. 6 and 7, and example left facial contour images are depicted in row 650 of FIGS. 6 and 7. The images are transmitted through blocks 414-1 through 414-n. Blocks 414-1 through 414-n comprise layers of the CNN that include multiple convolution filtering operations. In an example, the CNN may comprise between 32 and 512 layers to extract features from the images. The first convolution layer in block 414-1 captures low-level features, such as edges, color, and gradient orientation. As the process progresses through the additional layers to layer 414-n, higher-level features are captured such that the object of the image is captured. In the current example, the object of the image is a facial contour.

From block 414-n, the process proceeds to block 416. Block 416 is a pooling layer. The pooling layer may be a Max Pooling that returns a maximum value from the image. The pooling layer may be an Average Pooling that returns an average of all of the values from the image. The pooling layer of block 416 outputs a vector representation of each input image (in other words, a right image vector for the right facial contour and a left image vector for the left facial contour).

The right image vector and the left image vector are received as inputs to the regression phase 450. Within the regression phase 450, the right image vector and the left image vector are inputs into two fully connected layers 452 with a rectified linear unit (“ReLU”) between the fully connected layer 452. The fully connected layer 452 learns facial landmarks of the right image vector and the left image vector based on facial landmarks in a training data set, or ground truth, set of facial expressions. The fully connected layer 452 compares features of the right image vector to right side facial landmarks in the training data set of facial expressions to match the features of the right image vector to a right side facial expression in the training data set. Similarly, the fully connected layer 452 compares features of the left image vector to left side facial landmarks in the training data set of facial expressions to match the features of the left image vector to a left side facial expression in the training data set. The fully connected layer 452 outputs landmarks of both the right and left side of a user's face. The output landmarks are inputs to the matching module 454. The matching module 454 concatenates the landmarks from the right and left sides by aligning key landmarks that are present in both the right and left sides using translation and scaling. The matching module 454 outputs the final facial expression reconstruction, or predicted facial expression, as a set of facial landmarks as the reconstruction result in block 456. Examples of predicted facial expressions as a set of facial landmarks are depicted in row 630 of FIG. 6. In an alternate example, the facial expression reconstruction is further modeled to create a three-dimensional visualization of the predicted facial expression as depicted in row 730 of FIG. 7. The deep-learning model process 400 continues to repeat as additional right facial contour images and left facial contour images are received.

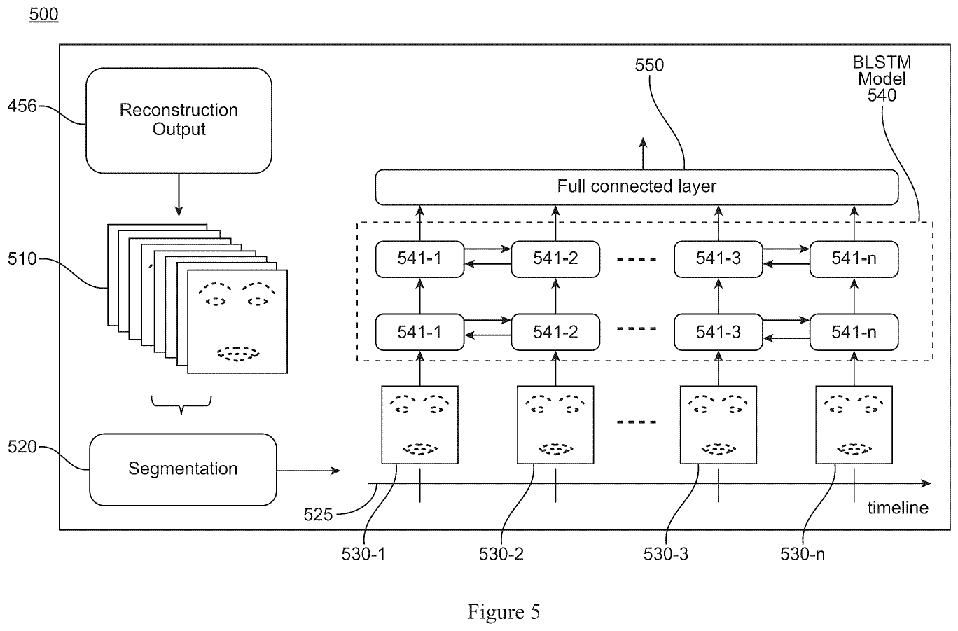

FIG. 5 is a block diagram depicting a classifier process 500, in accordance with certain examples. The classifier process 500 classifies the facial expression reconstruction output 456 of the deep-learning model process 400 for use in applications such as silent speech recognition, emoji input, real-time avatar facial expressions, or other suitable applications. In block 510, the reconstruction output 456 from the deep-learning model process 400 of FIG. 4 is received as input to the classifier process 500. In block 510, a stream of landmark positions from the reconstruction output 456 are received as frames. In block 520, the landmark positions are segmented.

Segmentation extracts an event from a stream of data and labels its start and end time. In the example of silent speech recognition, segmentation would identify the initial facial expression associated with the pronunciation of a word and the final facial expression associated with the pronunciation of the same word. For each frame, two indicators are calculated to measure the degree of transformation for the mouth and eyes, known as the Mouth Transformation Degree (“MTD”) and Eye Transformation Degree (“ETD”). The MTD and ETD are calculated by summing the differences between the landmarks outlining the mouth or eye/eyebrow at the time and the landmarks of the natural facial expression. Then, a lowpass filter is applied to filter out high-frequency noise. When an event happens, the MTD or ETD raises to a single peak or a primary peak with several secondary peaks. A peaking seeking algorithm is applied to find the peaks in the stream. Thresholds are set for peak height, peak prominence, and peak width to filter peaks that may be associated with noise. After finding peak positions, the first-order difference of the ETD and MTD are calculated. In the first-order difference sequence, the left nearest peak to the event is labeled as the beginning, and the right nearest valley to the event is labeled as the end. The frames associated with the event are placed sequentially on a timeline 525 as frames 530-1 through frames 530-n.

After the sequential placement of frames 530-1 through 530-n, the process 500 proceeds to block 540 where the frames are inputs into a Bidirectional Long Short-Term Memory (“BLS™”) model for classification. Block 540 depicts a two-layer BLS™ model. However, any suitable number of layers may be used. The blocks 541-1 through 541-n depicted within the BLS™ model 540 are recurrently connected memory blocks. Each of the blocks 541 have feedback connections such that sequences of data can be processed as opposed to single images or data points. As depicted in block 540, blocks 541-1 through 541-n comprise bidirectional connections within each of the blocks 541 in each layer of block 540. Processing sequences of data allows for speech recognition, emoji recognition, real-time avatar facial expressions, or other suitable applications. The output from block 540 is a vector representation of the input frames.

In block 550, the vector representation is received by a fully connected layer comprising a SoftMax function. The SoftMax function transforms the vector representation into a probability distribution to predict a facial event. The output from block 550 is an encoding of a facial event class. The facial event classification may be a facial expression. In the example of silent speech recognition, the facial event classification may be the pronunciation of a specific word or phrase, such as “hello” or “how are you.” In the example of emoji recognition, the facial event classification may be an emoji indicating a smiling face, a frowning face, a crying face, or any other suitable emoji associated with a facial expression. In the example of real-time avatar facial expressions, the facial event classification may be a three-dimensional visualization of a facial expression.

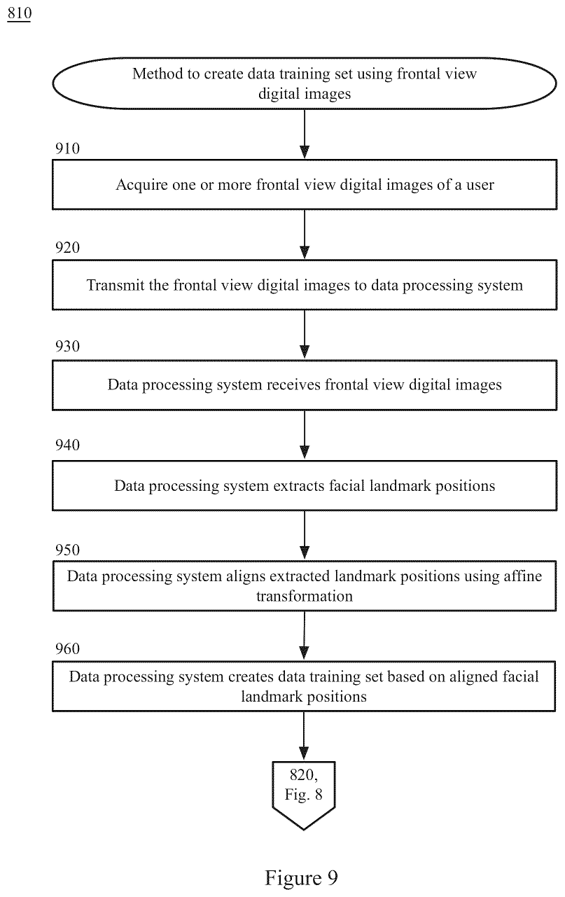

FIG. 6 is a diagram 600 depicting the correlation between frontal view camera images 610, landmark training data images 620, predicted facial expressions 630, and captured right and left facial contour images 640, 650, also referred to herein as respective rows 610-650, in accordance with certain examples. Row 610 illustrates frontal view camera images of a user. To construct a training data set or “ground truth,” frontal view camera images of a user are acquired, via an imaging capturing device, with the user making various different facial expressions as depicted in images 610-1 through 610-n. The method to create the training data set from the frontal view camera images is described herein in greater detail with reference to method 810 of FIG. 9. Row 620 illustrates a training data set in the form of facial landmarks. The landmark training data images depicted in images 620-1 through 620-n correlate with images 610-1 through 610-n. The landmark training data images 620 are the output of method 810 of FIG. 9.

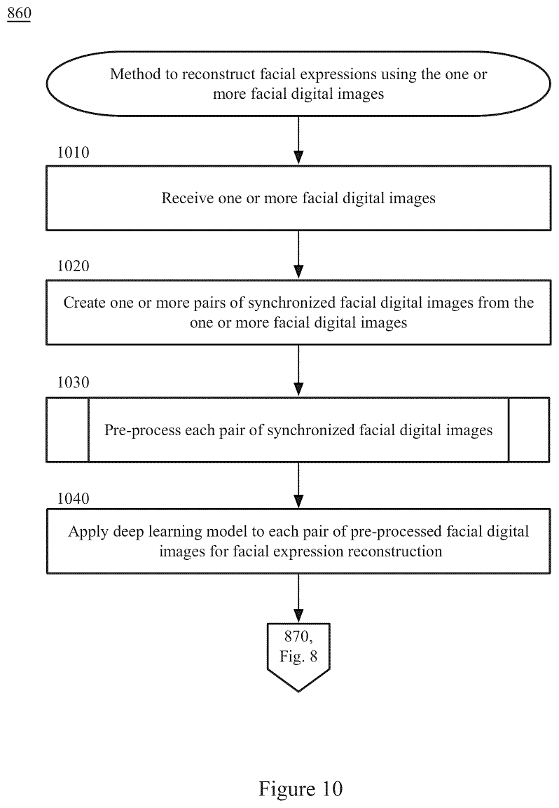

Row 640 depicts right facial contour images 640-1 through 640-n captured by a head-mounted, wearable device, such as headphone device 210 or earbud device 220 described herein with reference to FIG. 2. Row 650 depicts left facial contour images 650-1 through 650-n captured by a head-mounted, wearable device, such as headphone device 210 or earbud device 220 described herein with reference to FIG. 2. The right and left facial contour images 640, 650 are synchronized such that the images are representing the same facial expression. The synchronization of the images is described in greater detail herein with reference to block 1020 of FIG. 10. The synchronized images are used as inputs to the deep-learning model process 400, previously described herein with reference to FIG. 4.

The right facial contour images 640, the left facial contour images 650, and the landmark training data images 620 are used in the deep-learning model process 400 to construct the predicted facial expressions in row 630. The predicted facial expressions 630 are depicted as landmark images in images 630-1 through 630-n. The predicted facial expressions 630 are illustrated in FIG. 6 beneath the landmark training data images 620 to illustrate the accuracy of predicting facial expressions using right facial contour images 640 and left facial contour images 650 acquired from headphone device 210 or earbud device 220.

FIG. 7 is a diagram 700 depicting the correlation between frontal view camera images 610, training data with three-dimensional visualization 720, predicted facial expressions with three-dimensional visualization 730, also referred to herein as respective rows 720 and 730, and right and left facial contour images 640, 650, in accordance with certain examples. FIG. 7 is an alternate embodiment of FIG. 6, wherein training data images with three-dimensional visualization are depicted in row 720 and predicted facial expressions with three-dimensional visualization are depicted in row 730. The training data images 720-1 through 720-n are correlated with predicted facial expression images 730-1 through 730-n. The three-dimensional visualizations depicted in rows 720 and 730 are created using the facial landmarks described in rows 620 and 630 in reference to FIG. 6. The facial landmarks are input into a three-dimensional modeling application to create a three-dimensional visualization of the training data and the predicted facial expressions.

FIG. 6 and FIG. 7 present two-dimensional and three-dimensional correlations between training data and predicted facial expressions. Any suitable correlation can be made based on the type of camera used and the type of data collected. For example, correlations can be made based on imaging data such as thermal gradients or acoustic reflections.

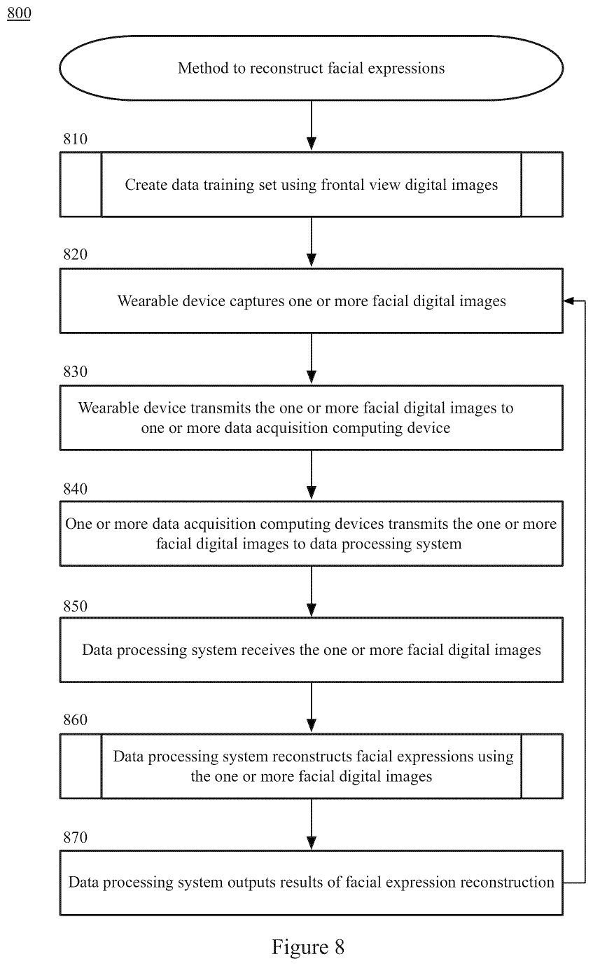

FIG. 8 is a block flow diagram depicting a method 800 to reconstruct facial expressions, in accordance with certain examples. In block 810, a data training set is created using frontal view digital images. Block 810 is described in greater detail in method 810 of FIG. 9.

FIG. 9 is a block flow diagram depicting a method 810 to create a data training set using frontal view digital images, in accordance with certain examples. In block 910, one or more frontal view digital image(s) of a user are acquired. The one or more frontal view digital image(s) depict the user making a variety of facial expressions. For example, the user may smile, frown, squint, close one or both eyes, make an angry facial expression, raise one or both eyebrows, or any other suitable expressions such that the one or more frontal view digital image(s) represent a wide range of potential facial expressions. Example frontal view digital images are depicted in row 610 of FIG. 6. The user may take the one or more frontal view digital image(s) of himself, another person may take the one or more frontal view digital image(s), or any other suitable method to acquire the one or more frontal view digital image(s) may be used. The one or more frontal view digital image(s) may be taken by any device or sensor capable of capturing a digital image including, but not limited to, depth cameras, red-green-blue (“RGB”) cameras, infrared (“IR”) sensors, thermal imaging sensors, charge-coupled devices (“CCDs”), complementary metal oxide semiconductor (“CMOS”) devices, active-pixel sensors, radar imaging sensors, fiber optics, and any other suitable image device technology.

In block 920, the frontal view digital images are transmitted to data processing system 130. The frontal view digital images may be transmitted to the data processing system 130 by a user's computing device, such as user computer device 150, or any other suitable device to transmit data.

In block 930, the data processing system 130 receives the frontal view digital images.

In block 940, the data processing system 130 extracts facial landmark positions. To extract the facial landmark positions, the data processing system 130 uses a computer vision library as a ground truth acquisition method. In an example, the computer vision library is a Dlib library. The computer vision library is used to extract key feature points or landmarks from the frontal view digital images. The computer vision library may extract 42, 68, or any suitable number of key feature points.

In block 950, the data processing system 130 aligns the extracted landmark positions using an affine transformation. Aligning the extracted landmark positions accounts for variations in a user's head position in the frontal view digital images. When a user acquires the frontal view digital images as described in block 910, the same facial expressions may vary if the user slightly changes his face orientation. To align the extracted landmark positions, a set of landmarks are selected whose relative positions change very little when making facial expressions. For example, the selected landmarks may be one or more of a right canthus, left canthus, or apex of the nose. The selected landmarks are used to calculate an affine matrix for each frontal view digital image. The landmark positions are aligned to the same range to reduce the influence of head position change when the frontal view digital images are acquired.

In block 960, the data processing system 130 creates the data training set based on the aligned facial landmark positions. In an example, after the extracted landmark positions are aligned, the data processing system 130 selects the most informative feature points from the extracted landmark positions. In an example, the Dlib library may extract 68 facial landmarks from each of the frontal view digital images. When making facial expressions, changes mainly occur in the areas around the mouth, eyes, and eyebrows. The less informative features points may be removed, leaving a smaller set of facial landmarks, such as 42 facial landmarks. Any suitable number of facial landmarks may be used. The data training set is the set of the most informative landmark positions for each facial expression from each of the frontal view digital images. Example data training set images are depicted in row 620 of FIG. 6. In an alternate example, the facial expression reconstruction is further modeled to create a three-dimensional visualization of the training data images as depicted in row 720 of FIG. 7. In an example, the data processing system saves the data training set in the data storage unit 133. In some embodiments, the system may extract information of at least 10, at least 20, at least 30, at least 40, at least 50, at least 60, at least 70, at least 80, at least 90, or at least 100 parameters or features from one or more image(s) captured by one or more imaging sensor(s) for a facial expression, wherein the parameters or features comprise facial landmark positions, shape parameters (for example, blendshape parameters), orientations (for example, head orientations), or any combination thereof.

FIG. 6 depicts frontal view digital images of a user at row 610, which are used to create the corresponding data training set depicted in row 620. In an alternate example, training data with three-dimensional visualization, as depicted in row 720 of FIG. 7, may be utilized. Any suitable method or visualization may be used to create the data training set.

From block 960, the method 810 returns to block 820 of FIG. 8.

Referring back to FIG. 8, in block 820, a wearable device captures one or more facial digital image(s). In an example, the wearable device may be a head-mounted device, such as headphone device 210 or earbud device 220, previously described herein with reference to FIG. 2. The head-mounted device is configured to capture right facial contour images and left facial contour images of a user's face directed towards the right and left cheekbones using two or more cameras 110. In the current example, the right and left facial contour images are two-dimensional images of the contour of a user's face. Example right and left facial contour images are depicted in rows 640 and 650, respectively, of FIGS. 6 and 7.

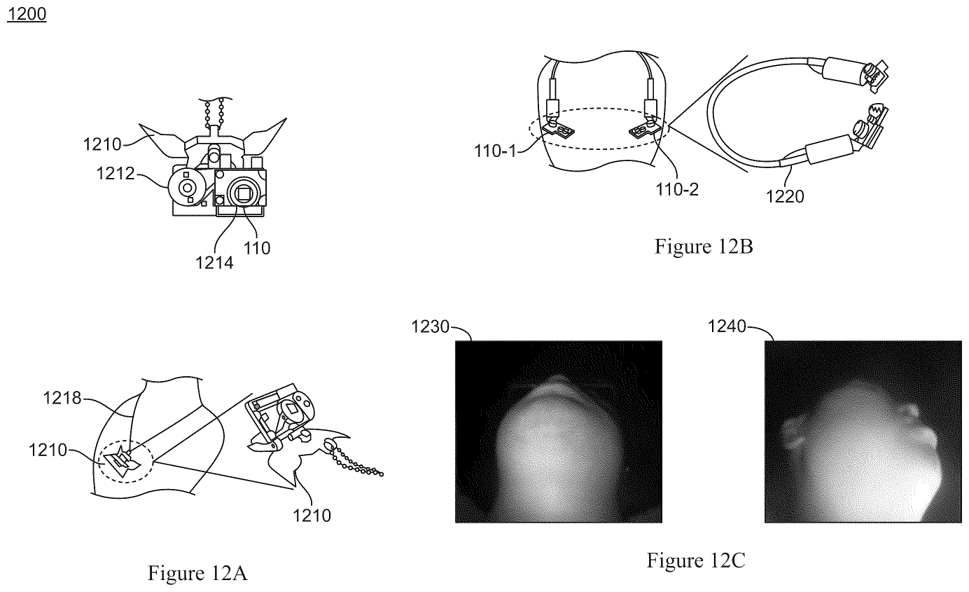

In an alternate example, the wearable device may be a neck-mounted device such as necklace device 1210 or neckband device 1220, described hereinafter with reference to FIG. 12. The neck-mounted device is configured to take digital images of the contour of a user's face directed towards the user's chin using one or more camera(s) 110.

In block 830, the wearable device transmits the one or more facial digital image(s) to one or more data acquisition computing device(s) 120. As depicted and described in reference to FIG. 1, each camera 110 is in communication with a data acquisition computing device 120.

In block 840, the one or more data acquisition computing device(s) 120 transmit the one or more facial digital image(s) to the data processing system 130.

In block 850, the data processing system 130 receives the one or more facial digital image(s).

In block 860, the data processing system 130 reconstructs facial expressions using the one or more facial digital image(s). Block 860 is described in greater detail herein with reference to method 860 of FIG. 10.

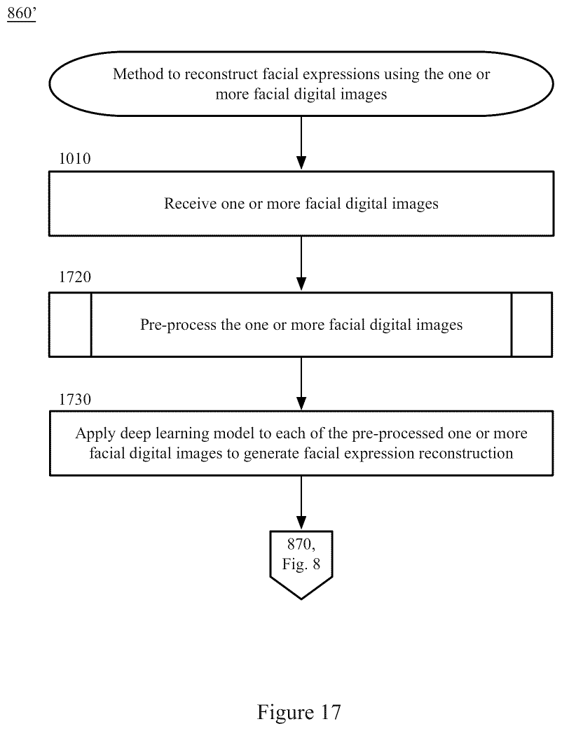

FIG. 10 is a block flow diagram depicting a method 860 to reconstruct facial expressions using one or more facial digital image(s), in accordance with certain examples. The examples of FIG. 10 are directed to the method to reconstruct facial expressions from one or more facial digital image(s) received from a head-mounted wearable device. An alternate method to reconstruct facial expressions from one or more facial digital image(s) received from a neck-mounted wearable device is described herein with reference to method 860′ of FIG. 17.

In block 1010, the data processing system 130 receives the one or more facial digital image(s).

In block 1020, the data processing system 130 creates one or more pair(s) of synchronized facial digital images from the one or more facial digital image(s). In the example where the one or more facial digital image(s) are acquired from a head-mounted wearable device, the wearable device captures right facial contour images and left facial contour images. To accurately reconstruct a facial expression of a user, the data processing system 130 synchronizes the images from the left camera 110-1 and the right camera 110-2 such that each pair of right and left facial contour images represents a particular facial expression.

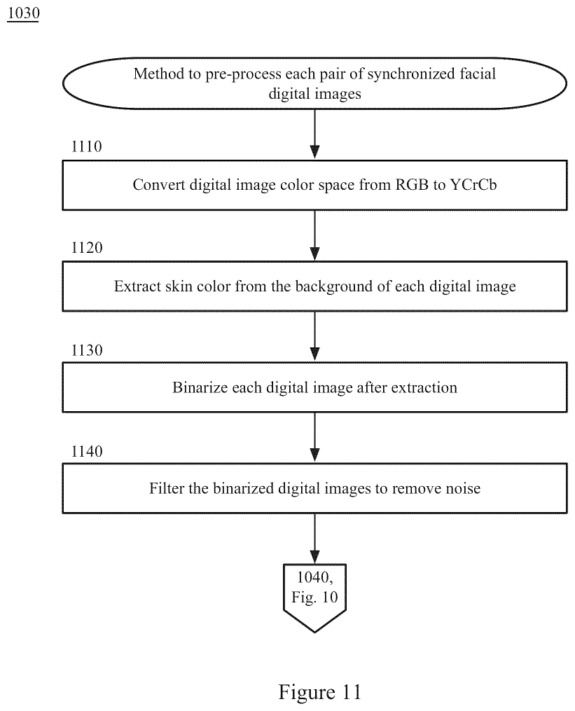

In block 1030, the data processing system 130 pre-processes each pair of synchronized facial digital images. Block 1030 is described in greater detail herein with reference to method 1030 of FIG. 11.

FIG. 11 is a block flow diagram depicting a method 1030 to pre-process each pair of synchronized facial digital images, in accordance with certain examples. In block 1110, the data processing system 130 converts a digital image color space of each pair of synchronized facial digital images from a red-green-blue (“RGB”) color space to a luminance, chrominance (red-yellow), chrominance (blue-yellow) (“YCrCb”) color space. The YCrCb color space is used to take advantage of a lower resolution with respect to luminosity amount of data stored with respect to each pair of synchronized facial digital images. The conversion from the RGB color space to the YCrCb color space is accomplished using a standard process.

In block 1120, the data processing system 130 extracts skin color from the background of each converted pair of facial digital images. In an example, the skin color is extracted using Otsu's thresholding method. Otsu's thresholding method determines whether pixels in an image fall into a foreground or a background. In the current example, the foreground represents a facial contour of each facial digital image, and the background represents an area of the image outside of the facial contour.

In block 1130, the data processing system 130 binarizes each facial digital image after the extraction of the skin color from the background. Image binarization is the process of taking the image in YCrCb color space and converting it to a black and white image. The binarization of the image allows for an object to be extracted from an image, which in this example is a facial contour.

In block 1140, the data processing system 130 filters the binarized digital images to remove noise from the images. Filtering the binarized digital images produces a smoother image to assist in more accurate facial expression reconstructions.

From block 1140, the method 1030 returns to block 1040 of FIG. 10. Referring back to FIG. 10, in block 1040, the data processing system 130 applies a deep-learning model to each pair of pre-processed facial digital images for facial expression reconstruction. The deep-learning model for facial expression reconstruction was described in detail herein in the deep-learning model process 400 with reference to FIG. 4 and in the classifier process 500 with reference to FIG. 5. The results of the facial expression reconstruction from block 1040 may include the reconstruction output from block 456 of FIG. 4 and/or the encoding of a facial event class from block 550 of FIG. 5. For example, the data processing system 130 may output from block 1040 the landmark images from the deep-learning model process 400 of FIG. 4. The data processing system 130 also, or alternatively, may further process the facial expression reconstruction such that the output from block 1040 comprises a three-dimensional visualization of the facial expression, silent speech recognition, an emoji associated with the facial expression reconstruction, and/or real-time avatar facial expressions associated with the facial expression reconstruction, such as described by the classifier process 500 of FIG. 5.

From block 1040, the method 860 returns to block 870 of FIG. 8. Referring back to FIG. 8, in block 870, the data processing system 130 outputs the results of the facial expression reconstruction. In an example, the results may be sent to user computing device 150 to be displayed visually or audibly to a user. In an example, the results of the facial expression reconstruction may be displayed as a graphical representation of a facial expression, such as row 630 of FIG. 6; a predicted facial expression with three-dimensional visualization, such as row 730 of FIG. 7; a three-dimensional facial expression, such as row 1530A of FIG. 15A; an emoji; text representing silent speech recognition; or any other suitable display of facial expression reconstruction results. User computing device 150 may comprise a speaker to audibly communicate the facial expression reconstruction results directed to silent speech recognition.

From block 870 of FIG. 8, the method 800 returns to 820 where the method 800 repeats the process of reconstructing facial expressions by capturing additional facial digital images.

### Other Example Architectures

FIGS. 12A, 12B, and 12C are perspective views 1200 of neck-mounted wearable devices 1210, 1220 for facial expression reconstruction with example IR images 1230 and 1240, in accordance with certain examples.

FIG. 12A depicts a necklace style neck-mounted wearable device 1210 (herein referred to as necklace device 1210) as a form factor to acquire images or data for use in facial expression reconstruction. Necklace device 1210 comprises a camera 110, previously described herein in reference to FIG. 1. In the current example, camera 110 is an infrared (“IR”) camera. Necklace device 1210 also comprises an IR LED 1212 and an IR bandpass filter 1214. Necklace device 1210 is configured to acquire images of a user's chin profile by directing the camera 110 at the profile of a user's chin. The IR LED 1212 projects IR light onto a user's chin to enhance the quality of the image captured by camera 110. The IR bandpass filter 1214 filters visible light such that camera 110 captures infrared light reflected by the skin of a user.

Necklace device 1210 comprises a chain 1218 or other suitable device for securing the necklace device 1210 about the neck of a user. In an alternate example, necklace device 1210 may attach to a user's clothing instead of being secured about the neck of a user. In the current example, necklace device 1210 may be attached to a user's clothing underneath the user's chin. In an alternate example, multiple necklace devices 1210 may be attached to a user's clothing to capture camera 110 images from multiple viewpoints. In the current example, a necklace device 1210 may be attached on a user's clothing close to each shoulder of the user. The necklace device 1210 may comprise a clip, a pin, a clasp, or any other suitable device to attach necklace device 1210 to a user's clothing.

The camera 110 is in communication with a computing device 120, as previously described with respect to FIG. 1. In an example, a computing device 120 may be connected to the camera 110 and be embedded within the necklace device 1210. In an alternate example, the camera 110 may communicate with a computing device 120 via a wireless technology, such as Bluetooth or Wi-Fi.

FIG. 12B depicts a neckband style neck-mounted wearable device 1220 (herein referred to as neckband device 1220) as a form factor to acquire images or data for use in facial expression reconstruction. Neckband device 1220 comprises two cameras 110-1 and 110-2 fashioned to be positioned on the left and right sides of a user's neck. Neckband device 1220 also comprises IR LEDs and IR bandpass filters configured in proximity to each camera 110-1 and 110-2 (not depicted in FIG. 12). In an example, neckband device 1220 may include functionality with Bluetooth or Wi-Fi connectivity and speakers embedded within the neckband device 1220. Each camera 110 is in communication with a computing device 120, as previously described with respect to FIG. 1. In an example, a computing device 120 may be connected to each camera 110 and be embedded within the neckband device 1220. In an alternate example, each camera 110 may communicate with a computing device 120 via a wireless technology, such as Bluetooth or Wi-Fi.

FIG. 12C depicts two example IR images 1230 and 1240. Example 1230 is an IR image acquired from necklace device 1210. Example 1240 is a right camera 110 IR image acquired from neckband device 1220. Additional examples of IR images acquired by either necklace device 1210 or neckband device 1220 are depicted in row 1540A of FIG. 15A and row 1540B of FIG. 15B.

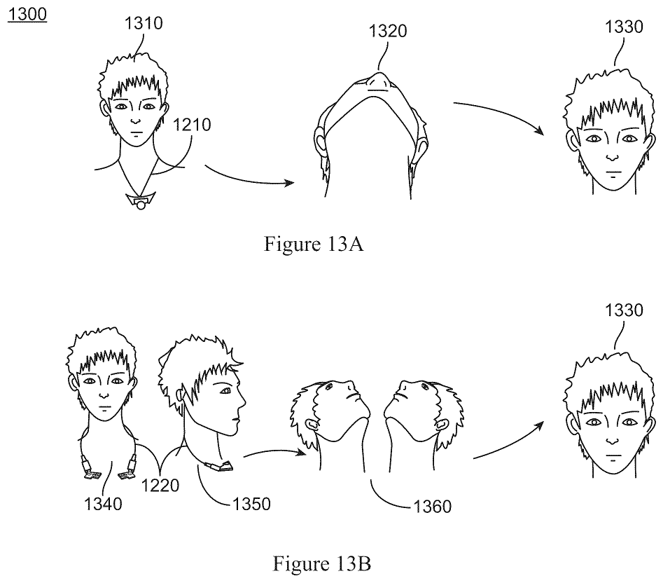

FIGS. 13A and 13B are illustrations 1300 depicting examples 1310-1360 of neck-mounted wearable devices 1210, 1220 on a user, camera views 1320 and 1360, and corresponding facial expressions 1330, in accordance with certain examples. In FIG. 13A, example 1310 illustrates a necklace device 1210 as being worn by a user in a front view of the user. Example 1320 illustrates a view of the user as captured by camera 110 of the necklace device 1210. The corresponding example 1330 illustrates a reconstructed facial expression based on IR images captured by the necklace device 1210.

In FIG. 13B, example 1340 illustrates a neckband device 1220 as being worn by a user in a front view of the user. Example 1350 illustrates a neckband device 1220 as being worn by a user in a right-side view of the user. Example 1360 illustrates two views of the user as captured by cameras 110-1 and 110-2 of the neckband device 1220. The corresponding example 1330 illustrates a reconstructed facial expression based on IR images captured by the necklace device 1220.

### Other Example Processes

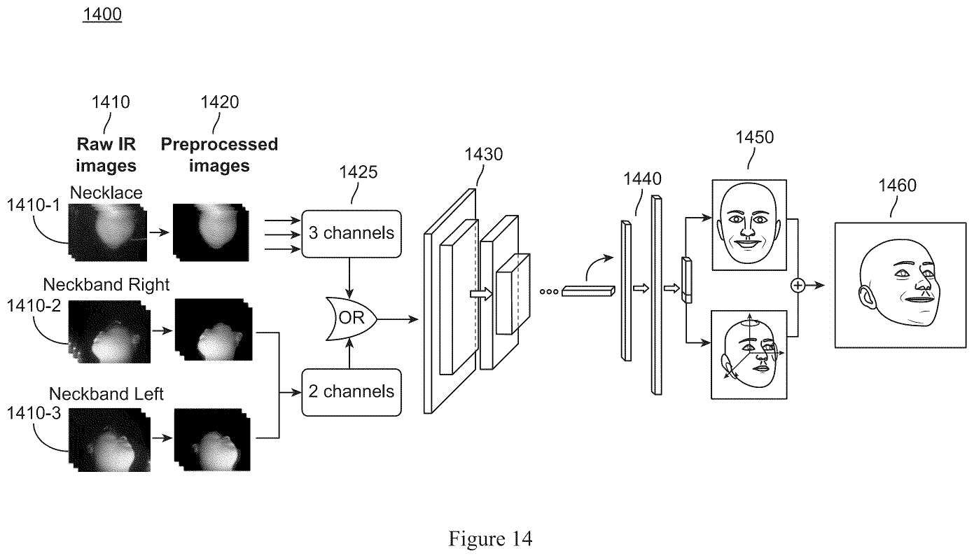

The methods illustrated in FIGS. 14 through 18 are described hereinafter with respect to the components of facial expression reconstruction system 100, necklace device 1210 of FIG. 12A, and neckband device 1220 of FIG. 12B. The methods of FIGS. 14 through 18 may also be performed with other systems and in other environments. The operations described with respect to FIGS. 14 through 18 can be implemented as executable code stored on a computer- or machine-readable, non-transitory, tangible storage medium (for example, floppy disk, hard disk, ROM, EEPROM, nonvolatile RAM, CD-ROM, etc.) that are completed based on execution of the code by a processor circuit implemented using one or more integrated circuit(s); the operations described herein also can be implemented as executable logic that is encoded in one or more non-transitory, tangible media for execution (for example, programmable logic arrays or devices, field programmable gate arrays, programmable array logic, application specific integrated circuits, etc.).

FIG. 14 is a block diagram depicting an alternate embodiment of a deep-learning model process 1400, in accordance with certain examples. The deep-learning model process 1400 may be performed by the modeling application 132 of the data processing system 130, previously described herein with reference to FIG. 1. In an example where the machine learning algorithm is a convolution neural network (“CNN”), the deep-learning model process 1400 receives images as an input and assigns importance (learnable weights and biases) to various aspects/objects in the images. The CNN reduces the images into a form that is easier to process without losing the features of the images that are critical for getting a good prediction. In the current example, the prediction is a reconstructed facial expression based on received IR images of a user's chin profile.

In block 1410, the data processing system 130 receives IR images from either the necklace device 1210 or the neckband device 1220. Example necklace device 1210 IR images are depicted at 1410-1. Example neckband device 1220 IR images are depicted at 1410-2 and 1410-3 as the neckband acquires both a right and left side IR image of a user's chin profile. Other example IR images are depicted in row 1540A of FIG. 15A and row 1540B of FIG. 15B.

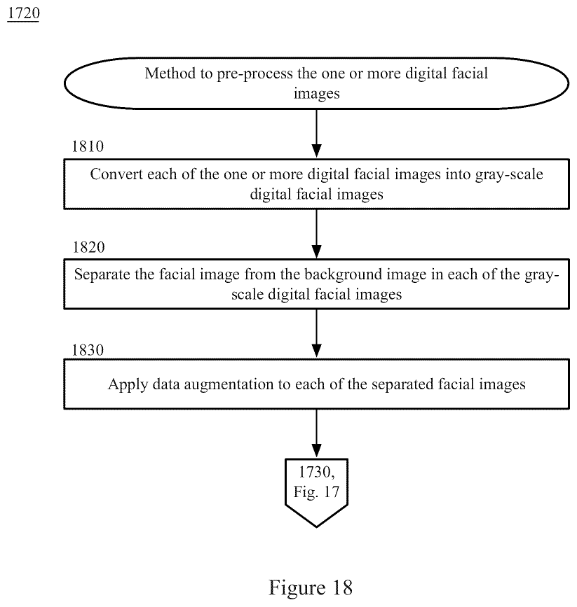

In block 1420, the data processing system 130 pre-processes the IR images. Pre-processing the IR images is described in greater detail in reference to method 1720 of FIG. 18.

In block 1425, the data processing system 130 duplicates the pre-processed IR images of the necklace device 1210 into three channels to improve the expressiveness and the ability to extract features of the model. As the neckband device 1220 already comprises two pre-processed images, the images are not duplicated into additional channels.

The pre-processed IR images are input into an image processing phase of the deep-learning model process 1400 depicted at block 1430. Block 1430 comprises convolution layers, normalization layers, and an averaging pooling layer. The processing of block 1430 is described in greater detail herein with reference to blocks 414 and 416 of FIG. 4. The output from block 1430 is a vector representation of each of the pre-processed IR images.

The vector representations of each of the pre-processed IR images are input into a regression phase 1440 of the deep-learning model process 1400. The architecture of the regression phase 1440 is similar to the architecture of regression phase 450, previously described herein with reference to FIG. 4. Within the regression phase 1440, the data processing system 130 extracts details from the vector representations of the pre-processed IR images regarding facial components including the cheek, mouth, eyes, eyebrows, chin, and nose and three-dimensional head rotation angles. The data processing system 130 represents each facial expression with blend shapes that are a three-dimensional representation of the vector representations. The parameters of the blend shapes and the three-dimensional head rotation angles, or Euler angles, are obtained by learning from the IR images captured from the neck. The data processing system 130 compares the blend shapes and Euler angles from the vector representations to the blend shapes and Euler angles of the data training set to match the blend shapes/Euler angles to a facial expression from the data training set.

In block 1450, the data processing system 130 combines the blend shapes with three-dimensional angles of rotation of the user's head. In an example, the three-dimensional angles of rotation are represented by Euler's angles of roll, yaw, and pitch. In block 1460, the final facial expression reconstruction is output as a three-dimensional image. Example three-dimensional facial expression reconstructions are depicted in row 1530A of FIG. 15A and row 1530B of FIG. 15B. In an example, the three-dimensional facial expression reconstructions may be further processed by a classifier process, such as classifier process 500 for applications such as silent speech recognition, emoji input, real-time avatar facial expressions, or any other suitable applications.

FIG. 15A is a diagram 1500A depicting the correlation between frontal view camera images 1510A, three-dimensional training data 1520A, predicted three-dimensional face expressions 1530A, and infrared facial images 1540A, also referred to herein as respective rows 1510A, 1520A, 1530A and 1540A, in accordance with certain examples.

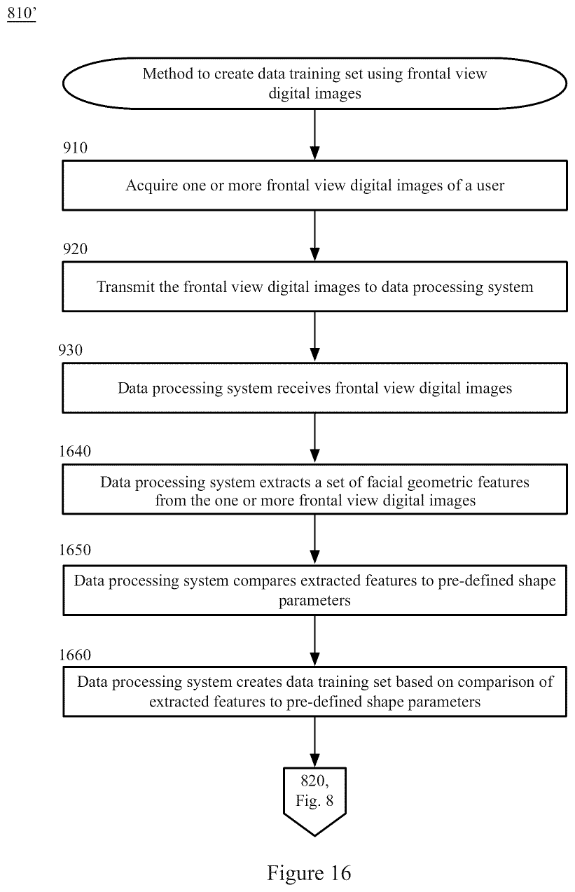

Row 1510A illustrates frontal view camera images of a user. To construct a training data set or ground truth, frontal camera images of a user are acquired with the user making various different facial expressions, as depicted in images 1510A-1 through 1510-n. The method to create the training data set from the frontal view camera images is described herein in greater detail with reference to method 810′ of FIG. 16. Row 1520A illustrates three-dimensional training data in three-dimensional blend shapes and head rotation angles. The three-dimensional training data images depicted in images 1520A-1 through 1520A-n correlate with images 1510A-1 through 1510-n. The three-dimensional training data images 1520A are the output of method 810′ of FIG. 16.

Row 1540A depicts IR images 1540A-1 through 1540A-n captured by a neck-mounted wearable device, such as necklace device 1210 or neckband device 1220 described herein in greater detail in reference to FIG. 12. The IR images 1540A, and the three-dimensional training data images 1520A are used in the deep-learning model process 1400 to construct the predicted facial expressions 1530A illustrated in row 1530A of FIG. 15A. The predicted facial expressions 1530A are depicted as three-dimensional images in images 1530A-1 through 1530A-n. The predicted facial expressions 1530A are illustrated in FIG. 15A beneath the three-dimensional training data images 1520A to illustrate the accuracy of predicting facial expressions using IR images 1540A acquired from necklace device 1210 or neckband device 1220.

FIG. 15B is a diagram 1500B depicting the correlation between additional frontal view camera images 1510B, three-dimensional training data 1520B, predicted three-dimensional face expressions 1530B, and infrared facial images 1540B, in accordance with certain examples. Each of the frontal view camera images 1510B, three-dimensional training data 1520B, predicted three-dimensional face expressions 1530B, and infrared facial images 1540B correspond to the frontal view camera images 1510A, three-dimensional training data 1520A, predicted three-dimensional face expressions 1530A, and infrared facial images 1540A described herein with reference to FIG. 15A, except these items correlate to different facial expressions.

In this example, the images captured by the cameras of the neck-mounted devices can be processed for facial reconstruction similarly to the methods discussed previously with reference to FIGS. 8-11. Various alternatives to the methods of FIGS. 8-11 will be discussed.

FIG. 16 is a block flow diagram depicting an alternative method 810′ to create a data training set using frontal view images, in accordance with certain examples.

Blocks 910, 920, and 930 of FIG. 16 were previously described herein with reference to FIG. 9.

In block 1640, the data processing system 130 extracts a set of facial geometric features from the one or more frontal view digital image(s). In an example, the one or more frontal view digital image(s) are three-dimensional digital images captured from a camera that provides depth data in real time along with visual information. Example frontal view digital images are depicted in rows 1510A and 1510B, respectively, of FIGS. 15A and 15B. In an example, the data processing system 130 extracts full facial expressions using an augmented reality (“AR”) application. The AR application extracts high-quality and fine-grained details of facial expressions/movements of the eyes, eyebrows, cheeks, mouth, nose, and chin. The AR application can extract facial features such as facial geometry and rotation from a depth map associated with the three-dimensional digital images. In an example, the rotation is represented by Euler's angles of roll, yaw, and pitch.

In block 1650, the data processing system 130 compares the extracted features to pre-defined shape parameters. In an example, the AR application comprises pre-defined blend shapes as templates for complex facial animations. In the example, the AR application comprises blend shapes with features for left and right eyes, mouth and jaw movement, eyebrows, cheeks, nose, tongue, and any other suitable facial features.

In block 1660, the data processing system 130 creates a data training set based on the comparison of the extracted features to the pre-defined shape parameters. The data training set comprises a blend shape with a Euler angle of head rotation as depicted in block 1520A of FIG. 15A and block 1520B of FIG. 15B. In an example, the data processing system 130 stores the data training set in the data storage unit 133.

From block 1660, the method 810′ returns to block 820 of FIG. 8.

FIG. 17 is a block flow diagram depicting an alternative method 860′ to reconstruct facial expressions using one or more facial digital image(s), in accordance with certain examples.

Block 1010 of FIG. 17 was previously described herein with reference to FIG. 10.

In block 1720, the data processing system 130 pre-processes the one or more facial digital image(s). Example facial digital images are depicted in rows 1540A and 1540B of FIGS. 15A and 15B, respectively. Block 1720 is described in greater detail herein with reference to method 1720 of FIG. 18.

FIG. 18 is a block flow diagram depicting an alternative method 1720 to pre-process the one or more digital facial image(s), in accordance with certain examples.

In block 1810, the data processing system 130 converts each of the one or more digital facial image(s) into gray-scale digital facial images. The one or more digital facial image(s) are converted to gray-scale to remove any potential color variance. As the IR bandpass filter 1214 only allows monochrome light into the camera 110, any color present in the one or more digital facial image(s) does not represent details related to the facial expression of the user.

In block 1820, the data processing system 130 separates the facial image from the background image in each of the gray-scale digital facial images. Using the IR technology previously discussed in reference to FIG. 12, the user's skin in the images appears brighter than the surrounding background. However, some light sources in the background may contain IR light that would introduce noise in the background. To remove the noise, the gray-scale digital facial images are binarized based on a set brightness threshold. The data processing system 130 separates the facial image as the brighter component of the gray-scale digital facial image.

In block 1830, the data processing system 130 applies data augmentation to each of the separated facial images. As a user wears a necklace device 1210 or a neckband device 1220 and performs activities, the position and angles of the cameras 110 of the necklace device 1210 and neckband device 1220 may not be constant. To mitigate the issue, a probability of 60% to conduct three types of image transformations is set, which can be caused by camera shifting causing translation, rotation, and scaling on the images. In an alternate example, any suitable probability may be used. Three Gaussian Models are deployed to generate the parameters for the translation (μ=0, σ²=30), rotation (μ=0, σ²=10), scaling (μ=1, σ²=0.2) on the synthesized training data. The data augmentation is performed on all the images in the training dataset during each training epoch before feeding the images into deep-learning model process 1400. Data augmentation improves the deep-learning model's ability to confront camera shifting and avoid over-fitting during model training.

From block 1830, the method 1720 returns to block 1730 of FIG. 17.

In block 1730, the data processing system 130 applies the deep-learning model to each of the pre-processed one or more facial digital image(s) to generate facial expression reconstruction. The deep-learning model for facial expression reconstruction was described in the deep-learning model process 1400 herein with reference to FIG. 14 and in the classifier process 500 with reference to FIG. 5. The results of the facial expression reconstruction from block 1730 may include the reconstruction output from block 1460 of FIG. 14 and/or the encoding of a facial event class from block 550 of FIG. 5. For example, the data processing system 130 may output from block 1730 the images from the process 1400 of FIG. 14. The data processing system 130 also, or alternatively, may further process the facial expression reconstruction such that the output from block 1730 comprises a three-dimensional visualization of the facial expression, silent speech recognition, an emoji associated with the facial expression reconstruction, and/or real-time avatar facial expressions associated with the facial expression reconstruction, such as described by the classifier process 500 of FIG. 5.

From block 1730, the method 860′ returns to block 870 of FIG. 8 to output results of the facial reconstruction.

Cameras 110 were described herein with reference to FIG. 1 as any suitable sensors for capturing images. For example, cameras 110 may include depth cameras, red-green-blue (“RGB”) cameras, infrared (“IR”) sensors, acoustic cameras or sensors, microphones and speakers, thermal imaging sensors, charge-coupled devices (“CCDs”), complementary metal oxide semiconductor (“CMOS”) devices, active-pixel sensors, radar imaging sensors, fiber optics, and any other suitable image device technology. While the examples herein described specific cameras for the headphone device 210, earbud devices 220, necklace device 1210, and neckband device 1220, it should be appreciated that any type of camera can be used with any of the wearable devices. The methods to process the images and recreate the facial expressions are adjusted based on camera/image type and are not dependent on the type of device used to acquire the images.

The embodiments herein describe wearable devices in the form of head-mounted devices including headphone device 210 and earbud devices 220, and neck-mounted devices including necklace device 1210 and neckband device 1220. Any suitable wearable device may be used such that the one or more camera(s) may be directed towards a user's face including, but not limited to, glasses, smart glasses, a visor, a hat, a helmet, headgear, a virtual reality (“VR”) headset.

The embodiments herein describe head-mounted and neck-mounted wearable devices comprises cameras 110 with adjustable positions and angles. Each camera 110 may be positioned such that at least one of a buccal region, a zygomatic region, and/or a temporal region of a user's face are included in the field of view of the camera 110.

In an alternate embodiment, the wearable devices previously described herein may be configured for use in a hand-face touching detection system to recognize and predict a time and position that a user's hand touches the user's face. An important step in reducing the risk of infection is avoiding touching the face because a virus, such as COVID-19, may enter the mucous membranes of the eyes, nose, and/or mouth. Touching different areas of the face carries different health related risks. For example, contacting a mucous membrane may introduce a higher risk of transmitting a virus than touching non-mucous areas such as the chin and cheek. In addition, the frequency of touching the face may be an indicator regarding the stress level of a person. Understanding how people touch their face may alleviate multiple health challenges. Accurately recognizing where the hand touches the face is an important step towards alleviating health risks introduced by hand-face touching behaviors. In order to implement behavior intervention technologies, the hand-face touching detection system predicts the behavior in advance rather than simply detecting the touching behavior.

A data training set is created similar to the data training sets described herein with reference to FIGS. 9 and 16. The difference is that instead of frontal view images of a user capturing just the user's face, the data training set uses frontal view images of a user with different hand-face touching positions. For example, frontal view images of the user may be acquired with the user touching his eye, nose, mouth, cheek, or any other suitable facial feature. In addition to touching faces directly, people move their hands closer to their faces when performing daily activities such as eating and drinking. The daily activities are classified as separate behaviors to avoid false-positive errors of a person touching their face. Additional frontal view images are acquired for the data training set depicting example daily activities. For example, the frontal view images may comprise a user eating with his hand, a fork, a spoon, or chopsticks. The user may be drinking with a straw, a bottle, or a cup. The user may be placing an earbud in or out, putting on or taking off eyeglasses, adjusting eyeglasses, applying lip balm, or adjusting his hair. Any suitable daily activities may be used in the frontal view images to create the data training set.

The frontal view images of the user are sent to a server, such as data processing system 130, to create the data training set, as previously described herein with reference to FIGS. 9 and 16. However, instead of extracting facial landmark positions as described in block 940 of FIG. 9 or facial geometric features as described in block 1640 of FIG. 16, the data processing system extracts hand/facial landmark positions or hand/geometric features to create the data training set.

In an example, necklace device 1210 may be positioned on a user to acquire images of the user's facial area, as previously described herein, to also include a user's hand if positioned or in motion near the user's face. Any suitable wearable device may be used to acquire the images of the user's face. To predict the time and location of a hand-face touch, camera images are monitored over a period of time. Camera images are sent to a server, such as data processing system 130, for processing. The data processing system receives the hand/facial images and reconstructs the position of the user's hand relative to the user's face using the data training set and a deep-learning model, such as the models previously described herein with reference to FIGS. 4 and 14. The data processing system monitors the hand-face position over time to predict where and when a user may touch his face. Alternatively, the data processing system may determine that the user is participating in a daily activity and that the user is not in the process of a hand-face touch. In each case, the system outputs a reconstructed image (or other similar information as described herein) depicting the user's facial expression and a representation of the hand-touch activity. The system also can log each hand-touch to the facial area and output notifications of the activity.

In an alternate embodiment, acoustic sensing technology can be used to reconstruct facial expressions using an array of microphones and speakers and deep-learning models. The acoustic technology comprises a wearable device such as headphones, earbuds, necklaces, neckbands, and any other suitable form factors such that the microphones and speakers can be mounted or attached to the wearable device. In an example, the microphones are Micro-Electro-Mechanical System (“MEMS”) microphones that are placed on a printed circuit board (“PCB”). In an example, each microphone/speaker assembly may comprise four microphones and one speaker. Any suitable number of microphones and speakers may be included. The positions of the microphones and speakers may be adjustable to optimize the recording of reflected signals.

The acoustic wearable device actively sends signals from the speakers towards a user's face. In an example, the speakers transmit inaudible acoustic signals within a frequency range of 16 kHz to 24 kHz towards the user's face. Any suitable frequency range may be used. The signals are reflected by the user's face and captured by the microphones on the acoustic wearable device. The signals are reflected differently back towards the microphones based on different facial expressions or movements. A Channel Impulse Response (“CIR”) is calculated based on the acoustic signals received at each microphone.

Each microphone is in communication with a computing device, such as computing device 120, such that the CIR images/data can be transmitted for processing to a server, such as data processing system 130.

The data processing system creates a data training set using frontal view images of a user in a machine learning algorithm, previously described herein with reference to FIGS. 9 and 16. The data processing system receives the CIR images/data and reconstructs the user's facial expression using the data training set and a deep-learning model, such as the models previously described herein with reference to FIGS. 4 and 14. The data processing system outputs the resultant facial expression reconstruction, such as previously described herein with reference to block 870 of FIG. 8.

The wearable devices and systems described herein may be used in applications such as silent speech recognition, emoji input, and real-time avatar facial expressions. Silent speech recognition is a method to recognize speech when vocalization is inappropriate, background noise is excessive, or vocalizing speech is challenging due to a disability. The data training set for silent speech recognition comprises a set of frontal view facial images directed to the utterance of a word or phrase. To recognize silent speech, the wearable device, such as necklace device 1210 or neckband device 1220, captures a series of facial movements from underneath the chin of a user while the user silently utters words or commands and transfers the series of digital facial images to the data processing system 130 for facial expression reconstruction. The results of the facial expression reconstruction, previously described herein with reference to block 456 or block 1460, are used as inputs to the classifier process 500, previously described herein with reference to FIG. 5. Using the series of facial expression reconstruction images, the classifier process 500 detects the start time and end time of an utterance and selects the frames from the series of facial expression reconstruction images associated with the utterance. A vector representation of the utterance is created and input into a probability distribution to predict a word or phrase. In some embodiments for applications, such as in a testing process after the training, or using a trained system, a front view of a user is not needed. In some embodiments for speech recognition, one or more imaging sensor(s), such as camera(s) in a necklace and/or a wearable device worn in or on ear(s) of a user, capture a series of images for speaking a syllable, word, or phrase with or without audio (for example, at least two images of a syllable, a word, or a phrase), wherein each image comprises only a portion of a full face. In some embodiments, one image used in the application only captures less than 50%, less than 40%, less than 30%, less than 25%, less than 20%, or less than 15% of a full face. In some embodiments, the one or more imaging sensor(s) used in the application do not capture direct visual information for eyes, nose, and/or mouth. In some embodiments, the one or more image(s) and the combination thereof used in the application capture incomplete visual information for eyes, nose, and/or mouth. In some embodiments, the system and method are configured to recognize or predict speech, and/or other facial expression(s) at a high accuracy, wherein the accuracy is at least 75%, at least 80%, at least 85%, at least 90%, at least 95%, or at least 98% for one or multiple words, phrases, or facial expressions on average. In some embodiments, the application is a speech recognition based on images/videos captured by the system. In other embodiments, the image-based or video-based speech recognition may be combined with an audio-based speech recognition to improve the accuracy of speech recognition. In some embodiments, the image-based or video-based speech recognition may be used to validate a result of an audio-based speech recognition.

### Alternate Embodiment

### Alternate Embodiment Example System Architecture

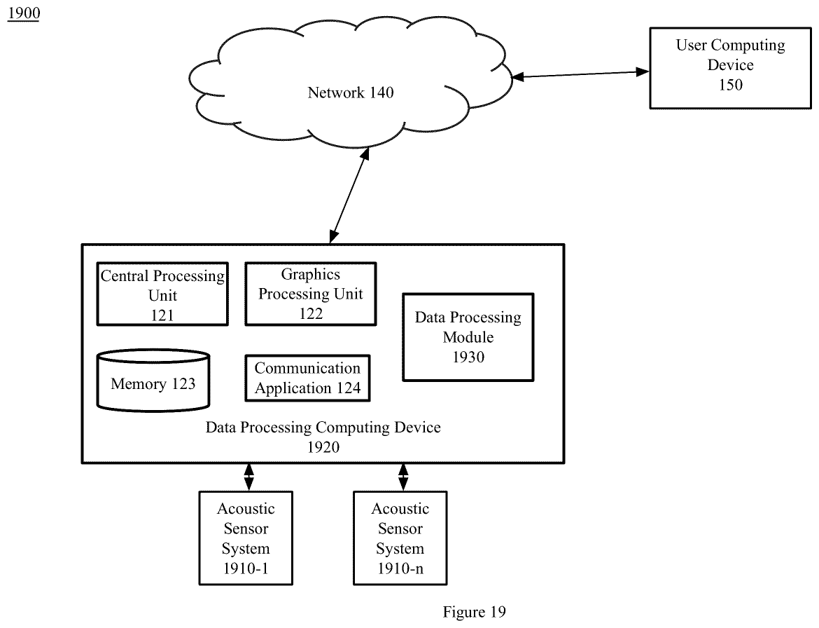

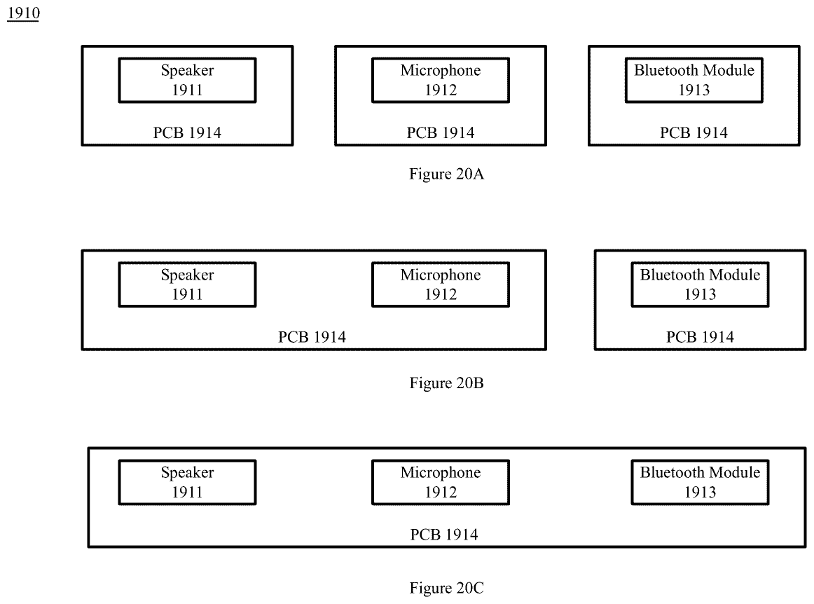

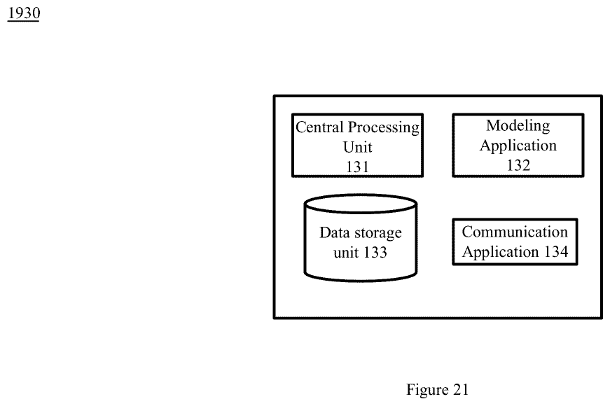

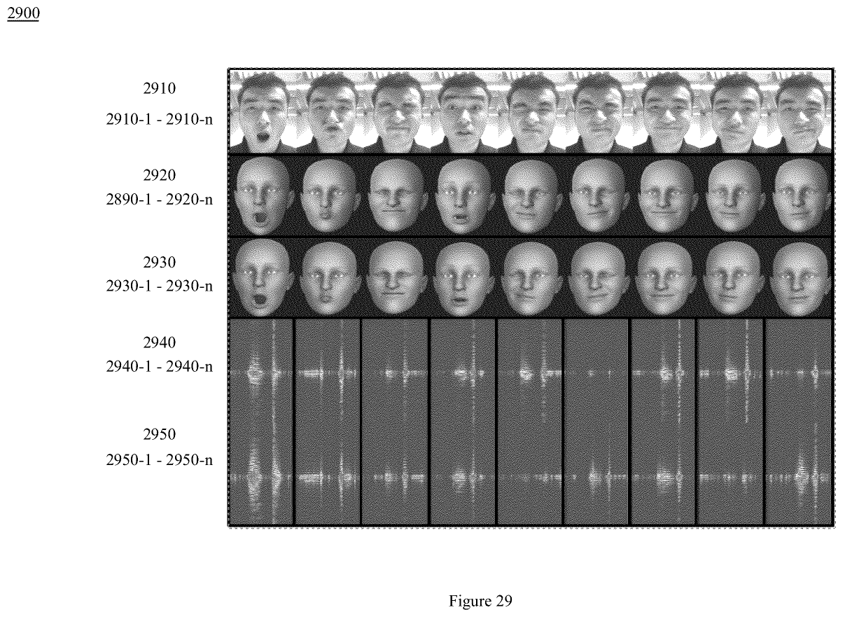

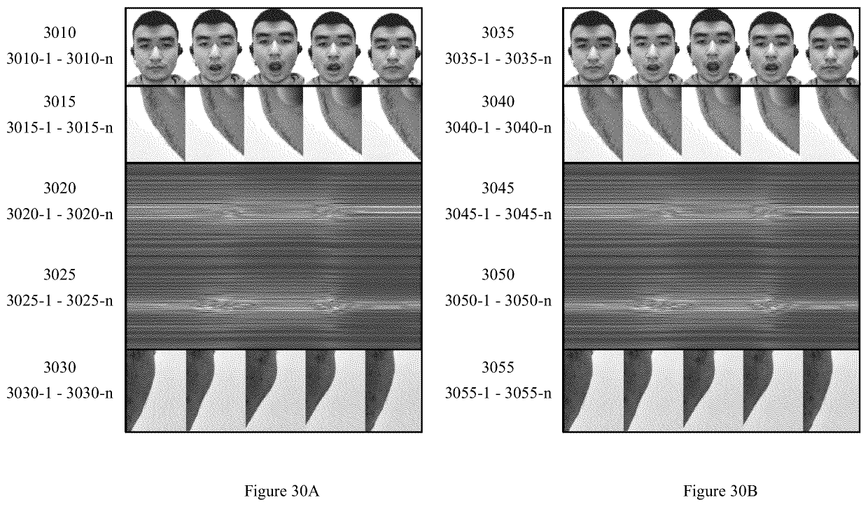

FIG. 19 is a block diagram depicting an acoustic sensor system based facial expression reconstruction system 1900, in accordance with certain examples. As depicted in FIG. 19, acoustic sensor system based facial expression reconstruction system 1900 comprises user computing device 150, acoustic sensor systems 1910-1 through 1910-n, and data processing computing device 1920. User computing device 150 and data processing computing device 1920 are configured to communicate via network 140. Network 140 and user computing device 150 were previously described herein with reference to FIG. 1. User computing device 150 may be configured to receive and display a facial output, such as a predicted facial expression with three-dimensional visualization with examples depicted at 2830 of FIG. 28 and 2930 of FIG. 29. Acoustic sensor systems 1910 are described in greater detail herein with reference to FIGS. 20A, 20B, and 20C.

FIG. 20A is a block diagram depicting a first embodiment of an acoustic sensor system 1910 in accordance with certain examples. Acoustic sensor system 1910 comprises speaker 1911, microphone 1912, Bluetooth module 1913, and printed circuit boards (“PCB”) 1914. Speaker 1911 is a small form factor speaker. In an example, speaker 1911 is a speaker configurable to transmit signals in an inaudible frequency range. For example, speaker 1911 may be configured to transmit signals in a frequency range of 16-24 kHz. Any suitable frequency range may be used. In an example, speaker 1911 transmits signals that are frequency modulation continuous wave (“FMCW”) transmissions, Channel Impulse Response (“CIR”) transmissions, or any other suitable type of acoustic signal. In an example, the speakers transmit inaudible acoustic signals within the frequency range of 16 kHz to 24 kHz towards a user's face. As depicted in FIG. 20A, speaker 1911 is affixed to a PCB 1914.

Microphone 1912 is a small form factor microphone. In an example, microphone 1912 is a Micro-Electro-Mechanical System (“MEMS”) microphone. Microphone 1912 may be a microphone chip, a silicon microphone, or any other suitable microphone. In an example, microphone 1912 is configured to receive reflected signals transmitted by speaker 1911. As depicted in FIG. 20A, microphone 1912 is affixed to a PCB 1914.

Bluetooth module 1913 may be a Bluetooth low energy (“BLE”) module. Bluetooth module 1913 may be a System-on-Chip (“SoC”) module. In an example, Bluetooth module 1913 may comprise a microcontroller unit (“MCU”) with memory. In an example, the memory may be an on-board SanDisk (“SD”) card. The SD card may function to save acoustic data on the MCU. Bluetooth module 1913 may be configured to control a battery (not depicted) to provide power to the acoustic sensor system 1910. In an example, the battery may be a lithium polymer (“LiPo”) battery. Bluetooth module 1913 may be configured to power and control speaker 1911 transmissions, microphone 1912 signal receptions, and data transmissions external to a wearable device, for example transmissions to computing device 1920. As depicted in FIG. 20A, Bluetooth module 1913 is affixed to a PCB 1914.

FIG. 20B is a block diagram depicting a second embodiment of an acoustic sensor system 1910, in accordance with certain examples. FIG. 20B depicts speaker 1911 and microphone 1912 affixed to a common PCB 1914 with Bluetooth module 1913 affixed to a separate PCB 1914.

FIG. 20C is a block diagram depicting a third embodiment of an acoustic sensor system 1910, in accordance with certain examples. FIG. 20C depicts speaker 1911, microphone 1912, and Bluetooth module 1913 affixed to a common PCB 1914. Any suitable configuration of speaker 1911, microphone 1912, Bluetooth module 1913 and PCBs 1914 may be used in addition to the configurations depicted in FIGS. 20A, 20B, and 20C.

In an example, a wearable device system may comprise one or more speaker(s) 1911 and one or more microphone(s) 1912, with a pair of a speaker 1911 and a microphone 1912 affixed on a PCB 1914. Any suitable number of speakers 1911 and microphones 1912 may be included on a particular wearable device system. The positions and/or orientations of the speakers 1911 and microphones 1912 may be adjustable to optimize the recording of reflected signals.

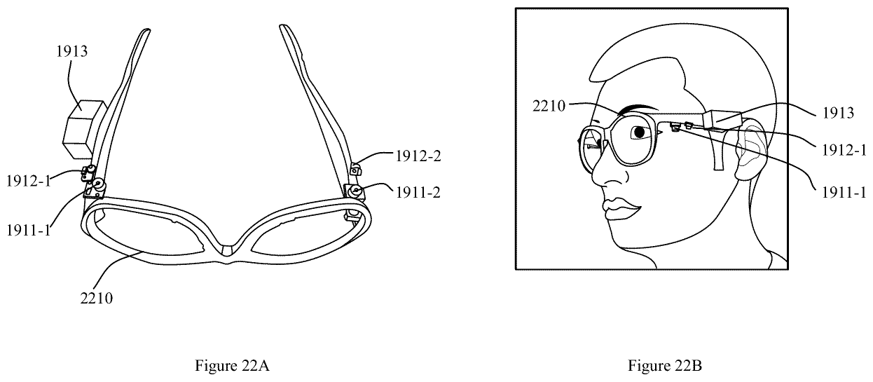

Returning to FIG. 19, acoustic sensor system based facial expression reconstruction system 1900 comprises data processing computing device 1920. Data processing computing device 1920 functions to receive data from Bluetooth module 1913 to construct a facial output. The facial output may comprise one of a facial movement, an avatar movement associated with the facial movement, a speech recognition, text associated with the speech recognition, a physical activity, an emotional status, a two-dimensional visualization of a facial expression, a three-dimensional visualization of a facial expression, an emoji associated with a facial expression, or an avatar image associated with a facial expression. Data processing computing device 1920 may be a smart phone, a mobile device, or any type of computing device described herein with reference to FIG. 31. Data processing computing device 1920 comprises central processing unit 121, graphics processing unit 122, memory 123, communication application 124, and data processing module 1930. Central processing unit 121, graphics processing unit 122, memory 123, and communication application 124 were previously described herein with reference to FIG. 1. Data processing module 1930 is described in greater detail herein with reference to FIG. 21.

FIG. 21 is a block diagram depicting a data processing module 1930, in accordance with certain examples. Data processing module 1930 comprises central processing unit 131, modeling application 132, data storage unit 133, and communication application 134. Central processing unit 131, modeling application 132, data storage unit 133, and communication application 134 were previously described herein with reference to FIG. 1.

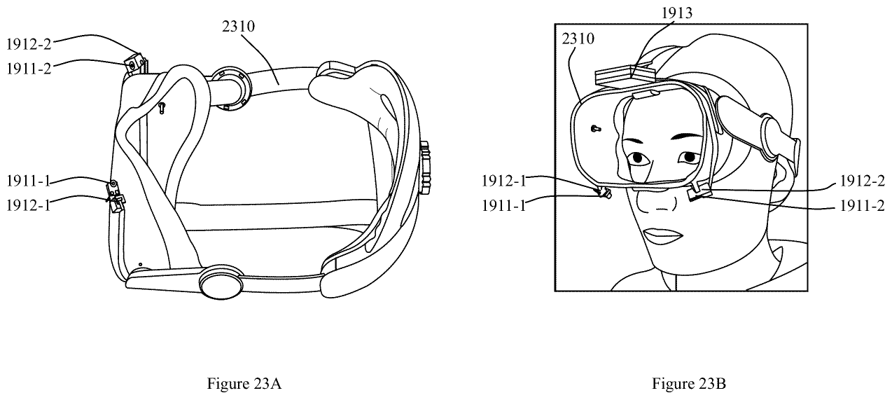

FIG. 22A depicts a first embodiment of a head-mounted acoustic sensor system wearable device 2210. As illustrated in FIG. 22A, the head-mounted acoustic sensor system wearable device 2210 is more particularly implemented as a glasses style wearable device 2210 (also referred to herein as glasses device 2210). Glasses device 2210 comprises two speakers 1911-1 and 1911-2, two microphones 1912-1 and 1912-2, and a Bluetooth module 1913. While two speakers 1911 and two microphones 1912 are depicted, any suitable quantity of speakers 1911 and microphones 1912 may be used.

FIG. 22B is an illustration depicting the first embodiment of the head-mounted acoustic sensor system wearable device 2210 on a user. As illustrated in FIG. 22B, glasses device 2210 may be positioned on a user such that a pair of speaker 1911-1 and microphone 1912-1 are located on the left side of the user's face and a pair of speaker 1911-2 and microphone 1912-2 are located on the right side of the user's face. The disposition of each pair on the left and right side of the user allows data associated with skin deformations to be collected for the left and right contours of the user's face.

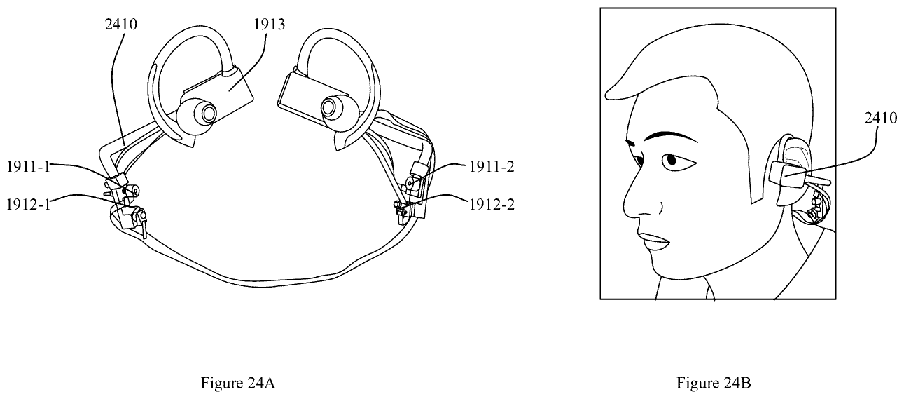

FIG. 23A depicts a second embodiment of a head-mounted acoustic sensor system wearable device 2310. As illustrated in FIG. 23A, the head-mounted acoustic sensor system wearable device 2310 is more particularly implemented as a headset style wearable device 2310 (also referred to herein as headset device 2310). In an example, headset device 2310 may be a virtual reality headset. Headset device 2310 comprises two speakers 1911-1 and 1911-2, two microphones 1912-1 and 1912-2, and a Bluetooth module 1913 (depicted in FIG. 23B). While two speakers 1911 and two microphones 1912 are depicted, any suitable quantity of speakers 1911 and microphones 1912 may be used.

FIG. 23B is an illustration depicting the second embodiment of the head-mounted acoustic sensor system wearable device 2310 on a user. As illustrated in FIG. 23B, headset device 2310 may be positioned on a user such that a pair of speaker 1911-1 and microphone 1912-1 are located on the left side of the user's face and a pair of speaker 1911-2 and microphone 1912-2 are located on the right side of the user's face. The disposition of each pair on the left and right side of the user allows data associated with skin deformations to be collected for the left and right contours of the user's face.

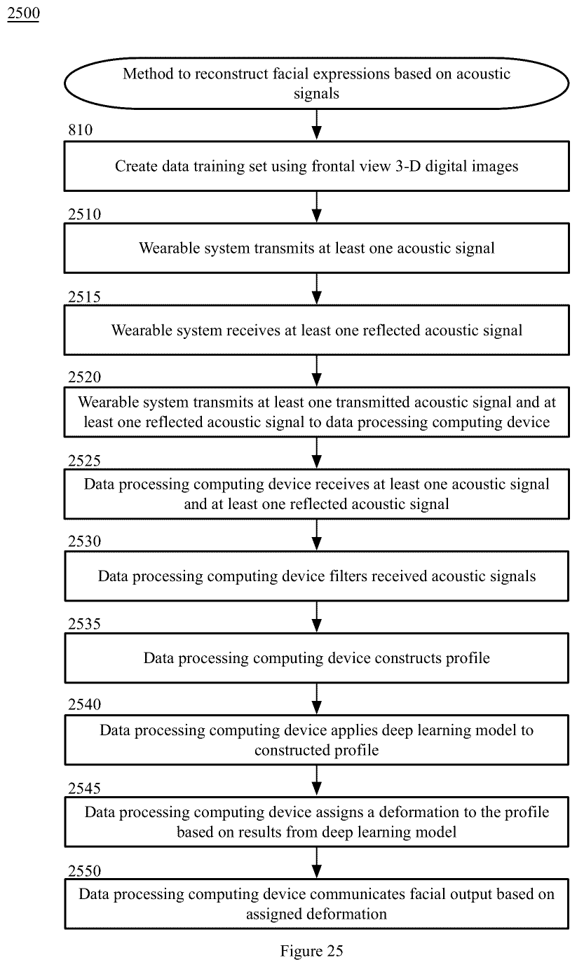

FIG. 24A depicts a third embodiment of a head-mounted acoustic sensor system wearable device 2410. As illustrated in FIG. 24A, the head-mounted acoustic sensor system wearable device 2410 is more particularly implemented as a headphone style wearable device 2410 (also referred to herein as headphone device 2410). In an example, headphone device 2410 may be a headband style headphone, ear pods, earphones, ITE headphones, over the ear headphones, or any other headphone type device. Headphone device 2410 comprises two speakers 1911-1 and 1911-2, two microphones 1912-1 and 1912-2, and a Bluetooth module 1913. While two speakers 1911 and two microphones 1912 are depicted, any suitable quantity of speakers 1911 and microphones 1912 may be used.

FIG. 24B is an illustration depicting the third embodiment of the head-mounted acoustic sensor system wearable device 2410 on a user. As illustrated in FIG. 24B, headphone device 2410 may be positioned on a user such that a pair of speaker 1911-1 and microphone 1912-1 are located on the left side of the user's face and a pair of speaker 1911-2 and microphone 1912-2 are located on the right side of the user's face. The disposition of each pair on the left and right side of the user allows data associated with skin deformations to be collected for the left and right contours of the user's face.

As described herein, FIGS. 22A, 23A, and 24A depict example embodiments of a head-mounted acoustic sensor system wearable device. Other example embodiments may include ear buds, ear pods, in-the-ear (“ITE”) headphones, over-the-ear headphones, outside-the-ear (“OTE”) headphones, glasses, smart glasses, a visor, a hat, a helmet, headgear, a virtual reality headset, another head-borne device, a necklace, a neckband, a garment-attachable system, or any other type of device or system to which at least one acoustic sensor system 1910 may be affixed.

### Alternate Embodiment Example Processes

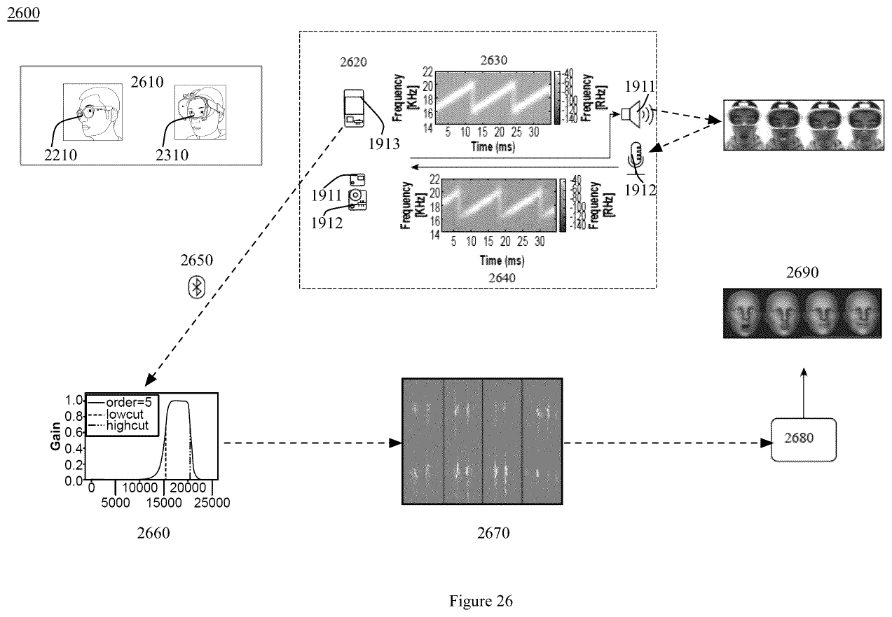

FIG. 25 is a block flow diagram depicting a method 2500 to reconstruct facial expressions based on acoustic signals, in accordance with certain examples. In block 810, a data training set is created using frontal view digital images. Block 810 was previously described herein with reference to method 810 of FIG. 9.

In block 2510, a wearable system transmits at least one acoustic signal. The wearable system may be a system as described herein with reference to glasses device 2210, headset device 2310, headphone device 2410. In an example, the wearable system may include other embodiments such as ear buds, ear pods, ITE headphones, over-the-ear headphones, OTE headphones, glasses, smart glasses, a visor, a hat, a helmet, headgear, a virtual reality headset, another head-borne device, a necklace, a neckband, a garment-attachable system, or any other type of device or system to which at least one acoustic sensor system 1910 may be affixed. In an example, the wearable system is positioned on a wearer such that the distance from the wearable system to the wearer's face is less than 10 cm, 11 cm, 12 cm, 13 cm, 14 cm, 15 cm, or any suitable distance. The at least one acoustic signal is transmitted by a speaker 1911 of at least one acoustic sensor system 1910. Acoustic sensor system 1910 may be configured to transmit signals in a frequency range of 16-24 kHz. Any suitable frequency range may be used. Acoustic sensor system 1910 may transmit signals that are FMCW transmissions, CIR transmissions, or any other suitable type of acoustic signal. In an example, the transmitted signals have an associated sample length. For example, the sample length may be set to 600 corresponding to a sample length of 0.012 seconds. In this example, approximately 83.3 frames may be collected per second. Any suitable sample length may be used. In an example, acoustic sensor system 1910 transmits inaudible acoustic signals within the frequency range of 16 kHz to 24 kHz towards a wearer's face. In an example, acoustic sensor system 1910 may be positioned on the wearable system to transmit acoustic signals towards a first facial feature on a first side of a sagittal plane of a wearer and to transmit acoustic signals towards a second facial feature on a second side of the sagittal plane of a wearer. In an example, acoustic sensor system 1910 may be positioned on the wearable system to transmit acoustic signals towards an underside contour of a chin of a wearer.

In block 2515, the wearable system receives at least one reflected acoustic signal. Subsequent to transmitting the at least one acoustic signal toward a wearer's face as described herein with reference to block 2510, the signal is reflected by the wearer's face. The at least one reflected acoustic signal is received by microphone 1912 of the at least one acoustic sensor system 1910. The at least one transmitted signal is reflected differently to microphone 1912 based on skin deformations associated with different facial movements.

In block 2520, the wearable system transmits the at least one transmitted acoustic signal and the at least one reflected acoustic signal to data processing computing device 1920. In an example, the at least one transmitted acoustic signal and the at least one reflected acoustic signal are transmitted in frames. The at least one transmitted acoustic signal and the at least one reflected acoustic signal are transmitted by the Bluetooth module 1913 of the at least one acoustic sensor system 1910.

In block 2525, data processing computing device 1920 receives the at least one transmitted acoustic signal and the at least one reflected acoustic signal.

In block 2530, data processing computing device 1920 filters the received acoustic signals. In an example, the at least one transmitted acoustic signal and the at least one reflected acoustic signal are filtered to remove noise outside of a target frequency range. In an example, the target frequency range is 15.5 kHz to 20.5 kHz. Any suitable target frequency range may be used. In an example, the at least one transmitted acoustic signal and the at least one reflected acoustic signal are filtered using a Butterworth band-pass filter. Any suitable filter may be used.

In block 2535, data processing computing device 1920 constructs a profile using the filtered acoustic signals. In an example, the profile is an echo profile. The echo profile is determined by calculating a cross-correlation between the filtered at least one transmitted acoustic signal and the filtered at least one reflected acoustic signal. The echo profile depicts deformations of the skin of the wearer's face in temporal and spatial domains. In an example, a differential echo profile may be calculated. A differential echo profile is calculated by subtracting echo profiles between two adjacent echo frames. The differential echo profile removes static objects that may be present in the echo profile. Further, as the wearable system was positioned to be less than 10-15 cm away from a wearer's face, echo profiles comprising distance greater than that range may also be removed. For example, echo profiles with a distance greater than ±16 cm, ±17 cm, ±18 cm, or any other suitable distance may be removed. In an example, the transmitted acoustic signal is an FMCW signal from which the echo profile is constructed. In alternate examples, the transmitted acoustic signal may be a CIR signal with global system for mobiles (“GSM”), characteristic impedance (“ZC”), or Barker sequence encoding; angle of arrival (“AoA”); doppler effect; or phase change detection.

In block 2540, data processing computing device 1920 applies a deep learning model to the constructed profile. The deep-learning model for facial expression reconstruction was previously described herein with reference to the processes and methods of FIG. 4, FIG. 5, and FIG. 14. In an example with reference to acoustic data, a sliding window of one second may be applied to the differential echo profiles to provide 84 frames of differential echo profiles in each window. In an example, each differential echo profile may have approximately 200 data points providing an input vector of size 200×84. The input vector is used in the deep learning model along with the training data to estimate facial expressions.

In block 2545, data processing computing device 1920 assigns a deformation to the constructed profile based on the results of the deep learning model. In an example, the assigned deformation has a predetermined degree of correspondence to a selected one of a plurality of deformations in the deep learning model.

In block 2550, the data processing computing device 1920 communicates a facial output based on the assigned deformation. In an example, the facial output comprises one of a facial movement, an avatar movement associated with the facial movement, a speech recognition, text associated with the speech recognition, a physical activity, an emotional status, a two-dimensional visualization of a facial expression, a three-dimensional visualization of a facial expression, an emoji associated with a facial expression, or an avatar image associated with a facial expression. In an example, the facial output is communicated to user computing device 150. In an example, the facial output is communicated in real time. In an example, the facial output is continuously updated.

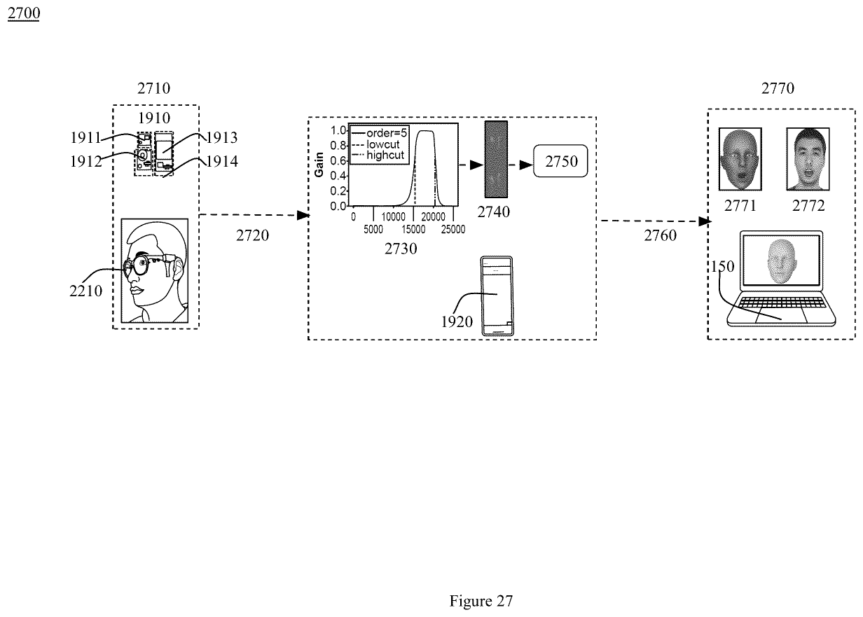

FIG. 26 is a diagram 2600 depicting an acoustic sensor system based facial expression reconstruction process. FIG. 26 is a visual depiction of the method 2500 described herein with reference to FIG. 25. At 2610, a wearer is depicted with glasses device 2210 and headset device 2310. In an example, a wearer may select a wearable device from the various embodiments previously described herein. At 2620, speaker 1911, microphone 1912, and Bluetooth module 1913 of an acoustic sensor system 1910 of the wearable device are illustrated. At 2630, an acoustic signal is depicted as being transmitted by speaker 1911 and directed to the wearer's face. At 2630, the acoustic signal is deflected by the wearer's face and received by microphone 1912 at 2640. At 2650, the transmitted acoustic signal and the deflected acoustic signal are transmitted to data processing computing device 1920 (not depicted) by Bluetooth module 1913. At 2660, the transmitted acoustic signal and the deflected acoustic signal are filtered. At 2670, differential echo profiles are depicted. At 2680, the differential echo profiles are input into a deep learning model. At 2690, predicted facial expressions are depicted.

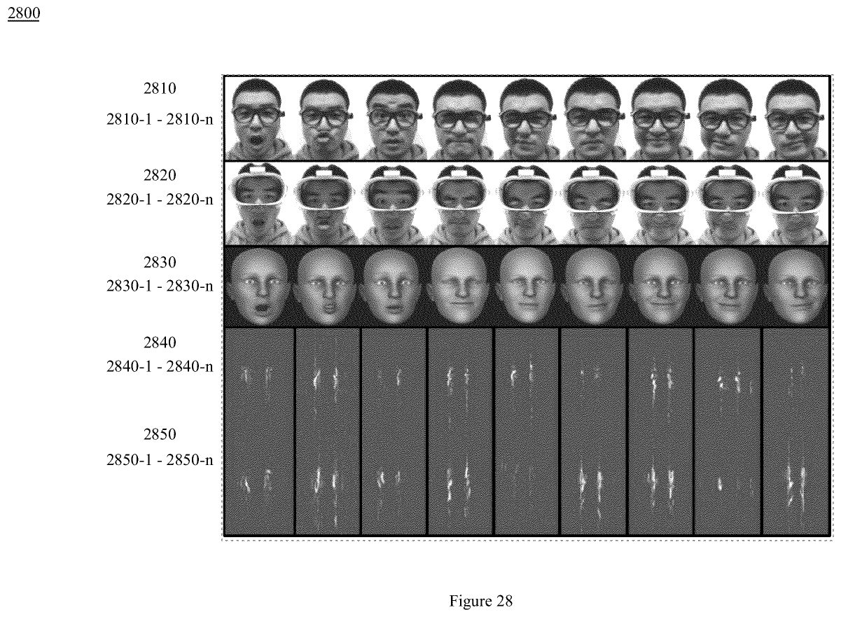

FIG. 27 is a diagram 2700 depicting an acoustic sensor system based facial expression reconstruction output process. FIG. 27 is a second visual depiction of the method 2500 described herein with reference to FIG. 25. At 2710, a wearer is depicted with glasses device 2210 with an acoustic sensor system 1910 comprising speaker 1911, microphone 1912, Bluetooth module 1913, and PCB 1914. At 2720, acoustic data, i.e., transmitted acoustic signal and deflected acoustic signal, are transmitted by acoustic sensor system 1910 to data processing computing device 1920. At 2730, the transmitted acoustic signal and the deflected acoustic signal are filtered. At 2740, differential echo profiles are depicted. At 2750, the differential echo profiles are input into a deep learning model. At 2760, data processing computing device 1920 transmits the output of the deep learning model to user computing device 150. At 2770, example facial outputs are depicted as received by user computing device 150. Example facial outputs may be a 3D avatar, such as depicted at 2771, or a personalized avatar, such as depicted at 2772.

FIG. 28 is a diagram 2800 depicting the correlation between frontal view camera images 2810 and 2820, predicted facial expressions 2830, and left and right differential echo profiles, 2840 and 2850 respectively, also referred to herein as respective rows 2810 through 2850, in accordance with certain examples. Rows 2810 and 2820 illustrate frontal view camera images of a user. To construct a training data set or “ground truth,” frontal view camera images of a user are acquired, via an imaging capturing device, with the user making various different facial expressions as depicted in images 2810-1 through 2810-n and images 2820-1 through 2820-n. The method to create the training data set from the frontal view camera images is described herein in greater detail with reference to method 810 of FIG. 9. Row 2840 depicts left differential echo profiles 2840-1 through 2840-n captured by a head-mounted, wearable device, such as glasses device 2210 or headset device 2310 described herein with reference to FIG. 22 and FIG. 23. Row 2850 depicts right differential echo profiles 2850-1 through 2850-n captured by a head-mounted, wearable device, such as glasses device 2210 or headset device 2310 described herein with reference to FIG. 22 and FIG. 23. Left differential echo profiles 2840 and right differential echo profiles 2850 are input into a deep learning model, as previously described herein, to create the predicted facial expressions depicted at 2830. Predicted facial expressions 2830-1 through 2830-n are illustrated in FIG. 28 beneath the frontal view camera images in rows 2810-1 through 2810-n and 2820-1 through 2820-n to illustrate the accuracy of the predicted facial expressions 2830.

FIG. 29 is a diagram 2900 depicting the correlation between frontal view camera images 2910, training data 2920, predicted facial expressions 2930, and left and right differential echo profiles, 2940 and 2950 respectively, also referred to herein as respective rows 2910 through 2950. Row 2910 illustrates frontal view camera images of a user. To construct a training data set or “ground truth,” frontal view camera images of a user are acquired, via an imaging capturing device, with the user making various different facial expressions as depicted in images 2910-1 through 2910-n. The method to create the training data set from the frontal view camera images is described herein in greater detail with reference to method 810 of FIG. 9. Row 2920 depicts a training data image or ground truth for the frontal view camera images in row 2910. Training data images 2920-1 through 2920-n correspond with frontal view camera images 2910-1 through 2910-n. Row 2940 depicts left differential echo profiles 2940-1 through 2940-n captured by a head-mounted, wearable device. Row 2950 depicts right differential echo profiles 2950-1 through 2950-n captured by a head-mounted, wearable device. Left differential echo profiles 2940 and right differential echo profiles 2950 are input into a deep learning model, as previously described herein, to create the predicted facial expressions depicted at 2930. Predicted facial expressions 2930-1 through 2930-n are illustrated in FIG. 29 beneath the ground truth images 2920-1 through 2920-n to illustrate the accuracy of the predicted facial expressions 2930.

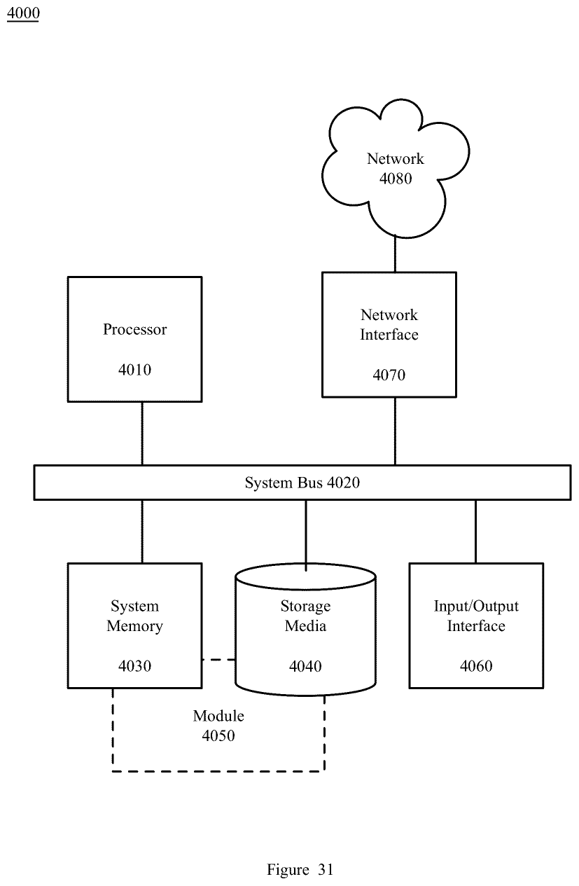

FIG. 30A is a diagram depicting the correlation between frontal view camera images of an open mouth 3010, a left view image 3015, a left and right echo profile, 3020 and 3025 respectively, and a right view image 3030. The skin deformations, depicted in left view images 3015-1 through 3015-n and right view images 3030-1 through 3030-n, created by the various facial expressions 3010-1 through 3010-n result in distinctive patterns changes depicted in left echo profiles 3020-1 through 3020-n and right echo profiles 3025-1 through 3025-n. FIG. 30B is a diagram depicting the correlation between frontal view camera images of a right sneer 3035, a left view image 3040, a left and right echo profile, 3045 and 3050 respectively, and a right view image 3055. The skin deformations, depicted in left view images 3040-1 through 3040-n and right view images 3055-1 through 3055-n, created by the various facial expressions 3035-1 through 3035-n result in distinctive patterns changes depicted in left echo profiles 3045-1 through 3045-n and right echo profiles 3050-1 through 3050-n.

While acoustic sensing technology may be used to determine facial expressions by detecting skin deformations, acoustic sensing technology may be used to directly determine other outputs associated with skin deformation without the need to first determine facial expressions. For example, the acoustic sensing technology may track blinking patterns and eyeball movements of a user. Blinking patterns and eyeball movements can be applied to the diagnosis and treatment processes of eye diseases. The acoustic sensing technology may detect movements of various parts of the face associated with speech, whether silent or voiced. While speaking, different words and/or phrases lead to subtle, yet distinct, skin deformations. The acoustic sensing technology can capture the skin deformation to recognize silent speech or to vocalize sound. By tracking subtle skin deformations, the acoustic sensing technology can be used to synthesize voice. The acoustic sensing technology may also be used to recognize and track physical activities. For example, while eating, a user opens the mouth, chews, and swallows. During each of those movements, the user's skin deforms in a certain way such that opening the mouth is distinguishable from chewing and from swallowing. The detected skin deformations may be used to determine the type and quantity of food consumed by a user. Similar to eating, a type and quantity of a consumed drink may be determined by skin deformation. The acoustic sensing technology may also be used to determine an emotional status of a user. An emotional status may be related to skin deformations. By detecting skin deformations, an emotional status can be determined and reported to corresponding applications. In an example, acoustic sensor system based facial expression reconstruction system 1900, described herein with reference to FIG. 19, may be configured to directly determine the other outputs associated with skin deformation without the need to first determine facial expressions, including, but not limited to, facial movements including eyeball movement, speech recognition, physical activities, and emotional status. Acoustic sensor system based facial expression reconstruction system 1900 may be configured to directly determine the other outputs associated with skin deformation using any type of acoustic sensor system 1910 as described herein with reference to FIG. 19.

### Other Examples

FIG. 31 depicts a computing machine 4000 and a module 4050 in accordance with certain examples. The computing machine 4000 may correspond to any of the various computers, servers, mobile devices, embedded systems, or computing systems presented herein. The module 4050 may comprise one or more hardware or software element(s) configured to facilitate the computing machine 4000 in performing the various methods and processing functions presented herein. The computing machine 4000 may include various internal or attached components such as a processor 4010, system bus 4020, system memory 4030, storage media 4040, input/output interface 4060, and a network interface 4070 for communicating with a network 4080.

The computing machine 4000 may be implemented as a conventional computer system, an embedded controller, a laptop, a server, a mobile device, a smartphone, a set-top box, a kiosk, a router or other network node, a vehicular information system, one or more processor(s) associated with a television, a customized machine, any other hardware platform, or any combination or multiplicity thereof. The computing machine 4000 may be a distributed system configured to function using multiple computing machines interconnected via a data network or bus system.

The processor 4010 may be configured to execute code or instructions to perform the operations and functionality described herein, manage request flow and address mappings, and to perform calculations and generate commands. The processor 4010 may be configured to monitor and control the operation of the components in the computing machine 4000. The processor 4010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 4010 may be a single processing unit, multiple processing units, a single processing core, multiple processing cores, special purpose processing cores, co-processors, or any combination thereof. The processor 4010 along with other components of the computing machine 4000 may be a virtualized computing machine executing within one or more other computing machine(s).

The system memory 4030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 4030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 4030. The system memory 4030 may be implemented using a single memory module or multiple memory modules. While the system memory 4030 is depicted as being part of the computing machine 4000, one skilled in the art will recognize that the system memory 4030 may be separate from the computing machine 4000 without departing from the scope of the subject technology. It should also be appreciated that the system memory 4030 may include, or operate in conjunction with, a non-volatile storage device such as the storage media 4040.

The storage media 4040 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 4040 may store one or more operating system(s), application programs and program modules such as module 4050, data, or any other information. The storage media 4040 may be part of, or connected to, the computing machine 4000. The storage media 4040 may also be part of one or more other computing machine(s) that are in communication with the computing machine 4000 such as servers, database servers, cloud storage, network attached storage, and so forth.

The module 4050 may comprise one or more hardware or software element(s) configured to facilitate the computing machine 4000 with performing the various methods and processing functions presented herein. The module 4050 may include one or more sequence(s) of instructions stored as software or firmware in association with the system memory 4030, the storage media 4040, or both. The storage media 4040 may therefore represent machine or computer readable media on which instructions or code may be stored for execution by the processor 4010. Machine or computer readable media may generally refer to any medium or media used to provide instructions to the processor 4010. Such machine or computer readable media associated with the module 4050 may comprise a computer software product. It should be appreciated that a computer software product comprising the module 4050 may also be associated with one or more process(es) or method(s) for delivering the module 4050 to the computing machine 4000 via the network 4080, any signal-bearing medium, or any other communication or delivery technology. The module 4050 may also comprise hardware circuits or information for configuring hardware circuits such as microcode or configuration information for an FPGA or other PLD.

The input/output (“I/O”) interface 4060 may be configured to couple to one or more external device(s), to receive data from the one or more external device(s), and to send data to the one or more external device(s). Such external devices along with the various internal devices may also be known as peripheral devices. The I/O interface 4060 may include both electrical and physical connections for operably coupling the various peripheral devices to the computing machine 4000 or the processor 4010. The I/O interface 4060 may be configured to communicate data, addresses, and control signals between the peripheral devices, the computing machine 4000, or the processor 4010. The I/O interface 4060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 4060 may be configured to implement only one interface or bus technology. Alternatively, the I/O interface 4060 may be configured to implement multiple interfaces or bus technologies. The I/O interface 4060 may be configured as part of, all of, or to operate in conjunction with, the system bus 4020. The I/O interface 4060 may include one or more buffer(s) for buffering transmissions between one or more external device(s), internal device(s), the computing machine 4000, or the processor 4010.

The I/O interface 4060 may couple the computing machine 4000 to various input devices including mice, touch-screens, scanners, electronic digitizers, sensors, receivers, touchpads, trackballs, cameras, microphones, keyboards, any other pointing devices, or any combinations thereof. The I/O interface 4060 may couple the computing machine 4000 to various output devices including video displays, speakers, printers, projectors, tactile feedback devices, automation control, robotic components, actuators, motors, fans, solenoids, valves, pumps, transmitters, signal emitters, lights, and so forth.

The computing machine 4000 may operate in a networked environment using logical connections through the network interface 4070 to one or more other system(s) or computing machines across the network 4080. The network 4080 may include WANs, LANs, intranets, the Internet, wireless access networks, wired networks, mobile networks, telephone networks, optical networks, or combinations thereof. The network 4080 may be packet switched, circuit switched, of any topology, and may use any communication protocol. Communication links within the network 4080 may involve various digital or an analog communication media such as fiber optic cables, free-space optics, waveguides, electrical conductors, wireless links, antennas, radio-frequency communications, and so forth.

The processor 4010 may be connected to the other elements of the computing machine 4000 or the various peripherals discussed herein through the system bus 4020. It should be appreciated that the system bus 4020 may be within the processor 4010, outside the processor 4010, or both. Any of the processor 4010, the other elements of the computing machine 4000, or the various peripherals discussed herein may be integrated into a single device such as a system on chip (“SOC”), system on package (“SOP”), or ASIC device.

Examples may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing examples in computer programming, and the examples should not be construed as limited to any one set of computer program instructions. Further, a skilled programmer would be able to write such a computer program to implement an example of the disclosed examples based on the appended flow charts and associated description in the application text. Therefore, disclosure of a particular set of program code instructions is not considered necessary for an adequate understanding of how to make and use examples. Further, those skilled in the art will appreciate that one or more aspect(s) of examples described herein may be performed by hardware, software, or a combination thereof, as may be embodied in one or more computing system(s). Moreover, any reference to an act being performed by a computer should not be construed as being performed by a single computer as more than one computer may perform the act.

The examples described herein can be used with computer hardware and software that perform the methods and processing functions described herein. The systems, methods, and procedures described herein can be embodied in a programmable computer, computer-executable software, or digital circuitry. The software can be stored on computer-readable media. Computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (“FPGA”), etc.

The systems, methods, and acts described in the examples presented previously are illustrative, and, alternatively, certain acts can be performed in a different order, in parallel with one another, omitted entirely, and/or combined between different examples, and/or certain additional acts can be performed, without departing from the scope and spirit of various examples. Accordingly, such alternative examples are included in the scope of the following claims, which are to be accorded the broadest interpretation so as to encompass such alternate examples.

Although specific examples have been described above in detail, the description is merely for purposes of illustration. It should be appreciated, therefore, that many aspects described above are not intended as essential elements unless explicitly stated otherwise. Modifications of, and equivalent components or acts corresponding to, the disclosed aspects of the examples, in addition to those described above, can be made by a person of ordinary skill in the art, having the benefit of the present disclosure, without departing from the spirit and scope of examples defined in the following claims, the scope of which is to be accorded the broadest interpretation so as to encompass such modifications and equivalent structures.

Various embodiments are described herein. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). Reference throughout this specification to “one embodiment,” “an embodiment,” “an example embodiment,” or other similar language means that a particular feature, structure, or characteristic described in connection with the embodiment is included in at least one embodiment of the invention described herein. Thus, appearances of the phrases “in one embodiment,” “in an embodiment,” “an example embodiment,” or other similar language in various places throughout this specification are not necessarily all referring to the same embodiment. Furthermore, the particular features, structures, or characteristics may be combined in any suitable manner in one or more embodiment(s), as would be apparent to a person having ordinary skill in the art and the benefit of this disclosure. Furthermore, while some embodiments described herein include some, but not other, features included in other embodiments, combinations of features of different embodiments are meant to be within the scope of the invention. For example, in the appended claims, any of the claimed embodiments can be used in any combination.

The following examples are presented to illustrate the present disclosure. The examples are not intended to be limiting in any manner.

Example 1 is a wearable system, comprising: at least one acoustic sensor system configured to transmit at least one acoustic signal, to receive at least one reflected acoustic signal, and to output the at least one transmitted acoustic signal and the at least one received reflected acoustic signal; a processor that receives the at least one transmitted acoustic signal and the at least one received reflected acoustic signal from each of the at least one acoustic sensor system; and a physical memory, the physical memory comprising instructions that when executed by the processor cause the processor to: calculate a profile associated with the at least one transmitted acoustic signal and the at least one received reflected acoustic signal; assign a deformation to the profile, the assigned deformation having a predetermined degree of correspondence to a selected one of a plurality of deformations in a model when compared to the profile; and communicate a facial output based on the assigned deformation.

Example 2 includes the subject matter of Example 1, wherein the at least one acoustic sensor system comprises at least one speaker and at least one microphone.

Example 3 includes the subject matter of Examples 1 and 2, wherein the at least one acoustic sensor system comprises a Bluetooth low energy (“BLE”) module to output the at least one transmitted acoustic signal and the at least one received reflected acoustic signal.

Example 4 includes the subject matter of any of Examples 1-3, wherein the at least one transmitted acoustic signal is a frequency modulation continuous wave (“FMCW”) signal.

Example 5 includes the subject matter of any of Examples 1-4, wherein the profile is a differential echo profile.

Example 6 includes the subject matter of any of Examples 1-5, wherein the deformation is a skin deformation.

Example 7 includes the subject matter of any of Examples 1-6, wherein the communicated facial output comprises one of a facial movement, an avatar movement associated with the facial movement, a speech recognition, text associated with the speech recognition, a physical activity, an emotional status, a two-dimensional visualization of a facial expression, a three-dimensional visualization of a facial expression, an emoji associated with a facial expression, or an avatar image associated with a facial expression.

Example 8 includes the subject matter of any of Examples 1-7, the at least one acoustic sensor system positioned on the wearable system to transmit acoustic signals towards a first facial feature on a first side of a sagittal plane of a wearer and to transmit acoustic signals towards a second facial feature on a second side of the sagittal plane of a wearer.

Example 9 includes the subject matter of any of Examples 1-8, the at least one acoustic sensor system positioned on the wearable system to transmit acoustic signals towards an underside contour of a chin of a wearer.

Example 10 includes the subject matter of any of Examples 1-9, the wearable system comprising ear buds, ear pods, in-the-ear (ITE) headphones, over-the-ear headphones, or outside-the-ear (OTE) headphones to which the at least one acoustic sensor system is attached.

Example 11 includes the subject matter of any of Examples 1-10, the wearable system comprising glasses, smart glasses, a visor, a hat, a helmet, headgear, a virtual reality headset, or another head-borne device to which the at least one acoustic sensor system is attached.

Example 12 includes the subject matter of any of Examples 1-11, the wearable system comprising a necklace, a neckband, or a garment-attachable system to which the at least one acoustic sensor system is attached.

Example 13 includes the subject matter of any of Examples 1-12, further comprising a computing device that receives and displays the communicated facial output.

Example 14 includes the subject matter of any of Examples 1-13, wherein the model is trained using machine learning.

Example 15 includes the subject matter of any of Examples 1-14, wherein the training comprises: receiving one or more frontal view facial image(s) of a subject, each of the frontal view facial images corresponding to a deformation of a plurality of deformations of the subject; receiving one or more transmitted acoustic signal(s) and one or more corresponding reflected acoustic signal(s) associated with the subject, each of the one or more transmitted acoustic signal(s) and the one or more corresponding reflected acoustic signal(s) from the at least one acoustic sensor system also corresponding to a deformation of the plurality of deformations of the subject; and correlating, for each of the deformations, the one or more transmitted acoustic signal(s) and the one or more corresponding reflected acoustic signal(s) from the at least one acoustic sensor system corresponding to a particular deformation to the one or more frontal view facial image(s) corresponding to the particular deformation.

Further examples are described below.

In some embodiments, a wearable system comprises at least one imaging sensor configured to capture one or more image(s) of a facial feature of a wearer of the wearable system and to output image data corresponding to the one or more image(s); a processor that receives the image data from each of the at least one imaging sensor; and a physical memory, the physical memory comprising instructions that when executed by the processor cause the processor to: generate a profile based on the image data from each of the at least one imaging sensor; compare the profile to a model; assign a deformation to the profile, the assigned deformation having a predetermined degree of correspondence to a selected one of a plurality of deformations in the model when compared to the profile; and communicate a facial output based on the assigned deformation.

The at least one imaging sensor in some embodiments comprises an acoustic camera or an acoustic sensor configured to: transmit at least one acoustic signal towards the wearer's face, wherein the at least one acoustic signal is a frequency modulated continuous-wave acoustic signal with a frequency above 18 kHz and within a range of 18 kHz to 24.5 kHz, including all 0.1 kHz values and ranges therebetween; and detect at least one reflected acoustic signal from the wearer's face, wherein the at least one transmitted signal is reflected differently based on a change in eyeball shape and/or skin deformation associated with ocular movement.

In various examples, the at least one imaging sensor comprises a first imaging sensor and a second imaging sensor. In an example, the first imaging sensor and the second imaging sensor are configured to transmit acoustic signals within different frequency ranges, e.g., the first imaging sensor is configured to transmit acoustic signals in a frequency range of 18-21 kHz (including all 0.1 kHz values and ranges therebetween) and the second imaging sensor is configured to transmit acoustic signals in a frequency range of 21.5-24.5 kHz (including all 0.1 kHz values and ranges therebetween). In an example, the first imaging sensor and the second imaging sensor are configured in a symmetrical orientation on the wearable system relative to a sagittal plane of the wearer.

In some embodiments, the acoustic camera or the acoustic sensor comprise one or more speaker(s) and one or more microphone(s), each of the one or more speaker(s) configured to transmit the at least one signal towards the wearer's face and each of the one of more microphone(s) configured to receive the at least one reflected signal from the wearer's face.

In some embodiments, the image data comprises the at least one transmitted signal and the at least one reflected signal.

In some embodiments, generating the profile comprises: filtering the at least one transmitted signal and the at least one reflected signal; and calculating a cross-correlation between the at least one filtered transmitted signal and the at least one filtered reflected signal.

In some embodiments, filtering the at least one transmitted signal and the at least one reflected signal comprises removing data outside of a target frequency range.

As additional examples, the target frequency range is 17.5 kHz to 25 kHz, including all 0.1 kHz values and ranges therebetween.

In some embodiments, the assigned deformation is associated with a shape of the wearer's eyes and/or a deformation of skin in an orbital region around the wearer's eyes.

In some embodiments, wherein the communicated facial output comprises a gaze position of the wearer.

In some embodiments, the gaze position comprises one or more position coordinate(s) associated with a Cartesian coordinate system, a polar coordinate system, or a spherical coordinate system, or the like.

In some embodiments, the profile is an echo profile.

In some embodiments, comparing the profile to the model comprises: generating a second profile based on the image data; generating a differential profile based on the profile and the second profile; and comparing the differential profile to the model. As additional examples, the profile is an echo profile and the differential profile is a differential echo profile.

In some embodiments, the at least one imaging sensor is positioned on the wearable system to capture image data of a first facial feature on a first side of a sagittal plane of the wearer and to capture image data of a second facial feature on a second side of the sagittal plane of the wearer. As additional examples, the first facial feature and the second facial feature are each associated with an orbital region of the wearer.

In some embodiments, the at least one imaging sensor is positioned on the wearable system to capture image data of an orbital region of the wearer.

In some embodiments, the model is trained using machine learning or the like. As additional examples, the training comprises receiving one or more orbital region image(s) of a subject, each of the orbital region images corresponding to a gaze position of a plurality of gaze positions of the subject; receiving one or more image(s) of the subject from the at least one imaging sensor, each of the images from the at least one imaging sensor also corresponding to a gaze position of the plurality of gaze positions of the subject; and correlating, for each of the gaze positions, the one or more image(s) from the at least one imaging sensor corresponding to a particular gaze position to the one or more orbital region image(s) corresponding to the particular gaze position.

In some embodiments, the at least one imaging sensor comprises a first imaging sensor and a second imaging sensor, with the first imaging sensor positioned on the wearable system to capture first image data of a first facial feature of the wearer, and the second imaging sensor positioned on the wearable system to capture second image data of a second facial feature of the wearer, wherein comparing the profile to the model comprises comparing a first profile associated with the first image data of the first facial feature of the wearer to the model and comparing a second profile associated with the second image data of the second facial feature of the wearer to the model, wherein assigning a deformation to the profile comprises assigning a first deformation to the first profile and a second deformation to the second profile, and wherein the facial output is based on the assigned first deformation and the assigned second deformation. In some embodiments, the first imaging sensor and the second imaging sensor are configured to transmit acoustic signals within different frequency ranges.

In some embodiments, the first imaging sensor is configured to transmit acoustic signals in a frequency range of 18-21 kHz and the second imaging sensor is configured to transmit acoustic signals in a frequency range of 21.5-24.5 kHz.

In some embodiments, the first imaging sensor and the second imaging sensor are configured in a symmetrical orientation on the wearable system relative to a sagittal plane of the wearer.

In some embodiments, the first imaging sensor is positioned on the wearable system to capture image data of the first facial feature on a first side of a sagittal plane of the wearer, and the second imaging sensor is positioned on the wearable system to capture an image of the second facial feature on a second side of the sagittal plane of the wearer.

In some embodiments, the first facial feature comprises a left side of an orbital region of the wearer, and the second facial feature comprises a right side of the face of the orbital region of the wearer.

In some embodiments, the wearable system comprising glasses, smart glasses, goggles, spectacles, or another head-borne device to which the at least one imaging sensor is attached.

In some embodiments, the physical memory comprises further instructions that when executed by the processor cause the processor to: compare the assigned deformation to a second model; and assign the facial output based on the assigned deformation, the assigned facial output having a predetermined degree of correspondence to a selected one of a plurality of deformations in the second model when compared to the assigned deformation.

In some embodiments, the second model is trained using machine learning or the like. As additional examples, the training comprises receiving one or more orbital region image(s) of a subject, each of the orbital region images corresponding to a gaze position of a plurality of gaze positions of the subject; receiving one or more image(s) of the subject from the at least one imaging sensor, each of the images from the at least one imaging sensor also corresponding to a gaze position of the plurality of gaze positions of the subject; and correlating, for each of the gaze positions, the one or more image(s) from the at least one imaging sensor corresponding to a particular gaze position to the one or more orbital region image(s) corresponding to the particular gaze position.

In some embodiments, the wearable system further comprises a computing device that receives and displays the communicated facial output.

In some embodiments, the physical memory comprises further instructions that when executed by the processor cause the processor to: receive a second set of image data from each of the at least one imaging sensor; generate a second profile based on the second set of image data from each of the at least one imaging sensor; compare the second profile to the model; assign a second deformation to the second profile, the assigned second deformation having a predetermined degree of correspondence to a selected one of the plurality of deformations in the model when compared to the second profile; and communicate a second facial output based on the assigned second deformation.

In some embodiments, the wearable system further comprises a computing device that receives and displays the communicated facial output and the communicated second facial output, wherein the communicated facial output and the communicated second facial output are gaze positions of the wearer, the communicated second facial output being displayed subsequent to the communicated facial output to illustrate a motion of gaze positions.

Another illustrative embodiment provides a method to determine a facial output using a wearable system, comprising: positioning a first imaging sensor of a wearable system to image a first facial feature of a wearer; imaging the first facial feature of the wearer using the first imaging sensor; comparing, via a processor, the imaged first facial feature to a first model; and assigning, via the processor, a facial output corresponding to the imaged first facial feature selected from one of a plurality of facial outputs in the first model.

In some embodiments, the act of positioning the first imaging sensor of the wearable system comprises positioning the first imaging sensor in a vicinity of eyes of the wearer facing inward to include within a field of view an orbital region of one side of the wearer's face.

Another illustrative embodiment provides a method to determine a facial output using a wearable system, comprising: positioning a first imaging sensor of a wearable system to image a first facial feature of a wearer; positioning a second imaging sensor of the wearable system to image a second facial feature of the wearer; imaging the first facial feature of the wearer using the first imaging sensor; imaging the second facial feature of the wearer using the second imaging sensor; comparing, via a processor, the imaged first facial feature and the imaged second facial feature to a model; and assigning, via the processor, a facial output selected from one of a plurality of facial outputs in the model corresponding to the imaged first facial feature and the imaged second facial feature.

In additional embodiments, a wearable system comprises at least one imaging sensor configured to capture one or more image(s) of a facial feature of a wearer of the wearable system and to output image data corresponding to the one or more image(s); a processor that receives the image data from each of the at least one imaging sensor; and a physical memory, the physical memory comprising instructions that when executed by the processor cause the processor to: generate a profile based on the image data from each of the at least one imaging sensor; compare the profile to a model; assign a deformation to the profile, the assigned deformation having a predetermined degree of correspondence to a selected one of a plurality of deformations in the model when compared to the profile; and communicate a text output based on the assigned deformation.

In some embodiments, the at least one imaging sensor comprises an acoustic camera or an acoustic sensor configured to: transmit at least one acoustic signal towards the wearer's face, wherein the at least one acoustic signal is a frequency modulated continuous-wave acoustic signal with a frequency above 18 kHz and within a range of 18 kHz to 24.5 kHz, including all 0.1 kHz values and ranges therebetween; and detect at least one reflected acoustic signal from the wearer's face, wherein the at least one transmitted signal is reflected differently based on different facial expressions or movements of the wearer associated with speech.

In various examples, the at least one imaging sensor comprises a first imaging sensor and a second imaging sensor. In an example, the first imaging sensor and the second imaging sensor are configured to transmit acoustic signals within different frequency ranges, e.g., the first imaging sensor is configured to transmit acoustic signals in a frequency range of 18-21 kHz (including all 0.1 kHz values and ranges therebetween) and the second imaging sensor is configured to transmit acoustic signals in a frequency range of 21.5-24.5 kHz (including all 0.1 kHz values and ranges therebetween). In an example, the first imaging sensor and the second imaging sensor are configured in a symmetrical orientation on the wearable system relative to a sagittal plane of the wearer.

In some embodiments, the acoustic camera or the acoustic sensor comprise one or more speaker(s) and one or more microphone(s), each of the one or more speaker(s) configured to transmit the at least one signal towards the wearer's face and each of the one of more microphone(s) configured to receive the at least one reflected signal from the wearer's face.

In some embodiments, the one or more speaker(s) positioned on the wearable system on a first side of a sagittal plane of the wearer and the one or more microphone(s) positioned on a second side of a sagittal plane of the wearer.

In some embodiments, a path is formed between each of the one or more speaker(s) and each of the one or more microphone(s) such that each of the one or more microphone(s) is configured to receive a reflected signal from each of the one or more speaker(s). As an additional example, each formed path traverses one or more of one or more of a buccal region, an infraorbital region, an oral region, or a mental region of the wearer's face.

In some embodiments, the image data comprises the at least one transmitted signal and the at least one reflected signal.

In some embodiments, generating the profile comprises: filtering the at least one transmitted signal and the at least one reflected signal; and calculating a cross-correlation between the at least one filtered transmitted signal and the at least one filtered reflected signal.

In some embodiments, filtering the at least one transmitted signal and the at least one reflected signal comprises removing data outside of a target frequency range. As additional examples, the target frequency range is 17.5 kHz to 25 kHz, including all 0.1 kHz values and ranges therebetween.

In some embodiments, the assigned deformation is associated with a shape of the wearer's mouth and/or a deformation of skin in one or more of a buccal region, an infraorbital region, an oral region, or a mental region of the wearer's face.

In some embodiments, the communicated text output comprises a text representation of silent utterances of the wearer.

In some embodiments, the profile is an echo profile.

In some embodiments, comparing the profile to the model comprises: generating a second profile based on the image data; generating a differential profile based on the profile and the second profile; and comparing the differential profile to the model. As additional examples, the profile is an echo profile and the differential profile is a differential echo profile.

In some embodiments, the at least one imaging sensor is positioned on the wearable system to capture image data of a shape of the wearer's mouth and/or a deformation of skin in one or more of a buccal region, an infraorbital region, an oral region, or a mental region of the wearer's face.

In some embodiments, the model is trained using machine learning or the like. As an additional example, the training comprises receiving one or more facial image(s) of a subject, each of the facial images corresponding to a silent utterance of a plurality of silent utterances of the subject; receiving one or more image(s) of the subject from the at least one imaging sensor, each of the images from the at least one imaging sensor also corresponding to a silent utterance of the plurality of silent utterances of the subject; and correlating, for each of the silent utterances, the one or more image(s) from the at least one imaging sensor corresponding to a particular silent utterance to the one or more facial image(s) corresponding to the particular silent utterance.

In some embodiments, the one or more facial image(s) are associated with a shape of the wearer's mouth and/or a deformation of skin in one or more of a buccal region, an infraorbital region, an oral region, or a mental region of the wearer's face captured during silent utterances.

In some embodiments, the at least one imaging sensor comprises a first imaging sensor and a second imaging sensor, with the first imaging sensor positioned on the wearable system to capture first image data of a first facial feature of the wearer, and the second imaging sensor positioned on the wearable system to capture second image data of a second facial feature of the wearer, wherein comparing the profile to the model comprises comparing a first profile associated with the first image data of the first facial feature of the wearer to the model and comparing a second profile associated with the second image data of the second facial feature of the wearer to the model, wherein assigning a deformation to the profile comprises assigning a first deformation to the first profile and a second deformation to the second profile, and wherein the text output being based on the assigned first deformation and the assigned second deformation.

In some embodiments, the first imaging sensor and the second imaging sensor are configured to transmit acoustic signals within different frequency ranges. As additional examples, the first imaging sensor is configured to transmit acoustic signals in a frequency range of 18-21 kHz and the second imaging sensor is configured to transmit acoustic signals in a frequency range of 21.5-24.5 kHz.

In some embodiments, the first imaging sensor comprises one or more first speaker(s) and one or more first microphone(s), and the second imaging sensor comprises one or more second speaker(s) and one or more second microphone(s), wherein the one or more first speaker(s) and the one or more second speaker(s) are positioned on the wearable system on a first side of a sagittal plane of the wearer, and the one or more first microphone(s) and the one or more second microphone(s) are positioned on a second side of a sagittal plane of the wearer.

In some embodiments, the wearable system comprises glasses, smart glasses, goggles, spectacles, or another head-borne device to which the at least one imaging sensor is attached.

In some embodiments, the physical memory comprises further instructions that when executed by the processor cause the processor to: compare the assigned deformation to a second model; and assign the text output based on the assigned deformation, the assigned text output having a predetermined degree of correspondence to a selected one of a plurality of deformations in the second model when compared to the assigned deformation.

In some embodiments, the second model is trained using machine learning or the like. As additional examples, the training comprises receiving one or more facial image(s) of a subject, each of the facial images corresponding to a silent utterance of a plurality of silent utterances of the subject; receiving one or more image(s) of the subject from the at least one imaging sensor, each of the images from the at least one imaging sensor also corresponding to a silent utterance of the plurality of silent utterances of the subject; and correlating, for each of the silent utterances, the one or more image(s) from the at least one imaging sensor corresponding to a particular silent utterance to the one or more facial image(s) corresponding to the particular silent utterance.

In some embodiments, the wearable system comprises a computing device that receives and displays and/or vocalizes the communicated text output representing silent utterances of the wearer.

In some embodiments, the physical memory comprises further instructions that when executed by the processor cause the processor to: receive a second set of image data from each of the at least one imaging sensor; generate a second profile based on the second set of image data from each of the at least one imaging sensor; compare the second profile to the model; assign a second deformation to the second profile, the assigned second deformation having a predetermined degree of correspondence to a selected one of the plurality of deformations in the model when compared to the second profile; and communicate a second text output based on the assigned second deformation.

In some embodiments, the wearable system further comprises a computing device that receives and displays and/or vocalizes the communicated text output and the communicated second text output, wherein the communicated text output and the communicated second text output are silent utterances of the wearer, and the communicated second text output is displayed subsequent to the communicated text output to depict continuous utterances of words and/or phrases.

Another illustrative embodiment provides a method to determine a text output using a wearable system, comprising: positioning a first imaging sensor of a wearable system to image a first facial feature of a wearer; imaging the first facial feature of the wearer using the first imaging sensor; comparing, via a processor, the imaged first facial feature to a first model; and assigning, via the processor, a text output corresponding to the imaged first facial feature selected from one of a plurality of text outputs in the first model.

In some embodiments, the act of positioning the first imaging sensor of the wearable system comprises positioning the first imaging sensor facing inward to include a field of view of the wearer's mouth and/or one or more of a buccal region, an infraorbital region, an oral region, or a mental region of the wearer's face.

Another illustrative embodiment provides a method to determine a text output using a wearable system, comprising: positioning a first imaging sensor of a wearable system to image a first facial feature of a wearer; positioning a second imaging sensor of the wearable system to image a second facial feature of the wearer; imaging the first facial feature of the wearer using the first imaging sensor; imaging the second facial feature of the wearer using the second imaging sensor; comparing, via a processor, the imaged first facial feature and the imaged second facial feature to a model; and assigning, via the processor, a text output selected from one of a plurality of text outputs in the model corresponding to the imaged first facial feature and the imaged second facial feature.

### Additional Illustrative Embodiments

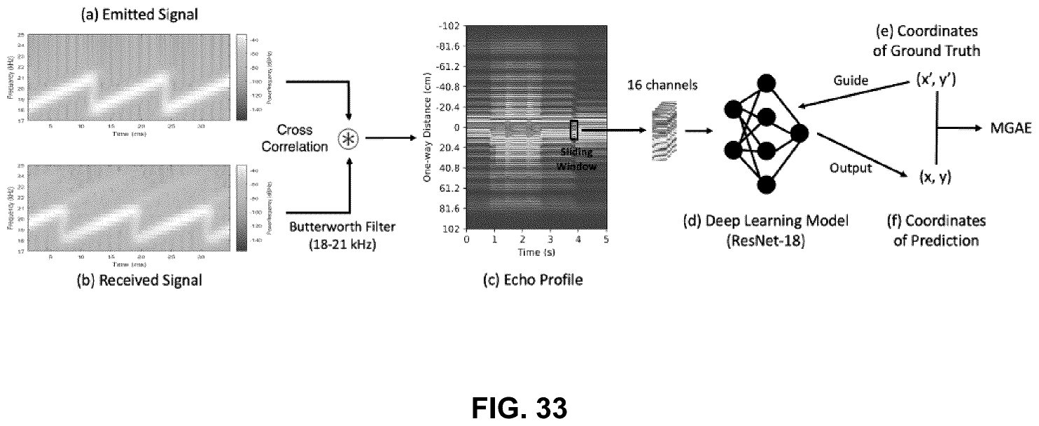

Additional illustrative embodiments will be described below with reference to FIGS. 32 through 41. These include additional embodiments relating to acoustic-based eye tracking, and additional embodiments relating to acoustic-based silent speech recognition.

### Additional Embodiments Relating to Acoustic-Based Eye Tracking

Illustrative embodiments relating to acoustic-based eye tracking will now be described in more detail with reference to FIGS. 32 to 35.

The acoustic-based eye tracking in some embodiments is implemented as an acoustic-based eye tracking system referred to herein as GazeTrak. GazeTrak is an acoustic-based eye tracking system on glasses, illustratively comprising one speaker and four microphones attached to each side of the glasses. These example acoustic sensors capture the formations of the eyeballs and the surrounding areas of a user wearing the glasses by emitting encoded inaudible sound towards the eyeballs and receiving the reflected signals. These reflected signals are further processed to calculate echo profiles, which are fed to a customized deep learning pipeline to continuously infer the gaze position. In a user study with 20 participants, GazeTrak achieves an accuracy of 3.6° within the same remounting session and 4.9° across different sessions with a refreshing rate of 83.3 Hz and a power signature of 287.9 mW. Furthermore, we describe the performance of the GazeTrak system fully implemented on an MCU with a low-power CNN accelerator, illustratively a MAX78002. In this configuration, the system runs at a frames per second (FPS) rate of up to 83.3 Hz and has a total power signature of 95.4 mW with a 30 Hz FPS.

Some conventional eye tracking technologies utilize cameras to capture gaze points. However, camera-based eye tracking solutions are known to have a relatively high power signature, which may not work well for smart glasses with a relatively small battery capacity. For instance, Tobii Pro Glass 3, which is considered one of the best eye tracking glasses, can only last for 1.75 hours with an extended battery capacity of 3400 mAh. When using the battery of a Google Glass (570 mAh), this eye tracking system can only last 18 minutes. The limited tracking time has hindered its ability to collect gaze point data in everyday life, which can be highly informative for many applications, such as, for example, monitoring users' mental or physical health conditions, gaze-based input, and attention and interest analysis.

Illustrative embodiments disclosed herein overcome these and other drawbacks of conventional systems such as the above-noted Tobii Pro Glass 3. For example, GazeTrak utilizes acoustic sensing to continuously track gaze points using an acoustic sensing system mounted on the frame of a pair of eyeglasses, also referred to herein as a “glass frame,” in a relatively low power, lightweight, and affordable manner. Its sensing principle is based on the fact that eyeballs are not perfectly spherical and rotating them would expose different shapes and stretch the skin around them with unique formations. This can provide highly valuable information for inferring gaze points. As indicated above, GazeTrak uses one speaker and four microphones arranged on each side of the glass frame. The speaker emits frequency-modulated continuous-wave (FMCW) acoustic signals with the frequency above 18 kHz towards the eyeballs. The microphones capture the signals reflected by the eyeballs and their surrounding areas, which are used to process and calculate the echo profiles. These echo profiles are fed to a customized deep learning algorithm based on ResNet-18 to predict the gaze point.

We conducted two rounds of user studies to evaluate the performance of GazeTrak. During the studies, each participant was asked to look at and follow the instruction points on the screen. In the first round of the study, 12 participants evaluated a first example implementation, in which the microphones and speakers were glued on a glass frame. The average cross-session tracking accuracy was 4.9°. It confirmed the optimal settings of the sensing system. A further example implementation was also developed, and will be described in more detail below.

FIG. 32 shows the further example implementation of the GazeTrak system, and illustrates echo profiles of different microphones when moving gaze to different regions of the screen. This example implementation as illustrated in the figure features a more compact form factor, significantly lowers signal strength, and improves environmental sustainability as it can be attached to different glasses.

As illustrated in FIG. 32, an example wearable 3200 of the GazeTrak system having a compact form factor comprises multiple instances of a speaker 3202 and multiple instances of a microphone 3204, arranged as shown in respective different positions on a glass frame 3205. More particularly, in this example embodiment, a single instance of speaker 3202 and four instances of microphone 3204 are deployed on each of respective right and left sides of the glass frame 3205. Also shown in the figure is an example view of a user wearing an implementation of the GazeTrak system, as well as an example MAX78002 evaluation kit and an illustration of the manner in which different eye fixations and movements are correlated with different patterns in echo profiles in illustrative embodiments.

To ensure consistent performance between the two example implementations, we conducted a second round of study with 10 participants, including some new participants, evaluating the second example implementation. The second example implementation achieved an average tracking accuracy of 4.9° for cross-session scenarios and 3.6° for in-session scenarios with a refreshing rate of 83.3 Hz.

Although the current accuracy of the GazeTrak system is less than that of commercial eye trackers such as Tobii Pro Glasses 3 and Pupil Labs Glasses, it is still comparable to some webcam-based eye tracking systems. Furthermore, due to the low-power feature of acoustic sensors, GazeTrak, including the data collection system, has a relatively low power signature of 287.9 mW. Compared to camera-based wearable eye tracking systems, this example eye tracking system reduces the power consumption by over 95%. If using a battery with the capacity similar to Tobii Pro Glasses 3, the GazeTrak system can extend the usage time from 1.75 hours to 38.5 hours. It can even last 6.4 hours on the battery of normal smart glasses, such as Google Glass. The power signature of the GazeTrak system can be further improved using an example microcontroller with a low-power CNN accelerator, illustratively the MAX78002, which is an example of what is more generally referred to herein as a microcontroller unit or MCU, or a microcontroller module. Hence, we implement the gaze tracking pipeline fully on MAX78002. With the refresh rate set as 30 Hz, the power consumption of the whole system including the data preprocessing and model inference is measured as 95.4 mW. The performance of the system remained robust under different noisy environments and with different styles of glass frames.

Illustrative embodiments also provide significant additional advantages relative to conventional webcam-based eye tracking platforms. For example, the positions of webcams are usually fixed and they have a relatively low resolution. Therefore, their performance can be more easily impacted by factors like lighting conditions, occlusions, camera orientations, etc. Also, frontal camera-based eye tracking systems such as Tobii Pro Fusion are mostly located at fixed positions and do not work well while users move to another position or are walking around. Other approaches utilize cameras on mobile phones or tablets to track eye movements. However, these eye tracking technologies based on mobile devices still require users to hold the mobile devices in front of their face all the time and cannot provide completely hands-free and motion-free experiences for users.

Despite acceptable tracking performance, current solutions to wearable eye tracking systems still have some limitations. For example, many existing eye tracking systems can only recognize discrete gestures, limiting their performance in applications that need continuous tracking of the eyes. Camera-based wearable eye trackers can provide high accuracy in continuous eye tracking, but cameras are usually power-hungry, which makes them relatively impractical while deployed in wearables that need to be worn in everyday settings. Also, changing lighting conditions can still be a problem for these camera-based systems, as the performance typically becomes worse in an outdoor setting. Besides, commercial eye trackers are usually expensive and do not provide open-source software for users, preventing them from being easily accessed and adapted by general users. Other known approaches can be adversely impacted by direct sunlight and glasses movement, e.g., the remounting of the glasses.

The GazeTrak system as disclosed in illustrative embodiments herein addresses these and other drawbacks of conventional approaches by providing a wearable sensing technology based on active acoustic sensing that can track gaze points continuously.

As indicated above, active acoustic sensing in GazeTrak is illustratively based on affordable sensors (e.g., speakers and microphones), the sizes of which are relatively small. Other embodiments disclosed herein have illustrated that acoustic sensing utilizing such components is able to provide enough information to track subtle skin deformations such as facial expressions. Additional details relating to the utilization of acoustic sensing for eye tracking will now be described.

In order to capture the formation around eyeballs, we use FMCW-based acoustic sensing, which has been widely proven effective to estimate distance and movements from complex environments.

While customizing the FMCW signals for the system, three main features are taken into account: 1) Operating frequency range: The device is expected to be worn by users for a long period of time in their everyday lives. As a result, the FMCW signals need to be transmitted in the inaudible frequency range. Besides, to ensure the encoded signals are minimally impacted by the noise in the environment, the operating frequency range we pick should also be uncommon in daily settings; 2) Sampling rate: To achieve a reasonable spatial and temporal resolution of tracking eye movements, the sampling rate of FMCW signals must be high enough; 3) Gain: As power signature increases with the signal gain, the signal gain should be properly determined to balance signal strength and power consumption.

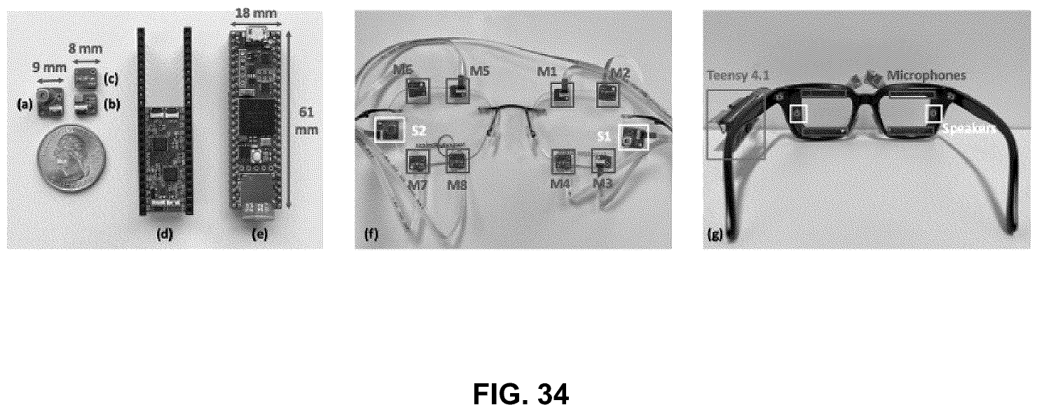

FIG. 33 shows an overview of the operation of the GazeTrak system, using the speaker on the right side (18-21 kHz) for illustration, and includes parts (a) through (f). Part (a) shows the emitted signal, part (b) shows the corresponding received signal, part (c) shows an example echo profile generated by cross-correlation of the emitted and received signals, part (d) shows the deep learning model, which is illustratively based on a ResNet-18 network, part (e) shows coordinates of ground truth, and part (f) shows coordinates of prediction.

Considering the factors described above, we set the operating frequency range of the FMCW signals that are emitted in the GazeTrak system above 18 kHz, because this range is nearinaudible and uncommon in the sounds generated by normal human activities. Because both eyes contain information while moving, we placed one speaker on each side of the glass frame. We set the speaker on the right side to operate at 18-21 kHz while the one on the left side operates at 21.5-24.5 kHz to make sure they do not interfere with each other. To guarantee that the system works reliably in these frequency ranges, we set the ADC sampling rate as 50 kHz with the frame length of FMCW signals as 600 samples. This gives the system a refresh rate of eye tracking at 83.3 Hz (50000 samples/s÷600 samples). We believe a refresh rate of 83.3 Hz is sufficient to provide continuous gaze tracking since the frame rate of most videos are 30 Hz or 60 Hz. Lastly, the gain was experimentally adjusted to make sure that the signal does not saturate the microphones while the power consumption is relatively low.

After receiving the reflected FMCW signals, we first apply a Butterworth band-pass filter with a cut-off frequency range of 18-21 kHz or 21.5-24.5 kHz on the signal to remove the signals in the frequency range that we are not interested in. It also helps protect the privacy of users because we remove the audible range of the signals. Then we further process the filtered signal to obtain unique acoustic patterns. As illustrated in parts (a) to (c) of FIG. 33, an echo profile is obtained by continuously calculating the cross-correlation between the received signals and transmitted signals. As indicated previously, FIG. 32 illustrates that different eye fixations and movements are correlated with different patterns in echo profiles. As described herein, the GazeTrak system utilizing FMCW-based active acoustic sensing to track eye movements continuously with high accuracy.

A professional eye-tracker (e.g., Tobii Pro Fusion) can provide highly accurate ground truth, but it is expensive. If an acoustics-based eye tracking system as disclosed herein were to require a professional eye-tracker to train the system, it would make the eye tracking system less accessible.

Therefore, we developed a new ground truth acquisition and calibration system that only needs a program running on a laptop. The program generates instruction points on the screen as the ground truth. During data collection, the users only need to look at and follow the movements of the instruction points. These ground truth data along with the echo profiles are fed into the machine learning model for training. This method is generally applicable on any device with a screen. Additional details regarding how the instruction points are generated can be found elsewhere herein. To better compare the system with commercial eye trackers, we also use a Tobii Pro Fusion (120 Hz) to record the eye movements to demonstrate the effectiveness of the training methods disclosed herein.

We developed a customized deep-learning pipeline to learn the echo profiles calculated on the received signals. Because in the echo profiles, the temporal information has been converted to the spatial information on an image, we use ResNet-18 as the encoder of the deep learning model because CNN networks are known to be good at extracting features from images. Then a fully-connected network is used as a decoder to predict gaze positions based on the features extracted from the images.

Because of the limited distance between the sensors on the glasses and the eyes, we are typically only interested in a certain range of the echo profiles. As a result, we crop the echo profiles of each channel to get the center 70 pixels (23.8 cm) vertically. Then we randomly select 60 consecutive pixels (20.4 cm) out of these 70 pixels for data augmentation purposes to make sure the system will not be severely impacted by the vertical shifting caused by remounting the device. To continuously track the gaze positions, we apply a sliding window of 0.3 seconds on the echo profiles. As a result, the dimension of the echo profile that we input into the deep learning model for one channel is 26 (0.3 s×50000 Hz+600 samples+1)×60 (pixels). Because we use 2 speakers and 8 microphones in the system, we crop out the same dimension of echo profiles for all 2×8=16 channels, making the dimension of the input vector to the deep learning model as 26×60×16.

We use the instruction points as the labels and the mean squared error (MSE) as the loss function. We utilize an Adam optimizer and set the learning rate as 0.01. The model is trained for 30 epochs to get the estimation of the two gaze coordinates (x, y).

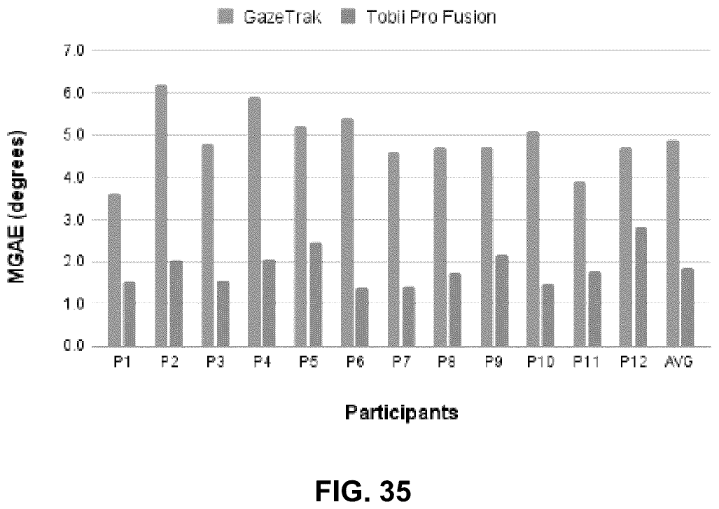

FIG. 34 shows example hardware and form factors for GazeTrak, and includes parts (a) through (g). Part (a) shows the speaker board, part (b) shows the microphone board (front view), part (c) shows the microphone board (back view), part (d) shows the customized PCB board for the audio chip NXP SGTL5000, part (e) shows the Teensy 4.1 microcontroller module, part (f) shows an example glasses form factor with speakers and microphones attached (M1-8: microphones, S1-2: speakers), and part (g) shows the attachable and more compact example implementation.

The prediction of this example system is the coordinate (x, y) of the estimated gaze position on the screen in pixels. To evaluate the accuracy of GazeTrak, we adopted the accuracy defined in COGAIN eye tracker accuracy terms and definitions. The evaluation metric we use in the GazeTrak system is the mean gaze angular error (MGAE) between the coordinate of the prediction (x, y) and that of the ground truth (x′, y′). To calculate MGAE in degrees from the coordinates, we first obtain the angular error 0 between the prediction and the ground truth of each data point, where 0 can be calculated using the law of cosines in a triangle as follows:

$$θ = arccos ( \frac{{d}_{eg}^{2} + {d}_{ep}^{2} - {d}_{gp}^{2}}{2 \times {d}_{eg} \times {d}_{ep}} ) \times 180 \div π \qquad ( 1 )$$

and where d_{eg}, dₑₚ and d_{gp} are the distance between user's eyes and ground truth, the distance between user's eyes and prediction, and the distance between ground truth and prediction, respectively. MGAE is obtained by averaging 0 over all the data points in the testing dataset.

In order to implement the FMCW-based active acoustic sensing technique described above, we utilize Teensy 4.1 as the microcontroller to provide reliable FMCW signal generation and receiving in multiple channels. We designed a PCB board to support two SGTL5000 chips which are the same as the one on the Teensy audio shield. With this customized PCB board plugged onto Teensy, it can support as many as 8 microphones and 2 speakers. The speaker is implemented as Part No. OWR-05049T-38D and the MEMS microphone is implemented as Part No. ICS-43434, to support signal transmission and reception. We also built customized PCB boards for the speaker and the microphone to make them as small as possible. We used the Inter-IC Sound (I2S) buses on the Teensy 4.1 to transmit data between the Teensy 4.1 and the SGTL5000 chips, speakers and microphones. The collected data is stored in the SD card on Teensy 4.1.

We designed the first form factor using a commodity glass frame. We glued 1 speaker and 4 microphones to each inner side of a pair of light-weight glasses. The speakers and microphones are symmetrically placed on the glasses, as shown in part (f) of FIG. 34.

A number of key factors were taken into consideration while designing the final form factor of GazeTrak, including: 1) Type of glass frame: We started designing the form factor with a large glass frame because we believe it has more room for us to place sensors. However, the larger the glass frame is, the easier it will be for the frame to touch the skin, blocking the signal transmission and reception. As a result, we finally picked a relatively small glass frame with a nose pad that can support the glass frame to a higher position. Besides, the light-weight glasses minimize the pressure on the user's nose, making it more comfortable to wear; 2) Sensor position: The speakers and microphones on two sides are symmetric because we believe the movements of two eyes are usually synchronized. On each side, we place the speaker on the frame of the glasses next to the outer canthi because it is easier for the speakers to touch the skin if they are placed above the cheekbones or next to the eyebrows, considering their height. The microphones are arranged on the frame as far away from each other as possible to capture more information by receiving signals travelling in different paths. The sensors are attached as far away from the center of the lenses as possible in order to avoid blocking the view of the user; 3) Stability: We found that the stability of the device severely impacts the performance of the system especially when users need to remount the device frequently. The anti-slip nose pad prevents the glasses from sliding down the user's nose. Furthermore, we added two ear loops at the end of the legs of the glass frame. They greatly help to fix the glasses position from behind the ears and improve the performance of the system. The final example form factor is shown in part (f) of FIG. 34.

This example form factor provides a more compact and less obtrusive form factor that is suitable for everyday use by users. To achieve this, we have designed two PCB boards, each containing one speaker and four microphones onboard, which can be attached to one side of the glasses. We have also deployed the Teensy 4.1 and the PCB board with SGTL5000 chips directly onto one leg of the glasses. To connect the microcontroller and the customized PCB boards, we have used flexible printed circuit (FPC) cables. The system has an interface that allows it to be powered by a LiPo battery. As indicated previously, the compact form factor is shown in FIG. 34 (g), and FIG. 32 shows a user wearing the glasses. This compact form factor can be easily adapted and attached to different types of glasses.

The example form factor has a total weight of 44.2 grams, including the glasses, Teensy 4.1, PCB boards, and the LiPo battery. Compared to camera-based eye tracking glasses, GazeTrak device is much lighter. For example, Tobii Pro Glasses 3 weigh 76.5 grams for the glasses and 312 grams for the recording unit. The GazeTrak system therefore has a significant advantage over camera-based eye tracking glasses in terms of weight.

A user study was conducted to validate the performance of GazeTrak on continuously tracking gaze points. As part of this user study, we carefully designed the instruction video for participants' gaze to follow. Basically, on the white screen, there would be one red dot moving around and we asked participants to stare at the point and follow it with their eyes. We divided the screen into 100 regions. For each data point, the instruction point appeared at a random position within one random region. The instruction point would move quickly to that random position and stay static at that position for a certain period of time because we mainly would like to test how GazeTrak performs to track the fixation of participants.

We recruited 20 participants (10 females and 10 males, 22 years old on average). Note that some participants participated in the study multiple times to test different settings. The study was conducted in an experiment room on a university campus. During the study, each of the participants sat on a chair and put on the glasses form factor with the GazeTrak system. For each participant, we produced 12 sessions of instruction points. During the interval between sessions, participants were instructed to remove the device, place it on the table, and then put it back on. This step was taken to demonstrate that the system continued to function correctly even after the device was remounted. In each session, the instruction point moved to all the 100 pre-defined regions in a random order. The duration for which the instruction point remained at each position varied from 0.5 to 3.5 seconds, with an average of 2 seconds. As a result, the average length of each instruction session was 200 seconds. Before each session, there was a 15-second calibration process with the instruction point moving to the four corners of the screen and the center of the screen.

The full study took no more than 1.5 hours for each participant, during which we collected approximately 40 minutes of data (200 seconds×12 sessions). Upon completing the study tasks, the participant was asked to complete a questionnaire to collect their demographic information and their feedback using this system.

We first evaluated the performance of GazeTrak with the above-noted first example implementation, corresponding to the form factor shown in part (f) of FIG. 34, comparing different ground truth acquisition methods, sensor configurations and amounts of training data. Then we tested the system under noisy environments and on glasses of various frame styles. Finally, we optimized the system for the second example implementation, corresponding to the more compact form factor shown in part (g) of FIG. 34, and evaluated it with a further study in which power consumption was also measured.

The first example implementation of part (f) of FIG. 34 was first tested with 12 participants. A user-dependent model was applied to train a separate model for each participant. Among 12 sessions we collected for each participant, we conducted a 6-fold cross validation to test the tracking performance of the system by using 10 sessions (33.3 minutes) of data for training and 2 sessions (6.7 minutes) of data for testing. Using the evaluation metrics defined above, we calculated the MGAE in degrees for all participants, and the result we obtained was 5.9°. To further improve the performance, we adopted the 15-second calibration data before each session to fine-tune the model, which resulted in an improved performance of 4.9°. It is worth mentioning that a similar calibration process is also required for commodity eye trackers (e.g., Tobii Pro). The distance between the participants' eyes and the screen center is measured to be around 60 cm so we have a field of view of 600 (the largest possible angular error) in this study.

Next, we aimed to compare the impact on gaze tracking performance of using different ground truth acquisition methods: a commodity eye tracker (Tobii Pro Fusion) versus the method disclosed herein (e.g., using instruction points on the screen). We used the eye tracking data recorded by Tobii Pro Fusion as the ground truth to train the model, and the MGAE after finetuning was 4.9°. We conducted a repeated measures t-test between the results using Tobii data as the ground truth and those using instruction points as the ground truth for all 12 participants, and did not find a statistically significant difference (p=0.92>0.05). This suggests that using instruction points on a screen monitor as the ground truth can be as effective as using Tobii data.

Apart from that, we also recorded the eye tracking accuracy of Tobii Pro Fusion itself which was reported after the calibration process of the Tobii platform. The results showed that Tobii Pro Fusion can track the gaze points with an average accuracy of 1.9° during the calibration process for all participants.

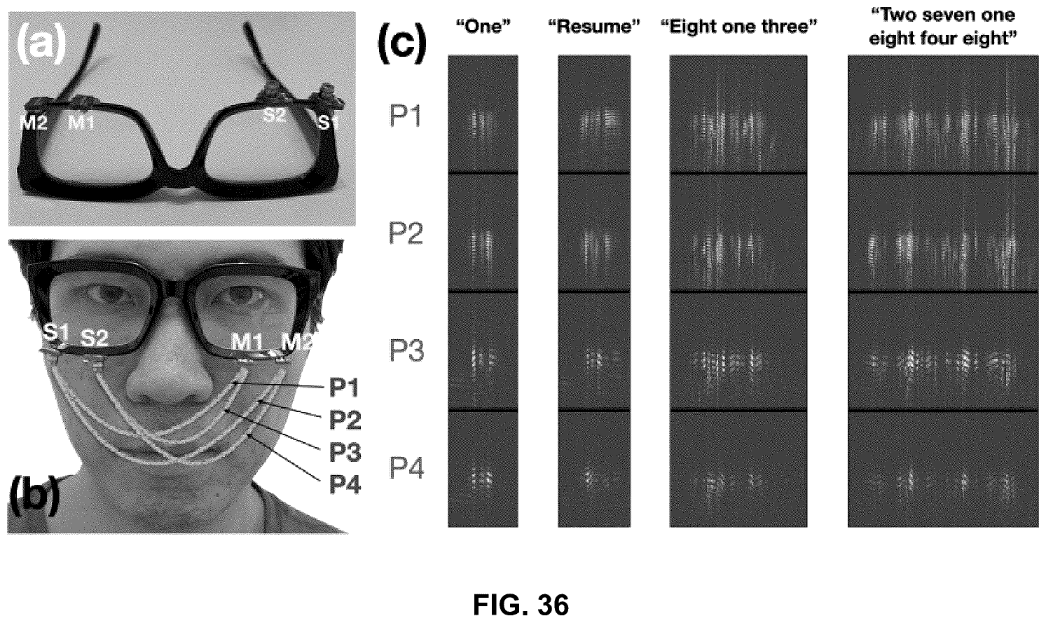

FIG. 35 shows the resulting tracking performance of both GazeTrak and Tobii for all participants.

As will now be described, we evaluated the impact of the number and placement of microphones on tracking performance to determine the optimal sensor position for the best results. We assessed four different settings: 1) one microphone on each side (left and right); 2) two microphones on each side; 3) three microphones on each side and 4) all four microphones on each side. In the first setting, we compared the performance using data from four sets of microphone settings (M1+M5, M2+M6, M3+M7, and M4+M8 in FIG. 34 (f)), which is presented in Table 1.

TABLE 1
Study Results for Different Mic Configurations.

| | Mic Config. | | | | | | |
|---|---|---|---|---|---|---|---|
| | | | | | Best 4 Mics | Best 6 Mics | All 8 |
| | M1 + M5 | M2 + M6 | M3 + M7 | M4 + M8 | (M2, 4, 6, 8) | (M1, 2, 4, 5, 6, 8) | Mics |
| MGAE | 7.7° | 7.2° | 8.5° | 6.9° | 5.9° | 5.5° | 4.9° |

The findings demonstrate that the M4+M8 pair of microphones provides the best tracking performance among the four pairs tested. We conducted a one-way repeated measures Analysis of Variance (ANOVA) test on the results of the four settings and identified a statistically significant difference (F(3,44)=6.74, p=0.001<0.05). These results indicate that microphone placement can affect gaze tracking performance, possibly due to differences in signal reflection before arriving at different microphones.

We conducted further experiments to evaluate performance using different combinations of microphones under settings 2 and 3. The results showed that the best performance was 5.9 degrees and 5.5 degrees, respectively. We also ran a one-way repeated measures ANOVA test among the results of these four settings using data from 12 participants. The results showed a statistically significant difference (F(3,44)=51.61,p=0.00001<0.05). These findings suggest that the example system with four microphones on each side (eight microphones in total) achieves the best performance.

Blinking can introduce noise in the highly-sensitive acoustic sensing system as it can lead to relatively large movements around the eye. We conducted an evaluation to determine whether blinking affects the tracking performance of the GazeTrak system. For this evaluation, we selected data from three participants with the best, worst, and average tracking performance (P1, P2, P10). We removed the data where the participant blinks (about 10% of total data) based on the ground truth data obtained from Tobii Eye Tracker. We then used the processed data to retrain the user-dependent model for each participant. The results showed that the performance did not improve after removing the blinking data. One possible reason for this is that the blinking patterns are consistent and can be learned by the machine learning model. Therefore, the findings suggest that blinking does not significantly impact the performance of the GazeTrak system.

To reduce the amount of training data for a new user, we employed a three-step process to train a user-adaptive model. First, we trained a large base model using data from all participants except the one being tested. Second, we fine-tuned the model using the training data collected from the current participant. Notably, the user only needs to provide training data once during the initial system use. Finally, at the beginning of each session, we further fine-tuned the model using calibration data collected from the participant before testing or using the system. To determine the amount of data required to achieve competitive tracking performance, we reserved two sessions of data for testing and used varying amounts of training data from the participant to fine-tune the large model.

The results show that a new user only needs to provide six sessions of training data (approximately 20 minutes) to achieve good performance. Collecting more data does not necessarily result in better performance. Additionally, with only two or three sessions of data (approximately 6 minutes), the system can achieve a performance of 6.7° and 6.1°, respectively. If no user data is collected, the performance is 11.3°. This is likely because different people have unique head, face, and eye shapes. Therefore, to further reduce the amount of training data required from each new user, we may need to collect a significantly larger amount of training data from a more diverse set of participants.

To ensure that the acoustic sensing system is resistant to different types of environmental noise, we conducted two experiments as described below.

In the first experiment, we recorded noises in different environments using the microphones on the glass frame. We then overlaid the noise onto the data collected in the user study to simulate different noisy environments. We recorded the noise in four different environments and measured the average noise levels using a sound level meter app called NIOSH provided by CDC: 1) street noise (70.8 dB(A)) recorded on the street near a crossroad; 2) music noise (64.5 dB(A)) recorded while playing music on a computer; 3) cafe noise (54.5 dB(A)) recorded in a cafe; driving noise (65.6 dB(A)) recorded while driving a vehicle. After overlaying each of these four noises, the tracking performance remained unchanged for every participant.

In the second experiment, we invited eight participants from the previous user study and recruited two new participants (P13 and P14) to test the GazeTrak device in different real-world noisy environments. Since this study required us to move to different environments, the study design differed slightly from the previously-described study.

In this study, we used an Apple MacBook Pro with a 13.3 inch display to play the instruction videos. We used the instruction points as the ground truth. The MacBook Pro was placed on a movable table, and participants were instructed to sit in front of the table to conduct the study. Additionally, it was found that 6 sessions of training data are sufficient to provide acceptable tracking performance. Therefore, for each participant, we collected a total of 8 sessions of data in a quiet experiment room, with 6 sessions for training and 2 sessions for testing. We then collected additional testing data under two different noisy environments. In the first environment, participants used the system while we played random music for 2 sessions. In the second environment, we collected 2 sessions of testing data at a campus cafe where staff and people were talking during business hours. The noise levels under each environment were measured using the CDC NIOSH app: 1) quiet room (33.8 dB(A)); 2) play music (64.0 dB(A)); 3) in the cafe (56.6 dB(A)). This study design led to a total of 12 sessions of data collection for each participant, which is the same as the previous study.

We trained a personalized model for each participant using 6 sessions of data collected in the quiet room. Then, the 2 testing sessions collected in each scenario were used to test the performance of the system in different environments. The average gaze tracking performance of the system across 10 participants remained satisfactory at 3.8° and 4.8° under two noisy environments, playing music and in the cafe, while the performance in the quiet room was 4.6°. Overall, the average accuracy of gaze tracking did not change significantly with the presence of noise in the environment. We conducted a one-way repeated measures ANOVA test among the results of these three scenarios for all 10 participants and did not find a statistically significant difference (F(2,27)=2.46, p=0.11>0.05). This again validates that the GazeTrak system is not easily affected by environmental noise.

In the initial user study, we tested the system on a particular glass frame, denoted F1, with a configuration as shown in part (f) of FIG. 34. However, the GazeTrak system can be easily applied to glasses with different frame styles. In order to validate this, we deployed the system on two other pairs of glasses. The original glass frame (F1) is frameless and relatively lightweight. In this study, we applied the system on two new glasses with different styles, size and weight. The first new glass frame (small glasses, F2) is of a smaller size than F1 but with a larger weight due to the frame around the lens. The second new glass frame (large glasses, F3) with a frame around lens has a much larger size and weight compared to F1 and F2. To evaluate the system on these new glass frames, three participants from the original study (P1, P5 and P7) agreed to participate in this additional study. The study setups and procedures were exactly the same as the previous study described above.

We collected 12 sessions of data for each participant testing each glass frame. Since, as indicated previously, 6 sessions of training data were found to be sufficient, we discarded the first 4 sessions for each glass frame and used the last 8 sessions to run a 4-fold cross validation in order to test the tracking performance of the system on different glasses. In this case, we can make sure that participants are familiar with the wearing of all the glass frames and eliminate the impact of some random factors. The evaluation result shows that the small glasses (F2) yielded a similar average performance to the original glasses (F1) (both at 5.3°), while the large glasses (F3) resulted in a relatively poorer average performance (at 6.1°), with a drop in performance of 15%. One possible reason for the performance difference is that the sensors on the larger glasses were much closer to the skin. Sometimes, the sensors may directly touch the skin, which could block the transmission and reception of signals, as indicated previously.

In the previous user studies, we evaluated GazeTrak with various configurations under different scenarios, using the first example implementation as illustrated in part (f) of FIG. 34. The results of these studies helped us confirm the various settings and configuration and to develop the second example implementation, which features the more compact form factor as shown in part (g) of FIG. 34. A further study was conducted to assess the performance and power consumption of this second example implementation.

In evaluating the second example implementation, we recruited 10 participants (four of whom participated in the previous study). The study design was similar to the previous study, except that we only used instruction points as the ground truth acquisition method. Each participant collected eight sessions of data (six sessions for training and two for testing). We reduced the signal strength from the speaker to 20% of the original setup, as we found that even with 2% of the original strength, the performance was similar in the previous study. Hence, the second example implementation has significantly lower signal strength and improved environmental sustainability. Additionally, we set the central processing unit (CPU) speed of the Teensy 4.1 to 150 MHz in this study (standard speed: 600 MHz) to lower power consumption. With this setting, the system experienced a data loss rate of 0.002%, and the performance of the system was not affected by this loss, as shown in Table 2. Apart from the cross-session performance, we also conducted a test of the in-session tracking accuracy in which the training data and testing data were split from the same sessions without remounting the device to show the optimal performance of the GazeTrak system.

TABLE 2
Gaze Tracking Performance in MGAE with the Final Prototype.

| Settings | P1 | P2 | P7 | P10 | P15 | P16 | P17 | P18 | P19 | P20 | Avg |
|---|---|---|---|---|---|---|---|---|---|---|---|
| Cross- | 4.4° | 4.9° | 5.9° | 8.0° | 3.6° | 3.6° | 3.9° | 4.8° | 4.7° | 5.7° | 4.9° |
| session | | | | | | | | | | | |
| In- | 3.9° | 3.6° | 4.9° | 5.3° | 1.8° | 2.6° | 2.6° | 3.6° | 3.1° | 4.9° | 3.6° |
| session | | | | | | | | | | | |

As shown in Table 2, the MGAE is 4.9° for the cross-session evaluation, which is similar to the previous study. When evaluating the performance of GazeTrak within the same sessions, the accuracy improves to 3.6°. We did not add ear loops to this second example implementation because the legs of the glasses were wider than the ear loops we had. For most participants, the glasses fit well on their ears, but one participant (P10) reported that the glasses kept sliding down during the study, which may have affected their performance. Based on the questionnaires, no participant reported being able to hear the signal emitted from the system. We also measured the signal level from the system using the NIOSH app. We placed the phone running the app close enough to the speakers in the system and the app gave us an average signal level of 43.1 dB(A). This is below the maximum allowable daily noise recommended by CDC, which is 85 dB(A) over eight hours in the workspace.

We measured the power consumption of the system with a current ranger. The average current flowing through the system was measured as 88.3 mA@3.26 V, which gives us a power consumption of 287.9 mW. This value was tested with all 8 microphones and 2 speakers working, and with the data being written into the SD card. The GazeTrak system can last up to 38.5 hours with a battery of similar capacity to Tobii Pro Glasses 3 (3400 mAh), while the working time of Tobii Pro Glasses 3 is only 1.75 hours. If applied to non-eye-tracking glasses, like Google Glass, the system can run for 6.4 hours. It is worth noting that these estimates do not include the power consumption of data preprocessing and deep learning inference running on a local server. Table 3 shows the measured power consumption of different components in the system. Teensy 4.1 has a high base power consumption, while the sensors (speakers and microphones) consume much less power.

TABLE 3
Power Consumption of Different Components on Teensy 4.1. Power of
data preprocessing and deep learning inference is NOT included.

| Total | Speakers & Mics | SD card writing | Other operations |
|---|---|---|---|
| 287.9 mW | 16.4 mW | 72.7 mW | 198.8 mW |

After the user study, we distributed a questionnaire to every participant to ask for feedback on the second example implementation. First, the participants evaluated the overall comfort and the weight of this compact form factor with a rating from 0 to 5. Across all 10 participants, the average scores they gave to these two aspects are 4.5 (std=0.7) and 4.2 (std=0.8), indicating that the compact form factor of GazeTrak is overall comfortable to wear and easy to use. Furthermore, all 10 participants answered “No” to the question “Can you hear the sound emitted from our system?” This verified the inaudibility of the acoustic signals emitted from the GazeTrak system.

In the previous evaluation, we recorded audio data with Teensy 4.1 first and then ran the signal processing and deep learning pipeline on a local server offline. However, to enable predictions of gaze positions in real-time on an MCU, we implemented the entire pipeline on a microcontroller with an ultra-low power CNN accelerator (e.g., MAX78002).

To achieve this, the deep learning models were trained and synthesized in advance, using ai8x libraries. We implemented two models with ai8x, which were ResNet-18 (used in the previous study) and MobileNet for comparison. Due to the hardware limit of MAX78002, we modified the models to be compatible with the chip. Specifically, for a Conv2d layer, the kernel size could only be set to 1×1 or 3×3 and the stride is fixed to [1,1]. In addition, some convolution layers of ResNet-18 were substituted with depth-wise separable convolution layers to avoid exceeding the limit of the number of parameters in the model. Furthermore, we quantized the input and the weights of the models with ai8x, which converted them all into 8-bit data format to save memory for storage and increase the speed of inference.

Before applying the deep learning model, we apply a band-pass filter on the received signals and perform cross-correlation between received signals and transmitted signals to obtain echo profiles as described previously. However, in the implementation using the MAX78002, to reduce processing time, we removed the band-pass filter since all the computations are done on the MCU and transmitting private data is no longer a concern.

Then we experimented with two different methods to realize the cross-correlation: (1) brute force to calculate echo profiles point by point; and (2) the dot product function in the CMSIS-DSP library. Results of standard tests revealed that it took the system 178.3 ms and 45.4 ms to compute one echo frame and make one inference utilizing these two methods, respectively. Considering that one frame of the audio data comes every 12 ms in the system (600 samples+50000 samples/s), the processing time is too long to keep the system running in real-time with an FPS rate of 83.3 Hz. Finally, we explored method (3) a Conv2d layer (kernel size 1×1) with transmitted signals as the untrained weights and received signals placed along the channel axis of the input. This can increase the speed of echo profile calculation because it uses the CNN accelerator on MAX78002. We compressed the samples used for cross-correlation from 600×600 to 34×34 and the pixels of interest from 60 pixels (20.4 cm) to 30 pixels (10.2 cm) in this case to further decrease the processing time.

With this Conv2d layer added on top of the deep learning model, the model directly takes the raw audio data as input in instances with the size of 64 (34+30 samples)×26 (frames)×8 (microphones). This method allows the system to make one inference within 10.3 ms, which is enough for the real-time pipeline with a double-buffer method applied, in which direct memory access (DMA) moves the current frame in one buffer while the CPU processes the previous frame in another buffer.

To validate these modifications and compression, we evaluated the in-session performance of different models with different settings using data collected with the second example implementation. The results are shown in Table 4.

TABLE 4
Average In-session Performance for 10 Participants
with Different Models and Settings.

| Models | ML Libraries | Compressed? | Quantized? | MGAE |
|---|---|---|---|---|
| ResNet-18 | pytorch | X | X | 3.6° |
| | ai8x | X | X | 4.0° |
| | ai8x | ✓ | X | 4.0° |
| | ai8x | ✓ | ✓ | 4.2° |
| MobileNet | ai8x | ✓ | X | 4.2° |
| | ai8x | ✓ | ✓ | 4.3° |

As shown in Table 4, the same model trained with ai8x is slightly worse than that trained with PyTorch given the constraints of the convolution layers discussed above. Compressing the size of input data does not affect the accuracy. While MobileNet yields comparable accuracy to ResNet-18, both models suffer a slight performance drop after quantization since the precision of data is decreased.

Given the limitation of the I2S interfaces on MAX78002, to test the system in a more realistic condition, we still use Teensy 4.1 to control the speakers and microphones and transfer the received audio data to MAX78002 via the serial port. To accelerate the transmission speed, only the samples that are used for processing on the MAX78002 are transferred. This generates a steady stream of audio data to MAX78002. In future, we will explore connecting microphones directly to MAX78002 using multi-channel audio protocols such as Time-division Multiplexing (TDM). Evaluation results showed that for ResNet-18 and MobileNet, MAX78002 spent 124.1 ms and 41.6 ms, respectively, loading the weights of the model. This is a one-time effort and can be done before running the real-time pipeline so it did not impact the refresh rate. Then it took 12 ms to load one instance and make an inference based on it in real-time for both ResNet-18 and MobileNet, giving a refresh rate of 83.3 Hz.

We measured the power consumption of the MAX78002 evaluation kit while it made inferences. Table 5 shows that MAX78002 consumes 96.9 mW and 86.0 mW respectively when making inferences with ResNet-18 and MobileNet at 83.3 Hz. The refresh rate can be reduced to 30 Hz to save power, which is enough for many applications. In this case, the power becomes 79.0 mW and 75.7 mW respectively.

In an embodiment configured to use MAX78002 to directly control speakers and microphones, the power efficiency can be further optimized and the overall power consumption of the corresponding real-time system kept to around 95.4 mW, i.e., 79.0 mW (MAX78002 with ResNet-18 running at 30 HZ)+16.4 mW (2 speakers and 8 microphones). One should keep in mind that this is just an estimate of the power of this real-time system and the power consumption of MAX78002 might increase if it does need to control the sensors. However, we do not expect it to be very high because the current power of MAX78002 already includes that of the CPU and the CNN accelerator running at full speed.

TABLE 5
Power Consumption of MAX78002
with Different Models Running.

| | | |
|---|---|---|
| Models | ResNet-18 | MobileNet |

| | | | | |
|---|---|---|---|---|
| FPS (Hz) | 83.3 | 30 | 83.3 | 30 |
| Power (mW) | 96.9 | 79.0 | 86.0 | 75.7 |

We also evaluated simpler regression models. More particularly, we utilized two traditional regression models, which are linear regression (LR) and gradient boosted regression trees (GBRT), to predict gaze positions using the data collected in the manner described previously, and the results showed that the average in-session tracking accuracy for these two models across 10 participants is 11.6° and 6.8° respectively. Compared to the results in Table 2, the traditional regression models output much worse accuracies than ResNet-18 (3.6°). We conducted an analysis of the impurity-based feature importance with GBRT, comparing the features in different channels of microphones in Table 6. It turns out that the channels receiving signals from 18-21 kHz (S1) are generally more important than channels receiving signals from 21.5-24.5 kHz (S2). Furthermore, the microphones that are closer to the inner corners of the eyes (M1, M4, M5 M8) are more important than those closer to the tails of the eyes (M2, M3, M6, M7).

TABLE 6
Feature Importance Analysis for Different
Microphones using GBRT (Scaled to 0-100).

| | Microphones | | | | | | | |
|---|---|---|---|---|---|---|---|---|
| | M1 | M2 | M3 | M4 | M5 | M6 | M7 | M8 |
| Importance | 100/ | 57/ | 33/ | 96/ | 66/ | 42/ | 28/ | 85/ |
| (S1/S2) | 27 | 23 | 12 | 29 | 81 | 17 | 15 | 79 |

The impact of various real-world factors was also examined, as follows. With regard to head movements, in the user study, we did not use a chin rest to fix the participants' head, so they could turn their head freely. However, head movements could affect the system performance, and therefore could be evaluated in more detail. Also, with regard to the degree of near- and far-sightedness of the participants in the user study, we collected participants' degrees of myopia in the questionnaires, and found that myopia showed no connection to the gaze tracking performance. In addition, with regard to user speaking, one researcher evaluated the system when keeping silent and when talking to himself. The gaze tracking performance of the silent sessions and the talking sessions were found to be the same, at 3.9°.

Illustrative embodiments herein demonstrate the feasibility of the disclosed acoustic-based gaze tracking system on glasses. While the eye tracking accuracy of 4.9° is comparable to some webcam-based methods, it is lower than commercial eye trackers (1.9° in the study). Therefore, the system may not be immediately applicable to some applications requiring highly precise eye tracking. However, the system can still be used in many applications, such as interaction with interface elements like buttons in AR or VR, that generally do not require very high accuracy eye trackers.

The GazeTrak system can also be used in tracking irregular eye movements, enabling healthcare applications for monitoring users' health conditions in everyday life. This requires monitoring the gaze movements throughout the day for analysis in everyday life, instead of just tracking their accurate gaze positions for a few hours in a controlled setting. The low-power and lightweight features of the GazeTrak system make it a good candidate solution to enabling a variety of applications that camera-based eye trackers cannot realize, by continuously understanding user gaze movements in the wild for extended periods. Furthermore, the system can alleviate the privacy concern from users as compared to camera-based methods.

In other embodiments, we can apply a calibration process on the output of the system to further enhance performance. For example, affine transformation and projective transformation can be used to transform the output, although the effectiveness of such techniques is limited as the error distribution of the eye tracking results in some embodiments is not linear. Accordingly, it is expected that use of non-linear transformation techniques may be utilized to further improve the performance.

The system currently utilizes a 15-second calibration process before each session to fine-tune the model, which may be inconvenient for users. However, the tracking accuracy without fine-tuning is still acceptable, at 5.9°, compared to the accuracy achieved with fine-tuning (4.9°).

It was noted above that GazeTrak achieves satisfactory performance on new users with approximately 20 minutes of training data using the user-adaptive model. This training effort can be further reduced by constructing a larger and more diverse dataset from many more participants to train the base model. Moreover, data augmentation methods, such as including simulation data to train the model, can be used as well.

In some embodiments, a Teensy 4.1 is used to control the speakers and microphones, and transfer audio data to the MCU MAX78002. In other embodiments, custom PCBs can be implemented for MAX78002 to allow it to directly control speakers and microphones. We believe that the power consumption of this example real-time system can be further reduced in this case because Teensy 4.1 with a high base power can be removed. Furthermore, we do not expect that the power consumption of MAX78002 will be significantly increased since the on-board CPU and CNN accelerator of MAX78002 were already operating at maximum speed in the current evaluation. Accordingly, such an arrangement can be utilized to provide a more integrated system in some embodiments.

As described above, some embodiments herein provide acoustic-based eye tracking glasses capable of continuous gaze tracking. A study involving 20 participants confirms that the system can accurately track gaze points continuously, achieving an accuracy of 3.6° within the same session and 4.9° across different sessions. When compared to commercial camera-based eye tracking glasses such as Tobii Pro Glasses 3, the system reduces power consumption by 95%. A real-time pipeline is implemented on MAX78002 to make inferences with a power signature of 95.4 mW at 30 Hz.

### Additional Embodiments Relating to Acoustic-Based Silent Speech Recognition

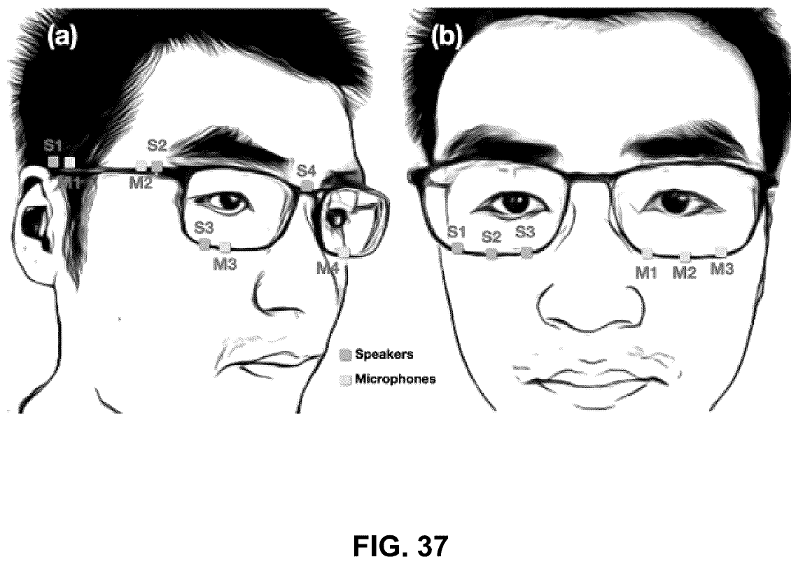

Illustrative embodiments relating to acoustic-based silent speech recognition will now be described in more detail with reference to FIGS. 36 to 40.

The acoustic-based silent speech recognition in some embodiments is implemented as an acoustic-based silent speech recognition system referred to herein as EchoSpeech. EchoSpeech is a minimally-obtrusive silent speech interface (SSI) powered by low-power active acoustic sensing. EchoSpeech uses speakers and microphones mounted on a glass frame and emits inaudible sound waves towards the skin. By analyzing echoes from multiple paths, EchoSpeech captures subtle skin deformations caused by silent utterances and uses them to infer silent speech. With a user study of 12 participants, we demonstrate that EchoSpeech can recognize 31 isolated commands and 3-6 figure connected digits with 4.5% (std 3.5%) and 6.1% (std 4.2%) Word Error Rate (WER), respectively. We further evaluated EchoSpeech under scenarios including walking and noise injection to test its robustness. We then demonstrated using EchoSpeech in example applications in real-time operating at 73.3 mW, where the real-time pipeline was implemented on a smartphone with only 1-6 minutes of training data. We believe that EchoSpeech takes a solid step towards minimally-obtrusive wearable SSI for real-life deployment.

SSI has drawn increasing attention lately. Compared with voiced speech, silent speech does not require the users to vocalize sounds, which expands its application scenarios to where voiced speech is limited. For instance, SSI can be used in noisy environments where voiced speech may suffer from severe interference or in quiet places and other scenarios where it is socially inappropriate to speak out loud. A recent study found that SSI is more socially acceptable than voiced speech, and that users are willing to tolerate more errors. Studies also found that social awkwardness and privacy concerns are important factors affecting user's perception of and willingness to use voice assistants. By removing the need to speak out loud, SSI better preserves privacy. These advantages make SSI promising in expanding the use case of voice assistant with a silent voice assistant. In addition, SSI opens up brand new opportunities where voiced speech has not touched. For instance, SSI can be used to input passwords without leaking out sounds to the environment. Collaborators in a shared workspace can use SSI to instruct AI agents without disturbing each other.

Despite these promising benefits, there exists substantial challenges preventing existing SSI technologies from being widely used. The most popular SSIs use cameras to capture lip movements. However, these methods require the presence of a camera without severe occlusion, which limits its availability. The wearable community comes up with various solutions to address this limitation. However, most of them require placing skin-contacting sensors inside the mouth or on the frontal face, which may not be physically or socially comfortable. Recent research tries to place less-obtrusive sensors at less-visible positions such as behind the ear or under the chin. However, such positions can only provide limited information thus requiring extra effort such as speaking slowly to ensure performance. Additionally, wearing such devices for an extended period of time may still be uncomfortable. Contact-free SSIs do not need sensors to be tightly coupled with the skin and have drawn recent attention. Promising results are seen on necklace-mounted camera and in-ear acoustic sensing based SSIs. However, camera-based methods often suffer from high power consumption and privacy concerns, while in-ear systems may still be uncomfortable for long-term wearing.

To make things worse, lack of a reliable, comfortable and minimally-obtrusive form factor is not the only obstacle faced by wearable SSIs. Performance is another key challenge. The ability to recognize speech with natural speaking speed and style (e.g., continuously speaking out multiple words together without pausing) is key towards a natural and user-friendly SSI. However, most wearable SSIs are only able to recognize a pre-defined set of discrete commands. Some have extra restrictions such as speaking slowly, remaining still, exaggerating speech, or were only evaluated in-session. In addition, the ability to recognize speech at a sentence level is still extremely limited in wearable SSIs. The past year witnessed most of such advancements in works such as MuteIt and EarCommand. However, their abilities to recognize continuous and connected speech are still limited.

To address these and other challenges, illustrative embodiments herein include EchoSpeech, a minimally-obtrusive contact-free SSI that is able to recognize both discrete and continuous speech. EchoSpeech is powered by active acoustic sensing using miniature speakers and microphones mounted on the lower edge of a commercial off-the-shelf (COTS) glass frame to track lip and skin movements from multiple paths. We designed a customized deep learning pipeline with connectionist temporal classification (CTC) loss that enables EchoSpeech to recognize both discrete and continuous speech without segmentation needed. We evaluated EchoSpeech with a study of 12 participants and demonstrate that EchoSpeech achieves a WER of 4.5% (std 3.5%) and 6.1% (std 4.2%) in recognizing 31 isolated commands and 3-6 figure connected digits spoken at a speed of 101 words per minute (wpm). To minimize training effort from new users and improve performance, we designed a two-step (pre-training+fine-tuning) training process. We demonstrate that with only 6-7 minutes of training data, EchoSpeech achieves 9.5% and 14.4% WER on recognizing isolated and connected speech. We further demonstrated EchoSpeech's robustness in scenarios such as walking and noise injection. To demonstrate the use case and effectiveness, we applied EchoSpeech in four real-time demos on a low-power variant operating at 73.3 mW.

Accordingly, illustrative embodiments include EchoSpeech, a minimally-obtrusive, contact-free SSI powered by active acoustic sensing on a glass frame that recognizes both isolated and connected speech with around 5% WER. EchoSpeech provides an SSI on a single glass frame, and utilizes a CNN-based segmentation-free silent speech recognition pipeline for acoustic sensing.

Conventional SSI approaches include contacting and contact-free SSI, depending on whether the sensors need physical contact with the skin.

Contact-free SSIs using cameras cover various granularities ranging from isolated commands and sentences to sound restoration. Despite their performance, the drawbacks are also evident: they require users to be present in front of a camera without severe occlusion, which may not be portable and may raise privacy concerns.

A workaround to the portability issue is deploying the system on mobile devices, illustratively using the built-in camera or speaker and microphone of the smartphone to capture lips movements and infer silent speech from them. However, such systems require holding the smartphone in the hand. For a real hands-free and eyes-free system, fully wearable solutions are needed.

Some Contacting SSI approaches involve directly placing sensors on the articulators in the mouth. For instance, magnetometers have been placed on the tongue and/or lips to directly capture tongue/lip movements. For similar purposes, capacitive sensors were also used inside of the mouth. However, these systems are highly obtrusive and many users might find putting artifacts inside the mouth uncomfortable.

For improved comfort, researchers also explored putting sensors externally to capture signals that reflect internal movements. In this category, ultrasonic imaging uses skin-contacting probes usually tightly under the chin to obtain direct imaging of the internal structures to infer silent speech or even synthesize voices. Another well-explored direction uses electromyography (EMG) to infer silent speech from muscle movements represented by EMG signals. This approach requires attaching multiple electrodes on the skin, mostly on the frontal face and the chin. Similar approaches with different sensing principles include placing RFID tags around the mouth to capture lip and cheek movements, using electrodes around the head to capture electroencephalography (EEG) signals and analyzing vocal tract shape using MRI signals.

However, wearing multiple sensors on the frontal face may not be physically or socially comfortable. Other approaches try to mitigate this issue by exploring less obtrusive sensor locations such as motion sensors behind the ear or under the chin, but in some cases require users to speak slowly. In addition, these approaches still require users to wear skin-contacting devices which may not be comfortable for long-term deployment (e.g., most users thought that MuteIt was comfortable to wear for less than 2 hours).

Compared with putting sensors contacting the skin, contact-free SSIs are usually more comfortable and user-friendly. However, they face more challenges in obtaining high quality signals because sensors need to be put relatively far away from the articulators. In addition, such often consume large amounts of energy (e.g., a sensing unit in one conventional camera-based approach operates at 2.4 W) and have significant privacy concerns.

Other approaches fall at the boundary of contacting and contact-free systems, where sensors themselves are contact-free but the form factor needs to be tightly attached to the skin. For instance, motion sensors and strain sensors have been deployed on a mask. However, these systems only achieve limited performance, likely due to lack of a reliable representation of articulator movements.

Another approach involves in-ear acoustic sensing. However, such approaches typically experience significant performance drop while tested across sessions. Additionally, compared with fully contact-free systems, these systems still have significant disadvantages during long-term wearing.

In both contacting and contact-free SSIs, continuous recognition ability is still extremely limited.

The EchoSpeech system as disclosed herein overcomes these and other drawbacks of conventional approaches, illustratively by providing a low-power, minimally-obtrusive contact-free SSI powered by active acoustic sensing. EchoSpeech is implemented in some embodiments as a contact-free SSI deployed on a single glass frame. It deploys miniature speakers and microphones on the lower edge of a COTS glass frame and achieves around 5% cross-session WER in recognizing 31 isolated commands and 3-6 figure connected digits that are spoken at 101 wpm.

The design rationale and basic operating principles of EchoSpeech will initially be described.

When people speak, whether with or without vocalizing voices, muscles on the face drive different parts of the face to move. Among these parts, lip movements are especially useful in inferring speech. EchoSpeech utilizes an active acoustic sensing approach to track subtle skin deformation as a user is speaking.

FIG. 36 shows an example configuration and corresponding echo profiles for the EchoSpeech system. Parts (a) and (b) of the figure show the wearable device and its corresponding signal paths. In this embodiment, the wearable device comprises speakers S1 and S2 and microphones M1 and M2, arranged on a glass frame as shown, providing signal paths denoted P1, P2, P3 and P4. Note that each path illustratively includes multiple path reflection and diffraction components that originate from the source speaker and ends at the target microphone. The lines shown for the respective paths in the figure only illustrate the sources and targets. Part (c) of the figure shows the echo profiles for different utterances, illustratively include utterances of “One,” “Resume,” Eight one three” and “Two seven one eight four eight.”

In this embodiment, the speakers and microphones are mounted on the glass frame so as to be positioned close to the face when the glasses are worn by a user. The speakers emit encoded sound waves, which are reflected and diffracted by various facial parts including the lips, and captured by the microphones. With the example form factor setup shown in parts (a) and (b) of FIG. 36, the speakers and the microphones are mounted on different sides of the glass frame corresponding to respective different sides of the face. Signals emitted by the speakers travel across the face through different paths and are captured by microphones on the other side of the face. To demonstrate how the system captures facial movements during speech, a few silent utterances (defined as a period of silent speech such as a word, phrase or short sentence separated by pauses) where recorded while a user was wearing the EchoSpeech system, and the corresponding echo profiles are shown in part (c) of FIG. 36. In the echo profiles, different silent utterances appear as strong yet distinct patterns, indicating that EchoSpeech is able to capture the movements caused by silent speech. With a customized machine learning pipeline, such patterns can be used to infer speech, as disclosed herein.

As indicated above, existing SSI systems exhibit a number of significant drawbacks, including lack of a reliable, and physically and socially comfortable form factor, and lack of an ability to recognize speech in a natural and continuous way. The EchoSpeech system disclosed herein addresses these and other drawbacks of conventional practice, through a design approach that emphasizes utilization of a form factor that is minimally-obtrusive and comfortable to wear, that is evaluated in a way that is as natural as possible, and that is low-power, privacy aware and requires as little training effort as possible.

With regard to form factor, EchoSpeech utilizes a contact-free acoustic sensing approach that can be easily deployed on wearables. Compared with other contact-free sensing methods such as cameras, acoustic sensing is much more power-efficient and privacy-aware. Compared with methods such as capacitive or distance sensing, acoustic sensing provides better sensing range and resolution. In addition, acoustic sensors are cheap and widely available on wearable devices. To minimize privacy concerns as well as avoiding annoying users with noises, some embodiments only use audio signals over 18 kHz and apply band-pass filtering to remove low frequency components where most sensitive sounds are distributed.

With acoustic sensing, EchoSpeech uses reflected and diffracted sound signals to recover the pattern of movements of the articulators and their connecting tissues which naturally occurs while speaking. It uses a COTS form factor, illustratively a glass frame, which was found to provide advantages over other form factors, such as in-ear and behind-the-ear form factors, that may be uncomfortable to wear, capture limited information, and can lead to unstable performance on participants with different head shapes. Other form factors such as necklaces also exhibit challenges, particularly when users are walking.

The glass frame form factor has several benefits that other form factors do not have. For example, it is comfortable for long-term wearing as many people wear it all day long. It is also stably mounted on the head, which allows users to be able to speak naturally without need to keep still. In addition, glass frame expands from behind the ear to above the nose in the front, which provides more flexibility in placing sensors at different locations without significant hardware modifications. Many of these locations are close to skin and muscles that have significant deformation during speech, resulting in better performance.

In order to find an optimal form factor setup that best balances the above-noted design objectives, we conducted experiments on various sensor positions, orientations, and quantities. To quickly quantify these explorations, we compared different setups with a small-scale standard test to compare their performances. In the test, one researcher wore the glasses and used a 10-word command set (10 digits, zero to nine) and collected 40 repetitions for each word. We used a simple CNN model to classify these 10 words. It should be noted that the simple CNN was utilized to quickly obtain horizontal comparison between different configurations, rather than to achieve the best possible performance in this step.

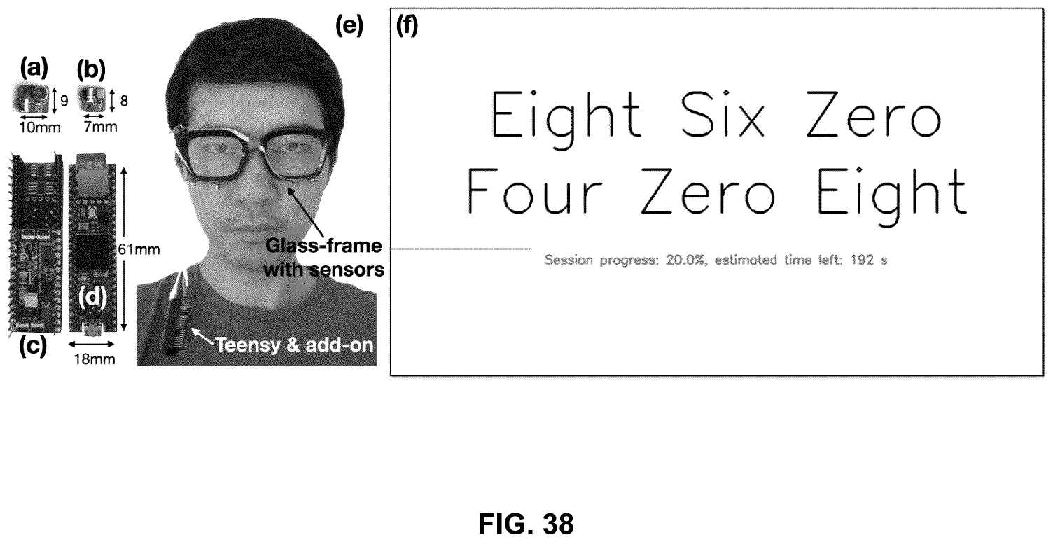

FIG. 37 illustrates example iterations that were performed on sensor and microphone positions in illustrative embodiments. Parts (a) and (b) of the figure more particularly show different sensor and microphone positioning arrangements.

In these experiments, we started with the most unobtrusive setup by placing the sensors on the leg of the glass frame. We experimented with S1+M1/M2, S2+M1/M2 as illustrated in part (a) of FIG. 37. This example setup did not put any sensor in the front. Instead, it captures skin deformations on the side of the cheeks. However, such deformations are very weak and not informative enough for inferring activities as subtle as silent speech. Accuracy for this example configuration on the above-noted standard test was under 50%.

We then moved the sensor to the front side, placing a speaker near the nose bridge while two microphones were placed on either side of the frame to get a symmetric setup utilizing S4+M3+M4 as illustrated in part (a) of FIG. 37. With this example setup, the system was able to capture quite strong patterns during speaking. However, such patterns are not distinguishable enough to tell over 10 different commands apart, achieving around 50% accuracy on the standard test. We believe that this is because the paths that signals travel only cover areas that have limited freedom in deformation, mostly around the eyes and the nose bridge. We then moved both the speaker and the microphones to the lower edges of the frame, using S3+M3 as illustrated in part (a) of FIG. 37, hoping to observe the frontal face from a closer-up position. This setup delivered a much better performance than previous trials, around 90% on the standard test. However, when we scaled up the command set size, performance decreased.

In the example setup using S3+M3, the signal travels from the speaker and reaches mostly the face and partly the lips before reaching back to the microphone. We hypothesized that having the signal paths over the lips could improve performance by capturing movements of the lip. Therefore, we updated the design and placed the speaker and microphone on different sides of the frame, utilizing S3+M4 as shown in part (a) of FIG. 37. With this updated example setup, we achieved a significant performance boost on the standard test from 90% to 98%. More importantly, this performance persisted after scaling up the command set.

We then further optimized this setup. We first experimented on the microphone location. We placed a speaker near the center and three microphones at the left, center and right of the lower frame, utilizing S2+M1+M2+M3 as illustrated in part (b) of FIG. 37. Since all setups of this type achieved over 97% on the standard test, we reduced the amount of training data to magnify the differences between the different setups of this type. Results showed that microphones M2 and M3 achieved the best results (around 90% accuracy with less training data) while microphone M1 which was closest to the nose performed significantly worse than the other positions (47% accuracy). Similarly, we experimented on the 3 speaker positions (S1, S2, S3) shown in part (b) of FIG. 37, and found that the speaker nearest to the nose (S3) had significantly worse performance than the other two.

Based on the preliminary findings, we configured the system to use two speakers (S1+S2) and two microphones (M2+M3) on respective sides of the frame, as illustrated in parts (a) and (b) of FIG. 36. In this way, signals can travel through different paths to capture more information. We verified through additional experimentation that, in illustrative embodiments, this setup indeed yields better performance than using fewer sensors. It is to be appreciated, however, that other embodiments can vary the number and placement of the speakers and microphones relative to these example arrangements, which are provided for purposes of illustration only, and should not be construed as limiting in any way.

Additional details regarding the hardware and software implementation of EchoSpeech will now be provided.

As illustrated in parts (a) and (b) of FIG. 36, we placed two speakers on the left edge (seen from the front) and two microphones on the right edge. We do not anticipate any difference if the sides of the speakers and microphones are reversed. The speakers and microphones are common commercial products, illustratively implemented as Part No. OWR-06049T-38D for the speakers, and Part No. ICS-43434 for the microphones.

The speakers and microphones were connected to a microcontroller module, illustratively a Teensy 4.1 microcontroller module, via FPC cables. We designed a separate add-on board to house the audio amplifier, illustratively an SGTL5000 audio amplifier, and FPC headers. Data were illustratively stored in an on-board micro-SD card on the microcontroller module.

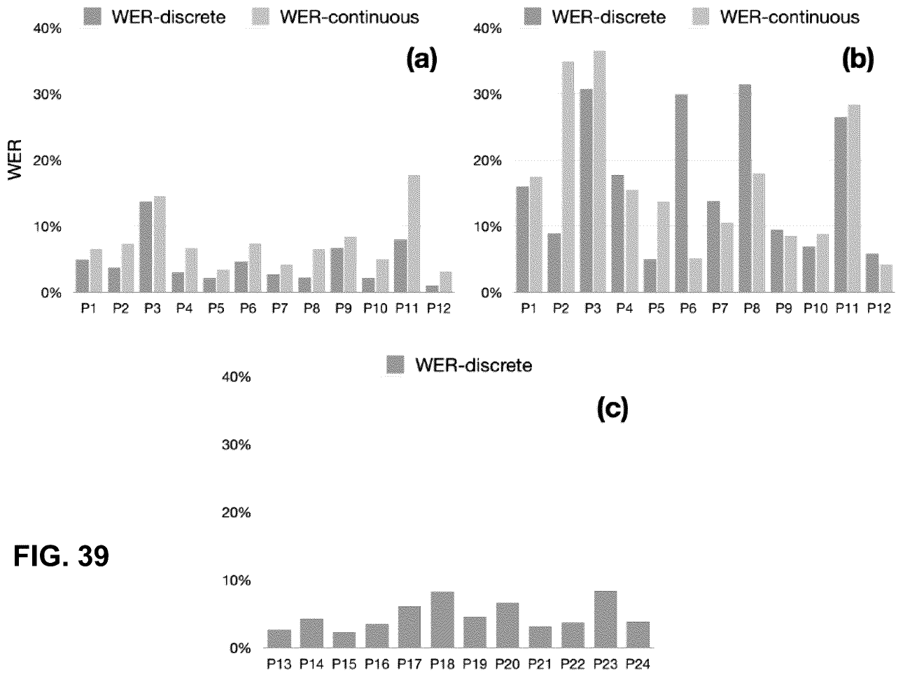

FIG. 38 shows aspects of this example setup, including hardware boards and their respective dimensions. More particularly, part (a) shows the speaker board, part (b) shows the microphone board, part (c) shows the Teensy 4.1 and add-on board (from the add-on board's side), part (d) shows the Teensy 4.1 and the add-on board (from the Teensy 4.1 side), part (e) shows a participant wearing the glass frame with sensors and the Teensy and add-on boards, and part (f) shows a screenshot of an example instruction provided to a user in a study conducted using this example setup, as described below.

As indicated previously, this embodiment uses active acoustic sensing as the sensing approach. More particularly, it utilizes FMCW acoustic signals as the transmitted acoustic sensing signals. To take advantage of two speaker positions, we used different frequency ranges for the two speakers (18-21 kHz for S1, 21.5-24.5 kHz for S2). Both frequency ranges are inaudible to most people. The microcontroller was configured to sample at 50 kHz.

We applied different band-pass filters to separate signals from the two speakers. In this way, four major paths were possible, as illustrated in part (b) of FIG. 36. Each frequency sweep lasted 12 milliseconds (ms), corresponding to an echo frame length of 600 samples. We experimented on different echo frame lengths and found out that 12 ms yielded the best performance in this example setup. After receiving the signals, we calculated echo profiles as the representation of patterns.

With this approach, the vertical axis of the echo profiles represents distance, with each pixel representing

$$\frac{1}{{f}_{s}} \times c ,$$

where fₛ=50 kHz denotes the sampling rate while c=343 m/s denotes the speed of sound. A bright strip on an echo profile represents strong reflection at that certain distance.

In order to remove constant echo reflections from the environment and only focus on the deformations on the skin caused by silent speech, we calculated differential echo profiles by subtracting the previous echo frame from the current one. We stacked the four path combinations as four channels. The differential echo profiles were used as the representation of facial movement patterns and fed into the deep learning pipeline described below. As previously indicated, examples of such representations of facial movement patterns can be seen in part (c) of FIG. 36, where facial movements during different silent utterances are represented by different patterns in the differential echo profiles.

The EchoSpeech system includes a customized deep learning pipeline configured to decipher speech from facial movement patterns represented by echo profiles, as will now be described.

After echo profile calculation, facial movement patterns are already represented by four-channel images. Given its wide application and success in image processing, we use a CNN to decode silent speech from echo profiles. We experimented with adding temporal recurrent neural network (RNN) layers including long short-term memory (LSTM) and gated recurrent unit (GRU) layers. However, they did not improve performance in the example configuration. However, other types of neural networks can be used in other embodiments.

For the CNN, we use ResNet-18 as the backbone. The convolutional layers are followed by a one-dimensional average pooling in which, instead of performing pooling on both axes, we only perform pooling on the spatial axis. In this way, the temporal information is preserved. After this pooling step, the dimensions of the feature vectors become [T/16]×512, where T is the original dimension of the time axis before going through the convolutional encoder. It is reduced to [T/16] during downsampling steps in the encoder. In this way, every 512-dimensional feature vector corresponds to a 16-frame block in the echo profile.

To adapt to variable sequence lengths, we use CTC loss. To achieve this, for each of the 512-dimensional feature vectors from the encoder, we use a fully-connected decoder network with output dimension of W+1 (W distinct labels plus blank) to predict the label of the corresponding position, where W is the number of distinct words in the command set. Note that W may not be equal to the number of commands since commands like “Hang up” are represented by two labels “hang” and “up.” In the discrete speech recognition task, W=32, while in continuous recognition W=10.

EchoSpeech illustratively utilizes a sliding-window implementation, which avoids the need to segment silent utterances manually. In this way, users can speak at different speeds and paces and speak or pause any time, as they wish. To achieve this, we adopted a sliding-window evaluation pattern. In this manner, the system does not rely on pre-existing segmentation that splits different silent utterances apart. Instead, the system automatically generates a prediction where there is a silent utterance detected and gives a blank prediction when no silent utterance is detected.

During training, sliding-window was not applied to avoid confusing the model with incomplete silent utterances. We used single silent utterance and consecutive utterances that last no more than 800 echo frames (9.6s) to train the model to increase training samples as well as to improve the model's generalizability to variable utterance lengths.

During testing, a sliding window with a size of 192 echo frames (2.3s) with a stride of 16 echo frames was applied. We experimented on the window size during evaluation and found that windows with sizes from around 160 echo frames to around 800 echo frames yielded almost the same performance. We utilized 192 echo frames for lighter computational cost. Every window of sample went through the same network as training. A prediction label was given for every 16-frame block in the window. We considered the label to represent the prediction at the corresponding location. Since the stride size 16 was smaller than window size 192, every 16-frame block will be covered by multiple windows. We performed a majority voting and assigned it with the label that appeared the most times among the windows covering that block. We then merged consecutive predictions with the same label and removed blank labels to generate the text prediction continuously.

During algorithm iterations, we analyzed and identified challenges that EchoSpeech faced with and tried to address them with data augmentation. Each data augmentation approach was provided to address a specific challenge, which we detail below.

As indicated above, sliding window was used during testing. With this approach, there is no guarantee that there is a silent utterance at the center of each window. To let the model see the utterances as well as the transitions between utterances, we merge consecutive silent utterances to form longer utterances with pauses in between. For instance, when a user said “One” “Pause” “Alexa” consecutively, we not only used samples such as “One” “Pause” and “Alexa” for training, but samples “One Pause,” “Pause Alexa” and “One Pause Alexa” were also added to the training set. Such operation also improves EchoSpeech's ability to adapt to different speaking speeds, as the same window may cover different number or portion of silent utterances for different users. During training, consecutive silent utterances that last no more than 800 echo frames (9.6s) were added. This means that samples with 1 to 4-6 silent utterances were all included during training. Further increasing this window size leads to marginally improved performance, but significantly increased training time.

During training, all pixels were multiplied by a random factor between 0.95 and 1.05, as random noise. This operation was adopted to increase variance in the samples and avoid over-fitting.

Also, random padding was applied to shift the position of the samples on the time axis and to adapt the model to variable lengths. In order to increase efficiency, samples in a batch were expected to have the same lengths. Due to the vast variance of sample lengths (from less than 100 to 800), we further applied random padding to adapt the model to variable sample lengths. We first sorted all samples according to their lengths. We then took consecutive samples after sorting to form batches. In this way, samples in the same batch have similar lengths. During training, for each batch, in 50% of the cases, we simply pad all samples to the longest sample in that batch. For the other 50% of the cases, we pad all samples to a random length between the longest length and 800.

A robust SSI should be able to recognize speech across different scenarios such as remounting the devices, walking, in noisy environments, etc. One method is to collect training data from participants in all these scenarios. However, it is neither feasible nor practical. In order to make the system robust across various real-world scenarios, we synthesize training samples by adding scenario-specific noises.

We found that EchoSpeech can capture clear echo reflections from the surrounding environment. If the user is static, since echoes from the environment are constant, they can be easily removed while calculating the differential echo profiles. However, if the user is in motion (e.g., a mobile setting), since the device itself is constantly moving, such echoes will leave scenario-specific noises in the echo profiles. We noticed that such noises were mostly linearly added to static echo profiles. Therefore, we applied data augmentation by randomly adding such noises to echo profiles in the static setting to synthesize echo profiles in the mobile setting.

To collect these noises while walking, researchers wore the EchoSpeech device while walking without moving their lips. Using this data, we created noise profiles. During training, a random slice of noise profiles is multiplied by a random factor between 0 and 1 and then linearly added to training samples.

Similar to scenario-specific noises, acoustic noise in the environment can also pollute the signal. Please note that we did apply band-pass filtering. This removed most of the environmental noises, which mostly only occupies lower frequencies. However, certain noises can still extend beyond audible ranges and mix with the EchoSpeech acoustic signals, such as, for example, in a restaurant setting with silverware touching each other, items dropping on the ground, clapping, etc.

The signals that we used in this embodiment are FMCW. It is possible to decode them frame by frame to improve signal-noise-ratio. However, that will inevitably sacrifice spatial resolution. We adopted an approach similar to scenario-specific noises by recording common noises and linearly adding them into training samples to synthesize noisy data. A researcher recorded noises using EchoSpeech devices that includes the following scenarios: people talking and background music playing in a restaurant, vehicles passing by near a road, home appliances running (washer, dryer, fridge, air conditioner), tap water running. During training, 1-3 random slices of noises of random lengths were multiplied by random factors between 0 and 1 and then mixed and added to training samples at random position.

We illustratively utilized a two-step training process to minimize training effort for new participants as well as to improve performance. The system is still user-dependent, but for each new participant, instead of training a customized model from scratch, we only need to finetune the model trained with other people's data. In this way, the entire training process is divided into two steps: 1) pre-train a model using data provided by other participants. The model in this step is denoted as the user-independent (UI) model. And 2) fine-tune the UI model with the new participant's data. In practice, we found that this process improves performance and significantly reduces training time for new participants at the same time.

In order to evaluate the example EchoSpeech system with this approach, we first pre-trained a UI model for each participant using a leave-one-participant-out process. We then fine-tuned the UI model using a different number of training sessions for each participant.

In both steps, we used an Adam optimizer with cosine scheduler and an initial learning rate of 0.0002. The batch size was set to 5. For the pre-training step, the model was trained for 100 epochs. For the fine-tuning step, the entire model was fine-tuned for 15 epochs.

In a user study described below, we evaluated EchoSpeech with a setup that is natural and close to real-life applications. To achieve this, we first designed two sets of commands to examine EchoSpeech's ability in recognizing discrete and continuous speech. We also considered two most common use cases, choosing static (sitting at a desk) and mobile (walking) as the evaluation scenarios. We first evaluate how well EchoSpeech works under these scenarios. Then we further explore the practical implications, especially on how much data a user needs to provide before being able to use EchoSpeech in both scenarios. To better encourage a natural way of speaking, we did not require users to speak slowly. Instead, we instructed users to speak at their normal speed and control the pace of the study themselves. We elaborate on these considerations in the following description.

An ideal silent speech recognition system should be able to recognize any words without limitations, similar to current speech recognition based on voice. However, training such a system requires substantial resources. Thus, the vocabulary in illustrative embodiments is designed to strike a balance between usability and training practicality, thereby allowing us to evaluate EchoSpeech in a variety of different application scenarios including real-time use cases.

We configured a number of example recognition commands for each of the following popular speech interaction scenarios, including 1) hands-free music player control; 2) interacting with smart devices; 3) digits input; 4) activation commands for voice assistants. In total, we have 31 commands for discrete silent speech recognition, as illustrated in Table 7. It is to be appreciated that additional or alternative commands can be used, involving a wide variety of different interaction scenarios, in other embodiments.

TABLE 7
Command set for discrete command recognition

| Scenario | Commands |
|---|---|
| Hands-free music | Play, Stop, Resume, Pause, Previous, Next, Volume |
| player control | |
| Interacting with | Left, Right, Up, Down, OK, Cancel, Menu, Dial, |
| smart devices | Hang up, Open, Close |
| Digits input | Zero, One, Two, Three, Four, Five, Six, Seven, |
| | Eight, Nine |
| Activating voice | Hey Google, Hey Siri, Alexa |
| assistant | |

In addition to the commands, we explored using SSI for continuous input. As discussed previously, continuous recognition is a challenging yet critical step towards adopting SSI in real-world applications. Instead of recognizing a set of pre-defined sentences, we are specifically interested in recognizing unseen combinations from existing vocabulary. We combine this task with voiceless passcode input/authentication. In this use case, users can silently utter a three- to six-figure passcode quickly without pauses in between. In total, there are 1,111,000 different possible combinations (from “000” to “999999”), which cannot be iterated and learned as a whole and can only be learned through breaking down silent utterances into words.

The main study mainly examines how EchoSpeech works in the static environment (sitting at a desk), as well as in the mobile environment (walking) if no training data from the mobile environment is provided. The main study was split into discrete and continuous sections, with the former focusing on the isolated commands while the latter focused on connected digits. The study was conducted in a large room on campus. Each participant came in twice to finish the two sections, each lasting 70-90 minutes. For each section, 18 sessions of data were collected. Participants were instructed to remount the device (take off the device and put it back on) after each session. During data collection, instructions were presented on a laptop screen, which showed the participant the command they need to perform. The laptop's webcam was used to record videos of the session with a clear view of the participant's face for reference. Participants were instructed to “mouth the word silently with lip movements similar or slightly larger than how you would have moved your lips when speaking out loud.”

As indicated previously, the hardware used in the study are illustrated in parts (a) through (e) of FIG. 38. Participants wore the glass frame with sensors installed as shown in part (e) of FIG. 38. The sensors were connected to a Teensy 4.1 microcontroller with a customized audio amplifier add-on board and configured to communicate with a laptop (MacBook Pro 2021) via a USB cable, as illustrated in part (e) of FIG. 38. At the start of each session, the laptop initiated a signal that started recording on Teensy. Meanwhile participants were instructed to clap their hands. We later manually found the clap in the video and audio to synchronize the audio with the ground truth. Clapping of hands was also used at the end of the session in case the one at the beginning was not captured.

During data collection, instructions on the laptop screen included the silent utterance itself (in large font to make sure participants saw them clearly), progress bar of the current utterance (to let the participant know how much time was left before the system jumped to the next utterance), and progress and estimated time left of the current session, as shown in part (f) of FIG. 38. In the discrete section, the maximum duration for each silent utterance was 3 seconds. The system would jump to the next utterance after 3 seconds passed. In the continuous section, the participant had 4 seconds to finish each utterance. It was longer because the length of sequence varied with a maximum length of 6 digits long. However, actual utterances were much faster because the participants were told that they should use the space bar (or the right arrow) to jump to the next utterance once the they finished the current one. This was applied to encourage the participants to speak at their natural pace and speed instead of waiting and pausing. The participants were instructed to use the “x” key (or left arrow) on the keyboard, if they made a mistake in the utterance, wanted to adjust the device or wanted a pause (by constantly pressing). In these cases, the current utterance was repeated.

Silent utterances were given in random order. In the discrete section, each command was repeated 4 times in each session. In the continuous section, each session had 60 connected digits with sequence lengths ranging from three to six. These combinations of digits were generated randomly so that each length (3 to 6 digits) had 15 occurrences and each digit (0-9) had the same number of occurrences (27 times) in each session. In both sections, for sessions 1 through 13, participants sat naturally at a desk. For sessions 14 through 18, participants walked in the room. They were instructed to walk in the room in the way, path and speed as they wished. Sessions 1 and 14 were used for participants to get familiarized with the system and not used during training nor testing.

Each participant finished 2 sections (continuous and discrete). Therefore, there were 24 sections in total. In 12 of the 24 sections, participants were asked to hold the laptop in their arms while walking. In the other 12, the laptop was placed on a moving table so that the participant could push it around while walking. This change was adopted because some participants reflected that the laptop was too heavy as well as to increase variance in the way of walking. No significant difference in performance was observed between these two walking styles.

A follow-up study was conducted after the above-described main study by 12 users that did not participate in the main study. The follow-up study mainly focused on the mobile environment. The main purpose was three-fold: 1) provide more data to conduct thorough evaluation on the mobile environment, 2) improve performance on the main study with new data and analysis, and 3) explore directions for future optimization on the mobile environment.

The follow-up study shared almost the same configuration and procedures as the main study except that there were 17 sessions. Participants walked in the room for sessions 1 through 13 and sat at a desk for sessions 14 through 17. Session 1 was used as a practicing session. Since participants finished the walking sessions first, they did not need to practice again for sitting sessions. In addition, the laptop was always placed on a moving table. It is worth noting that the follow-up study and the main study were conducted in different rooms. The room for the main study was quiet and had carpeted floors. The room for the follow-up study had a noisy ventilation system and hard concrete floors.

In the main study, 12 participants (all college students, 5 self-identified as male, 7 female, average age 23.5: from 18 to 32, std 4.4) were recruited. Hardware malfunction happened twice (broken cable on P3, SD card full on P11) but the participants returned to redo the lost sessions. On average, each session lasted 3.3 minutes in the discrete section, and 3.0 minutes in the continuous section. After removing the practice sessions, 23808 valid silent utterances were collected for the discrete section, in which 17856 were collected when participants were static, while 5952 were collected when participants were in motion. 11520 valid silent utterances (51840 digits uttered) were collected for the continuous section, in which 8640 (38880 digits) were collected when participants were static, and 2880 (12960 digits) were collected when they were in motion. Data collected in the main study is denoted as the main dataset in later text.

Allowing the participants to finish each silent utterance early using keyboard reduced study time. On average, participants spent 1.51 seconds on each discrete silent utterance and 2.67 seconds on connected ones. Variance is also observed: the slowest participants spent 1.83 s while the fastest one spent 1.22s on each discrete silent utterance. On continuous silent utterance, the difference is 2.27s (fastest) and 3.09s (slowest).

The follow up study only included the discrete section. 12 participants that did not participate in the main study were recruited (5 self-identified as male, 7 female, average age 25.4: from 19 to 35, std 5.0). Each session lasted 2.6 minutes on average. Participants spoke generally faster. The average silent utterance duration was 1.20 seconds (fastest: 0.93s, slowest: 1.53s). Data collected in this study forms the follow-up dataset.

We now further describe the experiments conducted to evaluate EchoSpeech. We start by presenting the evaluation metric. We then present the experiments conducted on the main dataset and the follow-up dataset, respectively. After that, we present further experiments and analysis to improve performance and reduce training effort.

As indicated previously, the evaluation metric used in these example embodiments was WER. WER is commonly used in speech recognition-related tasks. Compared with accuracy, WER is better at gauging continuous predictions. For instance, for sequence “Volume up,” if the prediction is “Volume,” using accuracy as metric will treat the prediction as wrong while the WER will be 0.5, better reflecting that the model finishes half the job. This is especially useful in longer sequences. WER of around 5% is usually considered human performance and is acceptable in conversations.

We calculate the metric in the unit of each silent utterance as recorded during the user study. For each silent utterance, we compare the text prediction generated using the sliding window approach as previously described with the ground truth and calculate WER as:

$$WER = \frac{S + D + I}{S + D + C} \qquad ( 2 )$$

where S, D, I and C are the numbers of substitutions, deletions, insertions and corrected words, respectively.

Experiments on the main study mainly examine how EchoSpeech works in recognizing discrete and continuous silent speech in the static environment. In addition, we also utilize the mobile sessions in the main study to evaluate how EchoSpeech works while walking without providing training data from the mobile environment.

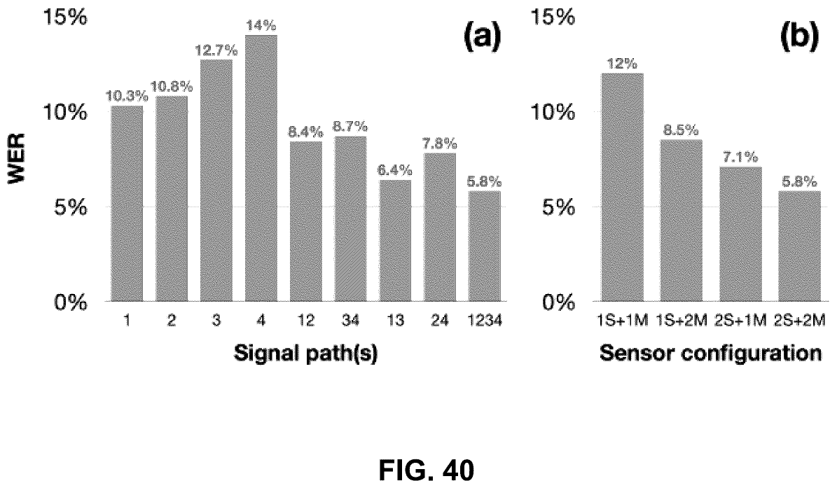

FIG. 39 shows discrete and continuous speech recognition performance, across participants, with part (a) showing performance in the static setting, part (b) showing performance in the mobile setting, and part (c) showing performance in the mobile setting on new participants from the follow-up study.

We evaluated EchoSpeech's capability to recognize discrete speech using the algorithm pipeline described previously. We adopted the two-step training process, training a leave-one-participant-out (LOPO) UI model for each participant first, and fine-tuning the UI model using the same participant's data. To remove random factors, we performed a 6-fold cross-validation on the 12 static sessions. To achieve this, we utilized 2 sessions as testing (sessions 2,3, sessions 4,5, . . . , sessions 12,13) and used the remaining 10 sessions to fine-tune the model. We used the model after the last epoch to evaluate. The discrete speech recognition results across participants are shown in part (a) of FIG. 39.

More particularly, for discrete speech recognition, the average WER across 12 participants was 4.5%, ranging from 1.0% (P12) to 13.7% (P3), std=3.5%. We specifically looked into the two participants with worst performance (P3, P11), we found out that they both pushed the glass frame multiple times as the glass frame frequently slipped down their nose during the study. Since the sensors of EchoSpeech were pointing downwards, pushing the glass frame introduces significant noise in the signals.

We evaluated EchoSpeech's capability in recognizing continuous speech using a similar approach to that of discrete speech. Results indicate that the average WER across 12 participants is 6.1%, ranging from 2.1% (P12) to 16.3% (P11), std=4.2%. Results for each participant are shown in FIG. 39 (b). Similar to that of isolated digits, pushing the glass frame was found to cause most issues in participants with worst performances (P3 and P11). For P11, an additional observation was that the participant made some mistakes but did not remove them from the samples. This was observed by watching the recorded study videos. It was difficult to remove all such bad samples, since the utterances were silent and difficult to make out from the video due to limited lip movement and fast speaking speed. If P11 is removed from the study, average WER was improved to 5.2%.

The results presented above were achieved with 10 sessions (around 30 minutes) of training data collected from the same user. This already represents a significant advancement relative to conventional approaches. However, we wish to further minimize training effort from new participants, pushing towards higher practicability. Therefore, we conducted several experiments to demonstrate how to minimize training effort from new participants.

We demonstrate that users can provide as little as 2 sessions (6-8 minutes) and still achieve acceptable performance. We experimented with different numbers of fine-tuning sessions. When no data was used for fine-tuning, the system works user-independently. In this way, WER for recognizing discrete and continuous speech is around 40%. The impact of the amount of data used for fine-tuning was assessed by using data from the same user collected in the same setup to fine-tune the model, using data from the same user collected in the static setup to fine-tune the model for the mobile setup, and adding other people's data to training to improve performance.

It was found that performance improves with more training sessions applied, while flattens after about 4 sessions of data applied. With only 2 sessions of training data, EchoSpeech is already able to recognize 31 isolated commands or 3-6-figure connected digits with 9.5% and 14.4% WER, respectively.

Using the 4 mobile sessions from each user, we evaluated how EchoSpeech performs when the user was in motion without providing training data while walking. This can minimize training effort. We applied data augmentation as described previously by adding motion noises to static data and evaluated EchoSpeech without any training data collected in mobile settings. The motion noises were collected by researchers at different locations from the study. We trained a model using data collected from all participants in the static setting, applied data augmentation, and evaluated on all participants' data collected in the mobile setting. Results show that average WER across 12 participants is 16.8% for both discrete and continuous speech (std: 10.3%, 11.0%, respectively), as demonstrated in part (b) of FIG. 39. This result is significantly worse than the static setting. Additional techniques to improve this result are described below.

As discussed earlier, the follow-up study was conducted to provide more data for thorough evaluation on the mobile environment, improve the mobile performance in the main study, and explore directions for further optimization.

The richness of new data allowed us to train a user-dependent model similar to that in the main study to explore the limit of EchoSpeech when the user was in motion. Adopting the same two-step training process as described previously, we trained a LOPO UI model for each user first, then fine-tuned it with 10 mobile sessions from the same user. Results shown in part (c) of FIG. 39 demonstrate consistent performance compared with when the user was static: average WER is 4.7% (std 2.1%), ranging from 2.3% (P15) to 8.4% (P23). This result demonstrates that with enough training data, EchoSpeech can adapt to different scenarios with robust performance.

To reduce training effort, we experimented with different numbers of fine-tuning sessions, similar to the main study. The results are also similar. It was found that performance improves with more training sessions applied, and flattens after about 4 sessions of data applied. With only 2 sessions of training data (about 68 minutes), EchoSpeech is already able to recognize 31 isolated commands in motion with 8.2% WER (std 2.5%).

As indicated above, performance on the mobile environment was significantly worse even after applying data augmentation. We demonstrate that even without new data from the same user, this performance can be improved by incorporating other users' walking data into training. Adding 11 other users' walking data into training from the original study, performance on discrete and continuous speech recognition improved from 16.8% to 13.1% and 13.2%, respectively. Continuing to add the 12 new users' data from the follow-up study, performance on discrete speech recognition further improved to 10.7%. It was found that performance steadily improved with more other users' data being added. This also points a future direction for further optimizing performance and reducing training effort with scaled up data collection.

To explore further reducing training effort, we conducted evaluation on the follow-up study, utilizing all available data from other users. With this approach, for each user, with 4 static sessions as training and no mobile sessions, EchoSpeech achieves 8.7% (std 2.8%) in recognizing 31 discrete commands. With only 2 static sessions, performance can still reach 13.2%.

Combined with the previously-described results, this means that a new user only needs to provide 6-8 minutes of static training data to use the system in both static and mobile environments with acceptable performance. Additionally, with potential large-scale deployment in the future, this performance can be further improved and the training effort can be further reduced. These results indicate that illustrative embodiments can provide a practical SSI useful in daily life.

While recognizing continuous speech, we are interested in how the errors distribute among sequences with different lengths. We calculated the average WER for 3-6 digit silent utterances separately. Results demonstrate that although longer sequences take more time and have more syllables, no significant performance discrepancy is observed in the recognition performance.

In addition, we also examined the impact of speaking speed on the performance. Results show that for discrete speech, performance decreases if the duration is shorter than 1.4 s and stays steady if participants spoke slower. For continuous speech, no significant trend is observed.

As described previously, EchoSpeech utilizes 2 pairs of speakers and microphones, enabling four major signal paths. In order to examine how each path contributes to the performance, we conducted an experiment isolating each path by applying different band-pass filters. We adopted one-step training to save time. Sessions 12-13 of all participants were used for testing and sessions 2-11 of all participants were used for training.

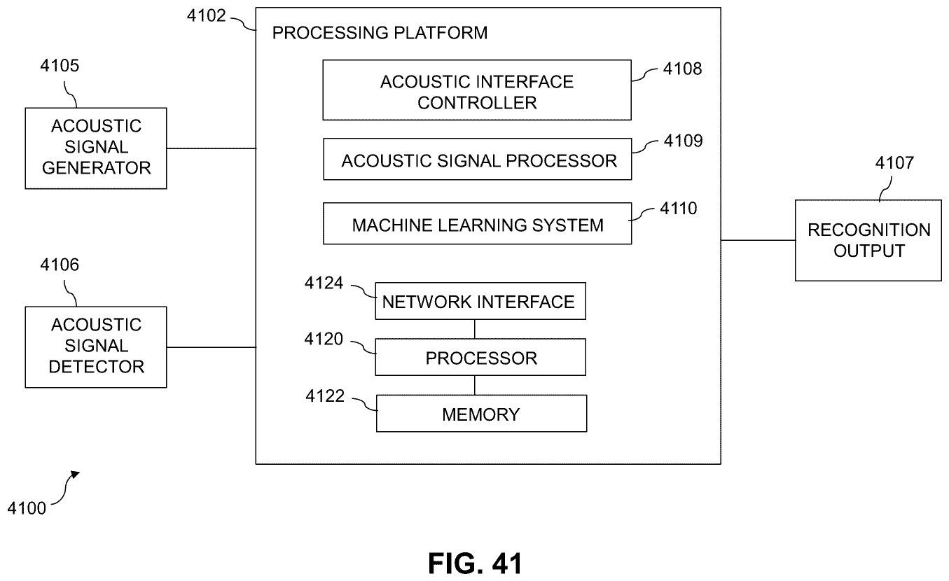

FIG. 40 shows the impact of different signal paths and sensor configurations. Part (a) of the figure illustrates variation in WER for different signal paths, and part (b) of the figure illustrates variation in WER for different sensor configurations, where 1S+1M denotes using one speaker and one microphone, etc.

The results shown in FIG. 40 indicate that performance degrades from 5.8% to 12.0% on average if only one path (one speaker and one microphone) is used. Path 1 and path 2 are more useful than path 3 and 4. This confirms that four paths all contribute positively to the system. However, considering the device size, cost, computation load and power consumption, such degradation can be acceptable in certain scenarios. We demonstrate herein that a low-power variation of EchoSpeech with only one speaker and two microphones can operate at as low as 73.3 mW and run in real-time on a smartphone.

In order to examine how EchoSpeech works in noisy environments, we experimented with noise injection by mixing noises into the data we collected. A researcher used the same device as used in the user study to record two types of noise: 1) street noise. The researcher walked along a busy street for 5 minutes. Cars passed by frequently. Using the NIOSH Sound Level Meter App on an iPhone 12, the noise level was 64 dB(A). 2) restaurant noise. The researcher went into a noisy restaurant and recorded for 5 minutes. Background music and crowd chatting could be heard. The same app measured the noise level at 76 dB(A).

A spectrum analysis of the injected noises and the EchoSpeech acoustic signals was performed. It was found that most of the noise components are below the range of the EchoSpeech acoustic signals. For those that do overlap, the amplitude of the EchoSpeech acoustic signals is much stronger than the noise.

We also mixed the two types of noise into each session collected during the user study. We used models trained and fine-tuned on clean data and directly tested them on noisy data. The results show that performance in static setting slightly decreases around 2% for street noise and around 3% for restaurant noise. However, there was almost no change in performance in the mobile setting. We hypothesize that noisy patterns on the echo profiles from walking makes the model robust to different noises on the echo profiles, thus providing extra resilience against environmental noises.

We then applied the data augmentation as described previously. One researcher collected the noises from different places. The data augmentation was applied during the fine-tuning stage without the need to re-train the model. After applying data augmentation, EchoSpeech becomes even more resilient against acoustic noises, yielding almost the same performance as when no noise was present.

As is apparent from the foregoing description, EchoSpeech can be used as an alternative hands-free and eyes-free input method in a variety of applications. We implemented the system in several sample applications and demonstrated them in the above-described experiments. Although these functions can all be achieved by using traditional speech interfaces, traditional speech recognition requires the user to speak aloud which is frequently inconvenient or socially inappropriate. EchoSpeech provides a new input form, that can be integrated with other existing interactive technologies or used alone.

For example, EchoSpeech can be used with CAD software. CAD software usually involves many options, configurations and dimensions. It can be challenging to incorporate them with the natural way of design (e.g., directly drawing on canvas) because users need to switch between options, specifications and the graph itself constantly. Furthermore, users often need to work at quiet places (e.g., library, lab) while working on these design tasks. Thus, speech recognition is not feasible. EchoSpeech provides an option to use silent utterance as an extra interface, without disturbing others with voice commands. We have demonstrated this use case by using EchoSpeech to draw basic shapes on CAD. Here EchoSpeech provides an additional input modality that can be used together with existing stylus input smoothly. The user first selected the types of shapes with silent commands. Then the user naturally drew the shape with a stylus and used silent commands to specify the dimensions.

As another example, silent utterances can be recognized by EchoSpeech in numerous mobile use applications. More particularly, while in motion, it is usually inconvenient and even dangerous to engage in interactions with hands and/or eyes. In such cases, uttering the interaction intention can be a good alternative. EchoSpeech provides a solution where users have access to a hands-free and eyes-free interface without needing to speak out loud, which can be particularly suitable for mobile use.

In addition to the applications discussed above, EchoSpeech can be used in certain scenarios as a replacement or improvement to existing interfaces. These scenarios particularly focus on cases where the users have occupied hands or inaccessible devices, and are presented as illustrations of the position of EchoSpeech. In addition, the EchoSpeech system in other embodiments can be fully integrated into real glasses or other form factors, so that the sensors are effectively invisible in terms of outward appearance. Such arrangements allow EchoSpeech to be used with minimal level of social awkwardness, thus facilitating the following use cases, among numerous others.

For example, EchoSpeech can be integrated with earphone/headsets to control music players. Voice has already been used to control music players. EchoSpeech provides an alternative approach without making sound, which could expand the use cases of voice music player control.

As another example, EchoSpeech can be used to assist with text input on mobile phones. Inputting punctuation and symbols using the keyboard on a smartphone is not very convenient, as it requires users to switch to secondary keyboards. In such cases, if these keys can be silently mouthed, then users can keep their focus on the main input without switching between keyboards. With a larger vocabulary, it is also possible to integrate more words and functions to realize a dictation-style input interface that is even more natural and smooth.

Example implementations of the above-described use cases were developed using a low-power variant of EchoSpeech and deploy the processing pipeline on a smartphone. We employed the wireless module with nRF52840 microcontroller for Bluetooth Low Energy (BLE) data transmission. Since the module only supports one-channel audio transmission, we used the one speaker (S1) and two microphones (M1+M2) setup. With this setup, we measured the power consumption of the entire module while transmitting data via BLE using a current ranger. Results show that the system operates at 73.3 mW (3.96 V, 18.5 mA).

We implemented the data processing and deep learning pipeline on an Android phone (Xiaomi Redmi K40) using PyTorch Mobile, for multiple example applications. For each application, one researcher collected a small amount of training data (1-6 minutes) with a command set including all the desired commands. The phone handled all processing and prediction and transmitted results to an ESP32 that registered itself as a Bluetooth keyboard. The ESP32 analyzed the predictions and sent corresponding action keys to the device that it paired with. For instance, when controlling a music player, the ESP32 paired with the phone that is playing music. When it received the command “Next,” it sent a “Next song” key to the phone.

As described previously, EchoSpeech uses a CNN-based model for both discrete and continuous silent speech recognition. It is also possible to use other types of neural network models, such as RNN models that include LSTM or GRU layers at the end of CNN layers to extract temporal patterns. We experimented on such convolutional RNN (CRNN) models, including, for example, attaching LSTM and GRU components after the CNN encoder in some implementations. The results generally indicated that GRU works better than LSTM. In most cases, CNN and CRNN networks work similarly. However, CNN converges faster than CRNN with the same number of epochs. In certain cases, the latter had trouble converging. Also, CNN without RNN layers needs less computational resources and runs faster. For these reasons, we used the CNN model without RNN layers. We attribute the success of CNN to the feature representation and customized pooling strategy of illustrative embodiments herein. With the echo profile calculation, we converted all temporal features into spatial ones. For instance, speech at different speeds will be reflected in the echo profiles as having different lengths. The one-dimension average pooling preserves temporal information and enables the network to cope with silent utterances with variable lengths without losing information.

In order to minimize power consumption as well as to reduce the potential impact on the user and the surrounding environment, we conducted an experiment on speaker power. One researcher collected data with 10 different signal amplitude configurations, ranging from 0.67% to 100% (using the amplitude used during the user study as 100%). For each amplitude configuration, 8 sessions of data of a smaller command set (10 digits) were collected. For each amplitude, 8-fold cross-validation were performed to minimize randomness. All 80 sessions were collected in random order to make sure that results are maximally directly comparable. The data was collected in a quiet environment while we injected noises later. Noise augmentation was also performed.

The results show that in a quiet environment, even with very low amplitude, the system still worked reliably. However, when the restaurant noise was injected, performance significantly degraded. The larger the amplitude, the less degradation happened. When noise augmentation was applied, performance significantly improved except for very low amplitude. The flattening point was between 10% and 20%. For speaker amplitude greater than 20%, the system performance was basically not impacted by noises when data augmentation was applied. At 20% amplitude, each speaker roughly consumes 1.2 mW, compared with 28 mW at 100%. This further reduced the system's power signature to around 50 mW with both speakers, compared with 73.3 mW with 1 speaker.

In the above-described real-time smartphone implementation, EchoSpeech operates at 73.3 mW, which can last for over a day on AR glasses such as Google Glass, Espon Moverio, and Microsoft HoloLens which all have a battery size of over 800 mAh. Adjusting the amplitude further reduced power consumption to around 50 mW. Further reduction of power consumption can be achieved by adjusting the duty cycle. For instance, it is possible to adjust EchoSpeech to operate at low sweeping rate when not actively used. Once an activation is detected, the system can be turned on at full speed.

With regard to the impact of native/non-native speakers, some studies have found out that native speakers tend to perform better in silent speech tasks. In the EchoSpeech study, all participants were fluent with English, but only P7 and P12 were native speakers. While their performance was indeed better than average (average WER 1.9% vs. 4.6% on isolated commands), the sample size is too small to draw any conclusion. We believe that just like voiced speech, SSI should be developed for all fluent speakers regardless of whether they are native speakers or not.

With regard to health implications on ultrasound exposure, it is noted that EchoSpeech uses near ultrasound as the sensing medium. NIOSH recommendation of noise exposure mainly focuses on noises below 16 kHz, which we did not use. A review focusing on airborne ultrasound exposure recommends 75-85 dB SPL as the limit for long-term exposure for frequencies near 20 kHz. To investigate the sound pressure level of the system, one researcher wore the device and placed a microphone near the edge of the left ear canal, the one closer to the speakers. At 100% amplitude, the RMS value of the recorded sound is 1107 (−26.4 dB FS). Taking the sensitivity (−26 dB FS @1 kHz, 94 dBSPL) and frequency response (+15 dB at 20 kHz) data into account, the estimated intensity at the ear canal is 78.6 dB SPL, near the edge of the strict versions of recommendations. However, as described above, reducing the amplitude to 20% has little impact on performance. At 20% amplitude, the RMS value of recorded sound is 167 (−42.8 dB FS), and the estimated intensity is 62.2 dB SPL, well below recommended levels.

The acoustic sensing signal in illustrative embodiments ranges from 18 to 24.5 kHz. To most adults, this range is not audible. However, it may still be audible to children and certain animals. To minimize impact on the environment, EchoSpeech can be used in an activate-to-speech way. For instance, it is possible to define an activation gesture such as nodding and integrate an IMU module on the glass frame to detect system activation. In this way, both power and computational resources can be saved, meanwhile bringing less disturbance into the environment.

With regard to impact of form factor and shape of face, different sizes of glass frame may have some impact on the performance in that the signal paths will be different. Intuitively, a lager glass frame usually has lower edges, which makes the sensors closer to the mouth. However, based on limited experiments, we did not observe discrepancy in different glass frames. During early stages of the exploration, researchers experimented on three different glasses: a small one that tightly fits the face, a light yet large one with lower edges, and the one used in the user study. All glass frames were commercial products purchased online or at a local store. We utilized the particular one shown in the illustrative embodiment of FIG. 36 because its size is easier to fit different head shapes: the small one was too small for some people while the large one slid down too easily.

We also examine possible impacts of different shapes of face. We measured the height and width of participants' face from the video and compared them against the size of the glass frame to obtain the actual sizes. The face shape was not found to have any correlation with performance, although the current sample size (12) is too small to draw any conclusion.

It should be noted that performance is degraded when objects get too close to the sensors, such as pushing glasses with fingers. We believe that this issue might be improved by applying data augmentation. However, we also believe that such a limitation might be acceptable. Research already shows that users are willing to tolerate more errors for silent speech system. Pushing glasses in the EchoSpeech system may be viewed as comparable to coughing or sneezing as to voiced speech interfaces.

Several participants reflected that the glass frame was not particularly stable during the study (P7, P8, P11). They all have relatively small faces. This issue may negatively impact performance. We believe that more glass frames size options or personalized glass frame can mitigate this issue.

Activating the system before use can save significant power and computational resources. Although EchoSpeech uses a segmentation-free pipeline that automatically detects the start and end of speech, it was not evaluated specifically for activation purposes. To be used with activation, the system needs to be able to tell certain activation gestures apart from various other activities, even including speech. Other embodiments can be specifically configured to include such functionality.

The above-described EchoSpeech embodiments provide a minimally-obtrusive contact-free SSI on a glass frame that can recognize both discrete and continuous speech. EchoSpeech strives to address the key challenges faced by wearable SSIs by placing two pairs of speakers and microphones on either side of a glass frame. Such configuration allows EchoSpeech to capture subtle yet highly-informative skin deformations with acoustic sensing at a close-up yet comfortable position. A customized deep learning pipeline enables EchoSpeech to recognize discrete and continuous speech without segmentation. A user study with 12 participants shows that EchoSpeech achieves a WER of (std 3.5%) and 6.1% (std 4.2%) on recognizing 31 isolated commands and 3-6 figure connected digits, respectively. Further evaluation demonstrates EchoSpeech's robustness across different scenarios such as walking and injected noises. Finally, we describe a real-time implementation that operates at 73.3 mW with pipelines running on a smartphone to show example use cases.

Illustrative embodiments disclosed herein provide acoustic interface systems for silent speech recognition and other applications. For example, some embodiments are configured to recognize silent speech, although it is to be appreciated that the disclosed techniques are more widely applicable to numerous other acoustic signal processing contexts.

One embodiment of an acoustic interface system as disclosed herein comprises a wearable device which uses acoustics to track the oral cavity or lung cavity of a human subject through the nostrils. The wearable device comprises one or more high frequency microphones or speakers positioned just below each nostril (e.g., one speaker under right nostril, one microphone under left nostril). These acoustic components can be embedded in any form factor positioning them under the nose (e.g., virtual reality (VR) headset, face mask, eyeglass frame, etc.). Acoustic signals generated by the speaker traverse through the nostril and are reflected back out and detected by the microphone. Depending on the shape of the oral tract or lungs (e.g., speaking, eating, moving tongue, breathing, etc.), acoustic attenuations will be altered. The system can be used for silent speech recognition, eating/drinking detection, tongue tracking, breathing detection and in a wide variety of other applications.

It is to be appreciated that the foregoing and other arrangements disclosed herein are only examples, including examples of potential applications of the disclosed techniques, and numerous alternative arrangements are possible.

These and other illustrative embodiments include but are not limited to systems, methods, apparatus, processing devices, integrated circuits, and computer program products comprising processor-readable storage media having software program code embodied therein.

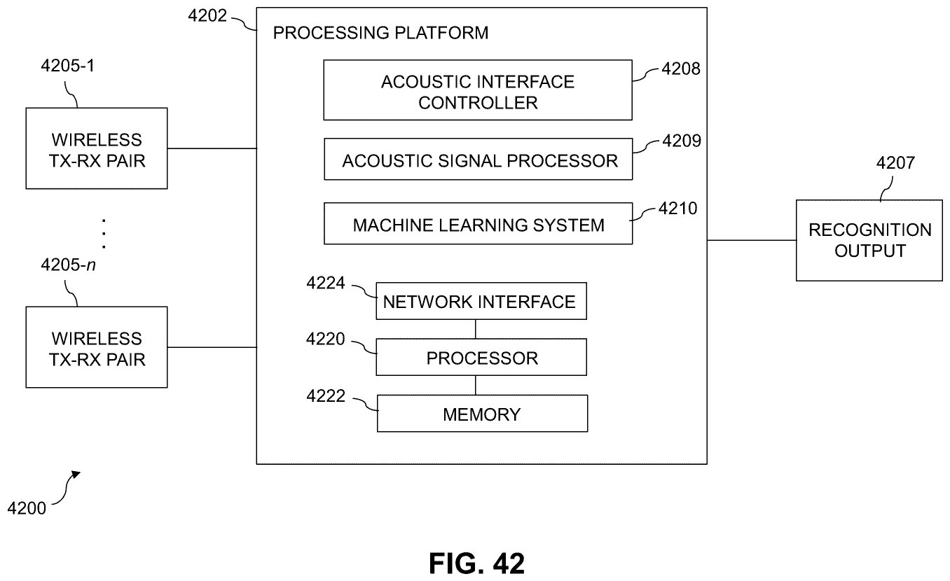

FIG. 41 shows an information processing system comprising an acoustic interface system that includes a processing platform configured to implement machine learning based acoustic signal processing in an illustrative embodiment.

In some embodiments, an acoustic interface system is configured to track activities inside the upper (e.g., oral tract, throat) and lower (e.g., lungs) respiratory system from outside the mouth in a minimalist form factor, illustratively using an inexpensive microphone and speaker. Numerous other applications can be implemented using the information processing system as illustrated in FIG. 41, including by way of example acoustics-based eye tracking and acoustics-based silent speech recognition, as previously described.

Illustrative embodiments overcome drawbacks of conventional approaches, in some implementations by using one or more nostril openings as a window into the respiratory tract cavities to detect various mouth-related activities and/or other activities, such as lung-related activities. For example, some techniques disclosed herein operate in a manner that is at least partially analogous to that of the human vocal folds, except that instead of sending sound at low frequencies (e.g., 80-300 Hz) through the pharynx and up into the oral cavity, the acoustic interface system is sending high frequency sound waves (e.g., 18 kHz+), illustratively from what is also referred to herein as an acoustic signal source, through the nasal cavity and into the underlying cavities (e.g., oral and lungs) to capture mouth-related and/or lung-related activities.

The disclosed embodiments have numerous diverse applications, including speech recognition, silent speech recognition, tongue tracking for human-computer input, breathing or coughing detection, eating/drinking detection, throat inflammation detection, etc. For example, illustrative embodiments of an acoustic interface system can be configured to recognize whenever the shape of the respiratory tract changes, even if due to minimal activity such as the tongue wiggling or a slight inhalation. Again, numerous other applications are possible, as is apparent from other description herein.

FIG. 41 more particularly shows an information processing system 4100 implementing machine learning based acoustic signal processing in an illustrative embodiment. The information processing system 4100 may be viewed as one possible example of what is also referred to herein as an “acoustic interface system” and is illustratively configured to interface with one or more human users. The system 4100 comprises a processing platform 4102. Coupled to the processing platform 4102 are at least one acoustic signal generator 4105 and at least one acoustic signal detector 4106, and the processing platform generates recognition output 4107.

The acoustic signal generator 4105 may be implemented, for example, utilizing one or more speakers, and the acoustic signal detector 4106 may be implemented, for example, utilizing one or more microphones, although it is to be appreciated that various types of alternative transducers or other acoustic components can be used. The recognition output 4107 in some embodiments comprises control signals or other types of signals generated by the processing platform 4102, possibly to control one or more external processing devices that are not explicitly shown. In some embodiments, the processing platform 4102, the acoustic signal generator 4105, the acoustic signal detector 4106 and the recognition output 4107 are part of the same device or set of devices, such as a VR headset or other type of wearable device. Other examples of wearable devices that can be used to implement at least portions of the system 4100 include face masks and eyeglass frames, among numerous others.

The processing platform 4102 comprises an acoustic interface controller 4108, an acoustic signal processor 4109 and a machine learning system 4110. The machine learning system 4110 in the present embodiment more particularly implements one or more machine learning algorithms, such as neural network based machine learning algorithms configured to facilitate the generation of recognition output relating to acoustic signal processing of the type described elsewhere herein, although other arrangements are possible. For example, in some embodiments, the machine learning system 4110 implements at least one neural network, such as a ResNet-18 neural network, which is a type of CNN that is 18 layers deep. It is to be appreciated that numerous other neural networks can be used, including a wide variety of alternative types of CNNs and/or RNNs, in any combination.

In operation, the system 4100 is illustratively configured to generate an acoustic signal via the acoustic signal generator 4105, and to direct the acoustic signal into at least a portion of a respiratory cavity (e.g., a nasal cavity and/or an oral cavity) of a human user. The system 4100 is further configured to detect the acoustic signal as reflected back from at least a portion of the respiratory cavity, utilizing the acoustic signal detector 4106, to process information characterizing at least the reflected acoustic signal in the machine learning system 4110, and to obtain recognition output 4107 from the machine learning system 4110 based at least in part on the processing of the information characterizing at least the reflected acoustic signal.

The information characterizing at least the reflected acoustic signal may comprise, for example, the reflected acoustic signal itself, and/or other information generated by acoustic signal processing of the input acoustic signal and the reflected acoustic signal in the acoustic signal processor 4109.

The above-noted operations are illustratively performed by or under the control of one or more processing devices of the processing platform 4102, with each such processing device comprising a processor coupled to a memory. For example, in some embodiments, the acoustic interface controller 4108 controls the performance of the above-noted operations, which may further involve directing the acoustic signal processor 4109 to provide appropriate control signals to drive the acoustic signal generator 4105 and to perform acoustic signal processing utilizing the input acoustic signal from the acoustic signal generator 4105 and the reflected acoustic signal detected by the acoustic signal detector 4106.

In some embodiments, the recognition output 4107 obtained from the machine learning system 4110 is indicative of one or more characteristics of at least one of speaking, eating, tongue movement and breathing of the human user.

Additionally or alternatively, the recognition output obtained from the machine learning system 4110 in some embodiments comprises silent speech recognition output.

In some embodiments, directing the acoustic signal into at least a portion of the respiratory cavity of the human user illustratively comprises directing the acoustic signal into a first nostril of the human user.

In such an embodiment, detecting the acoustic signal as reflected back from at least a portion of the respiratory cavity illustratively comprises detecting the reflected acoustic signal at a second nostril of the human user. Additionally or alternatively, detecting the acoustic signal as reflected back from at least a portion of the respiratory cavity illustratively comprises detecting the reflected acoustic signal at a mouth of the human user.

As indicated previously, the recognition output 4107 can include one or more control signals. For example, silent speech recognition output of the processing platform 4102 can be used to control an external device, such as a computer, mobile telephone, television, gaming console or other type of processing device.

The recognition output 4107 in some embodiments is illustratively configured to trigger at least one automated action in at least one processing device that implements the processing platform 4102, and/or in at least one additional processing device external to the processing platform 4102. For example, as mentioned above, one or more control signals that are part of the recognition output 4107 may be transmitted over a network from a first processing device that implements at least a portion of the processing platform 4102 to trigger at least one automated action in a second processing device that is external to the processing platform 4102.

As a more particular example, the control signal generated by the processing platform 4102 illustratively comprises at least one control signal configured to automatically adjust one or more parameters of an external computer or other processing device.

It is to be appreciated that the term “machine learning system” as used herein is intended to be broadly construed to encompass at least one machine learning algorithm configured to facilitate acoustic signal processing through utilization of one or more machine learning techniques. The processing platform 4102 may therefore be viewed as an example of a “machine learning system” as that term is broadly used herein.

Although the acoustic interface controller 4108, the acoustic signal processor 4109 and the machine learning system 4110 are all shown as being implemented on processing platform 4102 in the present embodiment, this is by way of illustrative example only. In other embodiments, the acoustic interface controller 4108, the acoustic signal processor 4109 and the machine learning system 4110 can each be implemented on a separate processing platform. A given such processing platform is assumed to include at least one processing device comprising a processor coupled to a memory.

Examples of such processing devices include computers, servers or other processing devices arranged to communicate over a network.

The network can comprise, for example, a global computer network such as the Internet, a WAN, a LAN, a satellite network, a telephone or cable network, a cellular network such as a 4G or 5G network, a wireless network implemented using a wireless protocol such as Bluetooth, WiFi or WiMAX, or various portions or combinations of these and other types of communication networks.

It is also possible that at least portions of other system elements such as the acoustic signal generator 4105 and/or the acoustic signal detector 4106 can be implemented as part of the processing platform 4102, although shown as being separate from the processing platform 4102 in the figure. For example, in some embodiments, all of these components of the system 4100 can be implemented in a VR headset or other wearable.

Examples of automated actions that may be taken in the system 4100 responsive to recognition output 4107 generated by the machine learning system 4110 include controlling one or more processing devices over a network.

A wide variety of additional or alternative automated actions may be taken in other embodiments. The particular automated action or actions will tend to vary depending upon the particular application in which the system 4100 is deployed.

For example, some embodiments disclosed herein implement acoustic interface systems for silent speech recognition and numerous other applications, as described in more detail elsewhere herein. It is to be appreciated that the term “automated action” as used herein is intended to be broadly construed, so as to encompass the above-described automated actions, as well as numerous other actions that are automatically driven based at least in part on outputs of a machine learning algorithm as disclosed herein.

The processing platform 4102 in the present embodiment further comprises a processor 4120, a memory 4122 and a network interface 4124. The processor 4120 is assumed to be operatively coupled to the memory 4122 and to the network interface 4124 as illustrated by the interconnections shown in the figure.

The processor 4120 may comprise, for example, a microprocessor, an application-specific integrated circuit (ASIC), a system-on-chip (SOC), a field-programmable gate array (FPGA), a central processing unit (CPU), a graphics processing unit (GPU), a neural processing unit (NPU), a data processing unit (DPU), a tensor processing unit (TPU), an arithmetic logic unit (ALU), a digital signal processor (DSP), and/or other similar processing device components, as well as other types and arrangements of processing circuitry, in any combination. At least a portion of the functionality of at least one machine learning system and its associated machine learning algorithms provided by one or more processing devices as disclosed herein can be implemented using such circuitry.

In some embodiments, the processor 4120 comprises one or more graphics processor integrated circuits. Such graphics processor integrated circuits are illustratively implemented in the form of one or more GPUs. Accordingly, in some embodiments, system 4100 is configured to include a GPU-based processing platform. Such a GPU-based processing platform can be cloud-based configured to implement one or more machine learning systems for processing data associated with a large number of system users. Similar arrangements can be implemented using NPUs, DPUs, TPUs and/or other processing devices, in addition to or in place of GPUs.

Numerous other arrangements are possible. For example, in some embodiments, a machine learning system can be implemented on a single processor-based device, such as a smart phone, client computer, wearable device or other user device, utilizing one or more processors of that device. Such embodiments are also referred to herein as “on-device” implementations of machine learning systems.

The memory 4122 stores software program code for execution by the processor 4120 in implementing at least portions of the functionality of the processing platform 4102. For example, at least portions of the functionality of acoustic interface controller 4108, acoustic signal processor 4109 and machine learning system 4110 can be implemented using program code stored in memory 4122.

A given such memory that stores such program code for execution by a corresponding processor is an example of what is more generally referred to herein as a processor-readable storage medium having program code embodied therein, and may comprise, for example, electronic memory such as SRAM, DRAM or other types of random access memory, flash memory, ROM, magnetic memory, optical memory, or other types of storage devices in any combination.

Articles of manufacture comprising such processor-readable storage media are considered embodiments of the invention. The term “article of manufacture” as used herein should be understood to exclude transitory, propagating signals.

Other types of computer program products comprising processor-readable storage media can be implemented in other embodiments.

In addition, illustrative embodiments may be implemented in the form of integrated circuits comprising processing circuitry configured to implement processing operations associated with one or more of acoustic interface controller 4108, acoustic signal processor 4109 and machine learning system 4110 as well as other related functionality. For example, at least a portion of the machine learning system 4110 is illustratively implemented in at least one neural network integrated circuit of a processing device of the processing platform 4102.

The network interface 4124 is configured to allow the processing platform 4102 to communicate over one or more networks with other system elements, and may comprise one or more conventional transceivers.

It is to be appreciated that the particular arrangement of components and other system elements shown in FIG. 41 is presented by way of illustrative example only, and numerous alternative embodiments are possible. For example, other embodiments of information processing systems can be configured to implement machine learning system functionality of the type disclosed herein.

As indicated previously, the system 4100 can be configured to support a wide variety of distinct applications, in numerous diverse contexts, as disclosed in conjunction with the description of other illustrative embodiments herein.

It is to be appreciated that the particular arrangements described above are examples only, intended to demonstrate utility of illustrative embodiments, and should not be viewed as limiting in any way.

Automated actions taken based on outputs generated by a machine learning system of the type disclosed herein can include particular actions involving interaction between a processing platform implementing the machine learning system and other related equipment utilized in one or more of the applications described above. For example, outputs generated by a machine learning system can control one or more components of a related system. In some embodiments, the machine learning system and the related equipment are implemented on the same processing platform, which may comprise a computer, mobile telephone, wearable device, gaming system or other arrangement of one or more processing devices.

### Additional Illustrative Embodiments

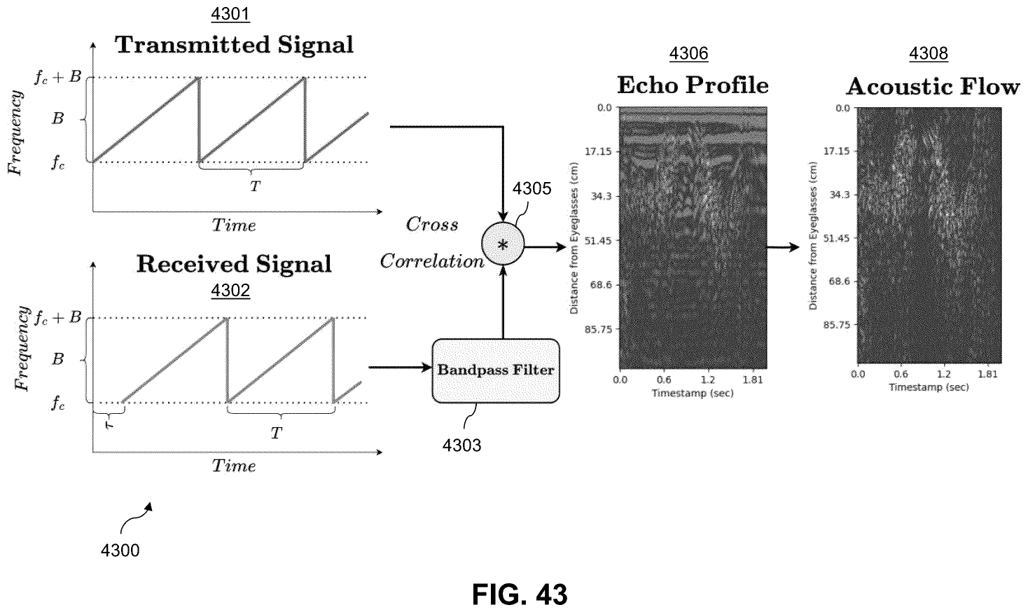

Additional illustrative embodiments will be described below with reference to FIGS. 42 through 62. These include additional embodiments relating to acoustic-based tracking of user activities and/or other user characteristics, including by way of example acoustic-based tracking of upper body poses, facial expressions, hand poses and silent speech.

These and other Illustrative embodiments disclosed herein can be implemented, for example, in the form of information processing systems comprising one or more wearable devices each having one or more wireless transmitter-receiver pairs for sensing of user activities and/or other characteristics. A number of examples of such systems will be described in detail herein. It should be understood, however, that embodiments of the invention are more generally applicable to a wide variety of other types of information processing systems comprising at least one wearable device and possibly one or more associated computers, servers or other processing devices, and/or other types of components. Accordingly, the term “information processing system” as used herein is intended to be broadly construed so as to encompass these and other arrangements. For example, in some embodiments, an information processing system comprises a machine learning system implemented at least in part in one or more wearable devices, possibly interacting with one or more other processing devices over one or more networks. Numerous other arrangements of one or more wearable devices and possibly one or more other processing devices may be implemented in information processing systems in the manner disclosed herein.

In some embodiments, wireless signal transmitters and receivers are deployed at least in part via one or more wearable devices at various locations on the body (e.g., face, head, arm, wrist, torso, legs, and/or foot) of a user. The wireless signal transmitters illustratively located on one or more wearable devices emit wireless signals in and around at least a portion of the body of the user. These signals are altered by various body parts in unique patterns corresponding to the user's current activities. The wireless signal receivers, also illustratively located on one or more wearables, capture these altered signals. These wireless signals illustratively take the form of physical waves, capable of transmission through the air without the use of wires, and may include acoustic signals, millimeter wave signals, and/or other radio frequency signals. Subsequently, the captured wireless signals undergo processing in illustrative embodiments through specialized signal processing algorithms to eliminate noise and extract patterns. Customized machine learning algorithms are implemented to estimate the user's activities based on these received and processed wireless signals.

The customized machine learning algorithms in some embodiments incorporate a self-supervised approach. In this approach, a deep learning encoder is pre-trained with unlabeled acoustic sensing data. Such an arrangement leverages pre-training to learn the semantic representation of acoustic echo profiles. Subsequently, the pre-trained encoder is fine-tuned using acoustic data with activity labels. Through this approach, the deep learning model can learn to infer everyday activities from acoustic data utilizing a relatively small, labeled dataset while maintaining very precise performance. Additionally, it facilitates the learning of a user-agnostic representation of acoustic signals, allowing illustrative embodiments to perform consistently without the need for training data from new users. More particular examples of machine learning algorithms utilized in illustrative embodiments include depth-wise separable convolution, skip connection-based residual convolution, and self-attention networks. In some embodiments, residual convolution is utilized as it generally exhibits a smaller memory footprint and can be more easily deployed on low-complexity edge microprocessors.

FIG. 42 shows an information processing system 4200 implementing acoustic sensing functionality in an illustrative embodiment. The system 4200 comprises a processing platform 4202. Coupled to the processing platform 4202 are multiple wireless transmitter-receiver (TX-RX) pairs 4205-1, . . . 4205-n. The processing platform 4202 generates recognition output 4207, which is illustratively utilized to drive one or more controlled components of the system 4200, which may be internal or external to the processing platform 4202. The processing platform 4202 further comprises an acoustic interface controller 4208 which interfaces with the wireless transmitter-receiver pairs 4205 and provides control signals thereto for controlling the transmission and reception of wireless acoustic signals utilized in acoustic sensing as disclosed herein. Also included in the processing platform 4202 is an acoustic signal processor 4209 and a machine learning system 4210. The system 4200 is an example of what is also referred to herein as an “acoustic sensing system.”

The information processing system 4200 illustratively embodiment comprises one or more wearable devices. For example, in some embodiments, the entire information processing system 4200 may be implemented in a single wearable device. In such an arrangement, the wireless transmitter-receiver pairs 4205 and the processing platform 4202 are all part of the same wearable device. Such a wearable device is an example of what is more generally referred to as one or more processing devices each comprising a processor coupled to a memory. The system 4200 may alternatively comprise multiple wearable devices, with each such wearable device comprising at least one of a transmitter and a receiver of at least one of the wireless transmitter-receiver pairs 4205. For example, one wearable device may comprise a transmitter of a given one of the wireless transmitter-receiver pairs 4205, and another wearable device may comprise a receiver of the given one of the wireless transmitter-receiver pairs 4205. In such embodiments, the processing platform 4202 may be implemented at least in part on at least one of the wearable devices. Alternatively, the processing platform 4202 may be external to the wireless transmitter-receiver pairs 4205, as a separate set of one or more processing devices, illustratively on a computer, mobile telephone, cloud-based system or other arrangement of one or more processing devices that is external to the one or more wearable devices.

It should also be noted that, although system 4200 of FIG. 42 shows multiple wireless transmitter-receiver pairs 4205, other embodiments can include only a single wireless transmitter-receiver pair, with that pair being implemented on one or more wearable devices. Accordingly, in embodiments with only a single wireless transmitter-receiver pair, that pair can be implemented on a single wearable device, possibly with at least a portion of the processing platform 4202. Alternatively, the transmitter of that pair can be implemented on one wearable device and the receiver of that pair can be implemented on another wearable device, with at least one of the wearable devices possibly including at least a portion of the processing platform 4202. Again, the processing platform 4202 can be completely external to the one or more wearable devices, but in such cases is assumed to be accessible to the one or more wearable devices over one or more networks, and possibly implemented at least in part in an external computer, mobile telephone or cloud-based system.

In operation, the transmitter of a given one of the wireless transmitter-receiver pairs 4205 transmits an acoustic signal, and the receiver of the given one of the wireless transmitter-receiver pairs 4205 receives the acoustic signal. The received acoustic signal is processed in the processing platform 4202 utilizing the machine learning system 4210 to detect at least one characteristic of a user of the at least one wearable device.

These and numerous other embodiments disclosed herein can be configured for use in a wide variety of different applications utilizing one or more multiple distinct wearable device form factors such as, for example, smart glasses, wristbands, headphones and/or rings, as described in more detail in the attached Appendices. A wide variety of other form factors can be used, in any combination.

Also, although some embodiments utilize acoustic signals, other embodiments can utilize other types of signals, such as millimeter wave signals and/or other radio frequency signals, in addition to or in place of acoustic signals.

In some embodiments, the acoustic signals have frequencies that fall within a specified range, such as, for example, between about 15 kHz and 25 kHz, or more particularly, between about 15.5 kHz and 24.5 kHz. More particular examples of illustrative frequency ranges that may be used for acoustic signals herein include 16 kHz to 24 kHz, 15.5 kHz to 20.5 kHz, 18 kHz to 21 kHz and 21.5 kHz to 24.5 kHz, although it should be emphasized that these are only examples, and numerous other acoustic device frequencies can be used in other embodiments, as well as non-acoustic signal frequencies.

At least some of the above-noted acoustic signals illustratively comprise inaudible acoustic signals. It should be noted that terms such as “acoustic” and “inaudible” as used herein are intended to be broadly construed, and should not be viewed as being strictly limited to particular frequency ranges such as those mentioned above and elsewhere herein.

In some embodiments, the acoustic signals transmitted and received by the wireless transmitter-receiver pairs 4205 are modulated. For example, a given acoustic signal may comprise a frequency modulated continuous wave (FMCW) signal. Other types of modulation can be used in other embodiments.

The transmitter of a given one of the wireless transmitter-receiver pairs 4205 in some embodiments is implemented, for example, utilizing one or more speakers of the at least one wearable device, and the receiver of the given one of the wireless transmitter-receiver pairs 4205 in some embodiments is implemented, for example, utilizing one or more microphones of the at least one wearable device. Numerous alternative arrangements are possible. For example, various types of alternative transducers or other acoustic components can be used.

The recognition output 4207 of the processing platform 4202 in some embodiments comprises control signals or other types of signals generated by the processing platform 4202, possibly to control one or more external processing devices that are not explicitly shown. As indicated previously, in some embodiments, the processing platform 4202, the wireless transmitter-receiver pairs 4205 and the recognition output 4207 of system 4200 are all part of the same wearable device or set of wearable devices, such as a virtual reality (VR) and/or augmented reality (AR) headset or other type of wearable device. Other examples of wearable devices that can be used to implement at least portions of the system 4200 include the above-noted smart glasses, wristbands, headphones and/or rings, among numerous others.

The acoustic signal processor 4209 in the present embodiment more particularly implements one or more signal processing algorithms that are applied to received acoustic signals. Such algorithms illustratively include filtering, cross-correlation, and echo profile generation, as described in more detail elsewhere herein.

The machine learning system 4210 in the present embodiment more particularly implements one or more machine learning algorithms, such as neural network based machine learning algorithms configured to facilitate the generation of recognition output relating to acoustic sensing of the type described elsewhere herein, although other arrangements are possible. For example, in some embodiments, the machine learning system 4210 implements at least one neural network, such as a ResNet-18 neural network, which is a type of convolutional neural network (CNN) that is 18 layers deep. It is to be appreciated that numerous other neural networks can be used, including a wide variety of alternative types of CNNs, recurrent neural networks, encoder-decoder neural networks, self-attention networks, and/or other neural networks, and combinations of multiple such neural networks. Other types of machine learning techniques can be used in addition to or in place of neural networks.

The above-noted operations of acoustic interface controller 4208, acoustic signal processor 4209 and machine learning system 4210 are illustratively performed by or under the control of one or more processing devices of the processing platform 4202, with each such processing device comprising a processor coupled to a memory.

In some embodiments, the recognition output 4207 obtained from the machine learning system 4210 is indicative of one or more characteristics of a user of the one or more wearable devices. For example, in some embodiments, the recognition output 4207 characterizes one or more user activities detected by machine learning system 4210 utilizing the processed acoustic signals. The recognition output 4207 can also include detected facial expressions, hand poses and/or hand-object interaction, as well as numerous other types of user characteristics, and combinations thereof.

Additionally or alternatively, the recognition output 4207 obtained from the machine learning system 4210 in some embodiments comprises silent speech recognition output. Such an embodiment illustratively utilizes acoustic signals transmitted and received by one or more wireless transmitter-receiver pairs of at least one wearable device to provide a silent speech interface, for detecting user characteristics that include silent commands generated by a user of the wearable device.

As indicated previously, the recognition output 4207 can include one or more control signals. For example, user activities, facial expressions, hand poses, hand-object interaction and/or silent speech detected by the processing platform 4202 using acoustic sensing as disclosed herein can be used to control at least one external device, such as a computer, a mobile telephone, a television, a gaming console, a cloud-based system or other arrangement of one or more processing devices.

The recognition output 4207 in some embodiments is illustratively configured to trigger at least one automated action in at least one processing device that implements the processing platform 4202, and/or in at least one additional processing device external to the processing platform 4202. For example, as mentioned above, one or more control signals that are part of the recognition output 4207 may be transmitted over a network from a first processing device that implements at least a portion of the processing platform 4202 to trigger at least one automated action in a second processing device that is external to the processing platform 4202.

As a more particular example, the one or more control signals generated by the processing platform 4202 illustratively comprise at least one control signal configured to automatically adjust one or more parameters of an external computer, mobile telephone or other processing device.

Other embodiments can utilize one or more such control signals to control one or more functions or other features of the same wearable device or set of wearable devices that implement other portions of the system 4200.

It is to be appreciated that the term “machine learning system” as used herein is intended to be broadly construed to encompass at least one machine learning algorithm configured to facilitate acoustic sensing through utilization of one or more machine learning techniques. The processing platform 4202 may therefore be viewed as an example of a “machine learning system” as that term is broadly used herein.

Although the acoustic interface controller 4208, the acoustic signal processor 4209 and the machine learning system 4210 are all shown as being implemented on processing platform 4202 in the present embodiment, this is by way of illustrative example only. In other embodiments, the acoustic interface controller 4208, the acoustic signal processor 4209 and the machine learning system 4210 can each be implemented on a separate processing platform. A given such processing platform is assumed to include at least one processing device comprising a processor coupled to a memory.

Examples of such processing devices include computers, servers or other processing devices arranged to communicate over a network.

The network can comprise, for example, a global computer network such as the Internet, a WAN, a LAN, a satellite network, a telephone or cable network, a cellular network such as a 4G or 5G network, a wireless network implemented using a wireless protocol such as Bluetooth, WiFi or WiMAX, or various portions or combinations of these and other types of communication networks.

As indicated previously, in some embodiments, the wireless transmitter-receiver pairs 4205 and the processing platform 4202 and its recognition output 4207 are all part of one or more wearable devices. For example, in some embodiments, all of these components of the system 4200 can be implemented in a VR/AR headset or other wearable device.

Examples of automated actions that may be taken in the system 4200 responsive to recognition output 4207 generated by the machine learning system 4210 include controlling one or more processing devices over a network. Again, other embodiments can control one or more functions or other features of the same wearable device or set of wearable devices that implement other portions of the system 4200.

A wide variety of additional or alternative automated actions may be taken in other embodiments. The particular automated action or actions will tend to vary depending upon the particular application in which the system 4200 is deployed.

For example, some embodiments disclosed herein implement acoustic sensing systems for detecting user activities, facial expressions, hand poses, hand-object interaction and/or silent speech, as described in more detail in the attached Appendices.

Additional examples of applications are provided elsewhere herein. It is to be appreciated that the term “automated action” as used herein is intended to be broadly construed, so as to encompass the above-described automated actions, as well as numerous other actions that are automatically driven based at least in part on outputs of a machine learning algorithm as disclosed herein.

The processing platform 4202 in the present embodiment further comprises a processor 4220, a memory 4222 and a network interface 4224. The processor 4220 is assumed to be operatively coupled to the memory 4222 and to the network interface 4224 as illustrated by the interconnections shown in the figure.

The processor 4220 may comprise, for example, a microprocessor, an ASIC, an SOC, an FPGA, a CPU, a GPU, an NPU, a DPU, a TPU, an ALU, a DSP, and/or other similar processing device components, as well as other types and arrangements of processing circuitry, in any combination. At least a portion of the functionality of at least one machine learning system and its associated machine learning algorithms provided by one or more processing devices as disclosed herein can be implemented using such circuitry.

In some embodiments, the processor 4220 comprises one or more graphics processor integrated circuits. Such graphics processor integrated circuits are illustratively implemented in the form of one or more GPUs. Accordingly, in some embodiments, system 4200 is configured to include a GPU-based processing platform. Such a GPU-based processing platform can be cloud-based and configured to implement one or more machine learning systems for processing data associated with a large number of system users. Similar arrangements can be implemented using NPUs, DPUs, TPUs and/or other processing devices, in addition to or in place of GPUs.

Numerous other arrangements are possible. For example, in some embodiments, a machine learning system can be implemented on a single processor-based device, such as a wearable device, a computer, a mobile telephone, or other user device, utilizing one or more processors of that device. Such embodiments are also referred to herein as “on-device” implementations of machine learning systems.

The memory 4222 stores software program code for execution by the processor 4220 in implementing at least portions of the functionality of the processing platform 4202. For example, at least portions of the functionality of acoustic interface controller 4208, acoustic signal processor 4209 and machine learning system 4210 can be implemented using program code stored in memory 4222.

A given such memory that stores such program code for execution by a corresponding processor is an example of what is more generally referred to herein as a processor-readable storage medium having program code embodied therein, and may comprise, for example, electronic memory such as SRAM, DRAM or other types of random access memory, flash memory, read-only memory (ROM), magnetic memory, optical memory, or other types of storage devices in any combination.

Articles of manufacture comprising such processor-readable storage media are considered embodiments of the invention. The term “article of manufacture” as used herein should be understood to exclude transitory, propagating signals.

Other types of computer program products comprising processor-readable storage media can be implemented in other embodiments.

In addition, illustrative embodiments may be implemented in the form of integrated circuits comprising processing circuitry configured to implement processing operations associated with one or more of acoustic interface controller 4208, acoustic signal processor 4209 and machine learning system 4210 as well as other related functionality. For example, at least a portion of the machine learning system 4210 is illustratively implemented in at least one neural network integrated circuit of a processing device of the processing platform 4202.

The network interface 4224 is configured to allow the processing platform 4202 to communicate over one or more networks with other system elements, and may comprise one or more conventional transceivers.

As indicated previously, these and other embodiments process one or more received acoustic signals utilizing the machine learning system 4210 to detect at least one characteristic of a user of at least one wearable device. This illustratively involves applying at least one signal processing algorithm to the received acoustic signal in the acoustic signal processor 4209 to extract one or more patterns from the received acoustic signal, and classifying the one or more extracted patterns in the machine learning system 4210.

In some embodiments, such aspects more particularly include filtering the received acoustic signal, cross-correlating the transmitted acoustic signal and the filtered received acoustic signal over a plurality of frequency sweep periods to generate respective echo frames, constructing an echo profile from the echo frames, the echo profile having a first axis corresponding to a time variable and a second axis corresponding to a distance variable, and classifying the echo profile in the machine learning system.

The echo profile in some embodiments illustratively comprises, for example, a differential echo profile providing an indication of acoustic flow, although other types of echo profiles can be used in other embodiments. In some embodiments, the differential echo profile is constructed at least in part by determining absolute differences between each of a plurality of pairs of consecutive echo frames.

Some embodiments include a single wearable device that comprises at least first and second wireless transmitter-receiver pairs 4205, with the transmitter of each of the first and second wireless transmitter-receiver pairs 4205 transmitting an acoustic signal having a different carrier frequency, such as first and second FMCW acoustic signals having respective different base carrier frequencies. Other modulation arrangements can be used in addition to or in place of FMCW in other embodiments.

In some embodiments of this type, processing the received acoustic signal utilizing the machine learning system to detect at least one characteristic of a user of the at least one wearable device illustratively comprises generating a first channel of a multi-channel echo profile for a first acoustic signal transmitted by the transmitter of the first wireless transmitter-receiver pair and received by the receiver of the first wireless transmitter-receiver pair, generating a second channel of the multi-channel echo profile for the first acoustic signal transmitted by the transmitter of the first wireless transmitter-receiver pair and received by the receiver of the second wireless transmitter-receiver pair, generating a third channel of the multi-channel echo profile for a second acoustic signal transmitted by the transmitter of the second wireless transmitter-receiver pair and received by the receiver of the first wireless transmitter-receiver pair, and generating a fourth channel of the multi-channel echo profile for the second acoustic signal transmitted by the transmitter of the second wireless transmitter-receiver pair and received by the receiver of the second wireless transmitter-receiver pair. The resulting multi-channel echo profile is then classified in the machine learning system 4210.

In some embodiments, the machine learning system 4210 comprises at least one encoder-decoder neural network that is pre-trained with unlabeled acoustic sensing data to learn a user-agnostic acoustic signal representation. The machine learning system 4210 in such embodiments illustratively implements at least one of depth-wise separable convolution, skip connection-based residual convolution, and a self-attention network, although, as indicated previously, numerous other types of neural networks and/or other machine learning techniques can be used. In some embodiments, a quantized version of at least one model of the machine learning system 4210 is implemented in the at least one wearable device.

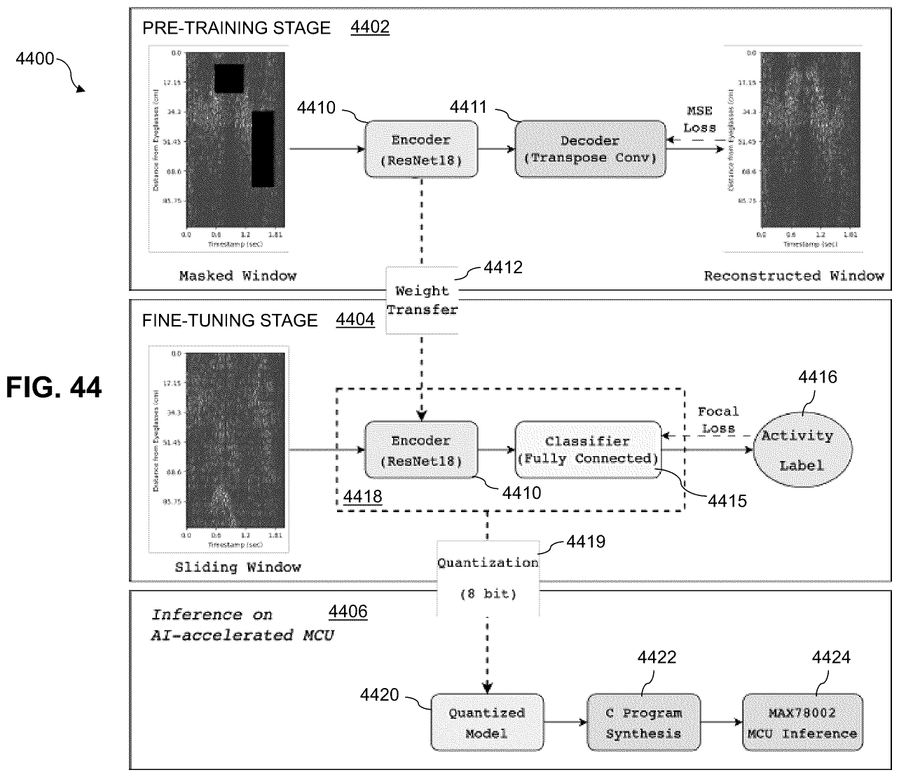

Additional illustrative embodiments further detailing example signal processing and machine learning aspects of the system 4200 are shown in FIGS. 43, 44 and 45.

FIG. 43 shows example acoustic signal processing operations 4300 performed by the acoustic signal processor 4209 of processing platform 4202 in system 4200 in an illustrative embodiment.

In this embodiment, a transmitted signal 4301 from a transmitter of a given one of the wireless transmitter-receiver pairs 4205 is shown, along with a corresponding received signal 4302 from a receiver of the given one of the wireless transmitter-receiver pairs 4205. The received signal 4302 is subject to a bandpass filtering operation in bandpass filter 4303, followed by cross-correlation of the filtered received signal with the transmitted signal 4301 in correlator 4305. The cross-correlation is used to generate an echo profile 4306 as shown, and acoustic flow 4308 is calculated via differentiation by taking the difference between pairs of consecutive echo profiles. Such operations are one example of what is more broadly referred to herein as a “signal processing algorithm” implemented by acoustic signal processor 4209. It should be noted that a separate set of acoustic signal processing operations 4300 are illustratively performed for each of the above-noted multiple channels, as each such channel includes a separate pair of transmitted and received signals.

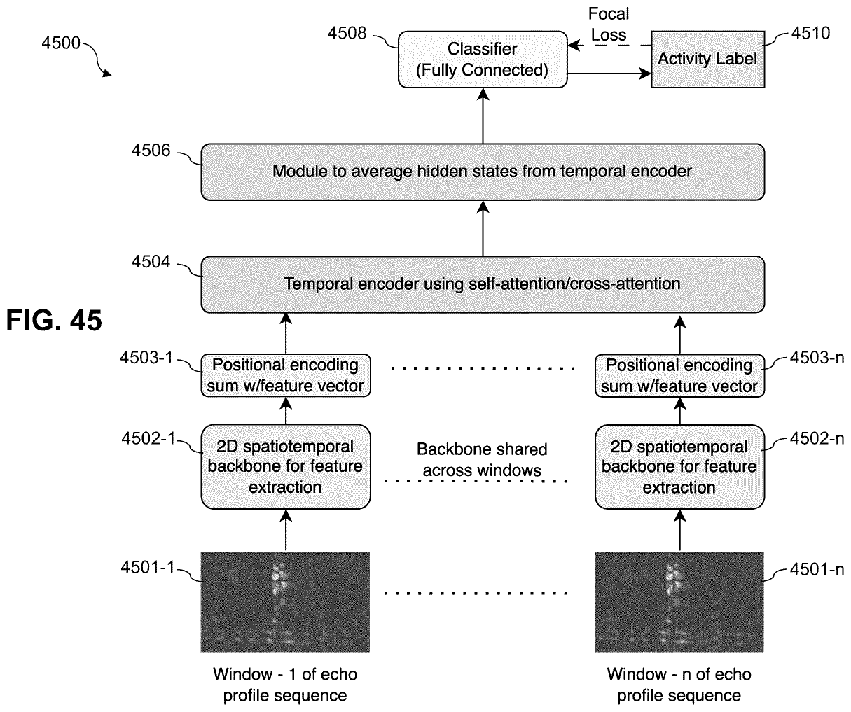

FIGS. 44 and 45 show respective examples of machine learning systems 4400 and 4500 that are utilized in acoustic sensing of user activities and/or other characteristics in illustrative embodiments. These machine learning systems 4400 and 4500 may be viewed as respective examples of machine learning system 4210 of FIG. 42. Other types of machine learning systems can be used in other embodiments.

Referring initially to FIG. 44, the machine learning system 4400 comprises a plurality of stages including a self-supervised pre-training stage 4402, a fine-tuning stage 4404, and an inference stage 4406. The pre-training stage 4402 comprises an encoder-decoder neural network, also referred to as an autoencoder, that includes an encoder 4410, illustratively a ResNet-18 neural network, and a corresponding decoder 4411, illustratively a transpose convolutional decoder. The autoencoder comprising encoder 4410 and decoder 4411 is trained on masked windows encoded by the encoder 4410 and corresponding reconstructed windows generated by the decoder 4411, utilizing a mean-squared error (MSE) loss function. Weights from the pre-training stage are transferred to the fine-tuning stage as indicated by weight transfer 4412.

The fine-tuning stage 4404 includes the pre-trained encoder 4410 with transferred weights, and a classifier 4415, the latter illustratively comprising a fully-connected layer. The encoder 4410 and classifier 4415 collectively comprise a machine learning model 4418 of the machine learning system 4400. The classifier 4415 generates activity labels 4416 based on a sliding window, utilizing a focal loss function.

The inference stage 4406 illustratively comprises a quantized model 4420 generated by applying a quantization operation 4419 to the machine learning model 4418. The quantized model 4420 is illustratively deployed via C program synthesis 4422 on an example wearable device processor in the form of an AI-accelerated microcontroller unit (MCU) 4424, illustratively a MAX78002 microcontroller. The MCU 4424 is considered another illustrative example of a “processor” as that term is broadly used herein.

The pre-training and fine-tuning stages 4402 and 4404 may be performed on a different processing device or set of processing devices than the inference stage 4406, which is illustratively configured for highly efficient edge operation using reduced processor and memory resources of the MCU 4424.

In the pre-training stage 4402, specific sections of the input echo profile are masked out as illustrated by the masked window and the encoder-decoder neural network comprising encoder 4410 and decoder 4411 is trained to reconstruct the original echo profile as a corresponding reconstructed window, with supervision utilizing MSE loss.

In the fine-tuning stage 4404, the encoder 4410 is further trained with classifier 4415, illustratively a “lightweight” classifier, on a supervised dataset.

Once the pre-training and fine-tuning stages are complete, the resulting machine learning model 4418 is quantized (e.g., using INT8 quantization) and can run directly on the edge (e.g., on a wearable device). For example, the quantized model 4420 is illustratively implemented in the above-noted MCU 4424 of a wearable device, although other types of processors and associated processing devices can be used.

Also, as indicated above, a wide variety of different neural networks and/or other machine learning techniques can be implemented in machine learning system 4210.

Referring now to FIG. 45, the machine learning system 4500 comprises a self-attention/cross-attention network and is illustratively implemented in the machine learning system 4210 of processing platform 4202 in an illustrative embodiment. In this embodiment, a temporal representation of echo profile sliding windows 4501-1 through 4501-n is created using the self-attention network. Each of the sliding windows 4501-1 through 4501-n of the sequence is fed through a corresponding two-dimensional (2D) spatiotemporal backbone feature extractor 4502-1 through 4502-n, implemented as a convolution network, followed by positional encoding 4503-1 through 4503-n to incorporate temporal information across windows. The outputs of the positional encoding layer are then fed to a temporal encoder 4504 that includes the self-attention/cross-attention network, and then to a module 4506 to average hidden states from the temporal encoder 4504. A fully connected classifier 4508 is then utilized to infer activity labels 4510. An advantage of this example architecture is it can capture patterns across different sliding windows which helps the model to learn temporal context. However, it exhibits a higher memory overhead than the FIG. 44 embodiment described previously.

Other illustrative embodiments can utilize depth-wise separable convolution. This arrangement is a variant of the residual network with a depth-wise convolution block instead of the regular convolution block. It is similar to the FIG. 44 embodiment, but with a MobileNetV3 network instead of the ResNet-18 network in the encoder block.

Additional examples of neural networks that can be used in illustrative embodiments include recurrent networks (e.g., LSTM or GRU) preceded by a convolutional layer.

It is to be appreciated that the particular arrangements of components and other system elements shown in FIGS. 42 through 45 are presented by way of illustrative example only, and numerous alternative embodiments are possible. For example, other embodiments of information processing systems can be configured to implement machine learning system functionality of the type disclosed herein.

As indicated previously, the system 4200 can be configured to support a wide variety of distinct applications, in numerous diverse contexts.

It is to be appreciated that the particular arrangements described above are examples only, intended to demonstrate utility of illustrative embodiments, and should not be viewed as limiting in any way.

Automated actions taken based on outputs generated by a machine learning system of the type disclosed herein can include particular actions involving interaction between a processing platform implementing the machine learning system and other related equipment utilized in one or more of the applications described above. For example, outputs generated by a machine learning system can control one or more components of a related system. In some embodiments, the machine learning system and the related equipment are implemented on the same processing platform, which may comprise at least one of a wearable device, a computer, a mobile telephone, a television, a gaming console, a cloud-based system or other arrangement of one or more processing devices.

Additional details of illustrative embodiments will now be described with reference to example implementations referred to herein as ActSonic. As will be described, ActSonic is an example acoustic sensing system, and is configured to recognize everyday activities from inaudible acoustic waves around the body. More particularly, ActSonic in some embodiments provides an intelligent, low-power active acoustic sensing system integrated into eyeglasses that can recognize multiple distinct everyday activities (e.g., eating, drinking, toothbrushing, etc.) from inaudible acoustic waves around the body with a time resolution of one second. It utilizes a pair of miniature speakers and microphones mounted on each hinge of the eyeglasses to emit ultrasonic waves to create an acoustic aura around the body. Based on the position and motion of various body parts, the acoustic signals are reflected with unique patterns captured by the microphone and analyzed by a customized self-supervised deep learning framework to infer the performed activities. ActSonic was deployed in a user study with 19 participants across 19 households to evaluate its efficacy. Without requiring any training data from a new user (leave-one-participant-out evaluation), ActSonic was able to detect 27 distinct user activities, achieving an average F1-score of 86.6% in fully unconstrained scenarios and 93.4% in prompted settings at participants' homes.

It is to be appreciated that these and other features of various ActSonic implementations described herein are presented by way of illustrative example only, and should not be construed as limiting in any way.

Despite smart glasses becoming popular and being worn daily, existing eyeglasses like many other commodity wearables, still lack the ability to understand the user's fine-grained everyday activities in real-world settings. Distinguishing human activities is challenging due to the substantial variance across different activities, each involving complex and subtle movements of multiple body parts (e.g., face, arms, hands). For example, eating requires the coordination of fingers and arms to deliver food to the mouth, as well as the movement of facial muscles for chewing.

Acquiring precise body pose data from various body parts is essential for accurately distinguishing different human activities. However, achieving this with everyday wearable devices (e.g., eyeglasses) has presented persistent challenges: Wearable cameras consume significant power, rapidly draining batteries. Furthermore, transmitting and processing video data on wearable devices is resource-intensive. Many sensing systems (e.g., Inertial Measurement Units (IMUs) or Electromyography (EMG)) only capture information around the instrumentation position, which is insufficient for activities involving multiple body parts (e.g., face and hands) unless multiple devices are worn on the body, which is less preferred by many users. Microphone-recorded passive sounds have shown promising performance in tracking human activities in the wild. However, such approaches do not work effectively for activities lacking distinctive auditory cues. It is therefore apparent that significant challenges exist in collecting data to track fine-grained human behaviors.

Illustrative embodiments of ActSonic as disclosed herein provide a simple sensing system implemented on eyeglasses that is low-cost, minimally-obtrusive, energy-efficient, and privacy-aware, while capable of recognizing a wide range of everyday human activities.

The ActSonic system in illustrative embodiments provides significant advantages over alternative approaches. For example, it can operate on low power to sustain continuous usage throughout the day. Also, privacy concerns of the user on wearing such a wearable system daily are alleviated, and comfort is not compromised. The system also demonstrates robustness to accommodate various daily activities and distinguish them from other categories, including “Null,” which refers to activities not included in the tracking set.

These and other embodiments leverage a single sensing modality-active acoustic sensing on eyeglasses-to simultaneously capture both facial movements and upper body poses, which can be used for activity recognition.

In some embodiments, the ActSonic system utilizes inaudible active acoustic signals reflected around the human body to recognize a rich set of everyday human activities. Given the small size, relatively low power consumption, low cost, and ubiquity of microphones and speakers, such eyeglasses capable of tracking diverse human activities can significantly reduce the barriers to activity monitoring. Instead of relying on multiple devices for different activities, this all-in-one system can effectively track and differentiate between multiple activities simultaneously. The fused reflected acoustic signals provide adequate information to distinguish a rich set of fine-grained human activities. The system utilizes machine learning and signal processing algorithms that focus on temporal and structural differences in activities from these reflected acoustic signals, rather than individual body shapes, for usability to minimize user effort for training. In addition, the system provides robustness to various acoustic noises, such as multi-path acoustic reflections from the environmental setups (e.g., surrounding furniture) and potential overlap with the ultrasound band, so as to facilitate handling different environmental conditions.

The disclosed ActSonic system in illustrative embodiments is able to capture nuanced variations in activities, particularly in large motions where finer details are significant. For example, it can recognize activities with similar arm or facial movements (e.g., yawning vs. coughing), utilizing an understanding of the combination of movements and temporal patterns, while also exhibiting robustness towards a large number of unknown or unlabeled activities in the “Null” category.

In some embodiments, ActSonic provides a self-supervised and low-power activity recognition system integrated into eyeglasses, utilizing active acoustic sensing. In some embodiments, the system can recognize 27 types of everyday activities without collecting training data from new users. Given the low-power nature of acoustic sensors, ActSonic can operate for over 21 hours with a battery capacity equivalent to that of Google Glass (570 mAh).

In some embodiments, ActSonic includes a pair of miniature, low-power, off-the-shelf microphones and speakers attached to the respective hinges of glasses. The sensing system emits inaudible ultrasonic waves to create an acoustic aura around the body. Based on the shape and position of various body parts, the acoustic signals are reflected with unique and fused patterns captured by the microphone. The system includes a customized self-supervised deep learning framework, various aspects of which were previously described in conjunction with the machine learning system examples of FIGS. 44 and 45, to interpret the reflected signals at areas of interest and their temporal patterns, which are presented with complex multipath echoes and include rich information about movements on both the face and upper body, to infer the performed activities.

Illustrative embodiments of ActSonic were evaluated comprehensively in two studies in real-world settings. The first study was a semi-in-the-wild investigation involving 12 participants. In this study, each participant performed all 27 activities at their own homes (12 homes) in the presence of a researcher. To further validate the system's performance in completely uncontrolled real-world conditions, we conducted a second study with 7 participants. In this second study, participants were provided with the device at their homes to record their unconstrained daily activities alone without any intervention. These two studies resulted in the collection of 40 hours of activity data from 19 different households, which were labeled with ground truth at each second. The leave-one-participant-out evaluation showed that ActSonic was able to distinguish these 27 activities at these 19 homes at each second without any training data from the user, with an average F1-score of 93.4% in the first semi-in-the-wild user study and 86.6% in the second in-the-wild study.

In some embodiments, ActSonic advances the field of wearable-based activity recognition and lowers the barrier of tracking everyday human activities, at least in part by creating and utilizing inaudible acoustic waves around the body for fine-grained everyday activity recognition. Unlike alternative approaches, ActSonic achieves promising performance without requiring training data from a new user or a new environment, which makes collecting human activity data much easier. Microphones and speakers are readily available, cost-effective to set up, and can sustain prolonged operation on a small battery attached to glasses, facilitating implementation and deployment of the ActSonic system. In some embodiments, ActSonic accurately recognizes 27 distinct activities with a single device at a time resolution of one second, although other parameters can be used in other embodiments.

In illustrative embodiments of ActSonic, we model daily living activities based on movements in different parts of the human body. To achieve this, we utilize an active acoustic sensing platform placed on eyeglasses to capture these fine-grained movements and subsequently recognize activities.

ActSonic in some embodiments provides a wearable activity recognition platform integrated into glasses, enabling the identification of a wide range of everyday activities based on the positions and movements of different body parts, as captured by active acoustic sensing technology. ActSonic seamlessly integrates active acoustic sensing in detecting facial changes and upper body poses for the comprehensive task of classifying diverse daily activities in real-world scenarios. Given that most daily activities entail movements across various body parts, particularly the upper body, head, and face, ActSonic is configured to capture and differentiate these activities based on the position and movement of these body areas, as detected by the sensing system. ActSonic can accomplish this with a single device, facilitating concurrent information capture.

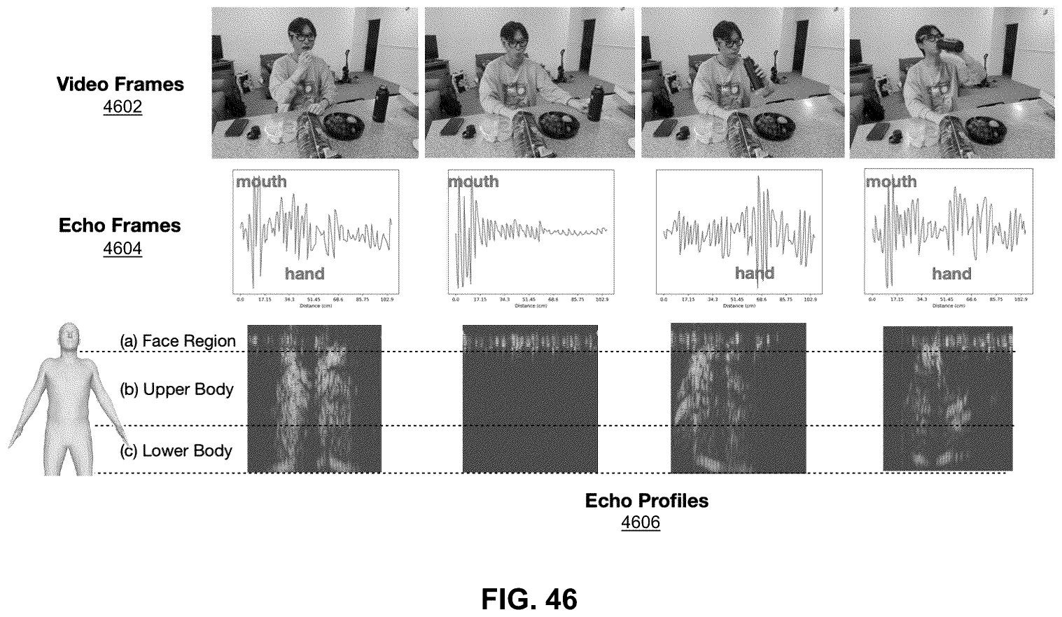

FIG. 46 shows an example of active acoustic sensing in an illustrative embodiment of ActSonic. In this embodiment, user activities shown in a sequence of video frames 4602 are captured by ActSonic in respective echo frames 4604, which are further processed to generate echo profiles 4606. The x-axis of the echo frames 4604 represents the distance of echo reception. The corresponding video frames 4602 serve as activity references. Each of the echo profiles 4606 is created by stacking multiple echo frames, and provides a spatiotemporal representation of the activity. These sliding windows with a duration of 2 seconds of echo profiles serve as inputs for the self-supervised learning algorithm.

As previously described in conjunction with FIG. 43, which illustrates an overview of echo profile and acoustic flow calculation in illustrative embodiments, the echo profile 4306 is generated by cross-correlating the transmitted signal 4301 with a bandpass filtered version of the received signal 4302. The bandpass filter 4303 is configured to ensure that only specific frequencies of the received signal 4302 are utilized in the cross-correlation performed in correlator 4305. This allows us to capture the direct echo profile 4306, and we can calculate corresponding acoustic flow 4308 by taking the difference between two consecutive echo profiles.

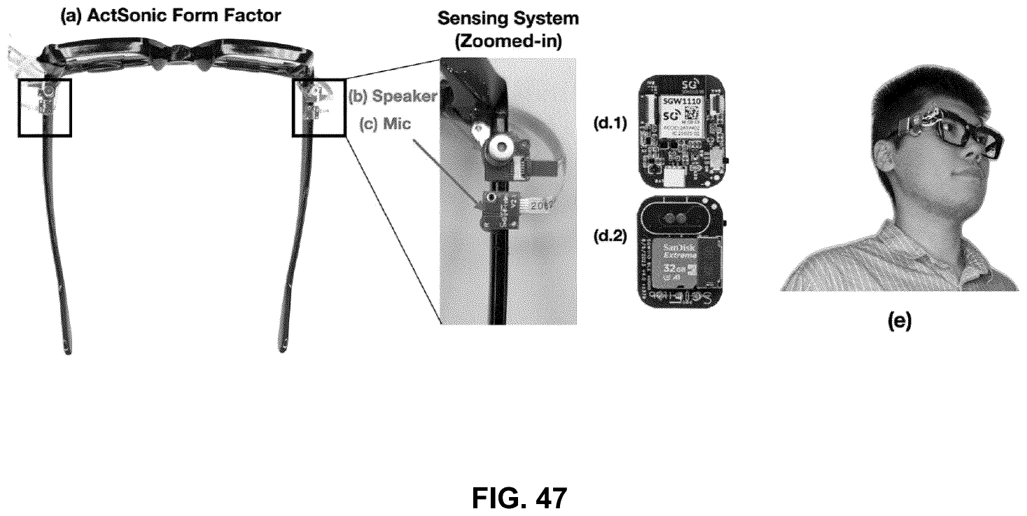

The active acoustic sensing system in ActSonic integrates two pairs of ultrasonic transmitters and receivers on eyeglass hinges, as illustrated in FIG. 47. Utilizing Cross-correlation based Frequency Modulated Continuous Wave (C-FMCW) chirps, ActSonic emits ultrasonic signals with linearly modulated frequencies ranging from 18 to 21.5 kHz and 21.5 to 24.5 kHz for the left and right transmitters, respectively, each with a bandwidth of B=3 kHz.

For the C-FMCW technique employed by ActSonic, the theoretical range resolution R can be derived as follows:

$$R = \frac{C \cdot Lag}{2 {F}_{s}} - vt \qquad ( 3 )$$

where C is the speed of sound (C=343 m/s in dry air at 20° C.), Fₛ is the sampling frequency of the microphone or receiver (Fₛ 50 kHz in the case of ActSonic), v is the velocity of the tracked body part, t is the elapsed time from the start of the modulation period, and Lag is the number of samples shifted between the transmitted and received acoustic signals. With N=600 samples transmitted for each chirp, ActSonic's sensing system has a sweep period of T

$$T = \frac{600}{50000} = 0.0 \; 12 seconds = 12 milliseconds .$$

Thus, the value of t ranges from 0≤t≤0.012 s, and the value of Lag in Eq. 1 ranges from 0≤Lag≤600.

In some embodiments, we can set v=0 in Equation (3) above in the case where the tracked body part is static or moving slowly with respect to the speed of sound. The velocity of extremely fast arm movements, such as punching, has been measured at approximately 8.9 to 11.5 m/s, while the duration of the fastest facial expression in humans is measured at 100 ms. The speed of these extreme body motions (v) is significantly smaller compared to the speed of sound (C). Therefore, based on Equation (3) above, the impact of the sensing resolution (vt) caused by body movements is minimal. As a result, the theoretical range resolution SR of the C-FMCW signal deployed in ActSonic can be simplified to:

$$δ R = \frac{C \cdot δ Lag}{2 {F}_{s}} \qquad ( 4 )$$

Since cross-correlation is computed for each sample in the case of C-FMCW, we can set δLag=1 for the theoretical range resolution calculation in Equation (4). Therefore, we can substitute the values of variables in Equation (4) and compute the resolution of the sensing system of ActSonic as follows:

$$δ R = \frac{343 m / s}{2 \cdot 50000} = 0.343 cm = 3.43 mm \qquad ( 5 )$$

The maximum sensing range of ActSonic can be computed as Rₘₐₓ=N·δR=600·0.343 cm=205.8 cm≈2 m. This combination of high sensing resolution (0.343 cm) and extensive sensing range enables us to capture both subtle skin deformations on the face and monitor the pose and coarse movement of the upper body region effectively. Additionally, it's important to note that the sensing resolution mentioned above is calculated for range-finding applications, which differs from our approach. This calculation is provided as a reference to facilitate readers' understanding of the sensing principle underlying the ActSonic system.

The active acoustic sensing mechanism in ActSonic measures the round-trip delay between emitted and reflected ultrasonic waves to detect human body movements. To capture this delay (τ), we utilize cross-correlation on transmitted and received signals, as illustrated in FIG. 43. More particularly, bandpass filtering is performed on the received signal 4302 in bandpass filter 4303. As there are two wireless transmitter-receiver pairs in ActSonic, each with a different frequency range, there are two separate instances of bandpass filter 4303 which match the respective transmitted frequency ranges (18-21 kHz and 21.5-24.5 kHz) on their corresponding received signals. This filtering eliminates audible frequencies, ensuring user privacy and eliminating environmental acoustic noise before the cross-correlation computation in correlator 4305.

The cross-correlation performed in correlator 4305 matches the sweep period of the emitted FMCW ultrasonic wave. It generates an echo frame, represented as a (600×1) column vector in ActSonic. Stacking these frames creates the echo profile 4306, where brighter pixels indicate strong reflections at specific distances. With two transmitter-receiver pairs, ActSonic accounts for four transmission paths. To elaborate, if we consider the left and right transmitter-receiver pair as (T_{left}, R_{left}) and (T_{right}, R_{right}) respectively, then the paths will be T_{left}→R_{left}, T_{left}→R_{right}→T_{right}→R_{left}, and T_{right}→R_{right}. In ActSonic, we stack the outputs of cross-correlation of these four paths as four channels of the echo profile. The arrangement illustrated in FIG. 43 shows the computation of echo profile 4306 and corresponding acoustic flow 4308 for a single one of these four channels, but these same computations are performed in a similar manner for each of the other three channels.

Acoustic flow, also known as the differential echo profile, is derived by computing the derivative of distance from the eyeglasses (echo profile's y-axis) with respect to time (x-axis). This is achieved by calculating the absolute difference between consecutive echo frames. Acoustic flow effectively eliminates reflections from stationary objects, enabling precise detection of human body movements. Moreover, it mitigates the effects of eyeglasses remounting, ensuring a resilient measurement of body motion across sessions. The y-axis of the echo profile (from top to bottom) indicates the distance from the eyeglasses, while the x-axis represents the temporal axis. The sliding window employed in ActSonic covers a sensing range of 300 pixels, roughly equivalent to 1 meter, extending up to the user's knees. This parameter of 300 pixels has been fine-tuned to optimize activity recognition.

In some embodiments, the active acoustic sensing system for ActSonic is implemented using two OWR-05049T-38D speakers and two ICS-43434 microphones. Managed by a microcontroller, the setup provides FMCW signal transmission and reception. To connect the speakers, microphones, and microcontroller, we developed a custom PCB housing two MAX98357A audio amplifier chips. Utilizing the I2S interface, ActSonic's hardware components communicate with one another. Received signals are stored on an SD card via the micro-SD interface on the microcontroller.

Referring now more particularly to FIG. 47, an example hardware configuration in one implementation of ActSonic is shown. Part (a) of the figure shows the eyeglasses form factor, part (b) of the figure shows the transmitter or speaker of the sensing system, and part (c) of the figure shows the receiver or microphone of the sensing system. The dimension of the sensor board of parts (b) and (c) of the figure is 9 mm×9 mm. Part (d) of the figure shows the front (d.1) and back (d.2) of the customized PCB board (dimension 18 mm×23 mm) with low-power nRF52840 microcontroller, and part (e) of the figure shows a user wearing the ActSonic eyeglasses form factor.

Positioned symmetrically on a standard pair of glasses, as illustrated in FIG. 47, the ActSonic sensor system optimally captures nuanced body movements from various angles, facing perpendicularly downwards towards the body. After several design iterations, this orientation proved most effective for sound wave propagation. Connected via FPC cables, the microcontroller, along with a LiPo battery, is affixed to one leg of the glasses, interfacing with the speakers and microphones.

Although some embodiments can utilize the Teensy 4.1 microcontroller, powered by an ARM M7 core, power consumption is further reduced in illustrative embodiments by utilizing a low-power variant featuring an nRF52840 microcontroller (depicted in FIG. 47 (d)), based on a low-power ARM M4 core. This variant includes two MAX98357A audio amplifiers, as indicated above, alongside power management modules and the SGW1110 module. A 32 GB SanDisk Extreme microSD card handles storage, with optimized firmware minimizing SD card accesses for swift operations.

To estimate human activities from acoustic sensing data in ActSonic, we designed a self-supervised deep learning framework, illustrated in FIGS. 44 and 45. This framework leverages the unlabeled acoustic data to create a pre-trained encoder. Then, we use this encoder to create an activity recognition pipeline.

ActSonic in illustrative embodiments utilizes a self-supervised learning pipeline. Self-supervised learning is a form of supervised learning where the model predicts a subset of unlabeled data from the rest. This learning pipeline of ActSonic includes two steps: pre-training an encoder to learn the representation of unlabeled data, and fine-tuning the pre-trained encoder weights for the target task with labeled data.

As previously described, FIG. 44 illustrates an example machine learning system 4400. The machine learning system 4400 provides a deep learning model architecture illustratively utilized for ActSonic. The architecture of the machine learning system 4400 illustratively comprises the self-supervised pre-training stage 4402 and the fine-tuning stage 4404, followed by the inference stage 4406. Within the self-supervised pre-training stage 4402, we mask out specific sections of the input echo profile and train an encoder-decoder architecture comprising encoder 4410 and decoder 4411 to reconstruct the input echo profile in decoder 4411 (e.g., a lightweight decoder) supervised by MSE loss. We then fine-tune the trained encoder 4410 from pre-training stage 4402 in the fine-tuning stage 4404 along with the lightweight classifier 4415 on the labeled dataset.

The pre-training approach to learning representation from the unlabeled data is to perturb the sliding window of acoustic flow with a binary mask and reconstruct the original window using the autoencoder depicted in the pre-training stage 4402 of FIG. 44. Here, the binary mask is constructed in a way such that a mask percentage m % of each channel of the sliding window is set to 0. In the case of ActSonic, the numerical value m of this mask percentage is randomly chosen from the range 15-20%, and the number of patches is randomly chosen from the range 1 to 4.

As illustrated in FIG. 44, the masked window goes through encoder 4410, illustratively a ResNet-18 encoder. The embedded representation from the encoder 4410 is then fed through the decoder 4411, illustratively a transpose convolution network. This customized transpose convolution, or deconvolution, network takes feature maps from the ResNet-18 as input and generates a three-dimensional matrix of the shape of the input sliding window. We calculate the MSE between each pixel in the reconstructed and original sliding window as the loss function for this example autoencoder architecture.

The aforementioned ResNet-18 encoder of the pre-training stage 4402 learns the representation of active acoustic data via self-supervision. This ResNet-18 encoder with learned weights serves as the feature extraction pipeline in the fine-tuning stage 4404. The fine-tuning stage 4404 includes an activity recognition architecture comprising the pre-trained ResNet-18 encoder 4410 followed by the classifier 4415, illustratively a fully connected classifier. We apply average pooling on the spatial axis of the feature map extracted by the encoder 4410 and feed it to the fully connected classifier 4415. The fully connected classifier 4415 is illustratively a feedforward neural network with batch normalization, Leaky ReLU activation, and dropout in between. We set the number of neurons in the last layer equal to the number of activity classes and perform a softmax operation to output a probability distribution.

The activity recognition model in the fine-tuning stage 4404 is trained using acoustic flow sliding windows as input and activity class labels as the target. To optimize the training process, we employ focal loss as the objective function. Focal loss is a modification of the standard cross-entropy loss, designed to emphasize learning from hard examples. It dynamically scales the loss function based on the confidence of the correct class prediction, with a decay factor that decreases as the confidence increases. In binary classification scenarios, where pₜ represents the predicted class probability, the standard cross-entropy loss CE(pₜ) is defined as −log(pₜ) when pₜ=p for the positive class and −log(1−pₜ) otherwise. Focal loss adds a scaling factor (1−pₜ)^{Y} to this standard cross-entropy loss, with y being a hyperparameter set to 0.5 for ActSonic. This modification ensures that the loss function assigns lower values to well-classified examples (pₜ>0.5) and focuses more on misclassified examples. This adaptation is particularly effective for ActSonic due to the imbalanced distribution of activity labels in the dataset and the similarity in body motion patterns observed in the echo profile for some activities.

The self-supervised activity recognition model of ActSonic processes overlapping sliding windows of the acoustic flow as input, with the shape of the sliding window being a hyperparameter. We conduct an iterative process to determine the optimal sliding window duration, ranging from 0.30 seconds to 5.00 seconds with a hop size of 0.10 seconds. Performance evaluation on the validation set helps us fine-tune this parameter, resulting in an optimal duration of 2.00 seconds with a 50% overlap. The shape of the input sliding window is defined as (num_channels×num_features×num_samples)=(4×295×166). Here, num_features represents the number of pixels from the echo profile, calibrated to 295, covering a sensing range of approximately 1 meter (precisely 101.185 cm), sufficient to capture upper body poses. Considering the sampling rate of ActSonic at 50 kHz and the number of samples in one sweep period at 600, a one-second sliding window contains approximately

$$⌊ \frac{50000}{600} ⌋ = 83$$

samples. Consequently, the num_samples for a 2.00-second sliding window of ActSonic is set to 166.

The dropout probability of the feedforward classification layer in the fine-tuning stage 4404 is configured to 0.2. Both the pre-trained and fine-tuning models are trained for 100 and 50 epochs, respectively, using a batch size of 64. We employ the Adam optimizer and incorporate a cosine annealing learning rate scheduler with an initial learning rate of 10-3. The self-supervised model, including both the pre-training and fine-tuning networks, is implemented using the PyTorch and PyTorch Lightning frameworks and trained on GeForce RTX 2080 Ti GPUs.

We use the Macro F1-score as our evaluation metric for ActSonic's activity recognition performance. If C is the set of activity classes such that classes are indexed as 0, . . . , (C-1) and |C| is the cardinality of this set, the evaluation metric is defined as:

$$Macro F 1 = \frac{1}{\vert C \vert} \cdot {\sum }_{i = 0}^{C - 1} \frac{2 \cdot {precision}_{i} \cdot {recall}_{i}}{{precision}_{i} + {recall}_{i}} \qquad ( 6 )$$

where precisionᵢ and recallᵢ are the numerical values of precision or positive predictive value and recall or sensitivity of i-th class, respectively.

As indicated previously, user studies were conducted to assess the performance of ActSonic. The objective of these studies is to evaluate the activity recognition pipeline under naturalistic conditions. To achieve this goal, we devised a diverse set of everyday activities to monitor throughout the study, recruited participants, and carried out both a semi-in-the-wild user study and a more extended unconstrained study, both conducted in participants' homes in a naturalistic environment.

To establish a set of activities, we conducted a pilot feasibility study encompassing over 50 activities of daily living with 5 users from our research team. Drawing on relevant prior studies and insights from a pilot study, we selected 27 activities of daily living to be incorporated into ActSonic's tracking set. Additionally, we introduced a Null label for activities not part of the tracking set. The primary criterion for selecting everyday activities was their involvement of movements across different body parts, aligning with ActSonic's reliance
on tracking body motion. The activities in the tracking set are categorized into three segments based on their typical indoor locations:
1. Bathroom (6 activities): Rinse Mouth, Brushing Teeth, Flossing, Brushing Hair, Flush Toilet, Opening Door.
2. Kitchen and Dining Area (8 activities): Washing Hands, Eating, Drinking, Pickup/Putdown, Pouring, Chopping, Wiping Surface, Stirring.
3. Bedroom and Living Area (13 activities): Stationary, Walking, Sitting, Coughing, Yawning, Talking, Putting on Outerwear, Vacuum, Throwing, Stretching, Using Phone/Tab, Squat, Reading Book

Based on insights from a pilot feasibility study, human activity patterns vary throughout the day. For instance, activities such as tooth brushing are more likely to occur in the morning or after dinner. Accordingly, we scheduled user studies to capture activity data across different parts of participants' daily routines.

We captured acoustic data using the sensing system integrated into ActSonic eyeglasses. Additionally, we recorded ground truth video data to annotate the activities. For this purpose, we employed a GoPro HERO9 camera mounted on the participants' chests using a lightweight body mount from the same manufacturer. The camera's horizontal and vertical field of view was set to 1180 and 690 respectively. It recorded egocentric videos at a resolution of 720 p and a frame rate of 30 FPS. Additionally, participants were provided with Apple Air Pods Pro during sessions where they received audio prompts or instructions for specific activities.

We conducted a 12-participant semi-in-the-wild study followed by an unconstrained study with 7 participants. Both of these studies were conducted at participants' homes in unconstrained settings.

We conducted two separate studies at participants' homes in a naturalistic setting. Given that the activity set of ActSonic encompasses a wide range of activities, obtaining samples of each activity in an uncontrolled setting, where participants are allowed to carry out their daily routines, proved challenging. Therefore, we conducted a semi-in-the-wild study where users were prompted with specific instructions to perform activities, thus covering the tracking set of ActSonic. Subsequently, we conducted a second unconstrained study at participants' homes, where they did not receive any particular instructions to perform activities but instead continued with their daily routines.

We utilized a chest-mounted camera to gather reference videos for ground truth annotation. In contrast to other activity recognition systems evaluated in real-world settings, we opted not to rely on self-reporting-based annotation, despite its facilitation of longer duration in-the-wild data collection without significant labeling effort. This decision stems from the impracticality of accurately self-reporting all 27 types of activities throughout a day. Additionally, we aimed to evaluate ActSonic based on the inference generated at each second, necessitating fine-grained ground truth annotation from the uncontrolled study, which is only achievable with a body-mounted camera.

The semi-in-the-wild user study is partitioned into two segments. In the first segment, the participants received audio instructions to perform certain activities by wearing Apple Air Pods Pro. The goal of this study segment is to collect data samples of all the activities included in the recognition set of ActSonic. Before starting this segment of the study, the participants were briefed about the procedure and familiarized with the audio instructions they were going to receive for each activity.

The activity set was split according to the indoor locations mentioned above. Two sessions of activity data were collected for the bathroom and kitchen locations. The living area activities were divided into two subsets for the convenience of participants, and two sessions of data were collected for each subset. In each session of the data collection process of this segment, the participants received audio instructions for specific activities in random order, and each activity was repeated 5 times within the session. The duration of each repetition of activities spanned from 10 to 30 seconds. The participants were provided minimal instruction regarding the way to perform certain activities so that they could perform their natural body movements. The duration of this segment, comprising a total of eight sessions, is 68 minutes, and each session was 8.5 minutes long. In between each session, the participants were asked to remount the ActSonic eyeglasses.

In the second segment of the semi-in-the-wild study, the participants did not receive any prompt or instruction to perform certain activities. They were allowed to perform their regular daily routine. The total duration of this segment was 30 minutes and was divided into three sessions. The participants wore a chest-mounted camera so that the ground truth video could be recorded for activity annotation. When the participants were performing the activities in this segment, the experimenter was present at the participants' home.

We designed a longer-duration unconstrained study with the goal of evaluating the ActSonic activity recognition system in the wild for extended hours. Furthermore,
the activity set of ActSonic contains a total of 27 activities, including the null class, and it is unlikely to get samples of all those activities in the second segment (30 minutes) of the semi-in-the-wild study in a naturalistic setting. Since the Institutional Review Board (IRB) protocol allows a maximum duration of two hours for a single study, we designed this in-the-wild study with a duration of two hours. However, the protocol allows multiple studies with the same participant, and therefore the participants were given an option to take part in multiple consecutive studies. One out of the 7 participants opted for that choice and participated in two consecutive studies which were four hours long in total, and they were compensated twice. Hence, we accumulated 16 hours of in-the-wild data from this study.

We followed the same data collection procedure for the unconstrained study as the second segment of the semi-in-the-wild study. One difference to be noted is that the experimenter left the participants' homes after briefing them and setting up the data collection system. The participants returned the data collection system after two hours. In this unconstrained study, the participants were not instructed with any specifics of the activities to be performed during the study; rather, they were allowed to continue their regular schedule at their homes. Note that we did not permit participants to leave their homes due to legal restrictions on video recording in public places in the country where the study was conducted.

To provide annotations for active acoustic data via ground-truth egocentric video data, we utilized the ANU-CVML Video Annotation Tool (Vidat) to annotate all ground-truth egocentric video data with action annotations. Subsequently, we synchronized the timestamps of acoustic and video data using a clapping action with a distinct acoustic signature. We then developed separate postprocessing scripts to align video annotations with acoustic echo profiles. To ensure accurate annotation of activities in a naturalistic setting, we implemented a peer-reviewed annotation process. In this procedure, one annotator from the research team labeled the data, while another researcher independently reviewed the annotations and provided feedback. After a phase of revision and approval from the reviewer, the annotated labels were incorporated into the ActSonic dataset.

We evaluated the performance of ActSonic on the data collected in user studies. Our evaluation can be partitioned into two phases. In the first phase, we evaluate the activity recognition performance on the prompted sessions of the semi-in-the-wild user study. Subsequently, we benchmark the performance of ActSonic on unconstrained sessions of the user study. For both scenarios, we employed a leave-one-participant-out strategy, to evaluate its performance without the need to collect training data from any new user in new environments.

We conducted a leave-one-participant-out cross-validation evaluation on prompted sessions of the semi-in-the-wild study. In the initial segment of the semi-in-the-wild study, involving 12 participants, each participant contributed 8 sessions. We trained 12 user-independent models, where, for instance, the model for participant P01 was trained solely on data from P02-P12 and tested on P01, and the same process was repeated for the other participants. The average macro F1-score for each participant ranged from 0.90 to 0.95, exhibiting a standard deviation of 0.035. Across all participants, the average macro F1-score in the leave-one-participant-out evaluation was 0.934. When examining individual activities, we observed high accuracy (macro F1-score) for all activities, ranging from 0.88 to 0.97 across participants in the semi-in-the-wild study with a prediction frequency of 1 Hz. Compared to other approaches, ActSonic has significantly better performance with a wider range of activities. However, we also acknowledge that in this part of the study, participants performed activities following audio stimuli with
the presence of a researcher at their home, which may reduce the variance in how they perform activities in real-world settings.

We further assess our user-independent models through a leave-one-participant-out cross-validation strategy on our dataset of unconstrained sessions. This evaluation aims to gauge ActSonic's performance in real-world naturalistic scenarios. As noted above, participants continued their regular daily routines at home during the
study. Hence, these sessions entail activity samples that might exhibit more diverse motion profiles compared to prompted sessions.

Our evaluation of the unconstrained sessions from both the semi-in-the-wild and the second studies involves two stages. In the initial stage, we take each model trained on prompted sessions and conduct a leave-one-participant-out evaluation. Subsequently, we fine-tune these models using unconstrained data from the semi-in-the-wild study for other participants before assessing the model on the original participant. For instance, the P01 “prompted” model, trained on P02-P12 “prompted” supervision, undergoes fine-tuning using “unconstrained” supervision from P02-P12, ensuring the exclusion of labels from P01 during model training.

In the second phase of the unconstrained session evaluation, we measure the performance using data from the second study. To assess the unconstrained sessions of users P13 to P19 from the unconstrained study, we first train a fine-tuned model using prompted session data of users P01 to P12 as supervision. Subsequently, we evaluate the model performance using data from individual users of P13-P19 as the test set.

Our findings reveal an average F1-score of 0.866 with a standard deviation of 0.052 with a predication frequency of 1 Hz. Although the system's performance in an unconstrained scenario is comparatively lower than in prompted sessions, the activity recognition remains accurate, considering the user variability and class imbalance present in the unconstrained sessions.

The observed accuracy imbalance among different actions within the unconstrained examples likely stems from the natural variability in individual interactions within an open-world setting, influenced by external context. While activities like “rinsing mouth,” “brushing,” “walking,” and “sitting/standing” seem less contextually dependent, actions such as “pouring,” “throwing,” and “pickup/putdown” might display lower performance due to subtler movements and inherent variability arising from interactions with different objects.

The ActSonic system initially consumed 577.8 mW with an example prototype employing the Teensy 4.1 microcontroller. Substituting this microcontroller with a low-power nRF52840 microcontroller significantly reduced power consumption. We integrated the speakers and microphones, adjusting the gain to ensure identical sound pressure levels (SPL) for both, maintaining emission consistency. The power signature, measured using a CurrentRanger, displayed an average operation of 96.5 mW(4.02 V, 24.0 mA) while saving all data to the SD card. Furthermore, we conducted long-term stability testing, and the prototype operated continuously for 11.3 hours using a 290 mAh 3.7 V LiPo battery. This configuration enables a full-day operation on commodity smart glasses or AR glasses. For instance, Google Glass, equipped with a 570 mAh battery, can support the ActSonic sensing system for over 21 hours if the activity recognition pipeline is the only active process.

We evaluated the latency and overhead of the ActSonic system on the Google Pixel 7 mobile platform. Table 8 presents the inference time and various parameters of the ActSonic ResNet-18 model evaluated on an unconstrained dataset with the same protocol described above. Initially, we generated lightweight mobile models from both the original and the 8-bit integer quantized versions of the ResNet-18 model using PyTorch Mobile. Subsequently, we conducted inference time benchmarks using a two-second sliding window on a Google Pixel 7 Android phone, performing inference on 1000 samples. The mean inference time is detailed in Table 8. The ActSonic performance on mobile devices was evaluated by transmitting the acoustic data to a Pixel 7 for inference. The BLE status was set to “connected” since it continuously streams data to mobile devices.

TABLE 8
ActSonic ResNet-18 model latency and system overhead on
Google Pixel 7 Android mobile platform.

| | Non-quantized | Quantized |
|---|---|---|
| Avg. Macro F1-Score | 0.864 | 0.772 |
| Size | 151.1 MB | 45.4 MB |
| Inference Time | 123.1 ms | 68.4 ms |
| CPU | 14% | 11% |

Furthermore, we utilized the Android Profiler to evaluate mobile CPU usage and energy consumption. Table 8 indicates that while the quantized model exhibits lower accuracy compared to its non-quantized counterpart, it demonstrates lower system overhead. This assessment utilized a post-training quantization strategy; employing a quantization-aware training approach for the ResNet-18 model might yield improved performance while preserving similar efficiency. The energy consumption was indicated as “light” for both the quantized and non-quantized models by the Android Profiler.

ActSonic is illustratively configured to track the movement of facial and upper body limbs to recognize everyday activities. To assess the impact of different body regions on activity recognition performance, we conducted an evaluation of the ActSonic system using acoustic signals solely from the face and upper body regions. We then compared this recognition performance with the evaluation reported above. In order to filter out the acoustic reflection from the face region, we crop the first 50 pixels from the top to bottom of the y-axis of the echo profile sliding window. This 50-pixel (=17.15 cm) approximately represents the face region of the user and the movement from this region is captured in the cropped differential echo profile. In addition, we evaluate the performance of ActSonic with the rest of the echo profile sliding window (representing the upper body region up to the knees).

From this performance evaluation, we observe a sharp degradation in performance if we exclude the movement patterns of the upper body region. Analyzing the activity-wise performance, we note that activities involving obvious facial movements have fewer errors compared to activities that involve upper body movements, such as eating, drinking, talking, etc. On the other hand, we observe less degradation in performance if we exclude the face region movement from the acoustic signal. This observation can be attributed to the fact that most activities in the ActSonic dataset involve hand or upper body movement. Overall, based on the evaluations described above, we can extrapolate that the combination of reflection patterns from the face and upper body regions yields the best performance for the ActSonic system.

TABLE 9
Comparison of ActSonic performance under different deep
learning encoders and training strategies, with number of
trainable parameters for each model in millions (M).

| | Number of | | |
|---|---|---|---|
| Model | Parameters | Prompted | Unconstrained |
| Architecture | (Approx.) | Sessions | Sessions |
| MobileNetV2 w/o | 4M | 0.827 | 0.743 |
| Self-supervision | | | |
| MobileNetV2 w/ | 4M | 0.854 | 0.761 |
| Self-supervision | | | |
| ConvLSTM | 16M | 0.879 | 0.788 |
| ResNet-18 w/o Self- | 11M | 0.912 | 0.785 |
| supervision | | | |
| ResNet-18 w/ Self- | 11M | 0.934 | 0.866 |
| supervision | | | |

As described previously, illustrative embodiments implement a self-supervised deep learning pipeline for ActSonic, utilizing ResNet-18 as the backbone encoder. The performance of this network is compared with architectures having different encoders and training strategies in Table 9 above. We present the performance of MobileNetV2 and the ConvLSTM architecture (ResNet-18 encoder followed by an LSTM decoder with two layers) in Table 9. We also evaluate the impact of self-supervised pre-training on convolutional encoders (ResNet-18 and MobileNetV2). Additionally, the number of trainable parameters (in millions) for each model is reported in Table 9.

It is apparent from Table 9 that, while self-supervision doesn't exhibit significant performance improvement in the controlled sessions, it does demonstrate an impact in maintaining performance in variable unconstrained scenarios. Furthermore, in comparison to the number of parameters of MobileNetV2, ResNet-18 has a larger memory footprint. This observation is particularly valuable in the scenarios involving the performance-inference time tradeoff of the ActSonic system. Additionally, ConvLSTM exhibits worse performance compared to self-supervised ResNet-18 despite having the explicit capacity to model temporal dependency.

ActSonic in illustrative embodiments can track fine-grained actions such as flossing or wiping surfaces since its sensing mechanism relies on tracking the movement of different body parts simultaneously. ActSonic's utilization of an active acoustic sensing mechanism enables the capture of signals representing fine-grained movements that passive sensing-based systems may miss. For instance, it can recognize actions occurring outside the frame of an egocentric camera or actions with minimal audio cues, which passive acoustic sensing may struggle to detect accurately. Additionally, passive acoustic sensing-based methods are vulnerable to changes in environmental parameters, hindering their ability to generalize signals across different environments and making deployment in the wild challenging.

The above-described user studies demonstrated competitive accuracy in recognizing 27 everyday activities by learning patterns from reflected inaudible acoustic waves around the body. The reflected acoustic signals are formed with complex multipath echoes from both the body and the surrounding environments. Additionally, the environment can occasionally generate acoustic signals with frequency components that overlap with the emitted frequency ranges of the sensing system. Therefore, received acoustic signals contain rich information about the environment in addition to the body poses.

We conducted saliency analysis using Gradient-weighted Class Activation Mapping (GradCAM) to visualize the ResNet-18 encoder's final convolutional layer. Overlaying feature heatmaps on acoustic flow or differential echo profile channels confirm the model's ability to capture the movements of body parts and areas related to each activity. Various activities activate distinct regions within the echo profile sliding window in the neural networks.

It was found that the disclosed deep learning algorithms allocate significantly higher attention to areas with heavy body movements (e.g., face, chest, arms) during different activities. For instance, in the activity of brushing teeth, repetitive movement near the face region is evident, with the ResNet-18 encoder displaying higher gradient values (indicative of heightened attention) in that area around the face (e.g., 5 cm-17.15 cm) to infer the activity.

While some activities share similar arm movement patterns, fine details in reflected acoustic waves around the face differentiate them. For instance, both drinking and eating involves moving the arm toward the mouth. However, after feeding during eating, the hand usually moves downward, leaving only mouth movements, visible as subtle highlights under 10 cm. Conversely, during drinking, the hand and container (e.g., cup) remain around the mouth, evident as a large area of heated sections (e.g., 15-30 cm). Additionally, the activity of opening a door demonstrates hand movement to unlock the door, followed by movement to enter the room.

This visualization confirms that our self-supervised model focuses on different explainable regions of the echo profile within the input sliding window to infer everyday activities. It underscores the importance of capturing detailed movements in both the upper body and face areas to distinguish fine-grained activities such as eating versus drinking, which may not be distinguished in isolation.

As described above, ActSonic employs an active acoustic sensing system integrated into eyeglasses to emit inaudible acoustic signals around the body and capture the reflected waves. Due to the low-power and compact nature of the microphones and speakers, this technology can be easily adapted to other wearable form factors for tracking human activities using a similar sensing principle. Here, we evaluate the feasibility of implementing ActSonic on different form factors. Two critical considerations for applying ActSonic to wearable form factors are: 1) the ability to continuously emit acoustic waves around both sides of the upper body and head, and 2) the stability of the wearable form factor during various activities.

Based on these criteria, we anticipate that ActSonic can be seamlessly deployed with minimal modifications on wearable form factors worn around the head (pending training data collection for each form factor), such as necklaces, earbuds, or the recently introduced Humane AI Pin worn on the chest. These form factors provide similar stability to eyeglasses while continuously covering both the upper body and head to track detailed facial and upper body movements.

Wearable form factors attached to limbs, such as wristbands, armbands, or rings, pose greater challenges for applying ActSonic for activity recognition with a single device. Limbs exhibit a wide range of movements, complicating signal interpretation as the source moves concurrently with other body parts. Additionally, signals emitted from one side of the limb may be obstructed by the body, hindering sensing on both sides. Moreover, capturing facial movements from limb-mounted devices is challenging due to the relatively long distance and
potential blockages. These issues may be mitigated with appropriate adjustments to the algorithms and hardware designs.

To explore the feasibility of deploying our framework on glasses, we implemented the model pipeline on the MAX78002 microcontroller unit (MCU), leveraging its built-in ultra-low-power CNN accelerator. Initially, we quantized the model by converting high-precision floating-point model parameters to 8-bit integers, a necessary step for deployment on the MAX78002 MCU. Subsequently, we generated a C program for the quantized model inference using the ai8x library provided by the MCU manufacturer. Due to hardware constraints, certain adjustments were made to the model pipeline for compatibility. Notably, 2D convolution kernel sizes were limited to (1×1) or (3×3), with fixed stride size at (1×1). Additionally, the fully connected layer was capped at a maximum of 1024 input neurons on the chip. Although we successfully ran the ActSonic model on the MAX78002 MCU, the computation for echo profile calculation resulted in a slower frame rate than anticipated for real-time inference.

The ActSonic system utilizes active acoustic sensing to detect daily activities by monitoring body motions. We evaluated its resilience to environmental noise across 19 participants' homes during the studies. Despite varying environmental factors like HVAC, running water, TV, and ambient sounds, ActSonic maintains consistent performance independent of environment setting. This resilience stems from its reliance on ultrasonic frequencies (e.g., 18 kHz to 24.5 kHz), which surpass most environmental noise sources (recorded at frequencies below 7.5 kHz). For instance, noises like café chatter (63.8 dB), roadside traffic (69.0 dB), and loud music (71.5 dB) fell below ActSonic's operational range. Additionally, any overlapping frequencies in this range would result in significantly stronger signals near the eyeglasses, reinforcing ActSonic's robustness to environmental acoustic noise.

ActSonic illustratively utilizes ultrasonic frequency ranges (e.g., 18 kHz to 24.5 kHz) to transmit and receive signals. As described above, we apply a bandpass filter on the audio received by the microphone to ensure that ActSonic does not access the audible frequency range to infer activities. Since ActSonic does not require any passively sensed audible acoustic signal, the system does not compromise user privacy by processing sensitive conversation information. Furthermore, the potential of adopting a customized ultrasonic speaker and microphone can further remove the possibility of collecting audible sound.

In some embodiments, ActSonic emits FMCW-encoded ultrasonic waves for active acoustic sensing. To assess health implications, we measured the transmitted signal intensity using a CDC-provided mobile app. The resultant intensity is 68 dB(A), well below the 85 dB limit set by NIOSH. Research on MHz range ultrasonic exposure suggests muscle tissue discomfort. However, ActSonic operates in the kHz range just above the audible threshold, with no reported issues in this range.

The promising performance of ActSonic recognizing 27 activities in the wild using low-power and minimally obtrusive glasses will significantly lower the barriers to logging everyday activities in numerous applications. It creates opportunities for many downstream applications that are based on tracking one or multiple types of activities. The following are a few example applications.

1. Behavioral Journaling. We can utilize this system to journal various everyday activities for different purposes. For instance, one crucial step in combating eating disorders is to journal food intake behavior, often recorded manually. Previous eating journaling systems required multiple sensors, had low time resolution (e.g., recognizing a meal every 10 minutes), or necessitated training data from a user. In contrast, ActSonic can recognize eating moments at 1 Hz with over 90% F1 score in real-world settings without the need for training data from a new user. This indicates that the system can be immediately deployed to facilitate eating journaling practices.

2. High-Resolution Behavior Data in the Wild for Health. ActSonic can track 27 everyday activities, many of which are related to health behaviors. Automatically logging these health-related activities can potentially provide researchers and clinical physicians with an opportunity to better understand a user's activities in the wild for health purposes. For instance, eating and drinking behavior can potentially be used to analyze the user's eating and drinking routines related to eating disorders and body hydration levels. Brushing teeth, flossing, and rinsing the mouth can be recognized with a very low error rate. This feature can be utilized by dentists to better track patient dental behavior.

3. Tracking Other Activities. In illustrative embodiments, the disclosed system was configured to track 27 distinct activities. However, the disclosed system can be configured to recognize a wide variety of additional or alternative activities, including numerous other activities that involve movements on the upper body and/or face. The ActSonic system in other embodiments can be customized to detect various activities that are of particular interest. For instance, this system can be configured to automatically track and log the duration and types of a user's exercise routines.

In some embodiments, larger datasets and a foundational deep learning feature extractor can be used, possibly in combination with external contextual information, to improve activity detection in these and other contexts. For example, integrating GPS or motion data for fine-grained head or hand movements could aid in understanding environmental affordances and improving activity detection.

Although illustrative embodiments utilize differential echo profiles, other embodiments can additionally or alternatively utilize original echo profiles, for example, to provide improved detection of static activities with consistent poses. However, embodiments utilizing differential profiles are generally more user-independent.

Some embodiments can be configured for multi-label or concurrent activity detection. Real-world scenarios often involve concurrent activities, and illustrative embodiments can be configured to detect such concurrent activities using multi-label classifiers.

Additionally or alternatively, some embodiments can be configured to incorporate a state machine or majority-vote mechanism in order to reduce classification errors that might otherwise occur during transitions between activities.

As described above, ActSonic in some embodiments provides a low-power and unobtrusive action recognition system employing acoustic sensing on smart glasses. Extensive experiments involving 19 participants in real-world settings showcase ActSonic's adeptness in distinguishing a diverse range of everyday actions across different environments. ActSonic provides a straightforward and efficient supplementary modality for egocentric action recognition, while also addressing concerns regarding privacy. Numerous other acoustic sensing systems can be implemented utilizing the disclosed techniques.

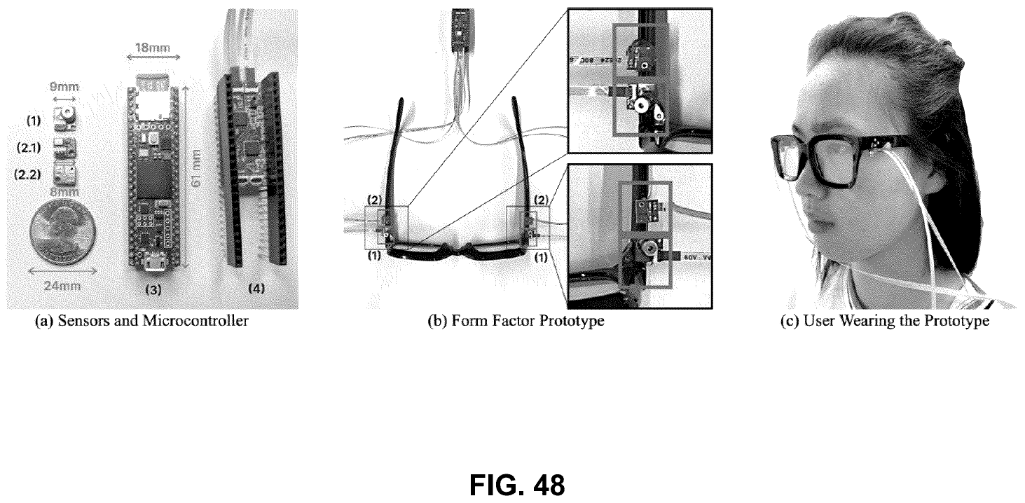

Additional illustrative embodiments include an acoustic sensing system referred to herein as PoseSonic, as will now be described in further detail with reference to FIGS. 48 through 50. The PoseSonic system in some embodiments provides 3D upper body pose estimation through egocentric acoustic sensing on smart glasses. More particularly, PoseSonic illustratively provides an intelligent acoustic sensing solution for smart glasses that estimates upper body poses. The system utilizes two pairs of microphones and speakers on the hinges of the eyeglasses to emit FMCW-encoded inaudible acoustic signals and receive reflected signals for body pose estimation. Using a customized deep learning model, PoseSonic estimates the 3D positions of 9 body joints including the shoulders, elbows, wrists, hips, and nose. We adopt a cross-modal supervision strategy to train the model using synchronized RGB video frames as ground truth. We conducted in-lab and semi-in-the-wild user studies with 22 participants to evaluate PoseSonic, and our user-independent model achieved a mean per joint position error of 6.17 cm in the lab setting and 14.12 cm in semi-in-the-wild setting when predicting the 9 body joint positions in 3D. Further studies showed that the performance was not significantly impacted by different surroundings or when the devices were remounted or by real-world environmental noise. PoseSonic is suitable for deployment in numerous real-world applications.

The PoseSonic system in some embodiments is similar in some respects to one or more of the acoustic sensing systems previously described herein. It utilizes differential echo profiles of the type previously described, but for estimating body joint coordinates for upper body pose detection. The echo profiles are generated using two wireless transmitter-receiver pairs, implemented as speaker-microphone pairs, on each side of a pair of eyeglasses, as shown in FIG. 48.

As in other embodiments disclosed herein, including the ActSonic system, such an arrangement illustratively provides four distinct acoustic sensing paths, which are more particularly defined as follows for the present description: Path-1: Left Speaker to Right Mic (LR), Path-2: Left Speaker to Left Mic (LL), Path-3: Right Speaker to Right Mic (RR), and Path-4: Right Speaker to Left Mic (RL).

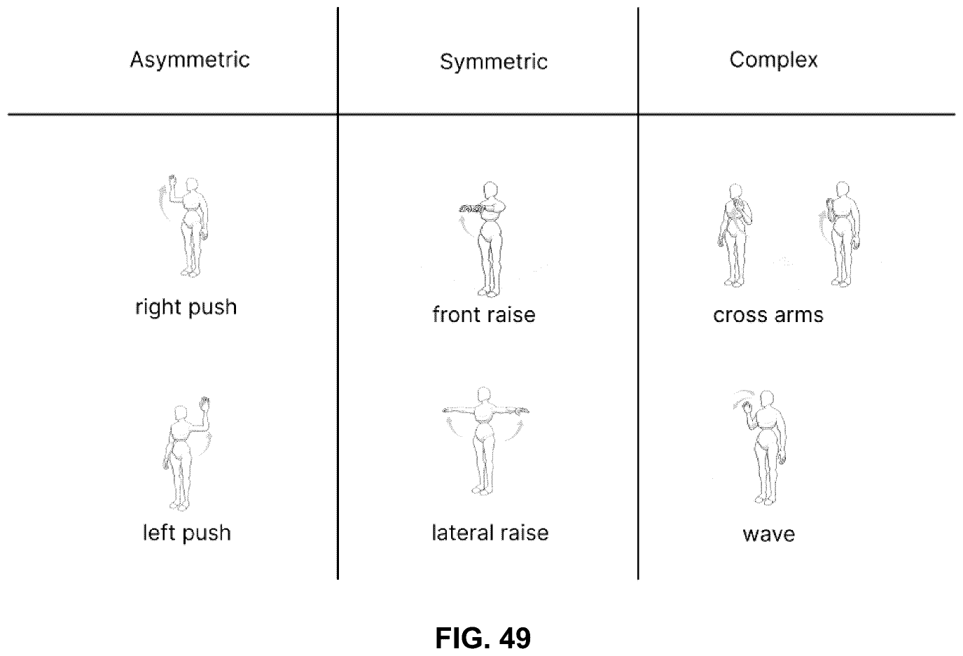

As will be described, the echo profiles for these four distinct acoustic sensing paths are processed to detect particular body poses, including the example body poses shown in FIG. 49. These more particularly include asymmetric poses such as right push and left push, symmetric poses such as front raise and lateral raise, and complex poses such as cross arms and wave. Additional or alternative poses can be detected in other embodiments.

Smart glasses have become an important form of personal wearable computing, but they face limitations when it comes to sensing the user's body postures. Due to restrictions in weight, size, and battery consumption of the hardware components inside the glasses, most current smart glasses are only able to capture head motion using IMUs, touch input using a touchpad, or speech interactions using a microphone. However, none of these sensors are capable of capturing body poses critical for a range of applications, such as activity recognition, health monitoring, and virtual reality. Upper body pose, for instance, is essential for virtual and augmented reality interactions and is involved in almost all types of physical activities. Tracking upper body poses allow computers to better understand and interpret a user's behavior and intention, such as detecting when the user is eating.

Tracking upper body pose has been proved to be an extremely challenging task for smart glasses, as they are not directly attached to any part of the limbs. There is a clear need for a new lightweight sensing solution for smart glasses to track fine-grained upper-body poses.

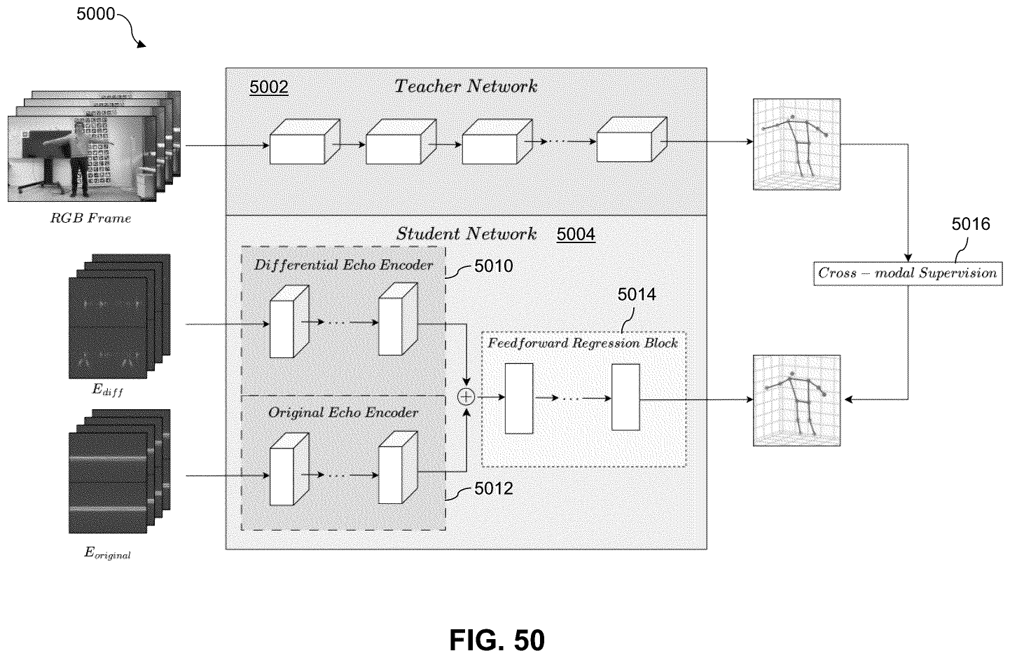

PoseSonic provides an intelligent upper body pose estimation solution on smart glasses that utilizes a low-power, minimally-obtrusive, and privacy-sensitive acoustic sensing technique. The disclosed techniques allow the smart glasses to track upper body poses including the 3D positions of upper limbs without the need of collecting any training data from the new user. Two pairs of MEMS microphones and speakers need to be attached to the two hinges of an off-the-shelf glass frame, as illustrated in FIG. 48. The speakers emit inaudible, FMCW-encoded acoustic signals that are reflected by different body parts, such as the arms, hands, torso, and shoulders. The two microphones on the glass frame capture these reflected signals, which are then analyzed to extract the reflection information in the form of echo profiles of the type previously described herein. To learn the complex mappings between the captured acoustic signals and upper body poses, we developed a customized convolutional neural network, to be described below in conjunction with FIG. 50. The neural network takes time series of both original and differential echo profiles extracted from acoustic signals as input and outputs the 3D coordinates of upper body parts, including nose, shoulders, wrists, elbows, and hips.

To evaluate the performance of illustrative embodiments of PoseSonic, we conducted an in-lab user study with 12 participants and a semi-in-the-wild study with 10 participants, where each participant performed a variety of pre-defined upper body poses wearing the commodity glass integrated with the disclosed solution. We conducted the studies in 5 rooms with different furniture settings and two places outside the lab (sidewalk and cafe). Each participant remounted the glasses multiple times during the experiment. The results show that, without the need of collecting any training data from a new user, PoseSonic can estimate the upper body poses including nine 3D body joint positions for the poses with an average localization error of 6.169 cm in the lab setting and 14.119 cm in semi-in-the-wild setting in a leave-one-participant-out experiment. The performance can be further improved to 5.633 cm in the lab setting if we fine-tune the model with the participant's own training data. On the other hand, the performance in a naturalistic setting can be improved to 12.004 cm with an addition of 30 minutes of training data not necessarily from the same user. Furthermore, by using the data from different rooms as testing data, we found that there is no significant difference in performance when the rooms and furniture are different. Moreover, the PoseSonic system demonstrates robustness to noise in different real-world settings.

PoseSonic in some embodiments provides acoustic-sensing technology on smart glasses that tracks upper body poses. Different from many data-driven sensing approaches which require training data from each user to fine-tune the model, the system works well even without the need for collecting training data from a new user, as shown by the promising performance in a user-independent evaluation. Additionally, the microphones and speakers are lightweight and have a low-power signature. Therefore, PoseSonic in illustrative embodiments herein provides smart glasses-based body pose tracking, in an effective acoustic-based body-pose sensing solution that can be deployed on commodity smart glasses.

Illustrative embodiments of PoseSonic use FMCW signals to indirectly measure the distance between a signal source and an object by using the difference in frequency between the transmitted and received signal. An example of transmitted and received FMCW signals were previously described in conjunction with FIG. 43, where r represents the time delay between the transmitted and received signals. The frequency of the signal increases linearly over time during each sweep period. The frequency of the acoustic FMCW signals can be represented as a linear function of time. At the time t, the frequency of FMCW is

$$f ( t ) = {f}_{c} + \frac{B}{T} \cdot t ,$$

where f_{c} is the carrier frequency, B is the bandwidth and T is the sweep period. The resolution SR is the minimum distance that the FMCW signal can appreciate and is measured as

$$δ R = \frac{v}{2 {f}_{s}}$$

where v is the velocity of sound and fₛ is the sampling rate. The maximum theoretical range of the signal is computed as

$${R}_{max} = δ R \cdot N = \frac{v}{2 {f}_{s}} \cdot N ,$$

where N is the number of samples in one sweep period.

The PoseSonic system in some embodiments is equipped with speakers emitting FMCW acoustic signals. The signal configurations of the system are determined as follows. First, sounds around 17 kHz and above are inaudible to most adults. Second, the microphones and speakers in the commodity wearables (e.g., smart glasses, “earables,” etc.) can be operated up to the Nyquist frequency of 22.05 kHz with a sampling rate of around 44.1 kHz. Thus, the choice of frequency in illustrative embodiments aims to find a solution that is potentially applicable to commodity microphones and speakers without losing performance. PoseSonic illustratively sets the carrier frequency f_{c} as 18 kHz and 21.5 kHz respectively for the left and right channels, and the bandwidth B is set to 3 kHz, although other values could be used in other embodiments.

In some embodiments of PoseSonic, the FMCW chirp sweeps within the frequency range of 18 to 21 kHz for the left channel and 21.5 to 24.5 kHz for the right channel, and bandpass filtering is utilized on the received signals in each channel for the corresponding frequency range of interest, such that the two channels do not interfere with each other. The sampling rate fₛ of the FMCW signal is 50 kHz. The sweep period of the signal is set to be N=900 samples or 18 milliseconds (90/50 kHz). The speed of sound v in dry air at 20° C.(68° F.) is 343 m/s. Given the above parameter values, the resolution of the system is

$$\frac{343}{2.50000} = 0.3 \; 43 cm ,$$

which is high enough to capture subtle movements of the body. The acoustic sensing mechanism also covers the whole body since the maximum range of the signal is

$$\frac{343}{2.5} \cdot 900 = 3.087$$

m or around 10 feet, which is higher than the average human height.

The system applies cross-correlation to measure the time delay between the transmitted and reflected signals, using the following cross-correlation function:

$$R ( n ) = \{ \begin{matrix}\begin{matrix}\frac{1}{N - n} {\sum }_{m = 0}^{N - n - 1} {v}_{tx} ( m ) \cdot {v}_{rx} ( m + n ) , & if n \geq 0\end{matrix} \\ \begin{matrix}\frac{1}{N - \vert n \vert} {\sum }_{m = 0}^{N - \vert n \vert - 1} {v}_{rx} ( m ) \cdot {v}_{tx} ( m + n ) , & if n < 0\end{matrix}\end{matrix} \qquad ( 7 )$$

where N represents the number of samples in each sweep period, n=−N+1, −N+2, . . . , N−1 and R (n) is the similarity between transmitted signal vtx and received signal vrx shifted away by n samples. The cross-correlation has the same period as the transmitted signal, and the output of the cross-correlation operation in that period is referred to herein as an echo frame. Through transmitting FMCW acoustic signal repeatedly, we obtain an array of consecutive echo frames and this array is defined as echo profile. If we consider an echo frame as a column vector, the vertical axis of the echo profile represents the distance between the object and the sensor, and the horizontal axis is the temporal axis. Each bright spot on the echo profile means a strong reflection signal is received at the corresponding distance and time. Since the period of the signal is 900 samples and the device contains two pairs of sensors mounted on the left and right hinges of the glass frame respectively, the echo profile is a 3600-dimensional vector with four 900-dimensional channels stacked together (4 possible speaker-microphone links between 2 speakers and 2 microphones).

We further process the echo profile to acquire a differential echo profile by calculating the absolute difference between two consecutive echo frames. One advantage of a differential echo profile is that it preserves the changes in the echoes across consecutive frames and removes unchanged signals reflected from static objects. As a result, it contains less noise from the surroundings and yields a higher signal-to-noise ratio (SNR). In addition, a differential echo profile is particularly helpful in mitigating issues of remounting. Although a change in the position of the device alters the absolute distance between the sensors and targets, such difference will not impact the differential echo profile which only considers the change across consecutive echo frames. Therefore, the same physical action or movement will offer a similar differential echo profile irrespective of the physical characteristics of the user.

FIG. 48 shows the example form factor of PoseSonic in an illustrative embodiment. Part (a) of the figure shows the acoustic sensors and microcontroller, including (1) transmitter or speaker, (2.1) one side of receiver or microphone board, (2.2) other side of receiver or microphone board, (3) microcontroller (Teensy 4.1) to interface speakers and microphones, and (4) customized adapter PCB. Part (b) of the figure shows a form factor prototype including the speakers and microphones mounted to the frame of the glasses and connected to the microcontroller using FPC cables, and part (c) of the figure shows a user wearing the prototype.

This example form factor includes two speakers (OWR-05049T-38D) and two microphones (ICS-43434), with a Teensy 4.1 microcontroller managing the signal emission and reception. It has an SD card interface on board so the received data can be saved into an SD card. To better control the audio signal, the example form factor further includes a customized PCB with two SGTL5000 chips compatible with the microcontroller. The hardware components are configured to communicate with each other through an I2S interface. The microcontroller, the speaker, the microphone, and the customized PCB are shown in part (a) of FIG. 48.

As illustrated in part (b) of FIG. 48, one speaker and one microphone is placed on each hinge of the glasses, pointing downwards. The system includes two pairs of speakers and microphones arranged symmetrically so that each one contains information mainly from one side of the body. In addition, the sensors are pointing downwards so that the signals are directly emitted towards the upper body and the microphones are better able to receive signal reflections. The speakers and microphones are connected to the microcontroller using FPC cables. This example form factor is minimally obtrusive and when worn does not have a significant impact on users' daily activities. In addition, this example form factor guarantees the stability of the system and is close enough to the users' upper body for tracking its posture. Other form factors can be used in other embodiments.

FIG. 49 shows example upper body poses that are detected by PoseSonic in illustrative embodiments, each corresponding to a different upper body action unit or body gesture. In this example, there are six upper body action units involving movements of different parts of the upper body, including left push, right push, front raise, lateral raise, cross arm, and wave. This design space was primarily influenced by the spatial location where upper limb movements take place. In order to evaluate a full range of upper body movements, we separated the body movements into three categories: asymmetric, symmetric, and complex. Asymmetric movements refer to activities that only involve one arm moving at a time. Symmetric movements refer to activities where both arms move in a similar pattern at the same time. We designed the action units in this way because the sensing system was placed on both hinges of smart glasses. Furthermore, we designed a third category—complex—which refers to activities involving both arms moving at the same time, but in different patterns. We designed the action units in this way because these complex movements are more similar to daily activities, such as waving one hand. These example upper body poses allow us to validate the performance of the sensing system under different movement synchronization conditions. Additional or alternative upper body poses can be detected in other embodiments.

FIG. 50 shows an example machine learning system 5000 implemented in the PoseSonic system. The machine learning system 5000 may be viewed as an example of machine learning system 4210 of FIG. 42. Other types of machine learning systems can be used in other embodiments.

The machine learning system 5000 implements a teacher-student training strategy and includes a teacher network 5002 and a student network 5004. The teacher network 5002 provides a processing pipeline which processes RGB frames and provides supervision to the student network 5004. The student network 5004 comprises a differential echo encoder 5010 that processes differential echo profiles, an original echo encoder 5012 that processes original echo profiles. Outputs of the differential echo encoder 5010 and the original echo encoder 5012 are combined and input to a feedforward regression block 5014. Cross-modal supervision 5016 of outputs of the feedforward regression block 5014 of the student network 5004 is provided by the teacher network 5002 as indicated.

In some embodiments, the teacher network 5002 comprises a pre-trained BlazePose GHUM 3D model that includes a MobileNetV2 convolutional architecture, and the differential echo encoder 5010 and the original echo encoder 5012 of the student network 5004 comprise respective ResNet-18 encoders. The input to the feedforward regression block 5014 is the elementwise summation of representation vectors retrieved from two branches.

Since it is not possible in some embodiments to manually label the acoustic signal with corresponding human upper limb joint coordinates, the student network 5004 utilizes a cross-modal supervisory signal obtained from the teacher network 5002 to learn this correspondence. The teacher network 5002 takes RGB video frames synchronized with the acoustic data as input, and utilizes a pre-trained neural network to predicts nine 3D upper body joint coordinates from RGB video frames. The student network 5004 takes echo profiles as input and predicts upper limb joint coordinates. The training of the student network 5004 is guided by the prediction retrieved from synchronized video frames by the teacher network 5002.

Consider a synchronized RGB video frame and corresponding pair of echo profile frames as (I, E) where I denotes an RGB frame and E denotes a pair of original echo profile E_{original} and differential echo profile E_{diff}. The pre-trained teacher network 5002, also denoted as T(·), predicts joint coordinates T(I) from the RGB video frame I. The student network 5004, also denoted as S(·), takes E=(E_{original}, E_{diff}) as input and predicts upper limb joints S(E). The training objective of the student network 5004 is to minimize the difference between predictions T(I) and S(E) and it can be formulated as:

$${min}_{s} {\sum }_{∀ ( I , E )} L ( T ( I ) , S ( E ) ) \qquad ( 8 )$$

Here, L(·) denotes the loss function of the deep learning model and is illustratively defined as the MSE between the joint coordinate prediction from the teacher network 5002 and the student network 5004:

$$L ( T , S ) = \frac{1}{N} {\sum }_{i = 1}^{N} {( {T}_{i} - {S}_{i} )}^{2} \qquad ( 9 )$$

where Tᵢ and Sᵢ are the prediction of i-th batch from the teacher and student network respectively, and N is the total number of batches.

The original and differential echo profiles illustratively represent movements of different body parts. Taking into consideration that the system is located on eyeglasses and is configured to predict upper body poses, we crop 450 pixels (which represent the range˜1.5 m) of each channel in the echo profiles. Then, we segment the echo profiles into overlapping sliding windows. As we have four channels in the echo profiles, the shape of each input original and differential echo profile will be (4×sliding window length×450). The student network 5004 for estimating upper body pose takes these sliding windows of the original echo profile and differential echo profile as input.

The student network 5004 processes the received differential echo profiles and original echo profiles in respective differential echo encoder 5010 and original echo encoder 5012. A ResNet-18 convolutional neural network is utilized as the encoder backbone in both of these encoder branches followed by an average pooling layer on the spatial axis. Each encoder learns a 256 dimensional representation of the echo profiles. We compute the element-wise summation of these two representation vectors and it serves as the input to the feedforward regression block 5014. The feedforward regression block 5014 outputs the prediction of the coordinates of nine 3D upper body joints as a vector with dimension 9×3=27.

The size of the input sliding window is tuned as a hyperparameter and set to 2 seconds (112 samples of echo frame) for this example system. Therefore, the shape of the input echo profile will be (4×112×450). In order to tune this hyperparameter, we create a holdout validation set using 20% of the training data. Then, we iterate over the range of sliding window sizes starting from 0.10 second to 7.50 second with a hop size of 0.10 second. For each sliding window size, we train the model with training data excluding the validation set for 30 epochs and evaluate the performance on the holdout validation set. We then chose the value of sliding window size that yielded the best performance as a tuned hyperparameter. After preprocessing the input data with the tuned value of the sliding window (2 seconds with 50% overlap), we have approximately 60,000 data samples for each participant in the user study. We use batch normalization after each layer in the encoder followed by the sigmoid activation function. The dropout probability for the feedforward regression layer is set to 0.2. We train the model for 30 epochs with a batch size of 48. We use Adam as an optimizer and deploy a learning rate scheduler with an initial value of 10⁻⁵ and decay factor y=0.1 in each 10 epoch. The neural network architecture is implemented in PyTorch and PyTorch Lightning frameworks and trained on GeForce RTX 2080 Ti GPUs.

The student network 5004 as described above takes both original and differential echo profiles as input to infer upper body pose. The deep learning model utilizes 32-bit floating point weight tensors to learn the parameters. In order to more effectively deploy the model locally on a wearable device with limited compute and memory resources, we can reduce the memory footprint of the deep learning model through floating point quantization. For example, we can implement a post-training quantization strategy on saved weights of the model and reduce the weight tensors to 8-bit integer precision. This approach reduces the ResNet-18 backbone deep learning model size from 46.76 MB to 10.28 MB. For each sliding window that represents 2 seconds of acoustic signal data, the inference time on an ARM64 CPU with the quantized model is 209.53 milliseconds. Using this quantized model, we can estimate the upper body pose from streaming acoustic data with a latency of 41 milliseconds. This compression approach can be viewed as a proof of concept for local deployment on wearable devices of various form factors and the inference time serves as a performance upper bound.

In order to evaluate performance of the PoseSonic system, we utilize Mean Per Joint Position Error (MPJPE) as an evaluation metric. MPJPE is defined as the average of Euclidean distances between the predicted joint coordinates and ground truth joint coordinates, and is computed in units of centimeters in the manner shown below:

$$Mean Per Joint Position Error ( MPJPE ) = \frac{1}{M} {\sum }_{j = 1}^{j = M} \sqrt{{\sum }_{i = 1}^{i = D} {( {q}_{i} - {p}_{i} )}^{2}} \qquad ( 10 )$$

where M is the total number of body joints to be tracked by the system (M=9) and D is the dimension of joint coordinates which is D=3 in our case. MPJPE is computed after we align the estimated joint coordinates with ground truth coordinates. The ground truth acquisition method BlazePose GHUM 3D utilized in the teacher network 5002 provides normalized coordinates of upper body joints with the origin at the center of gravity of the human body which is the pelvis joint. We align the estimated upper body coordinates with the origin of ground truth coordinates using the Procrustes method, which is an approach to finding a single orthogonal linear transformation such that the sum-of-square distances between the distribution point sets are minimized. The numerical value of the MPJPE can be described with a geometric intuition. If we consider a sphere with a radius equal to localization error centering at the ground truth point of a particular joint, the prediction is expected to be any 3D point within the volume of this sphere of uncertainty.

As indicated previously, user studies were conducted to verify the effectiveness of the PoseSonic system in detecting the example upper body poses of FIG. 49, across multiple users in different environments. It was found that the system could, without the need of collecting any training data from a new user, effectively estimate the upper body poses including the nine 3D body joint positions for the poses, based on the above-described MPJPE evaluation metric, in a manner that is robust to changes in environment as well as to different types of noise in different real-world settings.

Example applications of the PoseSonic system illustratively include one or more of the following use cases, although the system can be applied in numerous other use cases.

1. Eating and Drinking Detection. Since the system is able to track upper body poses accurately, it is very suitable for tracking users' eating and drinking behavior because these activities usually involve the movements of hands and arms. If the users wear the device all day long, it can analyze their daily eating and drinking habits for a long period of time. Moreover, the system has the potential to track more fine-grained information, such as the type of food and drinks that the users are taking. With this information, the system can provide constructive suggestions for users on their eating and drinking habits. For example, it can remind users if they are not drinking enough water every day or if they should have healthier food.

2. Disease Monitoring. Many neurodegenerative diseases (e.g., Parkinson's Disease), result in irregular body movements. The measurement of this kind of irregular movement is usually done at a clinical institution every several months. However, the patients may also need to monitor the progression of their diseases on a daily basis. In this case, it becomes inconvenient for patients to frequently go to the clinical institution. However, with the disclosed system, patients can easily record and analyze their body movements on a daily basis. This information is very helpful and valuable for doctors to monitor the progression of diseases.

Illustrative embodiments of PoseSonic as described above can be varied in other embodiments. For example, PoseSonic in some embodiments utilizes cross-modal supervision as the learning technique for estimating upper body poses. Therefore, it utilizes a supervisory signal obtained by processing synchronized video to train the end-to-end pose estimation model. However, it may be difficult to acquire video ground truth for “in-the-wild” deployment scenarios. Such scenarios may face a bottleneck in improving PoseSonic with in-the-wild video data. This limitation can be addressed, for example, by utilizing chest-mounted cameras such as GoPro cameras to record the synchronized video, and/or by utilizing high-precision IMUs as an additional or alternative source of cross-modal supervision. Although IMUs might not be able to provide information in as fine-grained a format as video frames, it may help in addressing real-life deployment performance.

As described above, PoseSonic in some embodiments utilizes a smart glasses form factor with wireless transmitter-receiver pairs on both hinges. The sensing technique relies on sound waves reflected from different body parts. In this regard, the reflection varies if the user is having substantial head movement. Since the deep learning pipeline in some embodiments is trained mostly with action units containing static or slight head movement, PoseSonic may not perform as well in the presence of larger head movements. This issue can be addressed in some embodiments by utilizing a data augmentation technique that incorporates head motions into the training dataset and adopting a transfer learning approach to learn those head motions in the reflection patterns obtained through PoseSonic.

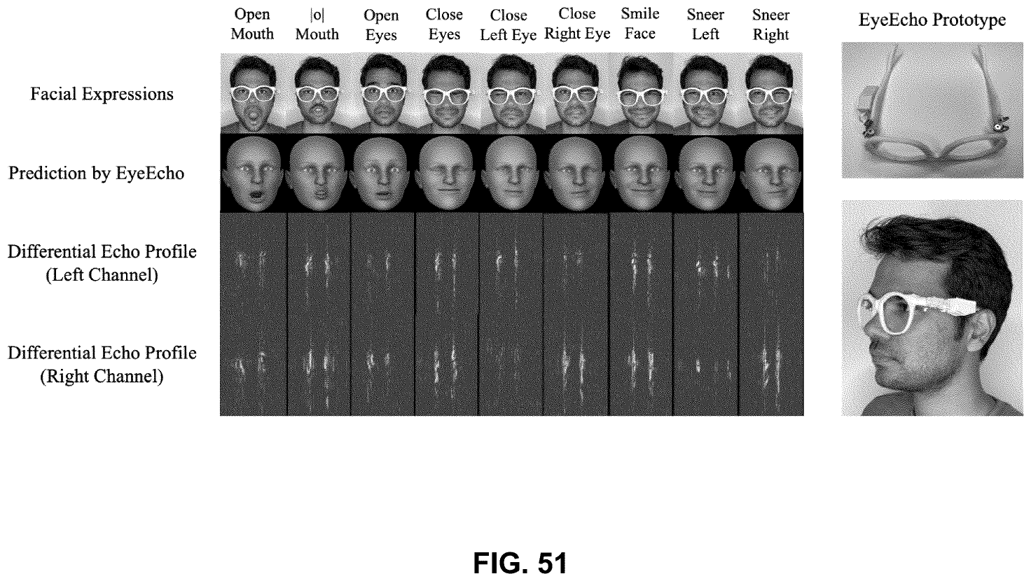

Further illustrative embodiments include an acoustic sensing system referred to herein as EyeEcho, as will now be described in further detail with reference to FIGS. 51 through 53. EyeEcho in illustrative embodiments provides continuous and low-power facial expression tracking on glasses. More particularly, EyeEcho in some embodiments provides a minimally-obtrusive acoustic sensing system designed to enable glasses to continuously monitor facial expressions. It utilizes two pairs of speakers and microphones mounted on glasses, to emit encoded inaudible acoustic signals directed towards the face, capturing subtle skin deformations associated with facial expressions. The reflected signals are processed through a customized machine-learning pipeline to estimate full facial movements. EyeEcho samples at 83.3 Hz with a relatively low power consumption of 167 mW. A user study involving 12 participants demonstrates that, with just four minutes of training data, EyeEcho achieves highly accurate tracking performance across different real-world scenarios, including sitting, walking, and after remounting the devices. Additionally, a semi-in-the-wild study involving 10 participants further validates EyeEcho's performance in naturalistic scenarios while participants engage in various daily activities. In some embodiments, EyeEcho can be deployed on a commercial-off-the-shelf (COTS) smartphone, offering real-time facial expression tracking.

Facial expressions play an important role in various interaction applications including video calls, facial gesture input and non-verbal communications (e.g., sign language), and are indispensable in virtual environments. Continuous and accurate facial expression tracking is critical for an immersive and convenient interaction experience for users. Deploying such technologies on eyewear such as smart glasses (e.g., Lenovo ThinkReality A3 and Bose Frames Tempo) and augmented reality (AR) glasses (e.g., Google Glass and Xreal Air 2 Ultra) is highly desirable as these devices are widely available and serve as direct media in these interaction applications.

However, developing continuous facial expression tracking technologies on glasses presents unique challenges due to the constraints of the sensor size and battery capacity. First, capturing both upper and lower facial movements is crucial, but glasses primarily cover the upper face, making lower face tracking challenging. Maintaining high temporal and spatial resolutions of continuous facial expression tracking is also difficult. Second, smart glasses often come with limited battery capacity due to the weight restriction. Power-hungry sensors like RGB cameras drain batteries on smart glasses quickly, e.g., in less than one hour. Third, the need for reliable performance after glasses are remounted (taken off and taken back on) poses challenges, especially for on-skin sensors (e.g., EMG sensors). As a result, a need exists for techniques for continuous facial expression tracking on glasses and other wearables.

In some embodiments, EyeEcho as disclosed herein provides an acoustic sensing system on glasses that can track facial expressions continuously. The system is light-weight, low-power, and can work well in real-world settings. EyeEcho in illustrative embodiments continuously tracks high-resolution facial expressions on glasses by analyzing the skin deformations around the cheeks captured using only two pairs of on-device speaker and microphone with inaudible acoustic FMCW signals. A customized convolutional neural network is provided to estimate facial expressions represented by 52 blend-shape parameters calculated using Apple's ARKit API from the processed acoustic signals in the form of echo profiles. A user study with 12 participants showed that EyeEcho can accurately estimate facial expressions continuously on glasses using only four minutes of training data from each participant. It is also able to detect eye blinks with an F1 score of 82%.

In order to gain a deeper understanding of the EyeEcho's performance in real-world scenarios, we conducted a semi-in-the-wild study involving 10 participants to evaluate the performance of the facial expression tracking system on glasses in a naturalistic setting. This study took place in three distinct rooms of an apartment: the living room, bedroom, and kitchen. The study aimed to assess the system's ability to track facial expressions continuously while participants engaged in various common daily activities. Importantly, the study encompassed real-world ambient noises, such as the sound of videos, noise from the microwave oven, and the hum of the refrigerator, among others. In total, around 700 minutes of
data were collected in this study. The results demonstrate that the EyeEcho system showed reliable performance in tracking facial expressions throughout the participants' engagement in diverse activities across different rooms and days.

In addition to the promising tracking performance, EyeEcho is also relatively low-power and light-weight compared to other systems. The full sensing system including sensors, Bluetooth module and microprocessors can operate at a sample rate of 83.3 Hz with a power signature of 167 mW. Theoretically, it can last for around 14 hours using the battery of Google Glass (570 mAh), if EyeEcho is used alone. With the usage of more power-efficient speakers, the power consumption of the system can be optimized to as low as 71 mW. The machine learning algorithm is optimized to be lightweight based on the ResNet-18 architecture, so that it can be deployed on a commodity smartphone for real-time processing. EyeEcho is also able to track users' facial expressions continuously at 29 Hz in real-time on a commodity Android phone. EyeEcho therefore provides a low-power and minimally-obtrusive sensing solution that can be deployed on commodity smartphones for real-time tracking. It excels in tracking capability, unobtrusiveness, power consumption and performance. Moreover, EyeEcho provides information on how the face appears during the process of making a facial expression. For example, EyeEcho can detect detailed facial movements on both lower and upper face including eyes, eyebrows, cheeks, and mouth. Such information can be utilized for a wide variety of downstream applications such as adding facial expressions to render a personalized avatar or enabling video conferencing on smart glasses without the need to hold a camera in front of the face.

FIG. 51 illustrates the operation of EyeEcho in some embodiments. The facial expressions that are detectable illustratively include open mouth, round mouth, open eyes, close eyes, close left eye, close right eye, smile face, sneer left and sneer right. Additional or alternative facial expressions can be detected in other embodiments. The figure shows the corresponding predictions generated by EyeEcho for each of the detected facial expressions, and the corresponding differential echo profiles for left channel and right channel generated from the acoustic signals. This figure also shows an example EyeEcho prototype, and the prototype being worn by a user.

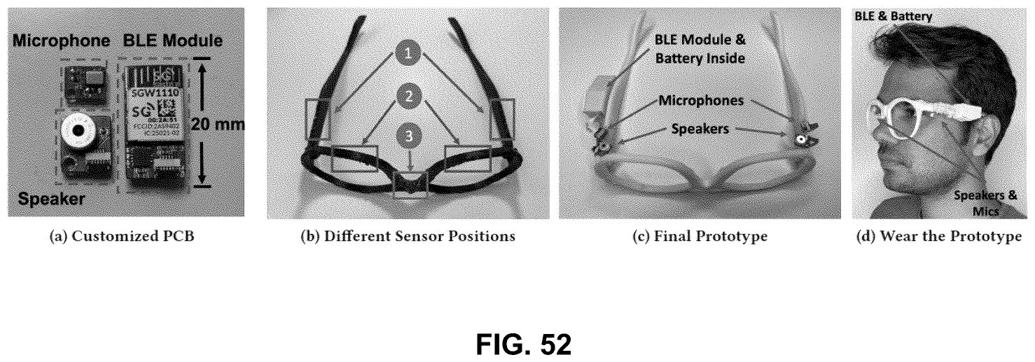

FIG. 52 shows a more detailed view of various aspects of the EyeEcho prototype. Part (a) of the figure shows the customized PCBs for the speaker, microphone and Bluetooth Low Energy (BLE) module. Part (b) of the figure shows the example glass frame and possible sensor positions that were considered. Parts (c) and (d) of the figure illustrate the final prototype with speaker-microphone pairs mounted on the respective legs of the glasses near respective corresponding hinges of the glasses, and the BLE module and battery mounted in a housing on one leg of the glasses as shown.

In these embodiments, the core acoustic sensing hardware of the Eye Echo acoustic-based tracking system more particularly comprises two MEMS microphones (e.g., ICS-43434), two speakers (e.g., SR6438NWS-000) and BLE module on customized PCBs, as shown in part (a) of FIG. 52. A Nordic nRF52840 BLE 5.0 system-on-chip (SOC) in the BLE module drives the speakers, microphones and data transmissions. The speakers and microphones are both connected to the I2S interface of nRF52840 via FPC cables. We set the sample depth of the data as 8 bits, which requires a bit rate of about 800 kbps to transmit two channels of received data to a smartphone (e.g., Xiaomi Redmi) via BLE in real-time without significant packet loss, as supported by BLE 5.0. This example setup of the core acoustic sensing hardware of EyeEcho allows the transmission of two channels of acoustic data reliably via BLE without compromising the performance.

In exploring different sensor positions on the glasses, as illustrated in part (b) of FIG. 52, we fabricated a pair of glasses using 3D printing and incorporated multiple holes at various positions. These openings allowed us to securely attach the speakers and microphones using screws. Given the limited space available on glasses, we identified three primary positions suitable for sensor placement to capture skin deformations without interfering with users' daily activities: 1) on the legs of the glasses; 2) at the bottom of the frame; 3) under the bridge of the frame, as depicted in part (b) of FIG. 52.

Position 1 involves placing one pair of speakers and microphones on each leg of the glasses, directed downward toward the user's face. This setup enables the capture of skin deformations on both the left and right sides of the cheeks, facilitating the detection of respective facial movements on each side. The second option, Position 2, relocates the two pairs of speakers and microphones to the bottom of the glasses frame, also pointing downward and closer to the user's cheeks. In addition to these two setups, the last option involves positioning only one speaker under the bridge of the glasses frame (Position 3), while keeping the microphones at Position 2. This configuration consumes less energy as it requires only one speaker.

We conducted a preliminary cross-session experiment involving two researchers to assess the tracking performance of the three positions using the algorithms detailed in the subsequent sections. Across the three setups, we obtained average Mean Absolute Error (MAE) of 18.0, 18.0, and 22.8, respectively, for 52 blendshape parameters when comparing the ground truth with our predictions. Based on these experimental results, the first two setups outperformed the last option in terms of tracking performance. Notably, Position 2 was found to be more obtrusive than Position 1, as the sensing unit on the glasses frame had a higher likelihood of obstructing the user's face and impacting their daily activities. It is also worth noting that many commodity smart glasses integrate sensors on their legs. Therefore, placing the sensors on the legs aligns with the potential future adoption of the disclosed sensing technology on smart glasses. Consequently, we chose Position 1 for the final prototype, which involves attaching a pair of speakers and microphones to each leg of the glasses.

After finalizing the positions of the speakers and microphones, we designed and 3D printed a single case with a sliding cover to house the BLE module and the battery. The case is mounted on the left leg of the glasses and specifically designed to match the shape of the leg. We cut a narrow slot on one side of the case in order to let the FPC cables go through and be connected with the speakers and microphones. While connecting the speakers and microphones to the BLE module, the FPC cables are routed along the glass frame, so that the cables will not block the user's view and will be less obtrusive. The final complete prototype is shown in part (c) of FIG. 52. It is minimally obtrusive and very close to a normal glass frame in appearance, as is apparent from part (d) of FIG. 52.

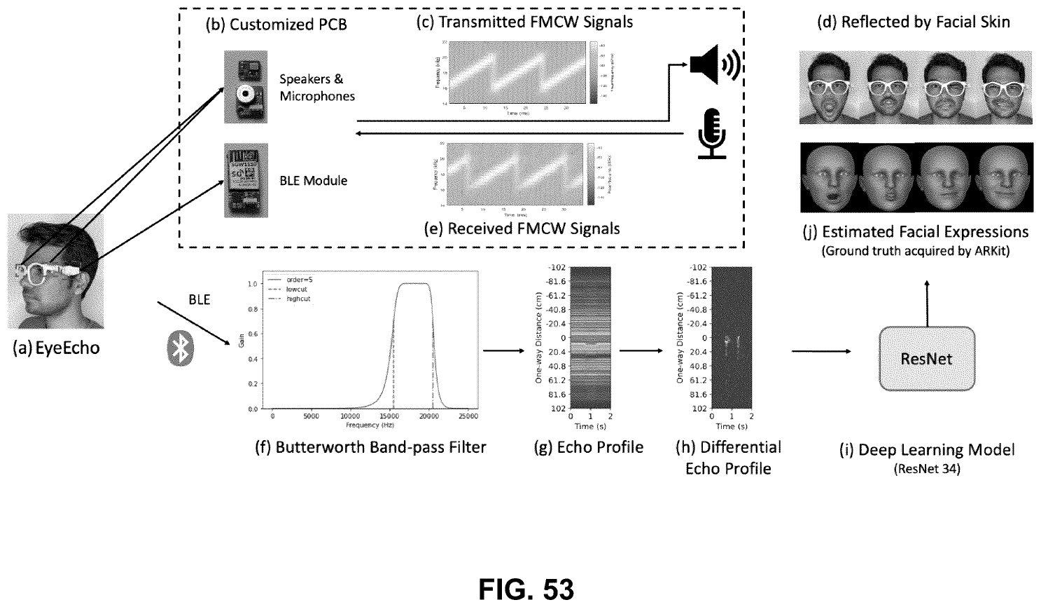

FIG. 53 illustrates the operation of the EyeEcho system in some embodiments. The system utilizes FMCW signal transmission for acoustic sensing. We set the frequency range of transmitted FMCW signals in the system to 16-20 kHz, which is nearly inaudible to most adults and can be reliably achieved by most commodity speakers and microphones. In order to emit the transmitted signals in this ultrasonic frequency range, we set the sampling rate at 50 kHz, which can support the frequency range up to 25 kHz in theory. In addition, the FMCW sample length is set as 600, which is 0.012 seconds long (600 samples/50 kHz). In this setting, the system is capable of estimating facial expressions 83.3 times per second, which is enough to provide a similar sample rate as video recordings (30 or 60 FPS). This FMCW signal is pre-generated as shown in part (c) of FIG. 53, and stored in the BLE module to drive the speakers. The transmitted signals are reflected by facial skin as shown in part (d) of the figure.

Once acoustic signals are reflected by the face and received by the microphone as illustrated in part (e) of FIG. 53, additional signal processing is performed. We first apply a 5-order Butterworth bandpass filter with low and high cut-off frequencies as 15.5 kHz and 20.5 kHz to filter out noise that is outside the frequency range of interest, as shown in part (f) of the figure. We then obtain the echo profile of the received signals by calculating the cross-correlation between the received signals and the corresponding transmitted signals, as illustrated in part (g) of the figure. The resulting echo profiles can display the deformations of the skin in both temporal and spatial domains. With the echo profiles calculated, EyeEcho provides a spatial tracking resolution of 6.8 mm(340 m/s/50 kHz) and a maximum tracking distance of 4.08 m (6.8 mm×600 samples). Because the speaker and microphone are placed very close to each other, the signals travel in round trips from the speaker to the face and back to the microphone. Thus, the real tracking resolution in space and the maximum one-way tracking distance are 3.4 mm and 2.04 m, respectively. This means that each “echo bin” in the echo profile reports the total signal strength the system receives at a specific distance from the system and two consecutive echo bins are 3.4 mm apart from each other.

As the skin deforms by small amount, the manner in which the signal strength is distributed in different echo bins also changes. Observing such changes in the echo profile allows the EyeEcho system to detect particular facial expressions. In order to remove the static objects in the background and alleviate the impacts of remounting the device, we further calculate, for each echo profile, a corresponding differential echo profile by subtracting the echo profile between two adjacent echo frames, as illustrated in part (h) of the figure. It should be noted that signals at the negative distance in the echo profile are the reflected signals of the last echo frame from a very long distance and are usually useless in tracking facial expressions. The system processes the differential echo profiles in a machine learning system (e.g., a machine learning system comprising a ResNet-18 neural network) as shown in part (i) of the figure to generate estimated facial expressions in part (j) of the figure. The estimated facial expressions detected in part ( ), which are based on training using ground truth acquired by ARKit, correspond to respective ones of the facial expressions of the user in part (d) of the figure.

In some embodiments, when the user performs one facial expression that only relates to one half of the face, a clear pattern can be observed in the differential echo profile in the corresponding channel. The other channel also contains weaker information because people's facial skin and muscles are interconnected. Moreover, the major parts of the patterns are generally within 0-10 cm because the user's face is located within this approximate distance from the EyeEcho system. Because the transmitted signal is finite in the frequency domain, it diffuses into further echo bins in the time domain when the cross-correlation is calculated. Also considering the multi-path reflection, some patterns can be observed at the negative distance and the distance beyond about 10 cm. However, the echo bins between about 0-10 cm tend to contain the most useful information for tracking of facial expressions. When the user blinks, patterns can be observed in the differential echo profiles of both channels. Compared with the patterns caused by sneering left or right, the patterns related to blinking are weaker and shorter because of the nature of people's blinks. All these features support our hypothesis that the skin and muscle deformations around eyes and cheeks are informative for both upper-face and lower-face movements and can be captured by acoustic sensors in the EyeEcho system to track users' full facial expressions.

In some embodiments, since the distance between the glasses and the face is usually under 10 cm, we remove any echoes that are beyond 10.2 cm (3.4 mm×30 echo bins) in the differential echo profile. This helps to minimize the impact of the acoustic echoes from environmental objects which are usually placed at a much further distance. This differential echo profile with a length of one second is sent to a customized machine learning algorithm to estimate the full facial expressions, as will now be described in more detail.

In order to infer full facial expressions continuously from the skin deformations represented by differential echo profiles, we implement a customized deep learning pipeline. The deep learning model requires reliable ground truth of the facial expressions to train the model. We use a TrueDepth camera on an iPhone powered by Apple's ARKit API to record the ground truth of facial expressions at 30 FPS, represented by 52 blendshape parameters. Each parameter is in charge of the shape and position of one part of the face (e.g., jawOpen). The original range of each blendshape parameter is from 0 to 1. We multiply the value of each blendshape parameter by 1000 to better train the model. After this operation, the maximum possible value of each parameter is 1000. This method can provide reliably track 3D facial movements on the cheeks, the eyes, the eyebrows, the nose, the mouth, and the tongue. We chose to use this blendshape-based ground truth instead of 2D landmarks because it can provide more visual expressiveness by showing the movements of different parts of the face in 3D.

We apply a sliding window of one second on the received acoustic data, which leads to 84 frames in differential echo profiles of each window. Each differential echo profile has 60 data points including 30 data points representing the echo distance of 10.2 cm for each microphone. In total, the dimension of the input vector for the deep learning model is 60×84. To make predictions for the current frame, we utilize the current frame plus the 83 frames prior to the current frame as input data so that there is minimum delay for the real-time prediction. Technically, the maximum possible delay caused by the sliding window is the length of one frame which is 12 ms. As we apply the sliding window technique, for each prediction, we store and reuse the last 83 echo frames from last prediction and just calculate the current echo frame so that the calculation is fast enough for real-time prediction at the expected refresh rate.

In order to estimate the full facial expressions from the computed differential echo profiles, some embodiments utilize an end-to-end CNN model. For example, we utilize a CNN model in the EyeEcho system rather than other models such as RNNs because after processing the raw audio data and obtaining the differential echo profile, the time series data is converted to images containing information in both spatial and temporal domains. Adopting a CNN achieves better performance in this kind of machine learning task. Thus, a 34-layer ResNet neural network, also referred to as ResNet-34, is used as the backbone network to learn the features from the input data vectors and a fully-connected decoder is utilized to estimate the facial expressions including the 52 parameters of the blendshapes. The MAE between the prediction and the ground truth was used as the evaluation metric to train the model.

Various parameters of the above-described EyeEcho system can be adjusted in other embodiments. For example, EyeEcho as described above uses an acoustic signal frequency range of 16-20 kHz, with the goal of easy adoption on most commodity speakers and microphones since the acoustic sensors in most commodity devices can sample up to 48 kHz. However, EyeEcho can readily adapt to utilization of higher inaudible frequencies with minimal impact on tracking performance. An embodiment using a higher operating frequency range of 20-24 kHz was found to exhibit similar tracking performance.

As another example, the EyeEcho system can be adapted for real-time deployment on smartphones. To demonstrate how EyeEcho can be integrated with commercial devices, we deployed the data processing and deep learning pipeline of EyeEcho with the help of PyTorch Mobile on an Android smartphone (Xiaomi Redmi K40, Android 12, Qualcomm Snapdragon 870 SoC). Keeping the algorithms deployed on the smartphone eliminates the need to transmit the data to a server on the cloud, which can better preserve the privacy of the user. In order to keep the algorithm making predictions fast enough in real-time, we replaced the deep learning model with a ResNet-18 architecture. To demonstrate that this lighter model results in a similar performance, we trained the lighter model (ResNet-18) in a manner similar to that previously described, and achieved performance comparable to that of the full model. For the usage of the real-time pipeline, we first trained the deep learning model with the data collected from users in PyTorch on a NVIDIA GeForce RTX 2080 Ti GPU. Then we traced the trained model to make it applicable to deployment on smartphones. The traced model was loaded onto the Android phone (Xiaomi Redmi K40) and used in the Android application we developed for data collection and facial expression prediction. During the inference stage, the running application continuously received data streamed from the BLE module in the EyeEcho system via Bluetooth, preprocessed the received data (e.g., organizing data based on channels, filtering the raw data, and calculating the echo frames), and fed echo profiles into the traced deep learning model for predictions. The predicted blendshape parameters representing users' facial expressions were finally streamed from the smartphone to a laptop via Wi-Fi for downstream applications. On average, it took 34 ms to make one inference, which led to a refresh rate of 29 FPS. We believe that this is sufficient for most applications since most videos can be played at 30 FPS. With the system implemented on the smartphone, we were able to predict users' facial expressions in real-time and rendered them with a personalized avatar powered by Avaturn.

It is therefore apparent that enabling facial expression tracking on glasses has a wide range of applications, from enhancing video conferencing experience to novel input methods. Video conferencing, a common mode of communication, can be significantly improved using the EyeEcho system. Currently, during online video conferences, participants must position themselves in front of a camera or hold it to ensure others can see their facial expressions. However, with EyeEcho integrated into smart glasses, users can engage in real-time video conferences and convey facial expressions effortlessly, even while walking or multitasking. We have implemented a system capable of generating personalized avatars with facial expressions for each user, as mentioned above. Consequently, the user experience in video conferencing with EyeEcho resembles traditional camera-based methods, but with the added convenience of hands-free operation.

Facial expressions can also serve as a novel input method. The EyeEcho system is well-suited for implementing this functionality, allowing different facial expressions to serve as distinct commands for interacting with smart or augmented reality glasses.

Moreover, facial expressions are linked to various health conditions. For instance, individuals with Parkinson's disease may experience a loss of facial expressions. EyeEcho can be instrumental in tracking and monitoring the symptoms of such diseases, potentially contributing to improved healthcare outcomes.

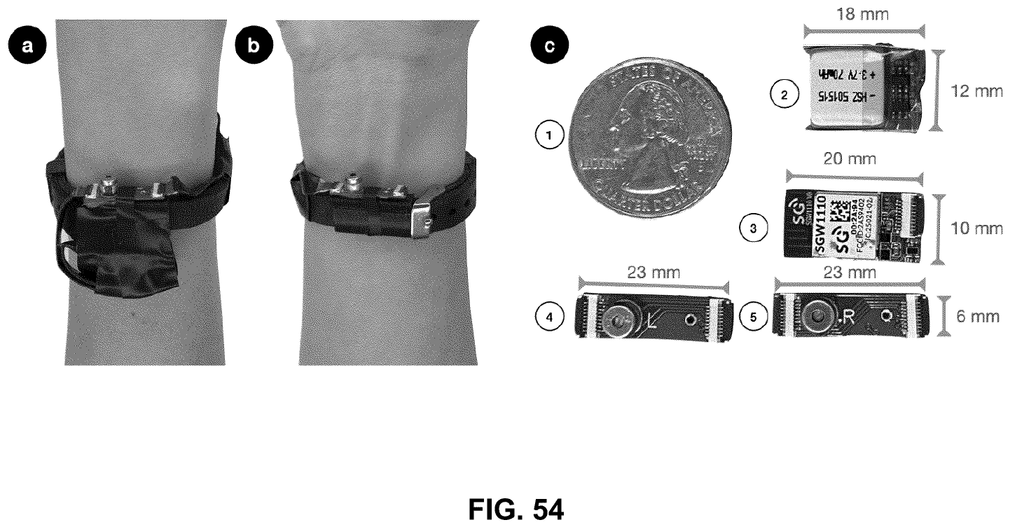

Further illustrative embodiments include an acoustic sensing system referred to herein as EchoWrist, as will now be described in further detail with reference to FIGS. 54 through 57. EchoWrist in some embodiments provides continuous hand pose tracking and hand-object interaction recognition using low-power active acoustic sensing on a wristband.

FIG. 54 in part (a) and (b) thereof shows an example implementation of an EchoWrist wearable device on a user. EchoWrist in some embodiments utilizes a wristband form factor and can understand 3D hand poses as well as hand-object interactions. EchoWrist has a minimally-obtrusive design that keeps the wearable device compact and low-profile, and is configured to continuously track hand poses and recognize various hand-object interactions at low power using acoustic sensing. EchoWrist is equipped with two speakers emitting inaudible sound waves toward the hand. These sound waves interact with the hand and its surroundings through reflections and diffractions, carrying rich information about the hand's shape and the objects it interacts with. The information captured by the two microphones goes through a deep learning inference system that recovers hand poses and identifies various everyday hand activities. Results from two 12-participant user studies show that EchoWrist is effective and efficient at tracking 3D hand poses and recognizing hand-object interactions. Operating at 57.9 mW, EchoWrist is able to continuously reconstruct 20 3D hand joints with a mean joint Euclidean distance error (MJEDE) of 4.81 mm and recognize 12 naturalistic hand-object interactions with 97.6% accuracy.

Building systems to track hand activities has been a long-standing challenge for the research community. This includes continuously capturing the 3D poses of hands and understanding the context of their interactions, e.g., what they are interacting with. The challenge arises due to 1) the highly flexible nature of hands and their numerous joints, 2) the potential occlusion of the fingers, and 3) the interaction with other objects that can change the shape of hands and obscure them from view. Consequently, understanding hand-object interaction poses a significant challenge since the system must possess knowledge of both the hand and the object. As a result, traditional hand-tracking solutions rely on external cameras to “see” the entire hand. However, these methods are often intrusive, power-hungry, or require pre-setup, making them inconvenient for deployment in everyday life. In summary, existing solutions exhibit at least one of the following limitations: 1) Discomfort from obtrusive form factor, 2) high power consumption, 3) lack of continuous tracking capabilities, 4) insufficient consideration of hand-object interactions, and 5) privacy concerns.

EchoWrist overcomes these challenges, by providing a minimally obtrusive, low-power wristband designed to provide both continuous 3D hand shape tracking and a nuanced understanding of various hand-object interaction activities. EchoWrist utilizes active acoustic sensing, incorporating two pairs of compact speakers and microphones positioned in close proximity to the skin on each side of the wrist. The speakers emit inaudible FMCW acoustic signals directed toward the hand, and the resulting sound wave reflections and diffractions are captured by the wristband's microphones, creating distinct patterns corresponding to different hand poses. The EchoWrist system further comprises a customized deep CNN to continuously deduce the 3D hand poses represented by the 3D positions of 20 finger joints while also classifying various hand-object interactions.

To evaluate EchoWrist's performance in continuous hand pose tracking and hand-object interaction recognition, we conducted two user studies, each involving 12 participants. The results indicate that EchoWrist can continuously track 20 finger joints with an MJEDE of 4.81 mm and an MJAE of 3.79°. Furthermore, EchoWrist exhibits impressive accuracy, achieving a recognition rate of 97.6% across 12 diverse hand-object interactions, spanning static scenarios, such as firmly holding a cup, to dynamic actions involving movement, such as chopping. In addition, EchoWrist operates at a significantly low power consumption of just 57.9 mW, with the sensing modules consuming only 10.0 mW, enabling full-day usage on standard smartwatches (e.g., 19 hours with 300 mAh battery on an Apple Watch), all with a wearable form factor that is smaller in size and less obtrusive than other devices.

EchoWrist employs active acoustic sensing as its primary sensing method. In this approach, we use speakers to emit inaudible sound waves and microphones to receive the reflections of these emitted waves. These sound waves propagate from the wrist toward the palm, fingers, and the surrounding environment. The skin and surfaces of nearby objects act as the reflection medium for these sound waves. The waves undergo reflection and diffraction, eventually reaching the microphones. Distinct hand shapes and the varying characteristics of the surrounding environment lead to different signal paths, resulting in complex multipath echo patterns, which could be distinguished with customized echo profile analysis and deep learning pipelines.

To facilitate this process, EchoWrist in some embodiments features two pairs of speakers and microphones strategically positioned on the top and bottom sides of the wrist, respectively. The inclusion of these two pairs of sensors allows for the comprehensive capture of echoes from both sides of the wrist, thereby providing a wealth of information about hand gestures and interactions.

In order to determine the optimal design for EchoWrist in efficiently tracking 3D hand poses and recognizing hand-object interactions, a series of pilot studies were conducted. We aimed to explore the limits of the sensing principle and identify the optimal setup that balances device obtrusiveness, power consumption, and performance. Overall, two design considerations were utilized:

1. The wearable device should be minimally obtrusive. Given that wearable devices are typically worn throughout the day and come into prolonged contact with the user, ensuring comfort is a prioritized consideration in the design. Additionally, as our aim is to introduce a wristband, it is important to prevent the device from interfering with daily hand-related activities. It is also vital to consider the social acceptability of the wearable device and how it can be blended with current wearables. In summary, to optimize comfort and enhance the potential for integration with commercial smartwatches and wristbands, maintaining a minimally-obtrusive design that sits close to the skin is important. This includes using small and non-skin-contacting sensors and keeping the system small and low-profile.

2. The wearable device should be low power. Wearable devices are generally worn for extended periods. Moreover, in the case of continuous tracking, they need to remain operational throughout. Therefore, it is important to consider power consumption during design.

A design goal in some embodiments was to find the balance between these design considerations and the sensing performance. To achieve the goal, the sensor type, number, and layout were examined in various studies.

We first experimented with different speaker types and positions. An experimental prototype based on a Teensy 4.1 microcontroller with 3D printed sensor mounts was built to explore sensor configurations. The prototype allowed us to manipulate the sensor layout easily. We connected 2 speakers and 8 microphones to the prototype. We started with ultrasonic transducers as the signal emitter for their excellent ultrasonic acoustic characteristics. We first tried to identify the optimal position for the speaker. We performed a grid search on the speaker position while doing single-finger movements (bending one of the five fingers at a time). One of the researchers collected the data and trained the model, and the reconstruction error was calculated, using techniques disclosed herein. Results indicated that speaker positions under the palm yield the best performance. To maximize the information we can get with an additional speaker, we placed a second speaker in its opposite position above the back of the hand to obtain more diverse information from both sides of the hand. In these experiments, we also realized that these transducers have strong directionality, which means that the emitted sounds are mostly directed to the fingers directly facing the transducer. These fingers had excellent performance, while other fingers did not work well. This inspired us to choose omnidirectional speakers so that sound waves can travel in all directions, allowing us to place speakers in less-obtrusive positions while still covering most fingers. We ended up using a commodity speaker, which comes in a smaller size as well.

Next, we experimented with different sensor heights. We conducted a quantitative study on the sensor height. We chose three heights, placing the sensors 13 mm, 9 mm, and 5 mm from the skin (measured from the skin surface to the outermost point on the sensor). With the last configuration, the lower edge of the speaker was almost touching the skin (the diameter of the speaker is 5 mm). Two researchers conducted the experiments, doing a series of pre-defined single-finger movements and complex finger gestures, respectively. The average performance of the three speaker heights was very close. Since no strong decrease in performance was observed, we chose 5 mm sensor heights for the illustrative embodiments utilized in the user study. This allows EchoWrist to adopt a low-profile form factor that can be easily integrated into commercial smartwatches or wristbands.

We then experimented with the number of sensors. We separated the emitted signals from the two speakers with different frequency ranges (18-21 kHz and 21.5-24.5 kHz). In this way, we could easily separate paths coming from the two speakers on each microphone. The MJEDE was calculated using data collected from a single pair of a speaker and microphone. An example layout of 2 speakers and 8 microphones was explored, where speaker S1 was placed on the back of the hand, and speaker S2 was under the palm. Two researchers experimented with using different channels and their combinations. When only using one of the 16 channels, results indicate that microphones close to the speakers yield slightly better results, but other positions also work well. We attribute this to the use of omnidirectional speakers combined with the use of echo profiles to maximally preserve information. Specifically, having the back speakers improves performance when the hand was bent outwards. We placed speakers at both the back and the palm sides of the hand to maintain reliable performance when the wrist is at different angles. To maximize the benefit of using 2 speakers, we decided to use 2 microphones that are close to the 2 speakers. Compared with having more sensors, the combination of 2 speakers and 2 microphones can be easily achieved as digital audio interfaces such as the above-noted 12S interfaces usually come with stereo audio.

We also determined that the cross-path signals (signal traveling from the palm speaker to the back mic, and vice versa) were negligible compared with direct-path signals. Another experiment on using the same frequency on the two speakers versus using different frequencies confirmed that no significant performance drop could be observed. Allowing the two speakers to send the same signal can save half of the bandwidth, which can save hardware cost and size by using mono-channel audio amplifiers instead of stereo ones. Therefore, we decided to emit the same signal on the two speakers in our system.

As shown in FIG. 54, the form factor for EchoWrist in an illustrative embodiment comprises a silicone wristband on which all acoustic sensing components are mounted. Parts (a) and (b) of the figure show the EchoWrist device from the top and bottom side of the wrist of a user. Part (c) of the figure shows customized PCBs for the microcontroller module and the sensing module, with sizes illustrated relative to a coin shown at (1). The hardware components in this embodiment more particularly include a 3.7V 70 mAh LiPo battery, shown at (2), a customized PCB with an SGW1110 microcontroller module at (3), and left and right side sensor modules, each including a speaker and microphone, shown at (4) and (5), respectively.

In this embodiment, EchoWrist uses two pairs of speakers (OWR-05049T-38D) and microphones (ICS-43434) mounted on a low-profile silicone band as shown in FIG. 54, with customized PCBs for the sensing modules. The two sensing modules are connected via an FPC cable and then connected to the customized microcontroller module. The microcontroller board includes an SGW1110 module (with an nRF52840 microcontroller), two MAX98357A audio amplifiers (in the user study, only one was used), plus a power management module with a TPS62743 buck regulator. These components are powered by a LiPo battery. The sensing module and the microcontroller module are both attached to 3D-printed cases that can slide along the silicone band to fit different hand sizes. The cases were printed with thermoplastic polyurethane (TPU) so that they were soft and comfortable. The weight of the sensing module and the microcontroller module is 0.7 g and 1.2 g, respectively. The weight of the entire wearable device, including the battery, is 16.8 g. While collecting data, the microcontroller drives the speakers to emit sounds and collects echoes from the microphones. The collected data are illustratively saved on a microSD card with an extended socket. To support real-time data collection, the collected data can also be transmitted to a smartphone (e.g., Xiaomi Redmi Note 10 Pro) via BLE operating at 800 kbps. The captured data are truncated to 8 bits to save bandwidth in this case. No performance degradation was observed between using a full 16 bits and the truncated 8 bits.

Designed for compact wearable devices such as smartwatches and wristbands, EchoWrist provides a low-power solution. We examined the power signature of EchoWrist using a CurrentRanger. Results show that when the system is on with BLE transmitting data at 800 kbps, the power consumption is 57.9 mW(3.86 V, 15.0 mA).

At 57.9 mW operation power, EchoWrist can easily last a full day with a common battery size of smartwatches (e.g., Apple Watch Series 8 has around 300 mAh battery size, which should last 19 hours). In embodiments in which EchoWrist is integrated into the existing hardware of the smartwatch/wristband, the microcontroller's base power consumption could be saved since the sensors only operate at 10 mW, leading to an even longer battery life. Note that this calculation did not consider the power consumption of the operating system on a smartwatch.

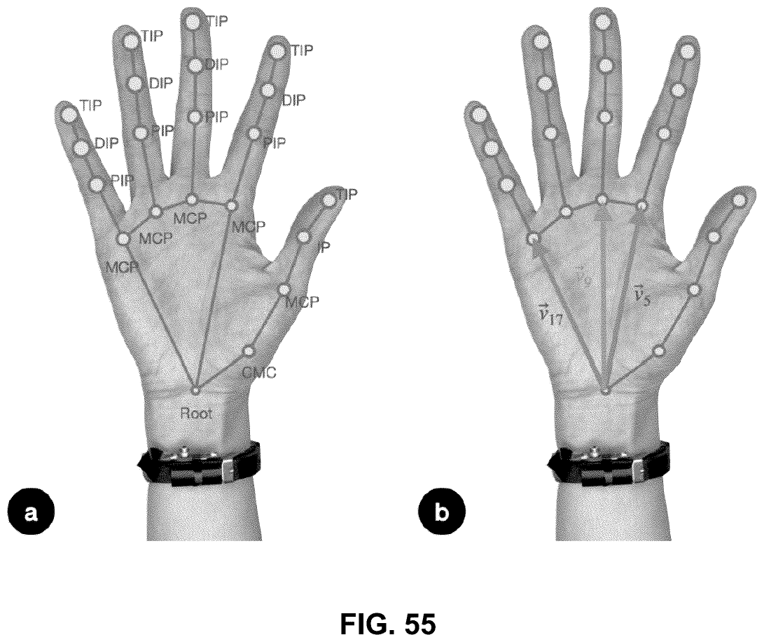

FIG. 55 shows the 3D hand pose ground truth annotation for hand pose tracking in some embodiments. Part (a) of the figure illustrates the acquisition of the ground truth of 3D hand shape utilizing 21 joints detected utilizing a MediaPipe Hands setup, and part (b) of the figure shows example vectors used during ground truth normalization. These vectors include \vec{v₉} which is the wrist-to-palm vector used to represent the orientation of the hand. The plan defined by vectors \vec{v₅} and \vec{v₁₇} is used to align the detected hand with the reference hand. The actual length of vector v₁₇ is measured in the image against the size of the sensing module to make the hand size in each frame uniform.

In illustrative embodiments, the shape of the hand is represented by 21 joints, including the wrist as shown part (a) of FIG. 55. Each joint is represented by 3D coordinates. While recovering the hand shape, we predict the coordinates of the 20 joints, excluding the wrist, which is set as the origin. While recovering the wrist rotation, we predict the wrist-to-palm vector v₉ as illustrated in part (b) of FIG. 55.

For the data collection of 3D hand pose tracking, we asked users to remount the EchoWrist device between sessions and allowed them to relax and move around. This causes variances in the relative position and orientation between the hand and the camera of the MediaPipe Hands setup. In addition, MediaPipe Hands may not capture the size of the hands reliably due to a lack of objects to compare. To address these issues, we developed an algorithm to normalize the ground truth. For each frame, we first used MediaPipe Hands to extract the positions of all hand joints. We then calculated the surface of the palm represented by vectors (\vec{v₅}, \vec{v₁₇}), where \vec{v₅} is the vector pointing from the wrist to the metacarpophalangeal joint of the index finger (joint 5 in part (b) of FIG. 55) and i is the vector pointing from the wrist to the metacarpophalangeal joint of the little finger (joint 17 in part (b) of FIG. 55). We calculated the rotation matrix that rotates this plane to the reference plane \vec{\hat{v}₅}, \vec{v₁₇} extracted from the reference posture. We chose this plane because it remains largely static even when the user is performing complex gestures. For each participant, we also measured the length of \vec{v₁₇} as against the size of the sensing module. We normalize each frame so that the length of \vec{v₁₇} is equal to the measured value, as illustrated in part (b) of FIG. 55. While recovering the wrist rotation, ground truth normalization was not applied so that the wrist rotations were faithfully recorded.

EchoWrist in illustrative embodiments utilizes FMCW-based echo profile analysis as the sensing method. With a sampling rate of 50 kHz and a frequency range of 20 k-24 kHz, chosen to be inaudible for humans, the signals of one frequency sweep are denoted as one FMCW frame. To eliminate other frequencies, we applied a 20-24 kHz bandpass filter to the received signals. Subsequently, cross-correlation between transmitted and received signals was performed to obtain echo profiles, which are formed by temporally stacking echo frames and represent the reflection strength of signals traveling from paths with certain distances. Using the current echo profile to subtract the previous one produces differential echo profiles, which eliminate static reflections and focus on moving objects.

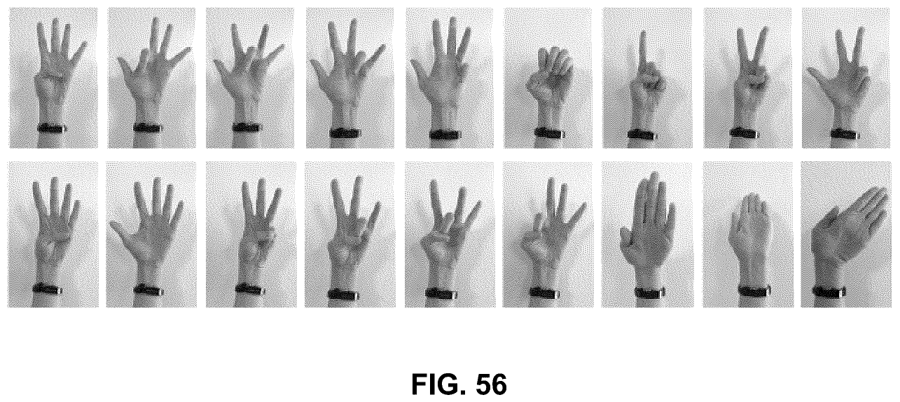

FIG. 56 shows various hand gestures that are recognized by the EchoWrist system using their corresponding echo profiles. Both original and differential echo profiles were employed to capture both movements and the static status of the hand and surroundings. The echo profiles were cropped to concentrate on distances of interest. For hand tracking, we used 72 pixels (24.6 cm) to focus on the hand, and for hand-object interaction, we used 88 pixels (30.2 cm) to encompass the hand's surroundings.

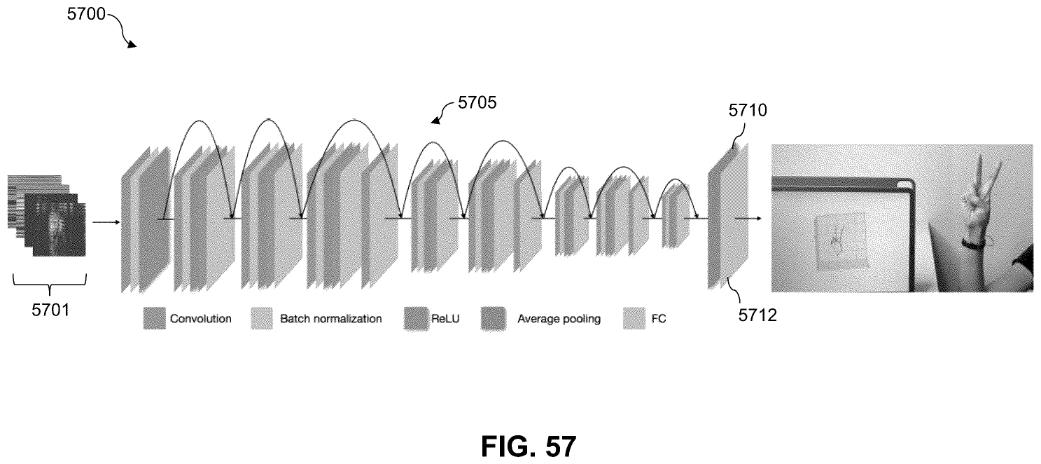

FIG. 57 shows an example machine learning system 5700 implemented in the EchoWrist system. The machine learning system 5700 may be viewed as an example of machine learning system 4210 of FIG. 42. Other types of machine learning systems can be used in other embodiments.

After obtaining the echo profiles, the information related to the hand postures is represented by a 2D image-like array. The machine learning system 5700 uses a customized deep CNN model to infer the 3D hand shapes or hand-object interactions from input echo profiles 5701. We stacked the original and differential echo profiles in channels to form the input echo profiles 5701. For hand pose tracking, we employed a shorter window length of 72(0.864 s) to predict the hand shape at the last moment of the window. For hand-object interaction, we incorporated a greater temporal context by employing a longer window length of 1050 (12.6s) since the activities are more intricate. In a pilot study, we observed significant variability in the time taken to complete each hand-object interaction. To accommodate this variability and prevent information loss, a larger window was utilized. This resulted in input sizes of 72×72×4 and 1050×88×4, respectively.

The model architecture of machine learning system 5700 incorporates a ResNet-18 backbone 5705, followed by an average pooling layer 5710, a dropout layer (not explicitly shown, but with a dropout rate of 0.8), and a fully connected layer 5712. In the task of recovering the 3D hand shape, the output shape comprises 60 elements, corresponding to 20 3D coordinates (without the wrist, which serves as the origin). The wrist is not included in this output as it serves as the origin. In the case of wrist rotation recovery, the output shape comprises 3 elements, representing the wrist-to-palm vector. To prioritize the joints with larger errors, the model employs MSE loss. During the training process, an Adam optimizer is utilized, with an initial learning rate set to 0.0002. The batch size for training is set to 30.

In the classification task of hand-object interaction, a similar architecture is employed, although the final layer of the CNN is replaced with a linear classifier. For this task, the output shape is 12 elements, signifying the number of classes, and Cross-Entropy (CE) loss is employed to facilitate accurate classification.

In some embodiments, we applied data augmentation to improve the robustness of the model. During training, the echo profiles were randomly vertically shifted by ±11 pixels. This was applied to compensate for the variance caused after remounting, where the position of the wristband may shift vertically. In addition, in 80% of cases during training, each pixel in the echo profiles was multiplied by a random factor between 0.95 and 1.05, to avoid overfitting to a fixed set of values after multiple epochs.

While the assessment of simple and complex gestures primarily centered on joint movements, the evaluation of wrist orientations specifically focused on wrist rotation. As a result, we employed different metrics for these two distinct tasks.

To evaluate the performance of EchoWrist in 3D hand pose estimation, we utilize mean MJEDE and MJAE. The MJEDE of each frame is calculated by averaging the Euclidean distance of 20 joints (excluding the wrist). The MJAE is calculated by averaging the angular error of the 15 joint angles (excluding five fingertips). Each joint angle is the angle between two consecutive bone segments. In addition to MJEDE and MJAE, we also present the error distribution and the error of each joint or joint segment.

To evaluate the performance of EchoWrist on wrist rotation estimation, we use the mean wrist angular error (MWAE) as the evaluation metrics, which is calculated by the angular error of the wrist-to-palm vector. In this context, the wrist-to-palm vector \vec{v₉} is defined as the vector pointing from the wrist to the metacarpophalangeal joint of the middle finger, as shown in part (b) of FIG. 55.

In the first study, we utilized three sets of hand gestures to demonstrate that EchoWrist is able to continuously recover the 3D hand pose when there is no object in the hand. With the second study, we incorporated 12 activities to demonstrate that, beyond the tracking of free-hand postures, EchoWrist possesses the ability to comprehend hand-object interactions.

Following a two-step training approach, we first trained a LOPO model for each participant and then fine-tuned the model with the specific participant's data. The fine-tuned model was tested on the last two sessions from the participant's data. When we used the first 18 sessions (i.e., all sessions except the testing ones) as training data to fine-tune the LOPO model, our results yielded an MJEDE of 4.81 mm (SD=0.99 mm) and MJAE of 3.790 (SD=0.68°) across all participants. It should be noted that this performance remained consistent among participants.

In general, fingertips exhibited the largest error, with an average of 10 mm, across all finger joints. Among the five fingertips, the thumb's fingertip had the highest error, measuring 10.0 mm. However, this discrepancy was not significantly larger than that of other fingertips. The joint angle at the proximal joint of the ring finger has the largest angular error of 5.1°. Specifically, although fingertips tend to have larger Euclidean distance errors, the angular errors of all joints are similar. This indicates that the larger error on the tips of the fingers largely comes from accumulated error from connected joints. Performance on single-finger and complex-finger gestures are similar: the MJEDE on simple and complex gestures is 4.69 mm (SD=1.17 mm) and 4.87 mm (SD=0.94 mm), while the MJAE is 3.64° (SD=0.75°) and 3.87° (SD=0.67°). This shows that EchoWrist works consistently in estimating the hand poses while performing hand poses with different complexities.

The results from the above experiments showed promising tracking performance. However, it required 18 sessions of training data from each participant, which took 36 minutes to collect. It may not be preferred by many users if a new user has to collect such a long period of training data.

Therefore, in a follow-up experiment, we examined how much training data is actually needed for a new participant without significantly compromising the performance. To do this, we manipulated the number of sessions used during the fine-tuning stage. When no data from the same participant is used, the MJEDE and MJAE across all participants are 12.2 mm (SD=3.73 mm) and 7.370 (SD=1.730), respectively. Note that this is performance in the user-independent experiment of EchoWrist. When only using 0.5 sessions (about 1 minute) of data, the performance improved to MJEDE 6.92 mm (SD=2.42 mm) and MJAE 4.99° (SD=1.28°). The error distribution when 0, 0.5, and 18 sessions were used for fine-tuning was determined, and it was found that the performance improves with more training data. However, we noticed the performance stopped increasing with 8 sessions of training data (20 minutes). This indicates that a new user only needs to provide 20 minutes of training data to obtain optimized performance. Even with only 1 minute of training data, EchoWrist can still achieve acceptable performance. These results show the potential of using the disclosed sensing technology for real-world users with minimal calibration from each new user.

A similar approach is followed to evaluate EchoWrist's performance in estimating wrist rotation. When using 18 sessions for fine-tuning, the MWAE across all participants is 6.95° (SD=2.23°). In the User-Independent (UI) setting, where no training data from the same participant was used, the performance is 17.5° (SD=5.75°). With only 0.5 sessions (72 seconds) of training data, EchoWrist still achieves a performance of 9.54°.

Additional experimental results indicate that there is no significant performance degradation when different types of noises are injected, for example, in café, curbside and background music scenarios. Moreover, the system was able to maintain consistent performance in terms of MJEDE across different motion speeds.

Illustrative embodiments of the EchoWrist system described above are low-power and minimally-obtrusive, demonstrating the potential for integration into commodity smartwatches. For example, EchoWrist in some embodiments implements acoustic sensing using two MEMS microphones and two corresponding speakers placed 5 mm above the skin. Therefore, integrating this sensing technology into existing and future smartwatches is straightforward. For example, the disclosed EchoWrist device can be integrated with an Apple Watch Series 8 45 mm. EchoWrist can take advantage of the thickness of the watch's body and the straps to keep the sensors minimally visible. It should also be noted that many smartwatches on the market today, including the Apple Watch, already come equipped with speakers.

Furthermore, the integration of the two pairs of microphones and speakers into the watch and the band, respectively, serves as a practical solution. Given the minimal cost, low energy consumption, and compact size of microphones and speakers, incorporating an extra speaker-microphone pair into a smartwatch is well within the capabilities of watch manufacturers with the appropriate resources. Moreover, integrating these sensing modules into existing hardware can lead to additional power savings, as our disclosed acoustic sensing arrangements can leverage the existing microprocessor and BLE module on the smartwatch. If we focus solely on the power consumption of the two pairs of microphones and speakers, the estimated power signature is as low as 10.0 mW.

EchoWrist in some embodiments uses 20-24 kHz acoustic sounds, which are generally inaudible to most people. Human conversations and most environmental sounds are usually distributed in low-frequency ranges that can be easily filtered out. However, in the current implementation of EchoWrist, all sounds under 25 kHz are recorded and transmitted to smartphones, which may expose potential privacy risks to users if the BLE transmission is hacked and raw audio is leaked, thereby damaging privacy. To mitigate this risk, several solutions can be adopted. First, an analog band-pass filter can be implemented in the hardware to remove low-frequency sounds before they are converted into digital signals. Second, raw audio data transmission can be avoided in the processing system. This can be achieved by implementing a digital filter to remove audible frequencies in the data or by extracting features on the smartwatch and only transmitting processed features. Finally, a complete local data processing pipeline can be employed on the user's personal devices, such as a smartphone, to avoid transmitting the data into the cloud.

The above-described illustrative embodiments of EchoWrist provide an acoustic sensing system with a wristband form factor that can both track 3D hand poses continuously and recognize hand-object interactions. Two user studies with 24 participants in total demonstrate EchoWrist's capability and robustness in these two tasks. EchoWrist operates at 56.9 mW while maintaining a low-profile minimally-obtrusive form factor, and is suitable for deploying at scale in smartwatches.

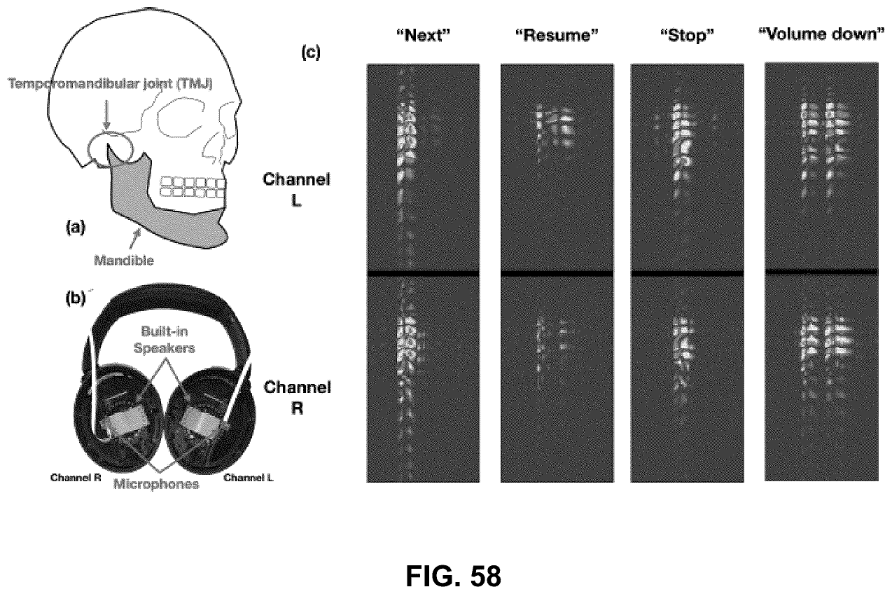

Additional illustrative embodiments include an acoustic sensing system referred to herein as HPSpeech, as will now be described in further detail with reference to FIG. 58. HPSpeech provides an example wearable device for acoustic-based silent speech recognition, and more particularly provides a silent speech interface (SSI) for commodity headphones. HPSpeech utilizes the existing speakers of the headphones to emit inaudible acoustic signals. The movements of the temporomandibular joint (TMJ) during speech modify the reflection patterns of these signals, which are captured by one or more microphones positioned inside the headphones. To evaluate the performance of HPSpeech, we tested it on two different headphones across a total of 18 participants. The results demonstrated that HPSpeech successfully recognized 8 popular silent speech commands for controlling a music player with an accuracy over 90%. While our tests use modified commodity hardware (both with and without active noise cancellation), our results show that sensing the movement of the TMJ using acoustic signals could be as simple as a firmware update for active noise cancellation headsets which already include a microphone inside the ear cup. Accordingly, the HPSpeech acoustic sensing system is suitable for rapid deployment on a variety of different types of existing and future headphones.

FIG. 58 illustrates various aspects of the HPSpeech system. HPSpeech uses active acoustic sensing to detect the movements of the TMJ of a user, as shown in part (a) of the figure, to detect silent speech of the user. Part (b) of the figure shows the wearable device in a headset form factor with two miniature microphones installed inside a pair of Bose QuietComfort (QC) 45 headphones. The built-in speakers of these example headphones are used as the acoustic signal transmitters, and corresponding acoustic signal receivers in the form of respective microphones are installed in each ear cup as shown, so as to provide right and left channels, each with a corresponding acoustic signal transmitter-receiver pair. Part (c) of the figure shows the echo profiles of respective right and left channels as generated for different silent speech commands for controlling a music player, including Next, Resume, Stop and Volume Down. It can be seen that each of these different commands results in a unique echo profile, and such echo profiles are processed in a machine learning system as disclosed herein in order to detect the respective corresponding silent speech commands.

Headphones are among the most popular wearable devices on the consumer market. The primary purpose of headphones is to listen to music or watch videos using a music or video player. Under conventional practice, there are two main methods of interacting with headphones to input commands for the corresponding music/video players. The first method requires users to use their hands to operate the buttons on the headphones or their phone or laptop. This requires users to divert their attention from their current task and can be especially challenging when their hands are busy. The second interaction approach involves using speech commands to control the headphones. While speech input provides a hands-free interaction, it may not always be convenient in certain settings, such as in a quiet library. In comparison to voice-based speech interaction, an SSI recognizes speech without the need for sound, eliminating the requirement of speaking out loud. Silent speech allows users to express their interaction intentions discreetly and in a hands-free manner, without disturbing the surrounding environment.

Recognizing silent speech has been a challenging task for the wearable community. Conventional approaches often require customized hardware or significant modification to existing form factors, and therefore may not be immediately deployable on commodity devices. Illustrative embodiments of HPSpeech as disclosed herein address these and other challenges of conventional approaches. Moreover, some embodiments can utilize acoustic sensors that are already embedded into many off-the-shelf headphones, particularly those with active noise cancellation.

In some embodiments, HPSpeech provides an SSI for commodity headphones that can recognize 8 silent speech phrases to control a corresponding music player. HPSpeech illustratively utilizes the existing speakers of the headphones to emit inaudible acoustic signals. The movements of the TMJ during speech alter the reflections of such transmitted signals before the corresponding received signals are captured by microphones positioned inside the headphone.

To understand the performance of HPSpeech, we evaluated it with 18 participants in total on two commodity headphones, namely, Bose QC 45 and Adesso Xtream G1. With a customized acoustic data processing and deep learning pipeline, HPSpeech was able to distinguish 8 popular silent speech commands to control a music player with over 90% accuracy, even when the speakers were playing music through the headphones during the entire study. Because HPSpeech utilizes the built-in speakers of commodity headphones and only needs a miniature microphone inside, it has great potential for efficient and inexpensive deployment on millions of existing and future commodity headphones. For example, as indicated previously, for devices with built-in microphones such as noise-cancelling headphones, it may be possible in some cases to deploy HPSpeech in a given such device primarily through a firmware update, and therefore with minimal or no hardware modifications.

When a user is speaking, either with or without sound, the mandible (the bone that forms the jaw) moves, as driven by facial muscles. Such movement can be detected at any position on the mandible, including the upper point, corresponding to the TMJ, which is close to the ear, as illustrated in part (a) of FIG. 58. As indicated above, HPSpeech employs active acoustic sensing using the built-in speakers on commodity headphones to sense such movements of the TMJ. Sound waves are emitted by the speakers towards the ear and its surrounding areas, including the TMJ. Movements at the TMJ causes deformations on the surface of the skin, thus resulting in subtle changes in the sound traveling paths. Such changes can be captured by microphones inside the headphones and analyzed by processing corresponding echo profiles as disclosed herein. With this method, different utterances appear as distinct patterns on the echo profiles, as illustrated in part (c) of FIG. 58.

HPSpeech utilizes active acoustic sensing as the sensing method, illustratively with 20-24 kHz FMCW signals. To simulate the case when the user is using the headphones to play music, the inaudible signals are mixed into normal music and played through the built-in headphone speakers simultaneously with the music.

After collecting the echoes from the microphones, we perform echo profile analysis utilizing the echo profiles as the representation of the TMJ movements. As mentioned previously, part (c) of the figure shows sample echo profiles we collected for different silent speech commands.

We then use a customized deep learning pipeline to infer silent speech from the echo profiles. The machine learning model in some embodiments contains a ResNet-18 backbone followed by a fully-connected decoder with cross-entropy loss. An Adam optimizer is used with initial learning rate of 0.0002. The model was trained for 100 epochs using a single NVIDIA RTX 2080 Ti GPU. The batch size was set to 5. The data was collected first during the study and then the evaluation was conducted offline.

In order to examine the impact of microphone position, we conducted a pilot study. We purchased a pair of headphones from the Internet (Razer Kraken), removed the foam and then installed 8 microphones on the left side that evenly cover the internal area, and then re-installed the foam. For the purpose of comparing different microphone positions, we only used the left side as the mandible is usually symmetric while speaking. For the Bose QC 45, we installed an additional microphone close to the built-in microphone. For the Xtream G1, we also installed a microphone, as it does not include a built-in microphone.

Following the same procedures as the main study, we evaluated the performance of each microphone position. Results show that all positions yielded very similar levels of performance, ranging from 93.0% to 94.2%, which indicates that any microphone inside the headphone could produce satisfactory results. This is especially promising considering that commodity headphones with active noise cancellation usually have multiple built-in microphones inside the headphones.

For the main study, we installed a miniature microphone inside the headphones on each side, as illustrated for the Bose QC 45 in part (b) of FIG. 58. We then tested implementations of HPSpeech on two different sets of headphones, the Bose QC 45, which is one of the most popular noise-cancelling headphones, and the Adesso Xtream G1, a pair of gaming headphones. We placed the microphone close to the location of the built-in microphone on the Bose QC 45 headphones. We chose this similar position to ensure that adopting HPSpeech on commodity headphones is highly feasible. We could not directly access the built-in microphone of Bose QC 45 due to lack of available APIs.

The built-in speakers and installed microphones were connected to a Teensy 4.1 microcontroller, which controlled the transmission and collection of acoustic signals. The data was first saved to an onboard micro SD card and then analyzed offline.

We evaluated illustrative embodiments of HPSpeech with a user study of 18 participants in total on the two slightly modified commodity headphones described above. In this study, we focused on how HPSpeech can be used to control music playing through the headphones. We designed a set of 8 example commands for controlling the music player using silent speech: Previous, Next, Pause, Resume, Stop, Volume up, Volume down, Play. These 8 commands cover common needs such as switching songs, controlling playback and pausing, as well as adjusting the volume.

During the study, participants were instructed to silently utter the commands. As people tend to speak with smaller mouth movements when speaking silently, we instructed participants to speak with exaggerated mouth movements. The level of exaggeration did not cause visually unusual speech behavior. The study was split into 21 sessions, each lasting around 2 minutes. Participants were asked to utter each command 8 times in random order in each session and remount the device between sessions. To simulate real-world scenarios where music is playing while the user attempts to utter silent commands to control it, we selected 21 songs of different genres. During each session, a random song was mixed with our inaudible signals and played through the headphones. Active noise cancellation was not turned on during the study. The sound pressure level of our signal to less than 75 dB.

After the data were collected, a researcher manually removed utterances where participants made a mistake or did not finish the command, which made up 0.86% of all utterances.

We trained a user-dependent model for each participant. We treated the first session as practice and used the remainder 20 sessions for training/testing. We performed 10-fold cross-validation on these 20 sessions, using 18 sessions for training and 2 for testing each time. Results showed that the average accuracy with Bose QC 45 was 90.3% (std=8.8%). We note that performance tended to improve with larger jaw movements, as such movements are easier for the system to detect.

HPSpeech in the illustrative embodiments of the user study utilized both sides of the headphones. Due to issues such as asymmetric head shape, head movements, etc., using both sides provided significantly better performance. Using only data on one side degraded the performance to around 83%.

The performance on Xtream G1 was more consistent, averaging 91.6% on 8 participants (std=4.1%). We performed a one-way ANOVA test on the results, and found an insignificant performance difference (F(1,16)=0.146, p=0.71>0.05) between the two headphones, indicating that HPSpeech can easily adapt to different headphones.

With regard to training, we first trained a leave-one-participant-out (LOPO) model for each user. This was a user-independent model, where new participants did not need to provide any training data. The average performance of this model was 46.9%, a lot better than random guess but far from satisfactory. This indicates that HPSpeech is still a user-dependent system in illustrative embodiments. We then fine-tuned the LOPO model with different amounts of data from the same user and generated a performance curve. Results indicate that with only 4 sessions (8 minutes) of training data from the same user, HPSpeech can already achieve 80.0% accuracy.

As indicated above, illustrative embodiments of HPSpeech are designed to be quickly deployed at scale. For example, HPSpeech in some embodiments utilizes the existing speakers on the headphones, which significantly reduces hardware modifications. Theoretically, HPSpeech can also utilize the existing microphones inside the headphones, which are widely available on commodity noise-cancelling headphones. Unfortunately, we could not find open APIs that grant access to these microphones. Also, the HPSpeech system should be coordinated with any noise cancellation system that is concurrently used, to prevent their respective signals from interfering with one another.

In the results described above, we demonstrated that HPSpeech can reach 80% accuracy with only 8 minutes of training data from new users. Additional training data generally provides higher levels of accuracy. However, this amount of training effort can also be further reduced in some embodiments. For example, EchoSpeech embodiments described elsewhere herein demonstrate that pre-training the machine learning model with other user's data can improve performance when the same amount of fine-tuning data is applied. With this approach, it is possible to first collect a large amount of training data from other users and pre-train a large base model to further reduce the training effort from new users or eventually obtain a fully user-independent system.

In some embodiments, HPSpeech is configured to implement machine learning models and other data processing calculations in a separate processing device that receives the data from the headphones. For example, some embodiments can deploy the data processing pipeline for the machine learning model and other data processing calculations on a smart phone or other device in communication with the headphones, in a manner similar to that described elsewhere herein for EchoSpeech. With recent and ongoing advancements in embedded AI chips, it is also possible to perform the data processing calculations inside the headphones themselves.

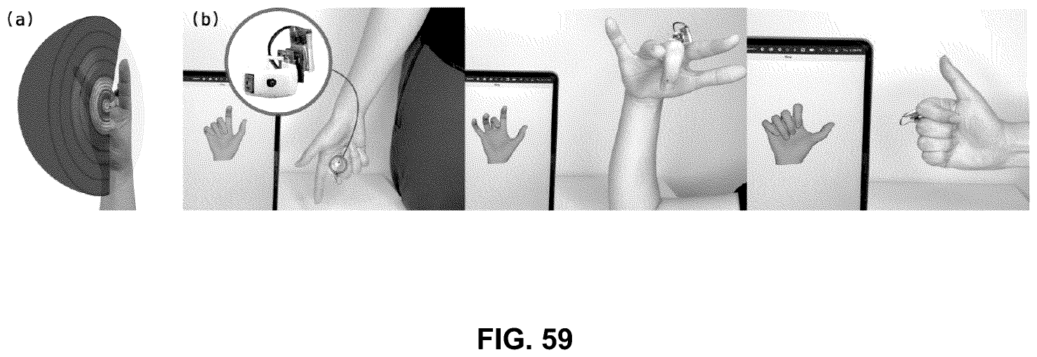

Additional illustrative embodiments include an acoustic sensing system referred to herein as Ring-a-Pose, as will now be described in further detail with reference to FIGS. 59 through 62. The Ring-a-Pose acoustic sensing system in some embodiments more particularly provides acoustic-based hand pose tracking using a wearable device in a ring form factor.

In some embodiments, the Ring-a-Pose system comprises a single untethered ring that tracks continuous 3D hand poses. Located in the center of the hand, the ring emits an inaudible acoustic signal that each hand pose reflects differently. Ring-a-Pose imposes minimal obtrusions on the hand, unlike multi-ring or glove systems. It is not affected by the choice of clothing that may cover wrist-worn systems. In a series of three user studies with a total of 30 participants, we evaluate Ring-a-Pose's performance on pose tracking and micro-finger gesture recognition. Without collecting any training data from a user, Ring-a-Pose tracks continuous hand poses with a joint error of 14.1 mm. The joint error decreases to 10.3 mm for fine-tuned user-dependent models. Ring-a-Pose recognizes 7 micro-gestures with a 90.60% and 99.27% accuracy for user-independent and user-dependent models, respectively. Furthermore, the ring exhibits promising performance when worn on any finger. Ring-a-Pose enables the future of smart rings to track and recognize hand poses using relatively low-power acoustic sensing.

FIG. 59 illustrates various aspects of illustrative embodiments of the Ring-a-Pose system. The wearable device form factor in these embodiments is an untethered ring that tracks hand poses continuously. With active acoustic sensing, we analyze the reflection strengths at different distances from the ring to reconstruct hand poses. Part (a) of FIG. 59 shows an example reflection profile, and part (b) shows examples of Ring-a-Pose's real-time inferences at different wrist and forearm orientations, with classification output presented on a display terminal of a separate processing device.

The smart ring is a promising and rising wearable for everyday use. However, due to the spatial constraint, the sensing capability of the ring has been limited: commodity rings generally only integrate miniaturized and low-power sensors (e.g., heart rate sensors, IMUs, etc.). Despite being worn on the finger, conventional smart rings generally cannot track hand poses continuously, which is crucial in understanding the user's actions and intentions (e.g., VR/AR interaction, human activity recognition, etc.). An important challenge in tracking full-hand poses on a ring is to sense enough information on the pose and movement on each finger from a single ring-worn position. For example, traditional motion sensors such as IMUs cannot provide sufficient information for continuous hand pose tracking. Illustrative embodiments of Ring-a-Pose as disclosed herein illustratively overcome these and other drawbacks of conventional approaches, through the use of acoustic sensing as disclosed herein, to provide continuous tracking of hand poses with just a single untethered ring.

Some embodiments configure the ring form factor with a wireless transmitter-receiver pair comprising a speaker and a microphone embedded into the ring. The speaker emits inaudible FMCW acoustic signals around the finger, which are reflected by the palm and fingers with unique patterns. The microphone on the same ring receives the reflected acoustic signals and transmits the received signals to a nearby computing device (e.g., a smartphone or computer) for processing using a BLE module. Then, a lightweight customized data processing and deep-learning pipeline processes the acoustic data to estimate the relative (to the wrist) positions of 20 finger joints in 3D or recognize the micro finger gestures. Ring-a-Pose is a low-cost device with a low profile, comparable with that of commercial smart rings. Furthermore, the battery consumption is relatively low power (148.0 mW) with the possibility of further optimization. To thoroughly evaluate the performance of Ring-a-Pose, we conducted three studies. In the first study with 10 participants, we compared the performance when the ring was worn on different fingers. The results showed that Ring-a-Pose can track the hand poses well, regardless of the particular finger on which the ring is worn by the user. In the second study with 12 participants, we showed that Ring-a-Pose achieves an MPJPE of 14.1 mm and 10.3 mm in user-independent and user-dependent evaluations, respectively. In the third user study with 10 participants, Ring-a-Pose was able to recognize 7 micro-finger gestures with accuracies of 90.60% and 99.27% in user-independent and user-dependent evaluation, respectively.

Unlike most data-driven hand pose tracking systems that have significant performance degradation when the sensor is remounted, Ring-a-Pose is independent of wearing sessions. Additionally, Ring-a-Pose exhibits excellent performance even when used out-of-the-box, i.e., with no calibration data from the new user, further highlighting the practicality of ring-based hand pose tracking systems using the techniques disclosed herein.

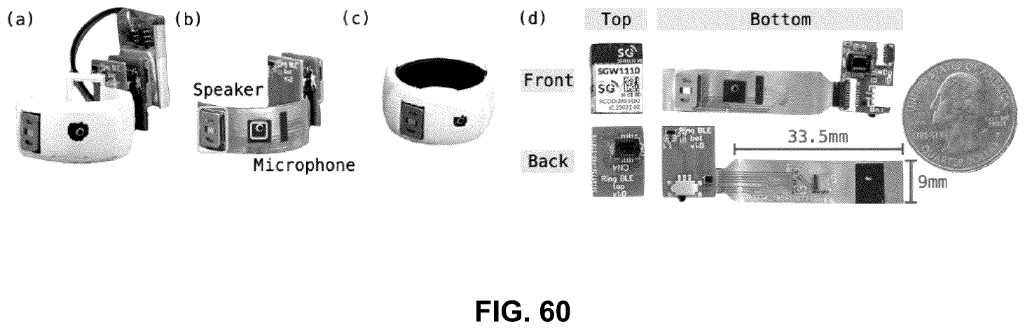

FIG. 60 shows an example hardware configuration of a Ring-a-Pose device in accordance with illustrative embodiments. Part (a) of the figure shows an example untethered Ring-a-Pose prototype used in the user studies. Part (b) of the figure shows the Ring-a-Pose prototype electronics without the case. Part (c) of the figure shows an example physical mockup of an alternative Ring-a-Pose device, in which the battery of the prototype is replaced with an arc battery and the MCU is removed. Finally, part (d) shows details of Ring-a-Pose's PCBs as implemented in the prototype device.

The Ring-a-Pose acoustics sensing ring, which provides a novel form factor for continuous hand pose tracking, places the sensors on the finger, inside the hand. This affords unique opportunities to simplify the hand reconstruction task, by maintaining great visibility of the hand and consistency between the orientations of the wrist and the sensor. Ring-a-Pose's acoustic sensing system implementation comprises a physical ring prototype and a software stack that processes the inaudible acoustic signals captured by the ring for hand pose tracking and gesture recognition.

This design in illustrative embodiments preserves the slim and miniaturized form factor of a ring for comfortable prolonged wear while achieving excellent sensing performance. The complex sensing task that predicts 3D coordinates of 20 hand joints requires information about the thumb and all other 4 fingers. Thus, working with the space constraint, we experiment with only one speaker and one microphone instead of multiple speakers and microphones. We have found that the disclosed acoustic signal processing techniques allow us to capture the shape and movements of fingers through intricate sound wave reflections. Furthermore, to minimize the width of the ring, the speaker and microphone are placed side by side horizontally, instead of vertically.

We started the prototype process with rigid PCB islands but we moved to the flexible printed circuit board (FPCB) for a slimmer ring body and a better fit to the ring curvature. The speaker and the microphone should be as close to each other as possible for accurate round-trip propagation time, but due to the ring curvature and thickness of the components, they are placed 5.4 mm away from each other in the prototype ring, which has a width of 11 mm. The ring body's thickest part, containing the speaker and microphone, is 3.58 mm thick, and the rest is 2 mm thick, comparable with that of the commercial Oura Ring. The prototype ring is also lightweight, weighing 4.3 grams including the battery (1.8 g). Finally, to fit the finger sizes of all user study participants, we utilized a ¾ circle ring for the prototype and used yarn to adjust the ring size with a sliding knot.

The ring includes a ring body, a customized FPCB enclosed in a 3D-printed PLA case, and a customized capturing and processing PCB. Part (b) of FIG. 60 shows the assembled hardware. The top PCB, shown at the left in part (d) of FIG. 60, houses the SGW1110 module, featuring the nRF52840 MCU. This low-power MCU implements Bluetooth 5 and provides BLE functions with a built-in PCB-mounted antenna. The bottom PCB, shown at the right in part (d) of FIG. 60, contains an audio amplifier (MAX98357A), a voltage regulator (TPS62743) that provides a constant 3.3V source, a switch that turns the ring on and off, an FPC connector that connects to the ring body, and a battery connector. The ring body FPCB includes a speaker (USound UTP2019) and a microphone (TDK ICS-43434). The ring is powered by a 3.7V 70 mAh LiPo battery. The power consumption of the ring was measured (using a CurrentRanger) to be 148.0 mW. The power consumption breaks down into the MCU consuming 24.0 mW, the speaker and the microphone consuming 120.0 mW, and the BLE transmission consuming 4.0 mW on average. The speaker emits FMCW signals in the range of 20-24 kHz, outside of the commonly stated range of human hearing. The 16-bit sampled signals are transmitted to a nearby device (e.g., smartphone or computer) using BLE UART communication at 800 Kbps.

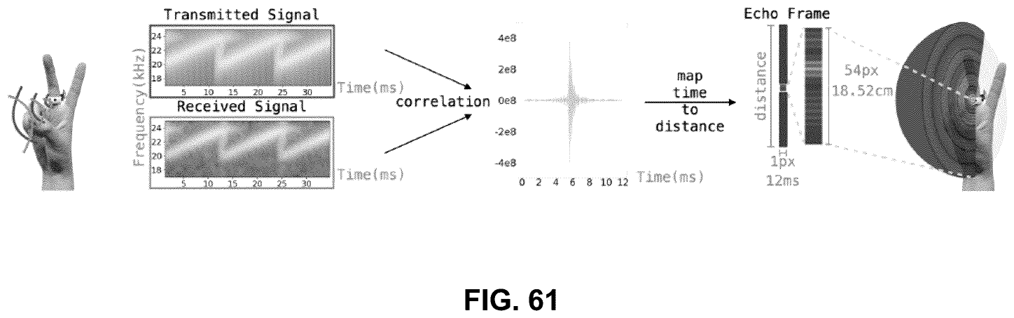

FIG. 61 illustrates the echo frame calculation in some embodiments. The cross-correlation between the transmitted FMCW signal and the received signal is mapped from the time domain to the distance domain as an echo profile. Ring-a-Pose crops 54 pixels of the echo frame, equivalent to 18.52 cm, to analyze hand poses. The black lines in the 3D visualization overlayed on the hand denote a 3 cm distance increment. The echo frame is illustratively visualized as concentric half spheres of various radii centered at the ring, as shown at the right in the figure, each characterizing the summation of reflection strengths from the corresponding radius.

Such embodiments use active acoustic sensing as the sensing principle for the ring to track continuous hand poses. The ring emits inaudible sound waves, which are then reflected and refracted by the surrounding fingers and the palm. As a result, the sound waves are received by the microphone with unique patterns, with different hand geometries yielding distinct reflected signals which we process to reconstruct hand poses.

The echo profiles in illustrative embodiments are made up of multiple 1-pixel wide echo frames of the type shown in FIG. 61, stacked along the time axis. The original echo profile captures the absolute hand geometries, and the differential echo profile captures the hand geometry movements, as described in more detail below.

As illustrated in FIG. 61, the ring's speaker emits an FMCW acoustic signal. By applying cross-correlation between the transmitted and band-pass filtered received signals, we acquire the strengths of the signals at different return/reflection times. The band-pass filtering illustratively limits the received signal to a frequency range of 20-24 kHz, the same frequency range as the emitted signals. The value of a given pixel represents the strength of correlation. The strongest correlation at the timestamp t₀ denotes the direct path between the speaker and the microphone. The delay from t₀, denoted as τ, is equivalent to fₛτ pixels in the echo frame, where fₛ=50 kHz is the sampling rate. In addition,

$$τ = \frac{2 d}{c} ,$$

where d is the distance between the ring and the reflected object, i.e., the hand, and c is the speed of sound, 343 m/s. Thus, assuming the use of C-FMCW signals, a single pixel is equivalent to

$$\frac{c}{2 {f}_{s}} = \frac{343 m / s}{2 \times 50 kHz} = 3.43$$

mm in distance along the y axis and 12 ms in time along the x axis. The hand is small compared to the theoretical sensing range of C-FMCW (3.43 mm/pixel×600 pixels=2.06 m). To remove reflections from the environment and focus on sensing the hand, we only use 54 pixels starting from to, equivalent to 18.52 cm, large enough to cover full-hand movements.

The echo frames are illustratively stacked along the time (x-axis) to acquire continuous reflection strengths at different distances. These stacked echo frames collectively form the original echo profile. To capture the changes between echo frames, we calculate a differential echo profile by subtracting the previous echo frame from the current echo frame for each of a given set of the echo frames.

A number of challenges arise in the context of hand pose tracking with a ring, including by way of example: (1) the limited physical space allows fewer electronics, reducing the amount of sensed information; and (2) the moving fingers can partially block the sensors, occluding the line-of-sight. We experimented with different sizes of microphones and speakers to minimize the obstruction.

Although there are only two input arrays of acoustic sensing information in some embodiments, these input arrays complement each other efficiently: the original echo profile encodes the positions of fingers related to poses, and the differential echo profile encodes the movement of hand geometry between poses. Each finger's position and its movements affect the original and differential echo profile, respectively. Together, they allow us to track 3D hand poses from a single point of instrumentation. With the omnidirectional speaker implemented in some embodiments, we can abstract the echo frame to be the above-noted half spheres of various radii centered at the ring, as shown at the right side of FIG. 61. A given such half sphere characterizes the total strength of reflection from the travel path lengths of the radius of the half sphere. It should be noted that the echo frame only contains reflection strength information from different distances, not exact points.

Line of sight sensors, which require a clear line between the sensor and the observed object, face the common sensor occlusion issue. Though our active acoustic sensing approach shares this obstacle, we found that the ring affords unique placement that turns hand geometrical occlusions (where fingers fully or partially block the ring) into useful and repeatable information. For example, certain hand gestures, such as “Shaka” and “Fist” gestures, are two hand poses where the ring is mostly blocked, so they both have very strong reflections. However, interestingly, the slight differences in the thumb and pinky finger positions lead to echo frame differences, with “Fist” having stronger reflections than “Shaka.”

In addition, illustrative embodiments of the Ring-a-Pose implement an acoustic sensing system is that relatively independent of the user, compared to alternative approaches, because the sensing system relies on multipath echoes reflected by the hands, which are largely determined by the anatomical structure of hands. Because human hands are similar anatomically with minor variations in size and shape between users, they lead to similar echo profiles for the same hand pose across different users.

As described above, echo profiles encode temporal (x-axis) and spatial (y-axis) information of reflection and diffraction signal strengths. With the calculated echo profiles as inputs, a deep learning pipeline of the Ring-a-Pose acoustic sensing system predicts the hand pose/gesture with data augmentation techniques.

To capture ground truth for training and evaluation, we use MediaPipe Hands to acquire the 3D coordinates of 21 key points. We subtract the wrist key point from the other 20 key points to acquire the relative ground truth joint position with respect to the wrist. We note that the depth prediction of MediaPipe Hands is not precise, but it is consistent under the same lighting conditions. Compared with a depth camera-based ground truth acquisition method, MediaPipe Hands provides better tracking of occluded joints. To account for hand position and orientation differences across sessions and participants, we normalize the hand orientation. For each detected hand pose, we find the plane defined by vectors (a) starting from the wrist (joint 0) and ending at the index finger metacarpophalangeal (MCP) joint (joint 5), and (b) starting from the wrist (joint 0) and ending at the little finger MCP joint (joint 17). We then re-align the hand by rotating the palm plane to that of a reference image. Furthermore, to ensure the same hand size for the same participant, we normalize the hand size based on the physical length measured between the wrist (joint 0) and ending at the little finger MCP joint (joint 17).

The camera we use with MediaPipe Hands is the built-in camera of an Apple MacBook Air 2022, and samples at 30 FPS, while the ring samples at 83 FPS, a much higher frequency. We synchronize the ground truth with sensor signals based on timestamps. To minimize real-time inference lagging, we pick the last sensor reading's corresponding hand coordinates as the ground truth for the echo profile window.

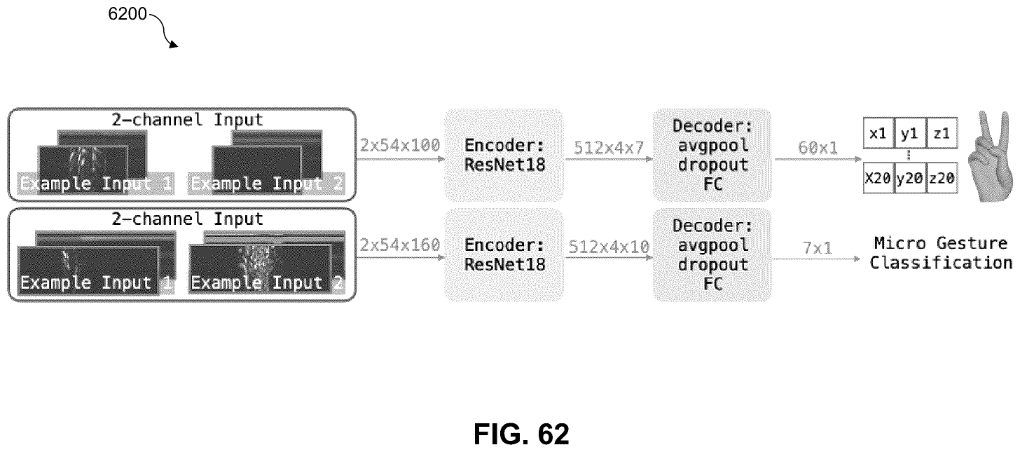

FIG. 62 shows an example machine learning system 6200 implemented in the Ring-a-Pose system. The machine learning system 6200 may be viewed as an example of machine learning system 4210 of FIG. 42. Other types of machine learning systems can be used in other embodiments.

In this embodiment, the machine learning system 6200 implements an encoder-decoder architecture for hand pose tracking and gesture classification. The encoder-decoder architecture includes an upper path shown in the upper half of the figure and a lower path shown in the lower half of the figure, each receiving 2-channel input for processing through an encoder and a decoder as indicated. Example inputs, shown as Example Input 1 and Example Input 2 for each of the upper and lower paths, have the differential echo profile channel in the front and the original echo profile channel in the back.

The trained deep learning model in the machine learning system 6200 takes echo profiles as input and outputs either 3D hand joint coordinates (e.g., 20 joint coordinates in each of x, y and z dimensions) in the upper path, or micro gesture classification labels (e.g., for 7 classes) in the lower path, depending on the sensing task. The regression and classification models share similar architectures for both tasks in the respective upper and lower paths, each including a ResNet-18 encoder and a corresponding decoder with average pooling, dropout and fully connected layers as indicated.

The differential echo profile (capturing hand movements) and original echo profile (capturing static hand poses) are stacked as 2-channel inputs as shown at the left side of FIG. 62. The dimensions of the inputs in the respective upper and lower paths are [2×54×100] and [2×54×160], equivalent to a 1.2-second (100 pixels) window and a 1.92-second (160 pixels) window for the regression and classification models, respectively. Note that for the hand pose tracking study data collection, each pose lasts 2 seconds, so some input instances capture the transition between poses, while other inputs capture static poses without movements. Thus, the pose tracking model in some embodiments learns both the static poses and dynamic transitions. For hand gesture classification data collection, each gesture is performed within a 2-second window, slightly longer than the training instance. Every collected gesture has its own unique input instance. The input echo profiles are normalized per channel to account for inconsistent magnitudes.

In the example encoder-decoder architecture, a ResNet-18 encoder is used as the encoder backbone in each of the upper and lower paths, and is configured to output a feature vector in each path. The corresponding decoder in each path illustratively comprises an average pooling layer (pool size=[1,1]), a dropout layer (p=0.8), and a fully connected layer. The final fully connected layer either outputs 20 joint coordinates each in 3 dimensions=60 coordinates for the hand pose tracking model in the upper path, or outputs the predicted label for the gesture classification model in the lower path.

The models are illustratively implemented in PyTorch and trained on an NVIDIA GeForce RTX 2080 Ti.

For the hand pose tracking model, we use the Adam Optimizer with a learning rate scheduler starting at 0.002. We train the regression model to predict the 20×3 hand joint coordinates using MSE loss. We train the user-independent model with 10 epochs and a batch size of 256. We fine-tune the model with another 15 epochs and a batch size of 32.

For the gesture classification model, we use the Adam Optimizer with a learning rate scheduler starting at 0.0002. We train the classification model to predict the gesture label using the cross entropy loss. The batch size is 32. We train the user-independent model with 120 epochs and fine-tune the model with another 120 epochs.

To improve the robustness of the models against variations in parameters such as the particular finger on which the ring is worn, ring orientations, and hand dimensions, we apply the following in-place data augmentation techniques in illustrative embodiments:

1. Randomness: Applied in both hand pose tracking and gesture classification models, random [−5%, 5%] increases at 80% chance in each pixel of the echo profile that introduces noise to hand geometry.

2. Vertical Shift: Applied in both hand pose tracking and gesture classification models, vertical shifts account for the different ring positions relative to the hand. All input echo profiles are randomly vertically shifted by ±3 pixels, equivalent to ±10.02 mm.

3. Horizontal Shift: Applied only in the gesture classification model, horizontal shifts account for inconsistent reaction times that the participants take to start performing the gesture when requested. The input echo profiles are randomly horizontally shifted by [−13%,13%] pixels at 80% chance, equivalent to ±0.15 s. Horizontal shifts are not used for hand pose tracking because the movements are continuous.

To extensively evaluate Ring-a-Pose's continuous hand pose tracking and recognition performance, we conducted three user studies: (1) a comparison of the performance with the ring worn on different fingers, (2) continuous hand pose tracking, and (3) micro gesture recognition.

As indicated previously, in the first study with 10 participants, we compared the performance when the ring was worn on different fingers. The results showed that Ring-a-Pose can track the hand poses well, regardless of the particular finger on which the ring is worn by the user. In the second study with 12 participants, we showed that Ring-a-Pose achieves MPJPE of 14.1 mm and 10.3 mm for continuous hand pose tracking in user-independent and user-dependent evaluations, respectively. In the third user study with 10 participants, Ring-a-Pose was able to recognize 7 micro-finger gestures with accuracies of 90.60% and 99.27% in user-independent and user-dependent evaluation, respectively.

It should be understood that the particular arrangements shown and described in conjunction with FIGS. 1 through 62 are presented by way of illustrative example only, and numerous alternative embodiments are possible. The various embodiments disclosed herein should therefore not be construed as limiting in any way. Numerous alternative arrangements of machine learning based acoustic signal processing can be utilized in other embodiments. Those skilled in the art will also recognize that alternative processing operations and associated system configurations can be used in other embodiments.

It is therefore possible that other embodiments may include additional or alternative system elements, relative to the entities of the illustrative embodiments. Accordingly, the particular system configurations and associated algorithm implementations can be varied in other embodiments.

A given processing device or other component of an information processing system as described herein is illustratively configured utilizing a corresponding processing device comprising a processor coupled to a memory. The processor executes software program code stored in the memory in order to control the performance of processing operations and other functionality. The processing device also comprises a network interface that supports communication over one or more networks.

The processor may comprise, for example, a microprocessor, an ASIC, an SOC, an FPGA, a CPU, a GPU, an NPU, a DPU, a TPU, an ALU, a DSP, and/or other similar processing device components, as well as other types and arrangements of processing circuitry, in any combination. For example, at least a portion of the functionality of at least one machine learning system, and its machine learning algorithms for acoustic signal processing applications, provided by one or more processing devices as disclosed herein, can be implemented using such circuitry.

The memory stores software program code for execution by the processor in implementing portions of the functionality of the processing device. A given such memory that stores such program code for execution by a corresponding processor is an example of what is more generally referred to herein as a processor-readable storage medium having program code embodied therein, and may comprise, for example, electronic memory such as SRAM, DRAM or other types of random access memory, ROM, flash memory, magnetic memory, optical memory, or other types of storage devices in any combination.

As mentioned previously, articles of manufacture comprising such processor-readable storage media are considered embodiments of the invention. The term “article of manufacture” as used herein should be understood to exclude transitory, propagating signals. Other types of computer program products comprising processor-readable storage media can be implemented in other embodiments.

In addition, embodiments of the invention may be implemented in the form of integrated circuits comprising processing circuitry configured to implement processing operations associated with implementation of a machine learning system.

An information processing system as disclosed herein may be implemented using one or more processing platforms, or portions thereof.

For example, one illustrative embodiment of a processing platform that may be used to implement at least a portion of an information processing system comprises cloud infrastructure including virtual machines implemented using a hypervisor that runs on physical infrastructure. Such virtual machines may comprise respective processing devices that communicate with one another over one or more networks.

The cloud infrastructure in such an embodiment may further comprise one or more sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the information processing system.

Another illustrative embodiment of a processing platform that may be used to implement at least a portion of an information processing system as disclosed herein comprises a plurality of processing devices which communicate with one another over at least one network. Each processing device of the processing platform is assumed to comprise a processor coupled to a memory. A given such network can illustratively include, for example, a global computer network such as the Internet, a WAN, a LAN, a satellite network, a telephone or cable network, a cellular network such as a 4G or 5G network, a wireless network implemented using a wireless protocol such as Bluetooth, WiFi or WiMAX, or various portions or combinations of these and other types of communication networks.

Again, these particular processing platforms are presented by way of example only, and an information processing system may include additional or alternative processing platforms, as well as numerous distinct processing platforms in any combination, with each such platform comprising one or more computers, servers, storage devices or other processing devices.

A given processing platform implementing a machine learning system as disclosed herein can alternatively comprise a single processing device, such as a computer, mobile telephone, wearable device or other processing device, that implements not only the machine learning system but also at least portions of one or more other system elements. It is also possible in some embodiments that one or more such system elements can run on or be otherwise supported by cloud infrastructure or other types of virtualization infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in an information processing system. Such components can communicate with other elements of the information processing system over any type of network or other communication media.

As indicated previously, components of the system as disclosed herein can be implemented at least in part in the form of one or more software programs stored in memory and executed by a processor of a processing device. For example, certain functionality disclosed herein can be implemented at least in part in the form of software.

The particular configurations of information processing systems described herein are exemplary only, and a given such system in other embodiments may include other elements in addition to or in place of those specifically shown, including one or more elements of a type commonly found in a conventional implementation of such a system.

For example, in some embodiments, an information processing system may be configured to utilize the disclosed techniques to provide additional or alternative functionality in other contexts.

It should again be emphasized that the particular embodiments described herein are intended to be illustrative only. As will be appreciated by those skilled in the art, other embodiments can be implemented utilizing a wide variety of different types and arrangements of systems, methods and devices than those utilized in the particular illustrative embodiments described herein, and in numerous alternative processing contexts. In addition, the particular assumptions made herein in the context of describing certain embodiments need not apply in other embodiments. These and numerous other alternative embodiments will be readily apparent to those skilled in the art.

What is claimed is:

1. An apparatus comprising:
at least one wearable device comprising at least one of a transmitter and a receiver of a wireless transmitter-receiver pair;
the transmitter of the wireless transmitter-receiver pair transmitting an acoustic signal;
the receiver of the wireless transmitter-receiver pair receiving the acoustic signal;
wherein the received acoustic signal is processed utilizing a machine learning system to detect at least one characteristic of a user of the at least one wearable device.

2. The apparatus of claim 1 wherein the at least one wearable device comprises at least one of smart glasses, a wristband, headphones and a ring.

3. The apparatus of claim 1 wherein the at least one wearable device comprises both the transmitter and the receiver of the wireless transmitter-receiver pair.

4. The apparatus of claim 1 wherein the at least one wearable device comprises at least a portion of the machine learning system.

5. The apparatus of claim 1 wherein the at least one wearable device comprises a first wearable device that comprises the transmitter of the wireless transmitter-receiver pair and a second wearable device that comprises the receiver of the wireless transmitter-receiver pair.

6. The apparatus of claim 1 wherein a given wearable device of the at least one wearable device comprises:
at least one of a transmitter and a receiver of a first wireless transmitter-receiver pair; and
at least one of a transmitter and a receiver of a second wireless transmitter-receiver pair different than the first wireless transmitter-receiver pair;
wherein acoustic signals received by the receivers of the first and second wireless transmitter-receiver pairs are processed utilizing the machine learning system to detect the at least one characteristic of the user of the at least one wearable device.

7. The apparatus of claim 1 wherein the acoustic signal has a frequency in a range between about 15 kHz and 25 kHz.

8. The apparatus of claim 1 wherein the acoustic signal comprises an inaudible acoustic signal.

9. The apparatus of claim 1 wherein the acoustic signal comprises a frequency modulated continuous wave (FMCW) signal.

10. The apparatus of claim 1 wherein the transmitter comprises a speaker of the at least one wearable device and the receiver comprises a microphone of the at least one wearable device.

11. The apparatus of claim 1 wherein processing the received acoustic signal utilizing the machine learning system to detect at least one characteristic of a user of the at least one wearable device comprises:
applying at least one signal processing algorithm to the received acoustic signal to extract one or more patterns from the received acoustic signal; and
classifying the one or more extracted patterns in the machine learning system.

12. The apparatus of claim 1 wherein the machine learning system comprises at least one encoder-decoder neural network that is pre-trained with unlabeled acoustic sensing data to learn a user-agnostic acoustic signal representation.

13. The apparatus of claim 1 wherein the machine learning system implements at least one of depth-wise separable convolution, skip connection-based residual convolution, and a self-attention network.

14. The apparatus of claim 1 wherein a quantized version of at least one model of the machine learning system is implemented in the at least one wearable device.

15. The apparatus of claim 1 wherein processing the received acoustic signal utilizing the machine learning system to detect at least one characteristic of a user of the at least one wearable device comprises:
filtering the received acoustic signal;
cross-correlating the transmitted acoustic signal and the filtered received acoustic signal over a plurality of frequency sweep periods to generate respective echo frames;
constructing an echo profile from the echo frames, the echo profile having a first axis corresponding to a time variable and a second axis corresponding to a distance variable; and
classifying the echo profile in the machine learning system.

16. The apparatus of claim 15 wherein the echo profile comprises a differential echo profile providing an indication of acoustic flow.

17. The apparatus of claim 16 wherein the differential echo profile is constructed at least in part by determining absolute differences between each of a plurality of pairs of consecutive echo frames.

18. The apparatus of claim 1 wherein a given wearable device of the at least one wearable device comprises at least first and second wireless transmitter-receiver pairs, with the transmitter of each of the first and second wireless transmitter-receiver pairs transmitting an acoustic signal having a different carrier frequency.

19. The apparatus of claim 18 wherein processing the received acoustic signal utilizing the machine learning system to detect at least one characteristic of a user of the at least one wearable device comprises:
generating a first channel of a multi-channel echo profile for a first acoustic signal transmitted by the transmitter of the first wireless transmitter-receiver pair and received by the receiver of the first wireless transmitter-receiver pair;
generating a second channel of the multi-channel echo profile for the first acoustic signal transmitted by the transmitter of the first wireless transmitter-receiver pair and received by the receiver of the second wireless transmitter-receiver pair;
generating a third channel of the multi-channel echo profile for a second acoustic signal transmitted by the transmitter of the second wireless transmitter-receiver pair and received by the receiver of the first wireless transmitter-receiver pair;
generating a fourth channel of the multi-channel echo profile for the second acoustic signal transmitted by the transmitter of the second wireless transmitter-receiver pair and received by the receiver of the second wireless transmitter-receiver pair; and
classifying the multi-channel echo profile in the machine learning system.

20. A method comprising:
transmitting an acoustic signal from a transmitter of a wireless transmitter-receiver pair of at least one wearable device;
receiving the acoustic signal in a receiver of the wireless transmitter-receiver pair of the at least one wearable device; and
processing the received acoustic signal utilizing a machine learning system to detect at least one characteristic of a user of the at least one wearable device;
wherein the method is performed by at least one processing device comprising a processor coupled to a memory.

21. The method of claim 20 wherein a given wearable device of the at least one wearable device comprises:
at least one of a transmitter and a receiver of a first wireless transmitter-receiver pair; and
at least one of a transmitter and a receiver of a second wireless transmitter-receiver pair different than the first wireless transmitter-receiver pair;
wherein acoustic signals received by the receivers of the first and second wireless transmitter-receiver pairs are processed utilizing the machine learning system to detect the at least one characteristic of the user of the at least one wearable device.

22. The method of claim 20 wherein a given wearable device of the at least one wearable device comprises at least first and second wireless transmitter-receiver pairs, with the transmitter of each of the first and second wireless transmitter-receiver pairs transmitting an acoustic signal having a different carrier frequency.

23. The method of claim 20 wherein processing the received acoustic signal utilizing the machine learning system to detect at least one characteristic of a user of the at least one wearable device comprises:
applying at least one signal processing algorithm to the received acoustic signal to extract one or more patterns from the received acoustic signal; and
classifying the one or more extracted patterns in the machine learning system.

24. The method of claim 20 wherein processing the received acoustic signal utilizing the machine learning system to detect at least one characteristic of a user of the at least one wearable device comprises:
filtering the received acoustic signal;
cross-correlating the transmitted acoustic signal and the filtered received acoustic signal over a plurality of frequency sweep periods to generate respective echo frames;
constructing an echo profile from the echo frames, the echo profile having a first axis corresponding to a time variable and a second axis corresponding to a distance variable; and
classifying the echo profile in the machine learning system.

25. A computer program product comprising a non-transitory processor-readable storage medium having stored therein program code of one or more software programs, wherein the program code, when executed by at least one processing device comprising a processor coupled to a memory, causes the at least one processing device:
to transmit an acoustic signal from a transmitter of a wireless transmitter-receiver pair of at least one wearable device;
to receive the acoustic signal in a receiver of the wireless transmitter-receiver pair of the at least one wearable device; and
to process the received acoustic signal utilizing a machine learning system to detect at least one characteristic of a user of the at least one wearable device.

26. The computer program product of claim 25 wherein a given wearable device of the at least one wearable device comprises:
at least one of a transmitter and a receiver of a first wireless transmitter-receiver pair; and
at least one of a transmitter and a receiver of a second wireless transmitter-receiver pair different than the first wireless transmitter-receiver pair;
wherein acoustic signals received by the receivers of the first and second wireless transmitter-receiver pairs are processed utilizing the machine learning system to detect the at least one characteristic of the user of the at least one wearable device.

27. The computer program product of claim 25 wherein a given wearable device of the at least one wearable device comprises at least first and second wireless transmitter-receiver pairs, with the transmitter of each of the first and second wireless transmitter-receiver pairs transmitting an acoustic signal having a different carrier frequency.

28. The computer program product of claim 25 wherein processing the received acoustic signal utilizing the machine learning system to detect at least one characteristic of a user of the at least one wearable device comprises:
applying at least one signal processing algorithm to the received acoustic signal to extract one or more patterns from the received acoustic signal; and
classifying the one or more extracted patterns in the machine learning system.

29. The computer program product of claim 25 wherein processing the received acoustic signal utilizing the machine learning system to detect at least one characteristic of a user of the at least one wearable device comprises:
filtering the received acoustic signal;
cross-correlating the transmitted acoustic signal and the filtered received acoustic signal over a plurality of frequency sweep periods to generate respective echo frames;
constructing an echo profile from the echo frames, the echo profile having a first axis corresponding to a time variable and a second axis corresponding to a distance variable; and
classifying the echo profile in the machine learning system.
